(19) United States
(12) Patent Application Publication
(10) Pub. No.: US 2015/0088670 A1
(43) Pub. Date: Mar. 26, 2015

(54) REAL ESTATE BUSINESS COLLABORATION AND GROWTH TECHNIQUES

(71) Applicant: Realeflow, LLC, Parma Hts, OH (US)

(72) Inventor: Gregory R. Clement, Brunswick, OH (US)

(21) Appl. No.: 14/536,857

(22) Filed: Nov. 10, 2014

Related U.S. Application Data
(63) Continuation of application No. 13/304,281, filed on Nov. 23, 2011.
Application No. 13/304,281 is a continuation-in-part of application No. 12/157,412, filed on Jun. 7, 2008.
(60) Provisional application No. 61/417,195, filed on Nov. 24, 2010.
(60) Provisional application No. 60/933,914, filed on Jun. 7, 2007.

(51) Int. Cl. G06Q 30/06; G06Q 50/16; G06Q 30/02

(52) U.S. Cl. CPC G06Q 30/0613; G06Q 30/0277; G06Q 50/16
USPC 705/14.73; 705/26.41

(57) ABSTRACT

Various technologies and techniques are disclosed for real estate business collaboration and growth. A real estate business system includes a lead generation module, collaboration module, and paperless office module for integrating various features together to advance one or more real estate transactions. Lead generation module facilitates the generation of leads for real estate transactions. Lead generation module has a property syndication tool, squeeze pages tool, follow-up sequences tool, lead pipes tool, property launch template tool, and other tools. Collaboration module facilitates transactions among users and/or third parties, as well as tracks the progression of activities throughout the life cycle of a real estate transaction. Collaboration module includes a suitability matching tool, linking tool, and other collaboration tools. Paperless office module provides various automated tools, such as an auto package generator tool, digital fax tool, and project estimator tool that streamline the process of moving through a real estate transaction.

### CROSS-REFERENCE TO RELATED APPLICATIONS

This application claims the benefit of U.S. Provisional Application No. 61/417,195, filed Nov. 24, 2010, and is also a continuation-in-part of U.S. application Ser. No. 12/157,412, filed Jun. 7, 2008, which claims the benefit of U.S. Provisional Application No. 60/933,914, filed Jun. 7, 2007, the entire disclosures of which are hereby incorporated by reference for all purposes as if fully set forth herein.

### BACKGROUND

Real estate investing remains a useful mechanism for building wealth, but it also presents unique challenges. Home buyers and sellers, for example, are often confronted with a variety of unfamiliar tasks. Home buyers generally have a fixed goal of buying or selling their part-time or full-time dwelling. Real-estate investors, on the other hand, are often confronted by an even wider range of short and long term tasks that may encompass a wide range of investment goals, rendering real estate investing difficult for even the expert, let alone the novice investor. It can be difficult or extremely time consuming for sellers to find interested buyers, and for real estate investors or owner-occupied buyers to find properties for sale that meet their specific criteria. Further complicating the issue is the series of steps involved in moving a transaction closer to closing, including the more complex scenarios involving short sale, probate, or bankruptcy scenarios. Unfortunately, few useful resources exist for addressing the challenges facing home buyers and sellers, or further, real-estate investors.

Accordingly, there is a need for systems and methods that provide for conducting or otherwise facilitating real estate business, collaboration and knowledge accumulation sharing.

### SUMMARY

Embodiments of the present invention include processing tools, resources and environment components that may be utilized alone or in combination for conducting or otherwise facilitating real estate business, collaboration and knowledge accumulation sharing, thereby enabling conventional difficulties to be avoided or further advantages to be achieved.

Embodiments of the invention provide for buying and selling real estate in a manner that may depart from the conventional single-match model. Much like buying or selling the family home, the conventional model requires a single user, working alone, to essentially conduct a repetitive cycle of separate tasks in which the user: purchases a single property, then searches for a buyer who may be interested in purchasing that particular property and then sells the property to the newly discovered buyer. Each real estate deal, for all practical purposes, begins completely anew with the purchase of each new property (e.g., find the new property, then begin a new search for a new buyer that may be interested in purchasing the new property, and so on).

While embodiments of the invention may support a single-match model (if desired in a particular instance), they also enable users to more optimally conduct potential or actual real estate deals, as well as included or otherwise related transactions or transaction aspects that may advance the real estate deals. Various embodiments enable users to conduct such deals, transactions or transaction aspects successively or concurrently as may be desired at any particular time. Embodiments also enable users to accumulate or share knowledge prior to or otherwise independently of a particular deal, transaction or transaction aspect in which such knowledge may be further utilized. Embodiments also enable the users to individually, coordinatingly or collaboratively conduct the same or different potential or actual deals, transactions or transaction aspects while: assuming the same or different roles, interacting according to the (typically advancing) status of other parties or assistance of third parties; accumulating, fully or partially sharing or utilizing pools of leads, prospects, other contacts, experience, tools or other knowledge; forming authoritative or self-authenticating transaction documentation, creating or utilizing modifiably reusable/adaptable tool automation, consulting with virtual advisors, party identification, user/knowledge linking, and so on, among other combinable aspects.

Users may, in various embodiments, include one or more of independent or affiliated buyers; sellers; buyer investors; seller investors; investor, owner/occupier, agent and other intermediaries; and users that may perform more than one role in the same or different actual or potential real estate deals, transactions or transaction aspects. Users may also, in various embodiments, include, for example, full access, limited access and guest access users.

In one embodiment, a real estate business, collaboration and knowledge acquisition sharing system (“real estate business system”) includes a real estate business application hosted by a central server, and one or more user systems that are couple-able to the central server for invoking features of the real estate business application. The real estate business application provides, within a multiple-focus timeline environment, a compliment of operational real estate transaction tools that may be invoked by respective system users to individually, coordinatingly or collaboratively: accumulate a knowledge base including user-specific and shared real estate business contact, property, experience and other conduct real estate business data; evaluate/conduct one or more real estate business deals; and utilize portions of the knowledge base or further data to conduct transactions or transaction aspects corresponding to the real estate business deals.

The multiple-focus timeline environment in one embodiment provides a split timeline-based presentation of a portion of the operational tools and knowledge base that are available to the user, and at least one persistable transaction attribute. A deal-&-transaction timeline provides user access to or presentation of real-estate business transaction tools or stored user/shared data according to an optimized progression of transactions/transaction aspects in advancing a real estate deal and a user/other party role in conjunction with the real estate deal or deals. A further transaction-&-aspect timeline provides user access to or presentation of real estate business transaction tools or stored user/shared data according to an optimized progression of transaction aspects of a current transaction. Each timeline may further correspond with one or more users, deals, transactions or transaction aspects. The embodiment may also persist one or more transaction attributes within the transaction-&-aspect timeline or in a further presentation. Such attributes may, for example, include a particular contact, property and/or other knowledge that may be needed for or the current focus of a transaction or transaction aspect. A further embodiment provides for modifying the environment (e.g., one or both timelines) to indicate or further conduct processing according to a status or advancing status of one or more other persons with which a user is interacting (e.g., lead, prospect, party to an actual/potential deal, and so on).

In another embodiment, the real estate transaction tools comprise resource utilization advisors including a deal advisor, short sales advisor, and project resource allocation estimator. The resource utilization advisors respectively provide for conducting scenario analysis, comparison, advancement evaluation and customizable reporting relating respectively to: potential, actual or alternative deals, transactions or transaction aspects, short sales viability, and allocation of cost or other resources relating to renovation and/or other investment of user and/or other party resources. The advisors may, for example, utilize user data input or statistical models, as well as other accumulated knowledge base data corresponding to a same or different deal, transaction or transaction aspect of the same or a different user.

A further embodiment provides suitability matching tools. These provide for determining transaction-utilization transaction attributes (“transaction attributes”) corresponding to transaction data that may be utilized in determining applicability of acquired data in conjunction with current or future actual and/or potential deals, transactions or transaction aspects. The embodiment further provides for responding to user invocation in conjunction with such deals, transactions or transaction aspects by determining a corresponding subset of the data, according to such attributes or further criteria. For example, a transaction matching tool provides for associating actual and/or potential buyers with transaction attributes indicating their areas of preference, proximity, resource availability, deal/transaction history, likely follow through or other indicators of suitability or comparative suitability in conjunction with a (typically future) actual or potential purchase or sale of a property. The transaction matching tool further provides, in conjunction with a (typically future) availability of one or more properties for purchase or sale, for determining one or more of those sellers or buyers that may be interested or should be considered (or the nature/extent of such interest/consideration) as potential purchasers of the properties. In another embodiment, potential buyers may include one or both of disclosed buyers (whom the user may identify) and blind or “community matching” buyers (that one or more other users or the system may indicate exist without requiring that they reveal corresponding contact information). Matching tools may also operate in conjunction with other persons, properties or other roles in conjunction with a particular deal, transaction or transaction aspect.

Yet another embodiment includes guest linking and lead development tools. Guest linking tools enable a user to permit selectively limited access by third parties to the user's data. Such access may, for example, be limited to one or more particular deals, transactions or transaction aspects with which the third party is or otherwise may participate. Lead development tools provide for determining a pattern of communication with non-user sellers or other transaction parties that is more likely to generate interest or responsiveness in the parties, for compiling communication information and for initiating such communication with the parties. Such tools may also provide for determining a current status of such operation or responsiveness of one or more of such parties or classification(s) of such parties, among other aspects.

Among other embodiments, one particular embodiment provides for conducting team-based real estate business. For example, the embodiment provides for one user assigning one or more tasks (e.g., management or other interactions or interaction aspects), to various team members or third parties, and further provides for presenting to a corresponding team member or third party only applicable information or tasks.

Various technologies and techniques are disclosed for real estate business collaboration and growth. A real estate business system includes a lead generation module, collaboration module, and paperless office module for integrating various features together that aid in advancing one or more real estate transactions.

Lead generation module facilitates the generation of leads for real estate transactions, such as leads on people or companies who may be interested in buying or selling particular type of property that other users may be interested in. Lead generation module has a property syndication tool, squeeze pages tool, follow-up sequences tool, lead pipes tool, property launch template tool, and other tools.

Collaboration module facilitates transactions among users and/or third parties, as well as for tracks the progression of activities throughout the life cycle of a real estate transaction. Collaboration module includes a suitability matching tool, linking tool, and other collaboration tools. Paperless office module provides various automated tools that streamline the process of moving through a real estate transaction. Paperless office module includes auto package generator tool, digital fax tool, project estimator tool, and other paperless office tools.

In one implementation, a property syndication tool is provided that receives property details about a particular property. A selected group of places to distribute a property listing associated with the particular property is received from a user. A custom property listing web page is created for the property listing. The property listing is submitted to the selected group of places with a link to the custom property listing web page.

In another implementation, a lead pipes tool is provided that receives lead source data from at least one data feed, the lead source data including details about people who may be interested in one or more real estate transactions. The lead source data is made available users for purposes of facilitating one or more real estate transactions, the users including buyers and sellers of real estate. A selection is received from a particular one of the users to filter the lead source data based upon a specified criteria. A subset of the lead source data is identified that includes properties that match the specified criteria. The subset of the lead source data is saved to corresponding lead records that are accessible by the particular one of the users for further follow-up. In one implementation, the selection to filter the lead source data is received through a direct mail campaign tool, where the direct mail campaign tool can send direct mail correspondence based upon the subset of the lead source data once the subset has been identified.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1a is a flow diagram illustrating a real estate business, collaboration and knowledge acquisition sharing system (“real estate business management system”) according to an embodiment of the invention.

FIG. 1b is a flow diagram illustrating a further real estate business management system according to an embodiment of the invention.

FIG. 2 is a flow diagram illustrating a real estate knowledge base and associations of data therein according to an embodiment of the invention.

FIG. 3a is a flow diagram illustrating a split dual timeline, transaction based data persistence and independent share-able data accumulation operations of a real estate management system and real estate management system interface (“REM interface”) according to an embodiment of the invention.

FIG. 3b is a flow diagram illustrating how the REM interface operations of FIG. 3a may be extended to the real estate business management system and REM interface by way of one or more further integral transaction or transaction aspect advancement sub-timelines in accordance with user selection or advancement of a potential or actual real estate deal.

FIG. 4-FIG. 70 illustrate various visual and textual presentations, user interactions and system responses thereto of the interface and operational features of the real estate business, collaboration and knowledge acquisition sharing system.

FIG. 71A-D, FIG. 72A-C, and FIG. 73A-D show diagrams illustrating embodiments that may comprise one or more of the components of the estate business, collaboration and knowledge acquisition sharing system according to any of the embodiments of the invention.

FIG. 74A-B is a diagram illustrating a computing system embodiment that may comprise one or more of the components according to any of the embodiments of the invention.

FIG. 75 is a diagrammatic view of a real estate business collaboration system of one implementation.

FIG. 76 is a process flow diagram for one implementation illustrating the stages involved in syndicating property listings to multiple web sites.

FIG. 77 is a simulated screen for one implementation that illustrates launching a property syndication tool.

FIG. 78 is a simulated screen for one implementation that illustrates specifying details for a property listing for use in syndication.

FIG. 79 is a simulated screen for one implementation that illustrates selecting the places to submit the property listing to.

FIG. 80 is a simulated screen for one implementation that illustrates a link to a custom property listing page that gets used with the syndication.

FIG. 81 is a simulated screen for one implementation that illustrates an exemplary custom property listing page that gets created by the syndication tool.

FIG. 82 is a simulated screen for one implementation that illustrates creating a property flyer.

FIG. 83 is a simulated screen for one implementation that illustrates specifying the type of document to be used to create a property flyer.

FIG. 84 is a simulated screen for one implementation that illustrates an alert message that is displayed to indicate the property flyer is being generated.

FIG. 85 is a simulated screen for one implementation that illustrates an alert message that is displayed once the property flyer has been generated.

FIG. 86 is a simulated screen for one implementation that illustrates selecting an option to view a property flyer.

FIG. 87 is a simulated screen for one implementation that illustrates an exemplary property flyer.

FIG. 88 is a process flow diagram for one implementation illustrating the stages involved in creating and managing squeeze pages and their corresponding autoresponder sequences.

FIG. 89 is a simulated screen for one implementation that illustrates selecting an option to view and manage squeeze pages.

FIG. 90 is a simulated screen for one implementation that illustrates same exemplary squeeze page setup details.

FIG. 91 is a simulated screen for one implementation that illustrates an exemplary squeeze page.

FIG. 92 is a simulated screen for one implementation that illustrates customizing autoresponder information for one or more squeeze pages.

FIG. 93 is a simulated screen for one implementation that illustrates some exemplary autoresponder steps for a selected squeeze page.

FIG. 94 is a simulated screen for one implementation that illustrates an example email for a selected autoresponder step.

FIG. 95 is a process flow diagram for one implementation illustrating the stages involved in using lead pipes as additional lead sources.

FIG. 96 is a simulated screen for one implementation that illustrates specifying criteria to use for identifying new leads using lead pipes.

FIG. 97 is a simulated screen for one implementation that illustrates selecting a county to use in a lead pipe search.

FIG. 98 is a simulated screen for one implementation that illustrates some example data records that were returned as possible leads from the lead pipe search.

FIG. 99 is a simulated screen for one implementation that illustrates some exemplary types of lead pipes.

FIG. 100 is a simulated screen for one implementation that illustrates some exemplary options for saving one or more selected leads for later use with other system features.

FIG. 101 is a simulated screen for one implementation that illustrates selecting recipients to use as part of a direct mail campaign.

FIG. 102 is a simulated screen for one implementation that illustrates selecting the creative to be used as part of a direct mail campaign.

FIG. 103 is a simulated screen for one implementation that illustrates customizing the creative to be used as part of a direct mail campaign.

FIG. 104 is a simulated screen for one implementation that illustrates setting a budget for the specified direct mail campaign.

FIG. 105 is a simulated screen for one implementation that illustrates finalizing the direct mail campaign settings for the specified direct mail campaign.

FIG. 106 is a simulated screen for one implementation that illustrates reviewing details about any existing direct mail campaigns.

FIG. 107 is a simulated screen for one implementation that illustrates a template library for use with direct mail campaigns.

FIG. 108 is a simulated screen for one implementation that illustrates previewing a selected one of the templates from the direct mail template library.

FIG. 109 is a process flow diagram for one implementation illustrating the stages involved in using a digital fax service.

FIG. 110 is a simulated screen for one implementation that illustrates the selection of an option to send a fax.

FIG. 111 is a simulated screen for one implementation that illustrates specifying details regarding the fax and for the cover sheet.

FIG. 112 is a simulated screen for one implementation that illustrates an alert message that is displayed when a new fax is received.

FIG. 113 is a simulated screen for one implementation that illustrates options for saving a fax to a particular record or other document location.

FIG. 114 is a simulated screen for one implementation that illustrates a documents section of the system that faxes can be saved to.

FIG. 115 is a simulated screen for one implementation that illustrates some options for saving a fax to a seller record.

FIG. 116 is a simulated screen for one implementation that illustrates selecting an option to split a fax into multiple documents.

FIG. 117 is a simulated screen for one implementation that illustrates an option to add page ranges for the split fax.

FIG. 118 is a simulated screen for one implementation that illustrates specifying page ranges to split a particular fax into.

FIG. 119 is a simulated screen for one implementation that illustrates having an option to save the original fax in addition to the split fax.

FIG. 120 is a simulated screen for one implementation that illustrates searching for a seller record to save the fax to.

FIG. 121 is a simulated screen for one implementation that illustrates the split fax being saved as separate documents to the selected seller record.

FIG. 122 is a process flow diagram for one implementation illustrating the stages involved in using an auto package generator to create document packages.

FIG. 123 is a simulated screen for one implementation that illustrates to selecting an option to use an auto package generator.

FIG. 124 is a simulated screen for one implementation that illustrates selecting a type of auto package to generate.

FIG. 125 is a simulated screen for one implementation that illustrates some exemplary section of a short sale package.

FIG. 126 is a simulated screen for one implementation that illustrates some additional exemplary section of a short sale package.

FIG. 127 is a simulated screen for one implementation that illustrates selecting a section to assign document(s) to.

FIG. 128 is a simulated screen for one implementation that illustrates choosing document(s) to use for a particular section of the package.

FIG. 129 is a simulated screen for one implementation that illustrates which sections of the auto package have been specified, and an option to generate the package.

FIG. 130 is a simulated screen for one implementation that illustrates specifying some title, footer, and other options for the package.

FIG. 131 is a simulated screen for one implementation that illustrates an alert message that is displayed once the package has been generated using the auto package generator.

FIG. 132 is a simulated screen for one implementation that illustrates selecting an option to open the newly created package.

FIG. 133 is a simulated screen for one implementation that illustrates an exemplary package that was created using the auto package generator.

FIG. 134 is a simulated screen for one implementation that illustrates how the package gets saved in the record it was generated for.

FIG. 135 is a process flow diagram for one implementation illustrating the stages involved in using a property launch template to launch a property for sale at a specific date and time.

FIG. 136 is a simulated screen for one implementation that illustrates selecting an option to launch a property launch template tool.

FIG. 137 is a simulated screen for one implementation that illustrates specifying details of the property launch.

FIG. 138 is a simulated screen for one implementation that illustrates an exemplary property launch web site.

FIG. 139 is a diagrammatic view of a computer system of one implementation.

### DETAILED DESCRIPTION

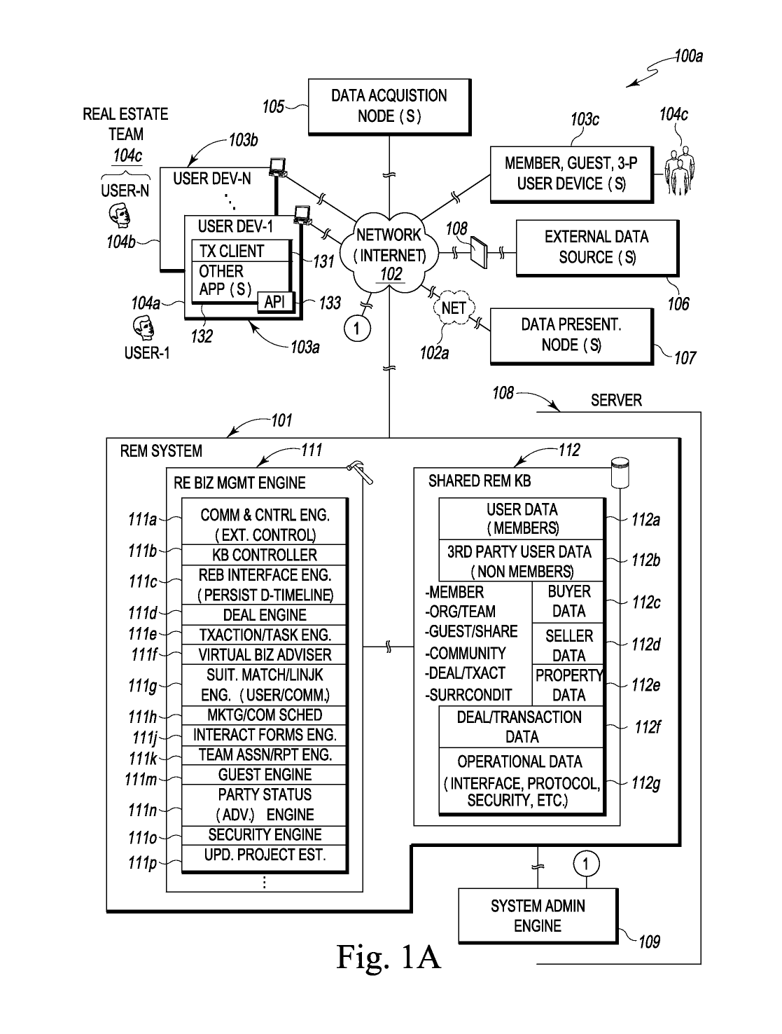

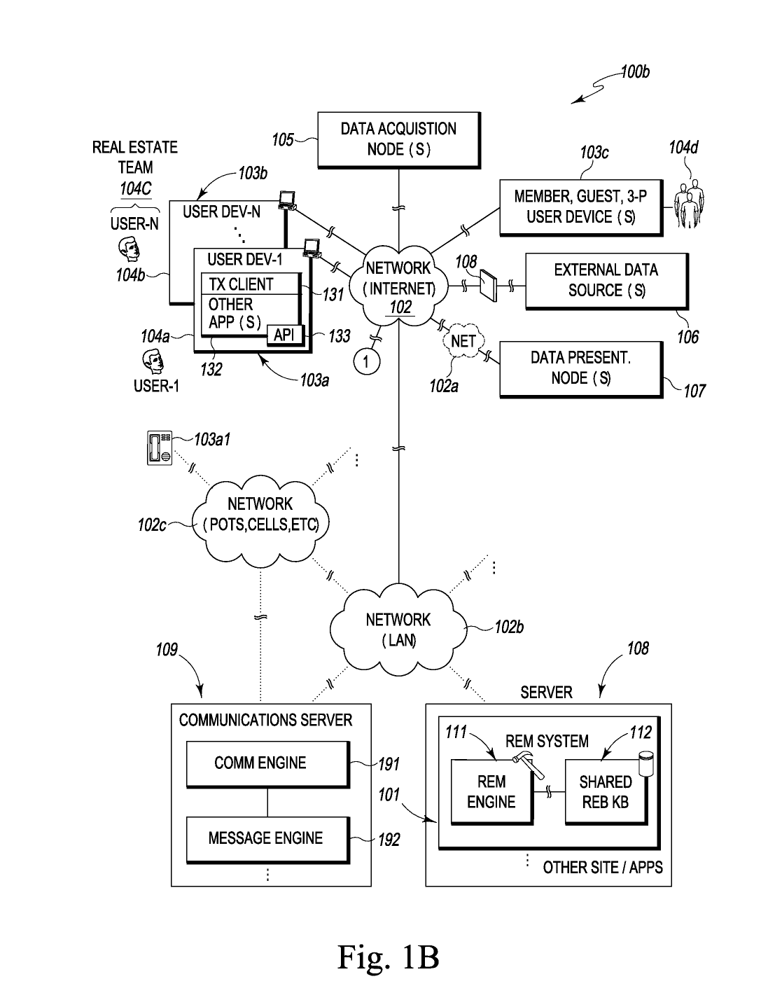

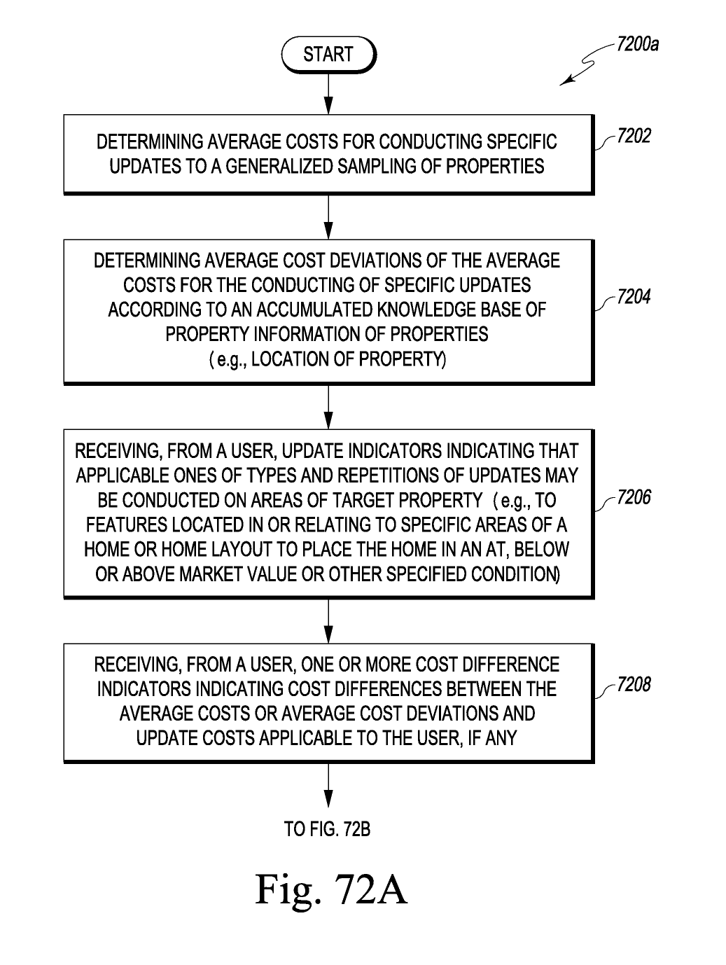

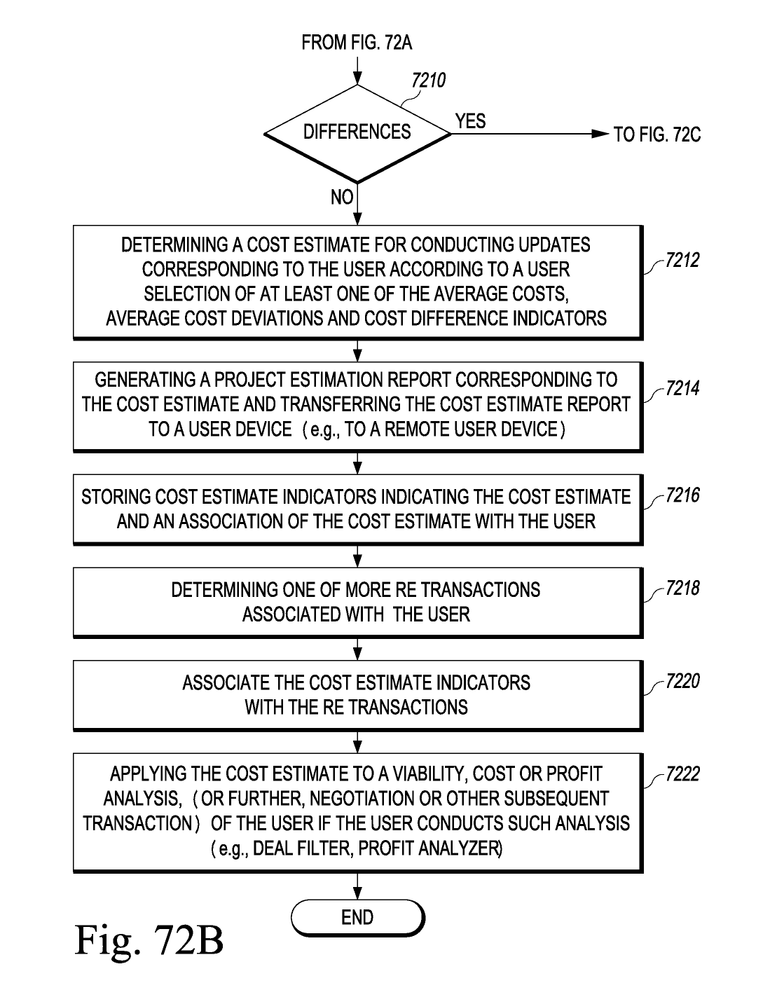

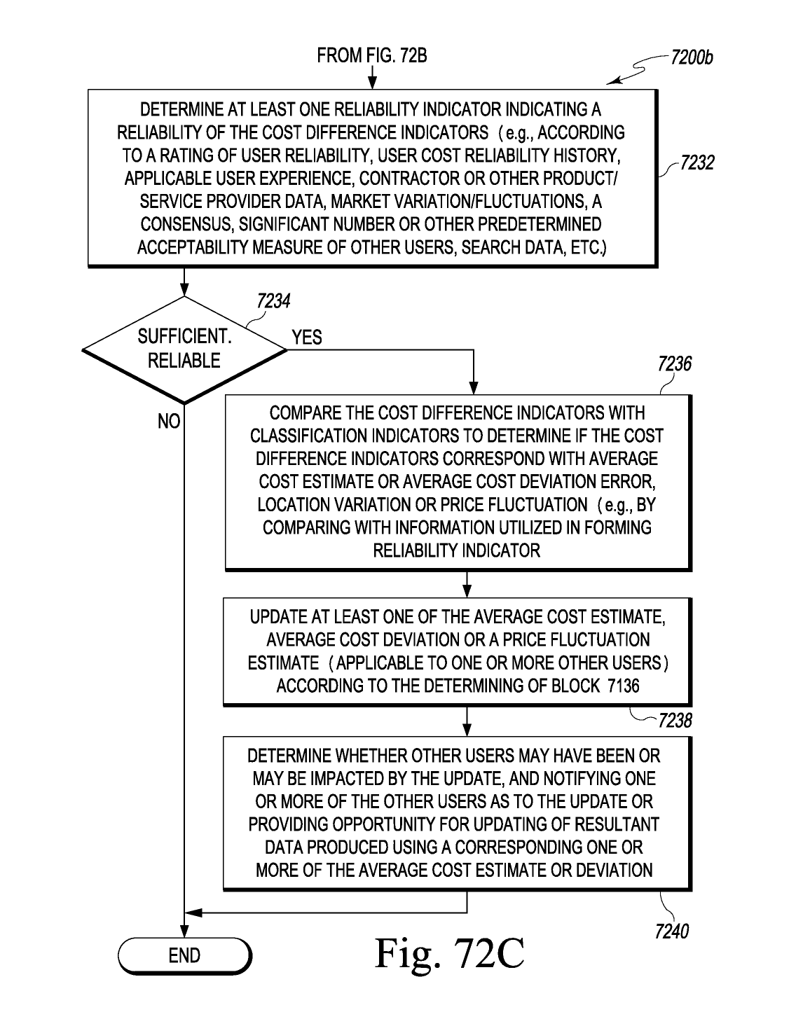

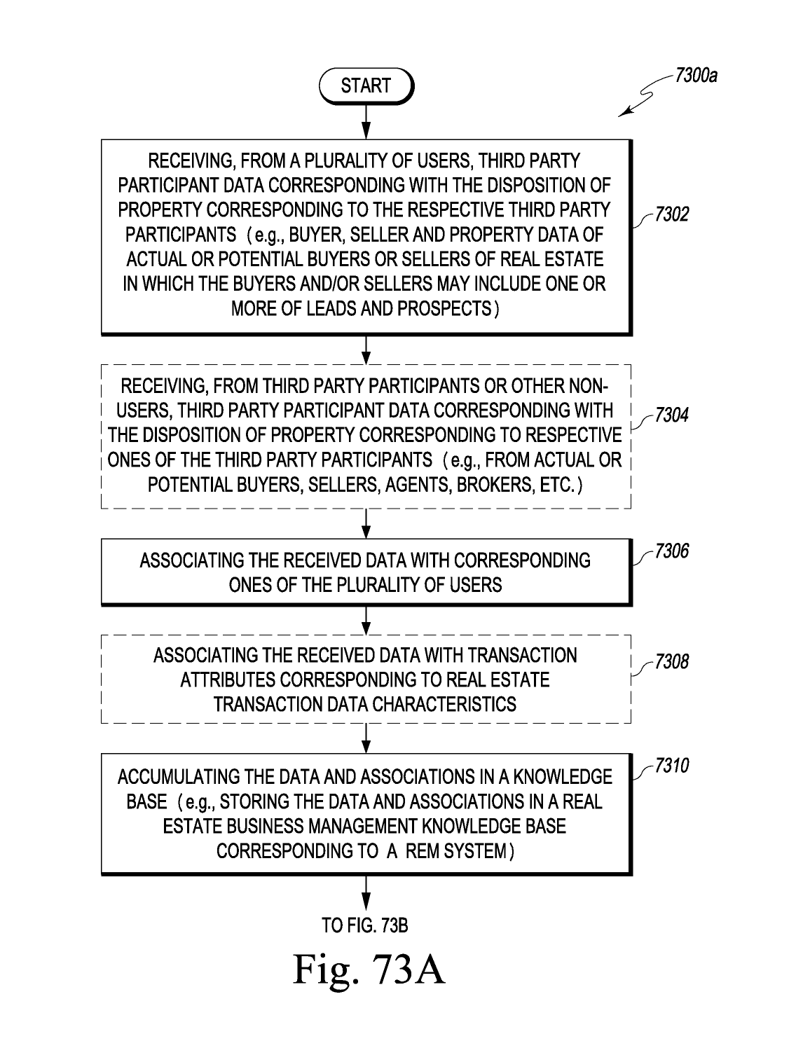

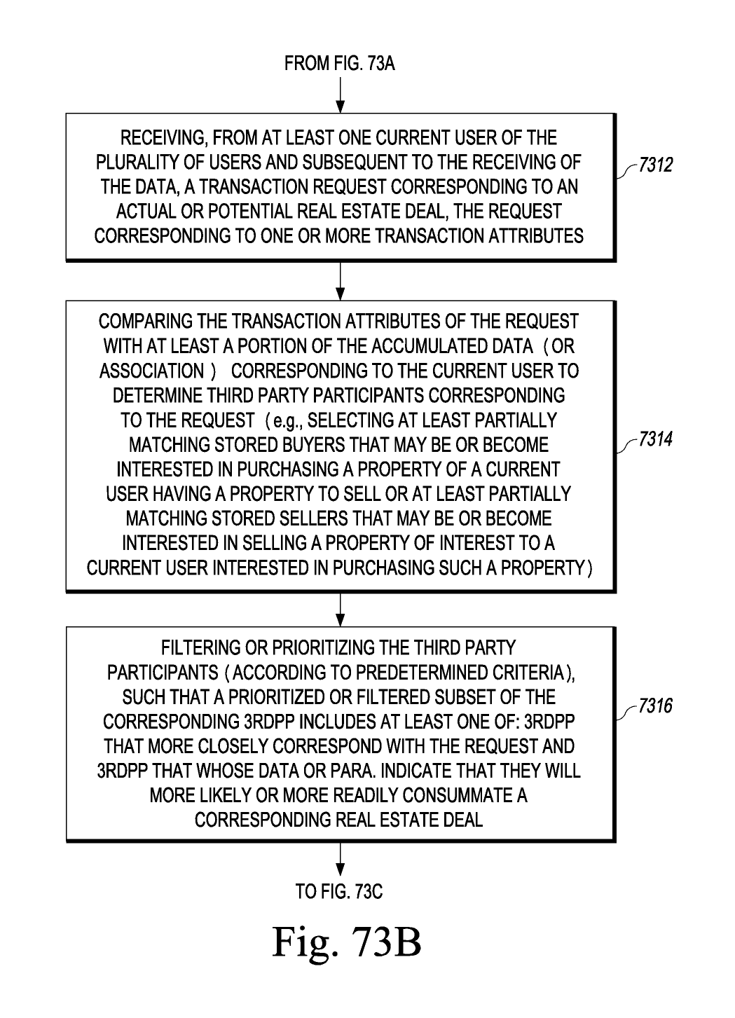

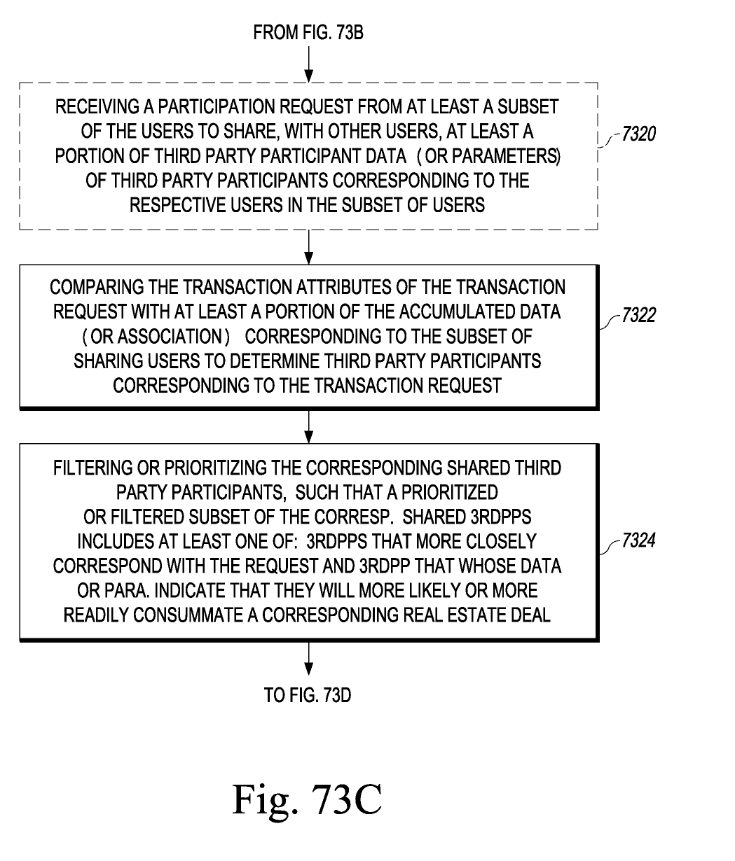

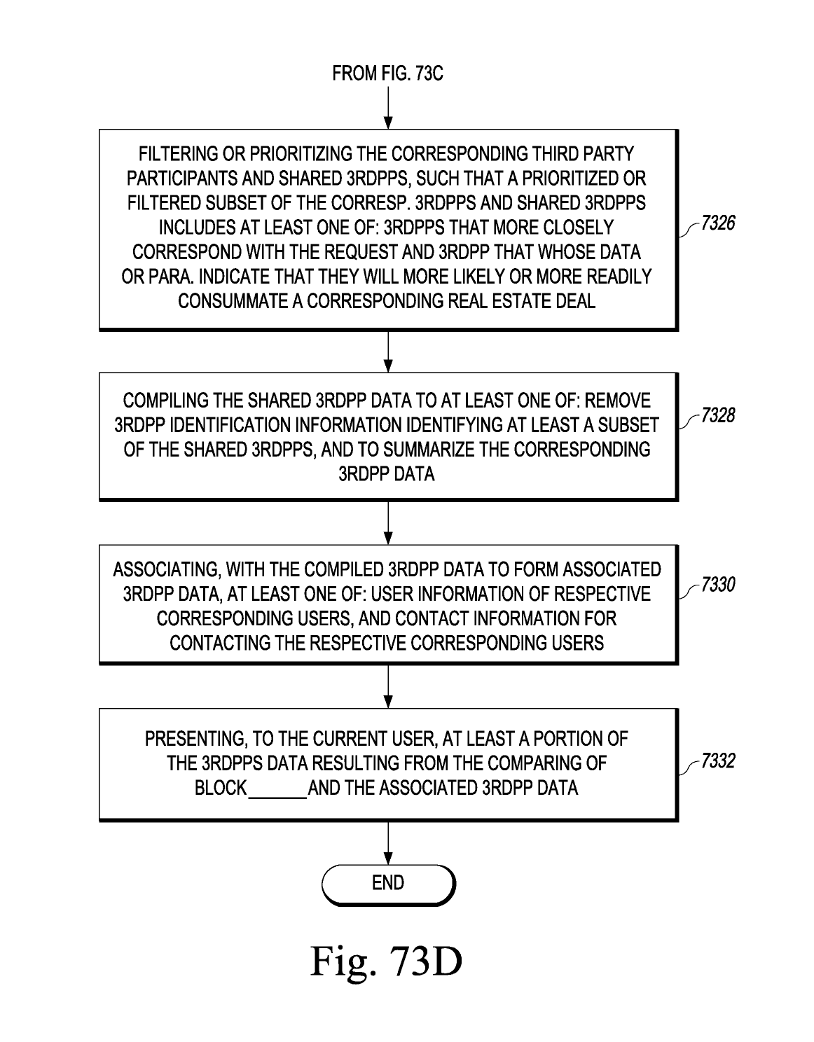

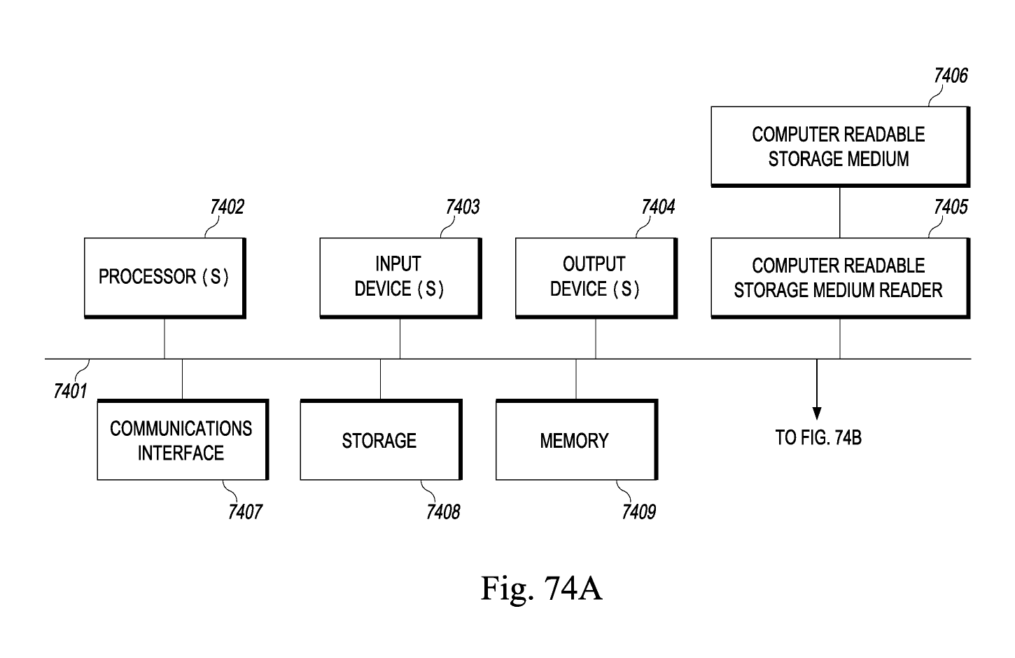

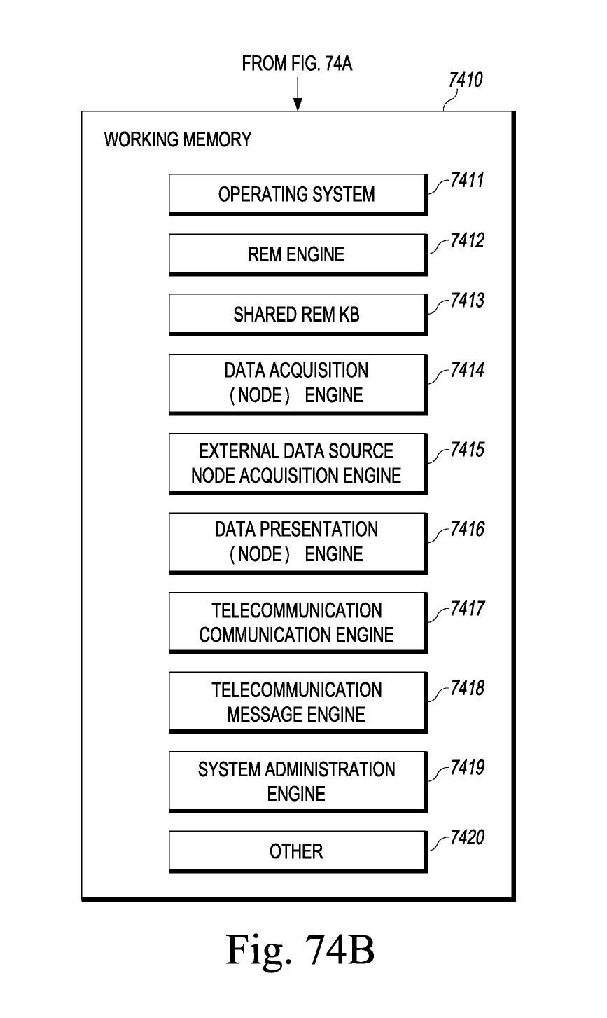

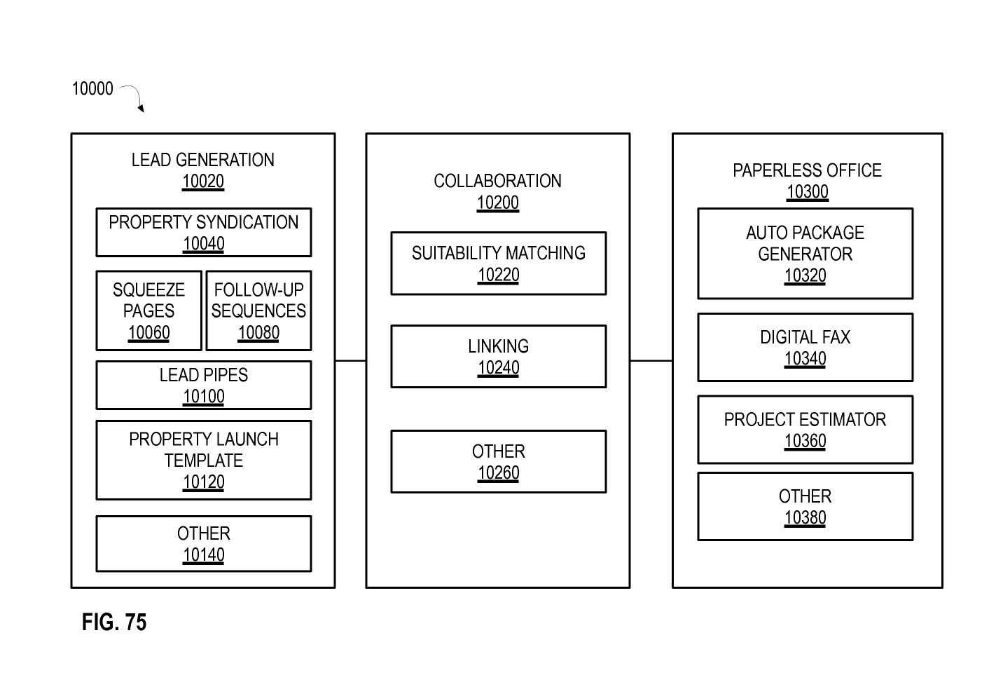

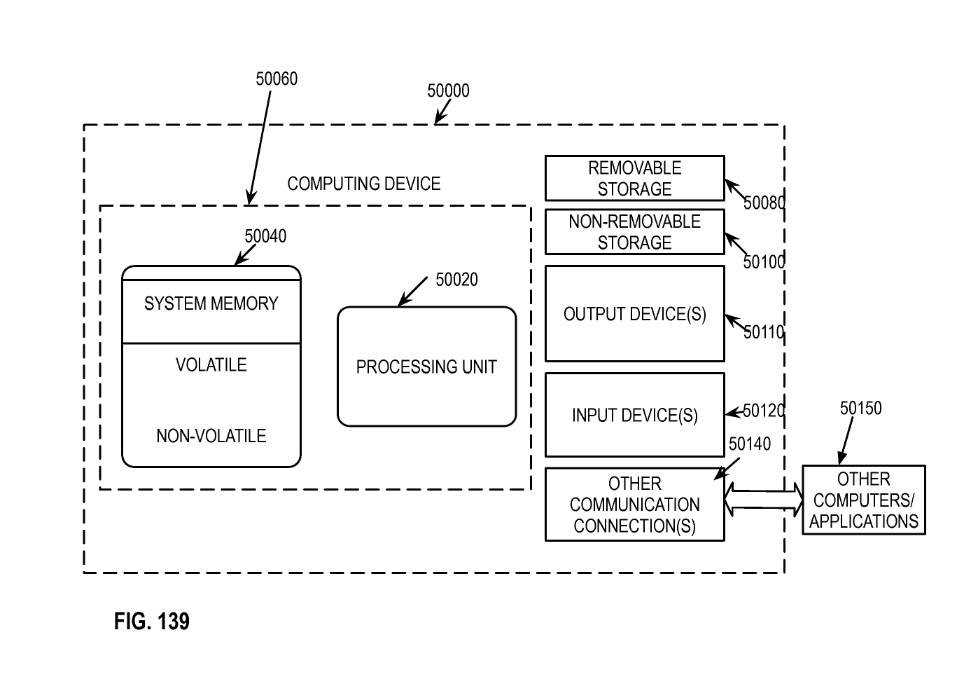

The technologies and techniques herein may be described in the general context as an application that facilitates real estate transactions, but the technologies and techniques also serve other purposes in addition to these. FIGS. 1-74 describe several embodiments or implementations of an application that facilitates real estate transactions, and FIGS. 75-139 also describe further implementations.

Turning now to FIG. 1A, there is seen a real estate business, collaboration and knowledge acquisition sharing system (“real estate business system”) according to an embodiment of the invention. Real estate business system 100a broadly provides for responding to one or more users or groups of users by managing or otherwise conducting real estate business transactions or transaction aspects that may currently or subsequently correspond to one or more potential or actual real estate deals or groups of real estates deals. In this manner, system 100a provides for advancing toward completion the respective real estate deals or groups of real estate deals or indicating that completion of such deals or groups of deals should be avoided.

System 100a also provides for accumulating a knowledge base of real estate business data that may include data that is independent of a current real estate deal. The accumulated data may therefore be automatically or manually utilized by system 100a or a user respectively in conjunction with a current real estate transaction or transaction aspect. Such data may also be similarly utilized in one or more other real estate transactions or transaction aspects, if the data is be determined to be applicable to such transactions or transaction aspects in a given instance. Such transactions or transaction aspects may further correspond with a current real estate deal or one or more other real estate deals or groups thereof, or with the same or different users, if the data is determined to be applicable to such users/deals. System 100a provides for conducting these or other real estate business/knowledge base operations in an individual or coordinated or combined (“collaborative”) manner in conjunction with system 100a member users, other users or other participants that may correspond to one or more of real estate business transactions, transaction aspects or deals.

A real estate deal may, for example, include potential or actual purchasing, selling, renting, converting, updating or other disposition of property, or some combination. A potential deal, transaction or transaction aspect, for purposes of the present example, includes a deal, transaction or transaction aspect in which one or more participants has not been advanced to a status of an actual deal participant or “party”. (A participant in this case may, for example, include a lead or prospect, whether or not he/she is aware of such participation.) A potential deal, transaction or transaction aspect may also transition from potential to actual in conjunction with sufficiently advancing a status of one or more potential deal participants, whether or not a deal is actually consummated. Users may, for example, include one or more of full or limited purpose users, “guest users”, intermediary or “community” users, third parties and so on, or groups (e.g., a “team” or “community”) thereof. A participant may, for example, include a person that is determined by a user or system 100a to be related to a particular transaction, transaction aspect or deal even if, as is typically the case, the participant never becomes a user or is unaware of his/her participation. Participants may also be associated with a participant type (“role”) or other transaction attributes corresponding to such transaction, transaction aspect or deal (e.g., see below). Real estate business knowledge base data may, for example, include one or more of potential or actual seller, buyer, property, contact, statistical or other user or shared real estate business data that may be stored, determined, presented or otherwise provided (e.g., in a fully presented or lesser disclosed or “blind” manner) by the real estate business system.

The illustrated embodiment also provides for implementing system 100a in a membership-based manner. That is, system 100a provides for receiving authorization from a person for enrolling at least that person under a service agreement as a full or partial use member, for utilizing selected ones or all of the system 100a real estate business management and data acquisition features. In another guest-enabled embodiment, system 100a may also provide for receiving authorization from the person to also enroll one or more other persons as “guests” of the member, whereby system 100a may respond to the guest, according to also received user selection, by presenting, modifying or saving user-selected data types of data corresponding to selected deals, transactions or transaction aspects that are associated with the user or that the guest may enter. In a further session sharing embodiment, system 100a may also provide for receiving authorization from a member to also present, to a third party remote user, a presentation that system 100a presents to the member, or further, to also respond to third party remote user invocation, according to received member selection, by one or more of receiving data, implementing data modification, saving, and so on. (In a more specific embodiment enabling greater third party access than presentation, the embodiment also provides for resolving competing or conflicting user input according to member priority, received member-designated priority or some other suitable conflict resolution mechanism.)

In yet another embodiment, system 100a may also receive authorization from the person to participate in community private data sharing. In this embodiment, system 100a may: (1) make available, to the member, selectable acquired private data portions or detail hiding indicators of acquired private data portions of one or more other members that are also enrolled in community private data sharing; or (2) make available, to other members that are also enrolled in community private data sharing, selectable acquired private data portions or detail hiding indicators of acquired private data portions of the member. Each of the above member enrollments may, for example, be provided by system 100a as a paid service, e.g., a membership Web site), and may system 100a may provide for billing or managing billing of a member. (For clarity sake, the terms “member” will be included in the term “user” unless specifically indicated or the context clearly dictates otherwise, such that a user may but need not be subject to a membership arrangement. The term “third party user” will further be used to refer to a guest, session sharing or other third party other than a full or limited purpose user that may access the system, and may include a “non-member user” where a membership arrangement may be imposed.)

Note that the term “or” as used herein is intended to include “and/or” unless otherwise indicated or unless the context clearly dictates otherwise. The term “portion” as used herein is further intended to include “in whole or contiguous or non-contiguous part”, which part may include zero or more portion members, unless otherwise indicated or unless the context clearly dictates otherwise. The terms “multiple” or “multi” as used herein are intended to include “two or more” unless otherwise indicated or the context clearly indicates otherwise. The term “multimedia” is intended to include one or more media types, streams, portions, and so on, or some combination thereof unless the context clearly indicates otherwise. The term “information” is further intended to include data, executable code or both unless otherwise indicated or the context clearly indicates otherwise.

As shown in the FIG. 1A example, system 100a comprises at least intermittently communicatingly couplable components including real estate business management system 101, network 102, and one or more of each of: user devices 103a-c, data acquisition points 105, external data sources 106 and data presentation nodes 107. (System 100a may also operate in conjunction with one or more additional static or reconfigurable networks, other connections or various network security mechanisms, e.g., as are generally indicated by network 102a and firewall 108 respectively, in accordance with the requirements of a particular embodiment. System 100a also includes server 108 and system administration engine 109.

Real estate business management system 101 (also referred to herein as “REM system”) provides for responding to user or remote device invocation, via user devices 103a-c or via other system 100a components, by conducting real estate business and data acquisition sharing operations corresponding to such invocation. REM system 101 may conduct such operations alone or may further invoke operabilities of such devices or other components in conjunction with providing such operations, or in providing a corresponding response, for example, as is discussed in greater detail below. REM system 101 may, for example, also provide for inter-operating with data acquisition nodes 105, external data sources 106 or presentation nodes 107.

Exemplary REM system 101 is implemented in a more centralized manner, operating as a hosted application hosted by a server 108. Server 108 may, for example, include a conventional Web server or other application server, and the REM system may include a World-Wide-Web based application (or other remote application) operating at a Web site that may also be hosted by server 108 or some other server (not shown).

REM system 101, in this example, also provides for generating Web pages that, together with various real estate, data acquisition and interface features provided by REM system 101, forms a real estate business, collaboration and knowledge acquisition sharing environment. The environment may also include extension applications provided by data acquisition nodes 105, external data sources 106 and data presentation nodes 107, which may also be implemented as hosted applications hosted by one or more of the same or different Web servers and delivered to devices 103a-c or further user devices, kiosks, and so on (not shown) in the form of Web pages. These or other “extension applications” that may be utilized may also communicate more directly with REM system 101, for example, as is discussed in greater detail below.

The above Web-based software implementation example will be presumed for the remainder of the discussion unless otherwise indicated or the context clearly indicates otherwise, so that aspects of the invention may be better understood. It will be appreciated by those skilled in the art, however, that various other mechanisms may also be utilized. For example, the exemplary implementation avoids installing operational code on a user device and provides “always available” online access to REM system 101 by most stationary or mobile network-ready user devices having a direct or indirect connection to the Internet. Other implementations may, however, also be used. For example, Local application software or other operational code may also be loaded onto a user device. Applets, servelets or other mobally executable code may also be utilized, or an implementation may utilize one or more of user devices, application/web servers, load balancing, generic or specialized hardware, add-ons, extensions, various mobile devices/peripherals, integrated/combined devices, peer-to-peer networking, and so on, many of which are well known in the related arts. These or other alternatives may, for example, be implemented in an otherwise conventional manner for implementing various other applications or portions thereof, in accordance with the requirements of a particular application.

Continuing now with FIG. 1A, transfers among various system 100a components may be conducted in an otherwise conventional manner for generally supporting Web-based or otherwise remote applications. For example, REM system 100a may generate (i.e., or retrieve from corresponding storage) a Web page. The Web page may, for example, include XML or other suitable protocol or protocol variants for transferring to a user a Web page including a currently presented or “current” interface portion or other applicable code or data (“information”). Server 108 may further transfer such information via network 102 to one or more corresponding user devices 104a-c, e.g., using TCP/IP or other suitable protocols.

A transmission client (e.g., Web browser) that is hosted by or executed at the client (e.g., transmission client 131) may present the Web page to a user, which user may review the presented information and may further respond by invoking command options, entering or modifying data and so on, as provided by one or more corresponding ones of the received interface portions. The transmission client may further transmit information corresponding to the user response via network 102 to REM system 101. Data acquisition nodes 105, external data sources 106 and data presentation nodes 107 may also transfer information to/from respective user devices in a similar manner when inter-operating remotely with a user. Data acquisition nodes 105, external data sources 106 and data presentation nodes 107 (“expansion nodes”) may further utilize conventional or other suitable transfer mechanisms, e.g., HTTP, SOAP, and so on, to transfer information to/from REM system 101 (e.g., including acquired data, external data or presentation information respectively).

As shown in FIG. 1A, REM system 101 comprises at least intermittently communicatingly coupled components including real estate business management engine (“REM Engine) 111 and real estate business management knowledge base (“REM KB”) 112. Real estate business management engine (“RBM engine”) 111 further includes communication engine 111a, knowledge base controller 111b, REM interface engine 111c, deal engine 111d, transaction/task engine 111e, virtual business advisor 111f, user/community suitability matching and linking engine 111g, transmission sequence engine 111h, interactive forms engine 111j, team assignment and reporting engine 111k, guest engine 111m, party status engine 111n and security engine 111o. REM system 101 may also include other components, e.g., as indicated by engine 111p.

Communication and control engine (“communication engine”) 111a operates largely as an REM engine communication manager and controller. Communication engine 111a provides for receiving control/data information from other system 100a components, decoding, converting or formatting such received information as needed and to a form suitable for use by corresponding system 101 components, and invoking other engine 101 components that may correspond to the received information. Communication engine 111a also provides for coding, converting or formatting information received from other engine 101 components (as needed and to a form suitable for use by other system 100a components) and initiating transfer of such “generated information”, via server 108, to corresponding ones of the other system 100a components. (It will be appreciated that encoding/decoding of information may be utilized in conjunction with more secure implementations, and any suitable encoding/decoding may be conducted, many of which are well known in the art.) In accordance with the above Web page implementation, for example, communication engine 111a provides for packaging and un-packaging information packets that may be transferred to and from REM system 101 in accordance with XML or one or more other protocols that may be utilized; communication engine 111a may provide for implementing suitable protocols for packaging and un-packaging information that may be transferred in a more direct manner to and from system 100a components other than user devices 103a-c.

Knowledge base controller 111b broadly provides for responding to communication engine 111a or other REM engine 101 components by storing and retrieving knowledge base data to and from shared real estate management knowledge base (“KB”) 112. In one embodiment, KB 112 provides a database management system (“DBMS”), for example, as produced by Oracle Corporation of Foster City, Calif. and various others. In this embodiment, KB controller 111b provides for interfacing with the DBMS for initiating data storage, retrieval, modification and manipulation operations (e.g., modify/delete data, query, sort, filter, extract, and so on). KB controller 111b similarly provides for storing, retrieving, modifying and manipulating real estate management information, other user/other participant information (e.g., organization, team, type, status, priority, preference, and so on) and system 100a operational information (e.g., interface, transaction attributes, and so on) in conjunction with KB 112.

Those skilled in the art will appreciate that a wide variety of database or non-database mechanisms may be used, including but not limited to one or more of flat file, relational, object-oriented, multi-tenant or other databases, lists, tables, n-dimensional arrays, and so on. Suitable well known and emerging database or other storage configurations supporting various fixed or customizable schema may also be used, for example, main tables, support table, key fields, metadata, and so on, and will likely vary and are commonly implemented in accordance with the requirements of a particular embodiment. Examples of data types, code and data, and associations thereof corresponding to various real estate business management and knowledge base acquisition embodiments are, however, discussed in greater detail below. (Note that, while the discussion that follows may refer to KB controller operations as simply “storing”; it will be appreciated that KB controller operation may nevertheless also include storage, retrieval, modification, manipulation or other operations as well.)

KB controller 111b may generally provide for storing such information in an otherwise conventional manner for storing, in a database, multiple party and multiple relationship information. The illustrated embodiment of FIG. 1A, for example, provides for the implementing the above discussed membership-based or other user-based RE business management and data acquisition. In this embodiment, KB controller 111b stores user information corresponding to member users in user data storage 112a, and information corresponding to third party users (here, non-member user data) in third party data storage 112b.

Member user data may, for example, include membership agreement, payment, security information (e.g., username, password, encryption keys, remote access authorization, user device support, payment/customer support information, organization or business management team information, and so on). Member user data may also include system 101 administration information (e.g., as authorized by engine 109) for determining enrollment authorization and permissions for guest, session sharing or other third party user access, as well as for participation in submitting to or sharing community or other information sharing, or use of system 101 extensions, such as data acquisition nodes 105, external data sources 106, data presentation nodes 107, and so on. KB controller 112b may further store, in third party data storage 112b, third party user access information (username, password, organization, team, etc., e.g. as with each member), contact information, global third party access privileges (e.g., whether guest or other access is available to a particular third party, type(s) of information that may be accessed, and the types of presentation, modification or other privileges that a user has determined are applicable to a particular third party, and so on.

KB controller 111b further stores, in data storage 112c-e, buyer data, seller data and property data respectively that may correspond to one or more members. As shown, KB controller 111b also provides for associating each of buyer data for each buyer, seller data for each seller and property data for each property with a corresponding member, one or more persons in a member's organization or on a member's team, applicable guest/session sharing third party or community member, as well as any applicable third party participant, deal, transaction, transaction aspect, transaction attributes, a time/date stamp and so on. (In various embodiments, for example, stored information may also be associated with other information that may be of interest to a user and ascertainable by controller 111b using prior stored information, system 100a accessible information or below-discussed custom field entries. Such information may, for example, include but is not limited to user device or node location, device/device resource identification, primary/secondary purpose of a trip, meeting or other contact or attempted contact, and so on.

It will become apparent as the discussion progresses that the storing of buyer, seller and property data may be conducted independently of a particular deal, transaction or transaction aspect, and further independently of other buyer, seller and property data. For example, members need not respond to a property becoming available by then attempting to locate a buyer for the property, or similarly attempt to create a deal in a strictly sequential manner. Rather, each member may instead seize available opportunities to accumulate buyer, seller or property “inventory”, and thereby create a share-able inventory or pool of available resources that the member may utilize to further expand his inventory, share or initiate, transact or conclude a deal as the opportunity arises. Moreover, while KB controller 111b may associate a portion of such data with a particular deal, transaction or transaction aspect (e.g., one or more potential or actual buyers, sellers or property), the data also remains independently available. A corresponding member may therefore further exploit such data for accumulating more such data (e.g., by contacting one or more of accumulated buyers/sellers, marketing one or more properties, and so on), sharing such data with a member community or others, or for use in conjunction with other deals, transactions or transaction aspects to which controller 111b may also associate such data. Such data utilization may also be extended by system 100a operation to a member providing or receiving community data, sharing a session, employing guests, utilizing other member contacts, and so on, among other system 100a features.

KB controller 111b also stores deal, transaction and transaction aspect data in storage 112f and operational data in operational data storage 112g. Deal, transaction and transaction aspect data may, for example, include forms, marketing, notes, calendaring, tasks, documentation, buyer, seller and property details, assignment of status in a deal, transaction or transaction aspect, or tasks to the member or one or more other persons on a member's team (that may also be members), third parties or community members, and so on that are not stored as member, third party, buyer, seller or property data, and that do not comprise operational data.

As with buyer, seller and property data, KB controller 111b may associate deal, transaction and transaction aspect data with one or more of corresponding member, guest, session sharing or other third parties, or may associate such data with community sharing or surrounding conditions; also as with buyer, seller or property data, KB controller 111b may also associate general “handling”, particular assignments of deal, transaction, transaction aspect portions or portions of other tasks (e.g., custom field data or other features that may not be otherwise directly supported by system 101) or access, modification or addition to such data by various member or non-member participants. Deal/transaction data may also include user preferences for conducting deal, transaction or transaction aspect portions (including any further task portions) or any further operational characteristics (e.g., stored in storage 112g), and which KB controller 111b may associate with a particular member, team, non-member participant, and so on, or one or more particular features. KB controller 111b may, for example, determine/conduct these or other associations automatically, e.g., according to responsible user operation, user preference, other criteria, according to user determination/selection or some combination thereof.

Operational data stored in operational data storage 112g may, for example, include code and data information for implementing, testing, maintaining, updating, administering, simulating or emulating REM engine 111, REM KB 112, or further, data acquisition nodes 105, external data sources 106 and data presentation nodes 107. Such data may, for example, include without limitation, the REM system/engine interface, protocol handling, tools, security, administration or other features (e.g., see below).

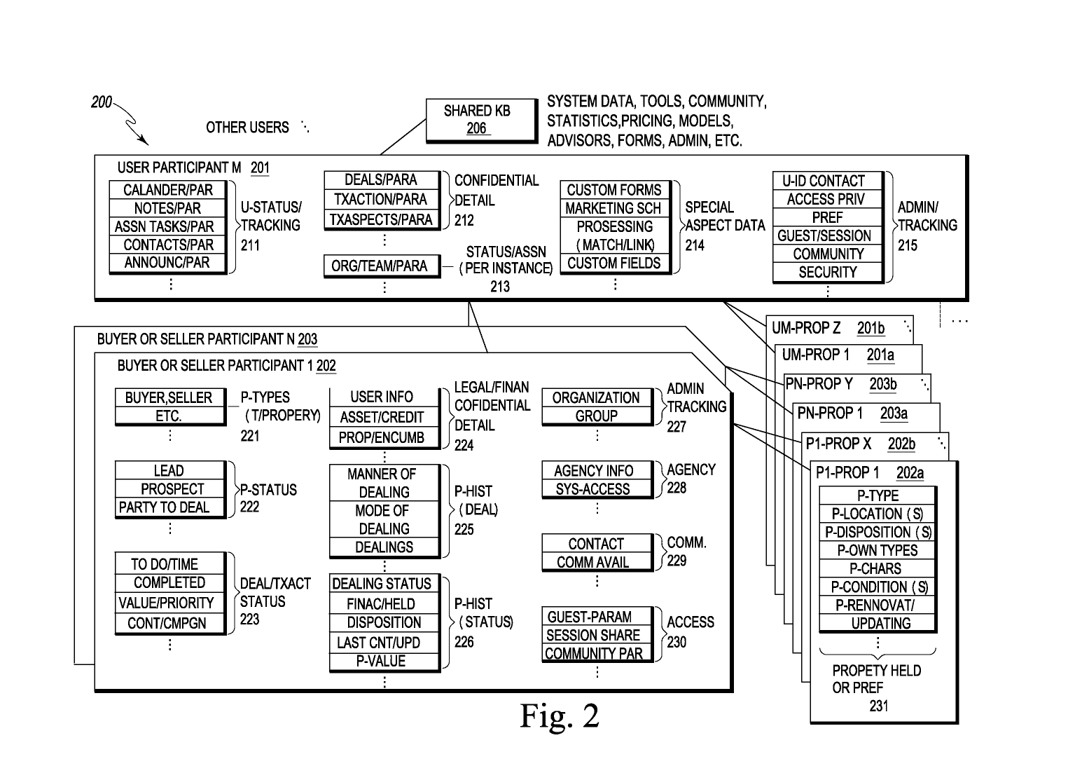

FIG. 2 illustrates, in greater detail, a further data storage embodiment that may be implemented for each full or limited system 100a user. In this embodiment, KB controller 111b provides for associating buyer, seller, property or other (e.g., shared) data that may be accumulated by the user to be associated with that user, and further with a participant type, status and other information. Note that the illustrated configuration shows data storage for only a single user. Such a configuration may be duplicated for other users, and may similarly provide for storing buyer, seller and property data corresponding to each of the other users. (Data that is initially unknown may, for example, be populated with null or other default data, and data storing and association may again be conducted by KB controller 111b of FIG. 1A.)

As shown in FIG. 2, and with further reference to FIG. 1A, knowledge base 200 may comprise various associations of knowledge base data. Knowledge base data includes user participant data (“user data”) 201 corresponding to a particular user, and data associated with user data 201. Such associated data includes accumulated buyer data or seller data 202, 203 (if any) that is associated with accumulated buyers or sellers (if any), accumulated property data corresponding to property of the user (“user property data”) 201a-b (if any) and any accumulated property data corresponding to the accumulated buyers and sellers (“buyer property data” or “seller property data” respectively) 202a-b, 203a-b. As shown, accumulated user property data 201a-b is associated with the user participant (“user”) and user data 201, while accumulated buyer or seller data 202a-b, 203a-b is associated with corresponding buyer and seller participants and data, and may, in various embodiments, also be associated with the user and user data. Knowledge base 200 also comprises a shared knowledge base 206 including system, community or other data, portions of which may also be associated with user data 201 or other knowledge base 200 data.

User data 201 includes user status/tracking data 211, deal, transaction or transaction aspect data 212, status and assignment data 213, special data processing aspect data 214 and administration and tracking data 215. As will be further discussed with reference to REM interface 111c (FIG. 1A), user data may include user status information 211 that may, for example, include calendar, notes, tasks, contacts and announcement data and parameters. As with other user data, KB controller 111b (FIG. 1A) may associate each status information entry that corresponds with a particular deal, transaction or transaction aspect with the corresponding deal, transaction or transaction aspect. Thus, for example, KB controller 111b may associate particular user calendar entries, notes, tasks, status/task assignments, contacts and announcements with the particular deal, transaction or transaction to which they pertain.

KB controller 111b may also store association of each of such data, according to corresponding parameters, with a particular user, entry/modifying participant, time/date stamp, access privileges, user preferences, user selectable guest, session sharing third party, availability to the community, location, device and security (e.g., guest or session sharing presentation, entry, modification; user location, device, use or other conditions, use of cryptography, and so on.), among other data associations. KB controller 111b may further provide for responding to REM interface engine 111c or other engine 111 components (FIG. 1A) by retrieving such information, for presentation, processing or other purposes, according to one or more of such data, parameters or associations. In accordance with one embodiment, however, at least those notes that have been entered and that pertain to a particular deal, transaction or transaction aspect may be rendered unalterable once entered; in accordance with another embodiment, all notes that have been accepted for storage are rendered unalterable, thereby enabling such notes to be utilized as self-authenticating notes.

Various embodiments may also provide for storing multiple types of user information, and may do so in accordance with integrated or separated constructs. One embodiment, for example, provides for storing various types of user information (e.g., real estate management, personal, other projects/tasks, and so on) as corresponding to a single integrated calendar or collection of notes, tasks, contacts, announcements, and so on. In this embodiment, KB controller 111b may automatically determine and associate with such data an information type; controller 111b may determine such type, for example, according to a context or condition at the time of entry or use (e.g., while handling a personal project). In another embodiment, a user may determine and enter or select such type, which controller 111b may in either case associate with corresponding data. In other embodiments, KB controller 111b may create a new construct for each new data type corresponding to the context or user determination, or the user may initiate or confirm such creation. Other examples will also become apparent to those skilled in the art in view of the discussion herein.

User information 201 also includes deal, transaction and transaction aspect data 212, as well as parameters according to which such information may be generated, stored, retrieved, modified, manipulated or presented. As with user status/tracking data 211, KB controller 111b may store associations with such data including user selectable parameters (“transaction attributes”). Transaction attributes may, for example, include but are not limited to assignment, status or access parameters through which a system 101 may determine a user or other participant status in conducting, assignment or read, write or modification access to one or more particular deals, transactions or transaction aspects. Such attributes may be applicable to all or particular data types or data thereof (e.g., user-determined range of calendar dates, notes, notes including particular references or terms, tasks corresponding to a particular user, contacts corresponding to RE business management, one or more particular deals, transactions or transaction aspects or of a particular type, and so on, or some combination).

Various embodiments may further provide such parameters for such conducting, assignment or access by a user organization, a user team or one or more members thereof, guest access, session sharing, community sharing, and so on, which parameters are indicated respectively as assignable tasks (of status/tracking data 211) organization/team status/assignment data 213 and guest/session and community data (of administration/tracking data 215). In various embodiments, such parameters may be provided as globally applicable or according to data type, deal, transaction, transaction aspect, data type, user, other participant, group or some combination. Thus, for example, KB controller 111b may provide for enabling or disabling task status/assignments or guest, session sharing or community privileges globally (to all users or other participants), respecting a particular deal, transaction or transaction aspect, notes or personal contacts, a fired employee, a now excluded or “dropped” participant, a subcontracting group, and so on, or some combination.

Of the remaining illustrated user data 201, organization/team data of status/assignment 213 may further store member (e.g., employee) information of an organization to which the user may be an agent or an indicator of such data as may be separately stored (e.g., a remote organization chart or directory). In other embodiments, status/assignment data 213 may also store user type or status of the user, user's organization or team or members thereof, which data (or parameters corresponding thereto) may be associated with one or more deals, transactions transaction aspects or properties. In this instance, status may, for example, correspond with one or more of team leaders, coordinators, task assignors/assignees, and so on as may correspond to all deals, transactions or transaction aspects, or one or more particular deals, transactions or transaction aspects or groups thereof. User type, as with other participant types, may correspond with a buyer or seller or other type of person when participating in the disposition of a subject property. In other embodiments, user type may also correspond to real estate product/service providers or others, among other combinable alternatives.

Note that while system 101 may often automatically determine a user type, for example, as corresponding to a particular other participant (e.g., user buyer if the other participant is a seller or user seller if the other participant is likely a buyer), this may not always be the case. For example, a user may assume a potential or actual role of contractor for all or part of a renovation or update, or the user may desire and system 101 may provide for comparing a valuations or other characteristics that may comprise outcomes of the user potentially or actually assuming the role of different participant types in conjunction with the same or different deals, transactions or transaction aspects, or with respect to various properties or in conjunction with different product/service vendors. In such cases, system 101 enables a user to determine/select his or others' participant type/status. Various such embodiments may not only provide for such “what if” comparisons, but also for modifying data input, processing or various other system 101 features in accordance with a particular user participant type or parameters corresponding thereto.

Custom forms, automated marketing scheduling, match/link and other processing and custom fields store data/parameters that applicable to such features, which features are discussed in greater detail below.

Administrative/tracking data 215 may, in various embodiments, apply to a user, or further, a guest, session sharing participant or other participant. Administrative tracking data 215 may, for example, include user name, identifier, contact, other information and parameters, access privileges and parameters (e.g., including system 101 permissions, usernames and passwords for a user and any corresponding further participants), system 101 operational preferences and parameters, the above-discussed guest/session and community data, and preferences and security data and parameters (e.g., sharing privileges, encryption, and so on or some combination). Other user data or some combination may also be utilized in accordance with the requirements of a particular embodiment.

KB controller 111b also provides for storing and associating with a user corresponding buyer and seller information that may be accumulated by the user (e.g., directly or indirectly via system 101 features or via guests, session sharing or the community). In the present embodiment, buyer or seller data 202 may include substantially the same set of data types. These include participant type 202, participant status 222, deal/transaction status 223, legal, financial or confidential details 224, participant deal (or other) history data 225, participant history status data 226, business/organization data 227, agency data 228, communication data 229 and access data 230.

Participant type 221 indicates a classification of the participant in conjunction with a deal, transaction or transaction aspect. In one embodiment, participant type 221 indicates whether the participant is a buyer or seller, while in other embodiments, participant type may include further predetermined or other classifications as well (e.g., renter, owner, occupier, lessor/lessee, contractor, other product/service provider, non-guest agent, and so on, or other participant types may also be utilized in accordance with a particular implementation). As with a user, such data may be associated with all or particular deals, transactions, transaction aspects, properties, or various other transaction attributes.

Buyer or seller data may also include participant status information 222. In the present embodiment, KB controller 111b may store status information including at least three basic participant status types to which a participant may be advanced by a user: a lead, prospect or party to a deal. Without intended to be limited to a particular definition, leads may include participants of which a user (or assigned other person authorized by a user) may become aware but may not yet have contacted or may not have accumulated sufficient basic information to determine that the participant should be advanced or to actually advance the participant to prospect status, and who the user has determined are not yet parties to a deal. Prospects may include participants who have been contacted or for whom at least sufficient basic information has been accumulated, who are not yet parties to either any deal or a current deal. Parties to a deal may include those participants for whom a deal has been initiated and not yet concluded. (It will, however, be appreciated that other participant status alternatives may also be utilized in accordance with the requirements of a particular implementation.)

While participant status is typically assigned by user advancement (e.g., see above and below), KB controller 111b may also store parameters according to which deal engine 111d, transaction/task engine 111d or other system 101 components (FIG. 1A) may automatically advance or assign participant status. Such status assigning/advancing parameters may, for example, include assigning/advancing participant status: as a party to a deal responsive to determining that the participant has become associated with a deal, as a prospect or party to a deal responsive to accumulation, excuse or null entry of a predetermined amount or particular participant information corresponding to a lead, participant or party to a deal, as a prospect or party to a deal responsive to determining that a particular contact has been made or notated in a note that corresponds with a deal, and so on, among other combinable criteria.

KB controller 111b may store participant status data as participant status indicators indicating that one or more statuses are applicable to the participant. Typically, lead status may exist only until a corresponding participant is advanced to prospect. However, a participant may retain prospect status generally, even though the participant may be advanced to “party to a deal” status in conjunction with one or more potential or actual deals or groups of deals (e.g., by a user selection via an REB interface control provided by REB interface engine 111c of FIG. 1A or automatically by system 101). As will be discussed, KB controller 111b responds to advancement of a non-user participant (or user) by modifying the tools, data, or other interface portion presentation accordingly. Such interface modifying may, for example, include hiding or presenting such aspects, presenting such aspects in a particular manner, and so on. (Various interface embodiments may, for example, provide for presenting visual, audio or other sensory or media components in a configuration or presentation that distinguishes completed or other aspects that likely will be merely presented from incomplete, not yet presented or other aspects that may require modification, and so on. One embodiment, for example, implements such interfacing in a manner that corresponds to a dual-timeline/persistence interface model that is discussed in greater detail below).

Buyer or seller data 202 may also include deal/transaction data 223. In this embodiment, such data may include status qualifying transaction attributes, such as indicating tasks that may be assigned or otherwise assumed by a participant, planned or critical time for completion. (Time for completion may, for example, include user entered or system 101 generated times according to which a deal, transaction or transaction aspect may be impacted or one or more users/participants should be sent predetermined type, content or content criteria of phone, email, instant message, fax or other alert indicator, and so on.) Status qualifying attributes may also include, value/priority of a participant action/inaction or completion of the task, response to a lead, prospect or other contact or marketing campaign (e.g., see below), incompleteness, type(s) or nature (e.g., potential impact, priority and so on) of lack of completion of one or more deals, transactions or transaction aspects, and so on, among other combinable alternatives.

Buyer or seller data may also include legal, financial or other information 224 that may include confidential user information (“confidential user information”), or may include history information corresponding to a deal, transaction or transaction aspect 225 or participant status 226. Confidential user information may, for example, include user information (e.g., user name, social security number, account numbers, aliases, username, and so on), well as general or specific assets, liabilities, credit report or other information that may impact extension of credit or other user/other person or organization resources to the participant, or still other information that may impact dealing with the participant or the absolute/comparative desirability of doing so (e.g., as compared to one or more other participants or potential participant deals).

Deal history information 225 may, for example, include indicators or other accumulated information accumulated by or for use by the user that may relate to prior dealings with the participant by the user or others. Such information may vary widely and may, for example, include indicators, other data or parameters for the user/system 101 determining the participant's manner of dealing, mode of dealing or prior dealings. Manner of dealing may, for example, include objective or subjective assessment of absolute or conditional likeability, fairness, responsiveness, openness to alternatives, reaction or other response to general or particular time, event or other conditions, and so on. Mode of dealing may, for example, include telephone, email, instant messaging, fax, video, graphics, speech recognition/synthetic speech, messages, in person meetings, and so on. Prior dealings may, for example, include indicators, data or parameters for determining the occurrence, types, events, results or other aspects of prior dealings with the participant by the user or others. As with other accumulated user, participant or property information, deal history information 225 may, for example, be retrieved by KB controller 111b for use by suitability matching/linking engine 111g, other engine 111 components or still other system 100a components (FIG. 1A) for conducting their respective real estate management or knowledge acquisition aspects or for presenting such raw or processed data or indicators thereof to a user for use in the conducting of deal/transaction viability, likely difficulty, prioritization, value, conditions or other real estate management or knowledge acquisition aspects.

Participant history status information 226 may, for example, include data or parameters for indicating a user dealing status (e.g., current engagement in real estate business), financial position or properties held, disposition to engaging in RE business management generally “the right deal” (e.g., seller, buyer, property, terms, conditions and so on) or with the user, user organization, team, team member(s), and so on. Participant history status information 226 may also include last contact with the participant or last update of participant information, as well as an assigned priority, value of conducting real estate business with the participant, and so on.

Of the remaining knowledge base data of the illustrated example, administrative/tracking data 227 includes identification and relationship information corresponding to a user organization, its employees, and so on, as well as a group or team and the status with which members may conduct real estate business (generally or with respect to a particular deal, transaction or transaction aspect. Agency data 228 includes infra or extra organization or team agents or organizations with which the participant does or tends to conduct real estate business, their role in conducting such business or conditions under which an agent or agents should be contacted, and system access that may be made available to such agents. (Similar information may also be stored with respect to administrative/tracking data. Communication data 229 includes available communication mechanisms and corresponding contact information corresponding to the participant, organization, group or agents. Finally, access data 230 includes guest, session sharing and community data and parameters that may be allocated or provided to the participant or his co-participants (e.g., organization, group or agents) and the respective limitations of such access, e.g., as was already discussed above. Those skilled in the art will appreciate that other participant data or parameters may also be utilized in accordance with the requirements of a particular implementation.

Property data 201a-b, 202a-b and 203a-b includes data and parameters corresponding to the user and one or more accumulated participants respectively and is associated with respective ones of the aforementioned user and accumulated participant data and parameters. In this embodiment, property data and parameters may be substantially the same for users and various accumulated seller and buyer participants. More specifically, property data may correspond with a property that is held by a user or other participant seller or that is requested or otherwise determined to be preferred by a user or other participant buyer (e.g., according to stored results of personal knowledge, participant interview/submission and so on).

Each of property data 201a-b, 202a-b and 203a-b includes property type data, location data, disposition data, ownership type data, property characteristic data, property condition data, property renovation/updating data and so on. Property type data indicates a type of property, for example, single or multiple family home, n-unit office building, n-unit condominium, leased land, and so on. Property location data indicates aspects of the property relating to its location, for example, end unit, region, neighborhood, district, proximity to schools, shopping transportation, airport, industry, zoning, and so on. Property disposition data indicates others' held or “preferred” legal or other interest in the property (e.g., own, subject to lien by x-organization, repossessed/status, short sale opportunity, and so on). Ownership types indicates the participant's held or “preferred” or others' ownership interest in the property, for example, as owner, occupier, having n-renters of m rental units at x dollars per month, and so on. Property characteristics data includes data describing the property held or “preferred”, for example, including number of bed, bath or other rooms, construction, dimensions, exterior space, lot size, accoutrements, and so on.

Property condition data includes indicators of the condition of the property, for example, including damage, work needed generally, in accordance with the location or market, or according to other predetermined criteria for evaluating a condition of a property or portions thereof. Property renovation/updating data indicates renovation or updating that may be needed and not yet described, completed or scheduled, as well as progress or other information relating to the setting up or conducting of renovation or updating, and so on. Those skilled in the art will appreciate that other property data or parameters may also be utilized in accordance with the requirements of a particular implementation. Property data may also be utilized in presentation or other manners as, for example, have already been discussed with reference to user or participant data and parameters.

It should also be noted that knowledge base data 112 or 200 data/parameters are not limited to textural data and any or all may also include images, audio, video, fly thru or other animation, and so on, as will be further discussed herein or otherwise in accordance with the requirements of a particular implementation.

Returning now to FIG. 1A, REM interface engine 111c, along with the above discussed knowledge base and other REM system components, provides a real estate business environment within which one or more users may individually or collaboratively conduct real estate business management and share-able real estate business knowledge base accumulation. REM interface engine 111c provides for generating at least a current REM interface portion of an REM interface, for populating the interface portion with currently applicable data, if any, and for causing the interface portion to be transferred to one or more corresponding user devices, e.g., user devices 104a-c. REM interface engine 111c also provides for receiving, from a user device, responsive data entry, tool invocation or other user interaction with a current REM interface portion, transferring corresponding invocation or data information to communication engine 111a, and, if applicable, (e.g., to the received user interaction information), receiving REM interface data/parameters from other system 101 components and generating an REM interface portion corresponding with the user interaction information and the data and parameters. REM interface engine 111c also provides for interfacing with and causing data to be received from or transferred to data acquisition nodes, 105, external data sources 106 and data presentation nodes 107.

In one embodiment, the REM interface includes a group of Web pages that may include text, audio, graphics, video or other multimedia components. Those skilled in the art will appreciate that that REM interface engine 111c may generate the Web pages by constructing one or more of the pages in substantially real time or on demand, or the Web pages or portions thereof may be predetermined (other than the data with which they may be populated) and engine 111c may conduct the generating by integrating such portions.

It will become apparent, however, that the latter case of integrating predetermined interface portions may deviate substantially from conventional interfacing. For example, REM interface engine 111c may generate an interface or interface portion that may correspond with one or more of users and other participants, participant types, statuses, a deal, transaction or transaction aspect and advancement of a deal, transaction or transaction aspect, among other transaction attributes.

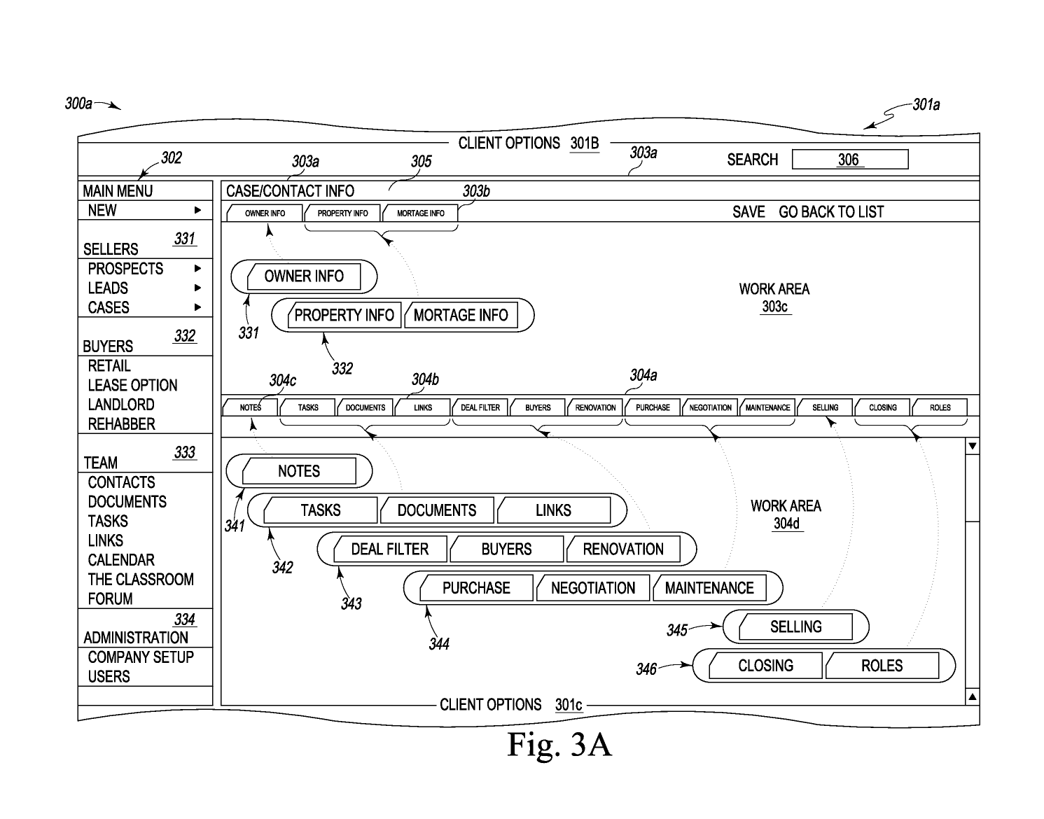

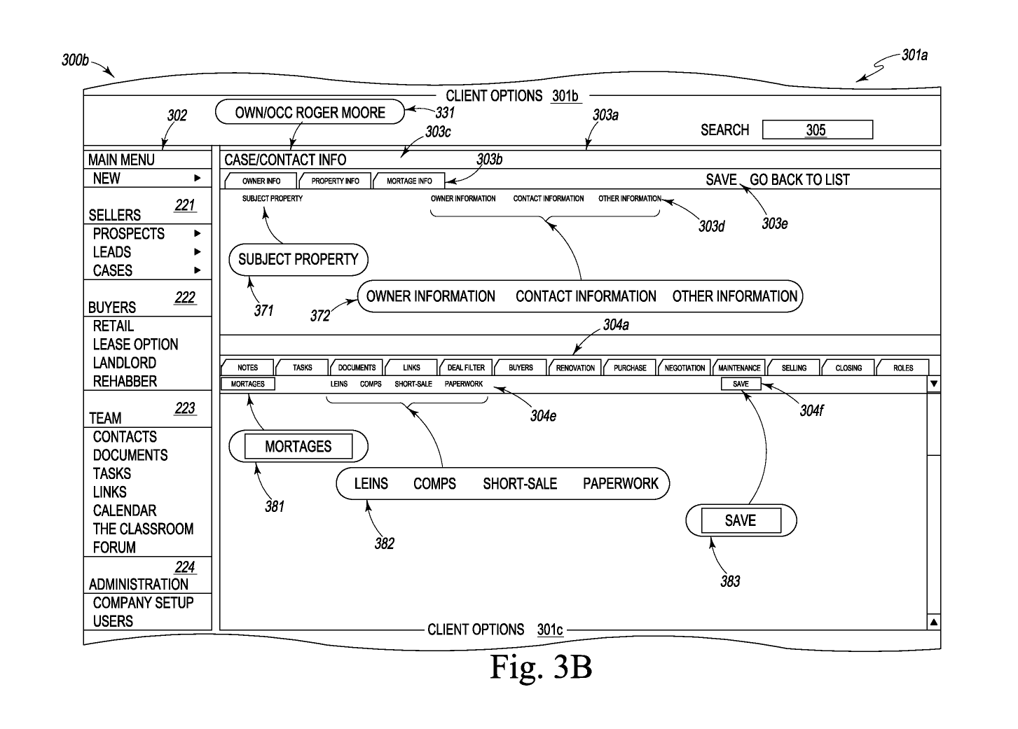

RE Interface engine 111c in one embodiment receives such attributes from one or more of communication controller 111a (e.g., as user interaction data received via a user device), and deal engine 111d or transaction engine 111e (e.g., as knowledge base data, i.e., or attributes, that one or both of engines 111d-e may invoke KB controller 111b to retrieve from REM KB 112. Thus, not only may the user advances or be advanced by system 100a through a potential/actual deal (e.g., via pre-deal, intra-deal, inter-deal or knowledge base transactions or transaction aspects) without requiring user selection of independently operable generic tools. (Rather, interface engine 111c provides interface portions corresponding to and anticipating such advancement, thereby enabling the user to avoid having to locate and utilize tools within a remote or temporary popup interface menu or remote toolbar while advancing a particular actual/potential deal.) Interface engine 111c in one embodiment also generates an REM interface portion in which tools for advancing or responsive to an advanced potential/actual deal integrate non-obtrusively (with respect to a user workspace) with an already presented existing interface. The embodiment further provides for automatically providing new interface portions or RE management processing (e.g., according to such data or transaction attributes) that correspond with advancing an actual/potential deal, transaction or transaction aspect and that were not previously presented to the user. Moreover, RE interface engine 111c provides for presenting the interface portion or tools for invoking RE management processing in which deal or transaction processing are presentable independently and without obscuring the corresponding transaction aspect processing that may be concurrently conducted, an example of which is discussed below, beginning with reference to FIG. 3A.

REM interface engine 111a further provides for populating the interface with data corresponding with deal, transaction or transaction aspects received from suitability matching/linking engine 111f or information received from other of engines 111b-o. The generation of the current interface portion may be conducted in an otherwise conventional or other suitable manner, and may utilize one or more of extensible markup language variants (e.g., XML) or other suitable page creation constructs that may further include application program interface or API commands for invoking application programs or APIs 103a that may reside on the user device.

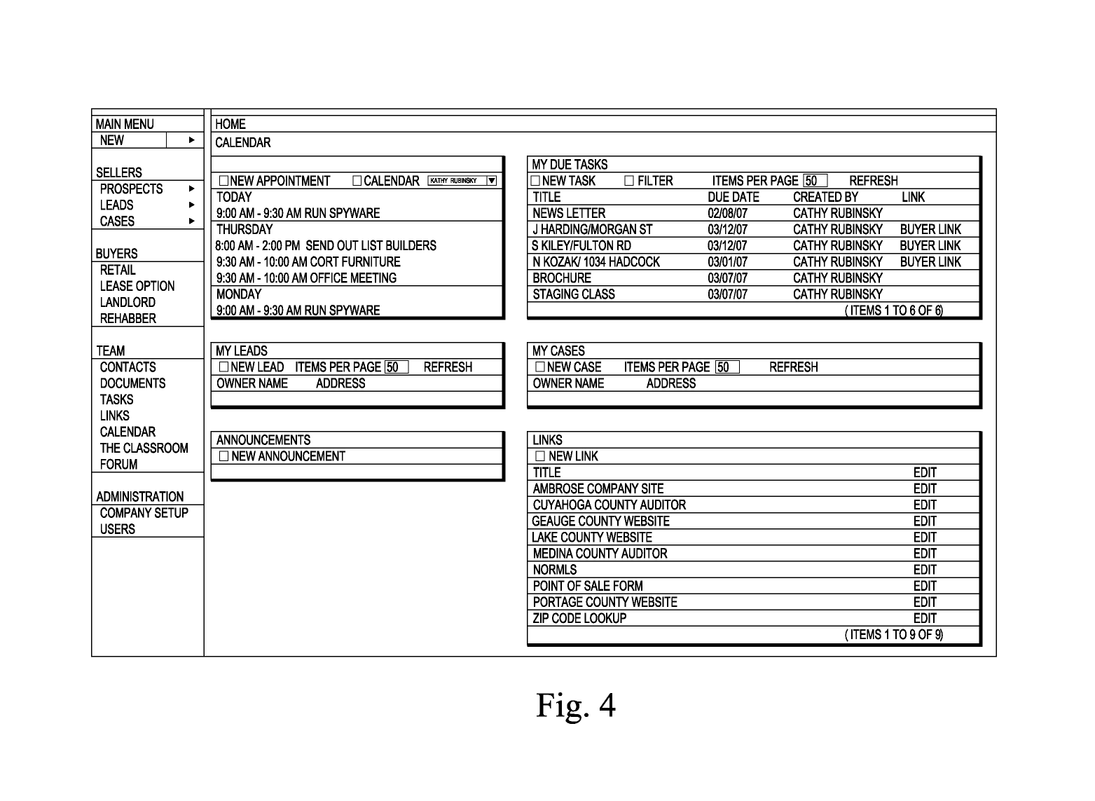

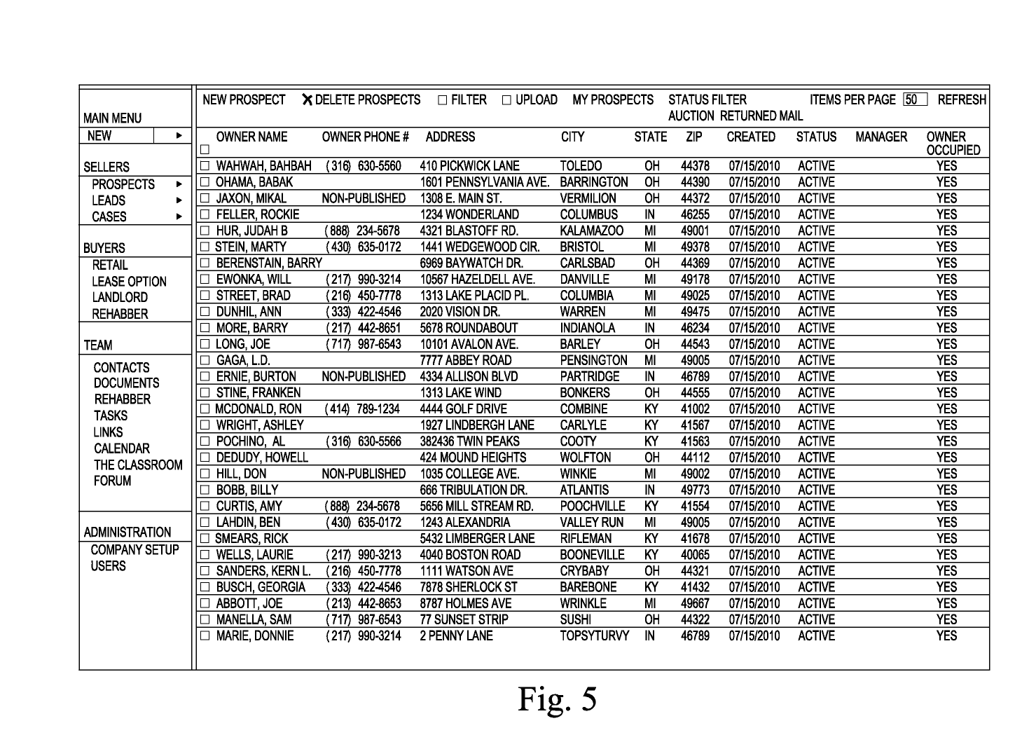

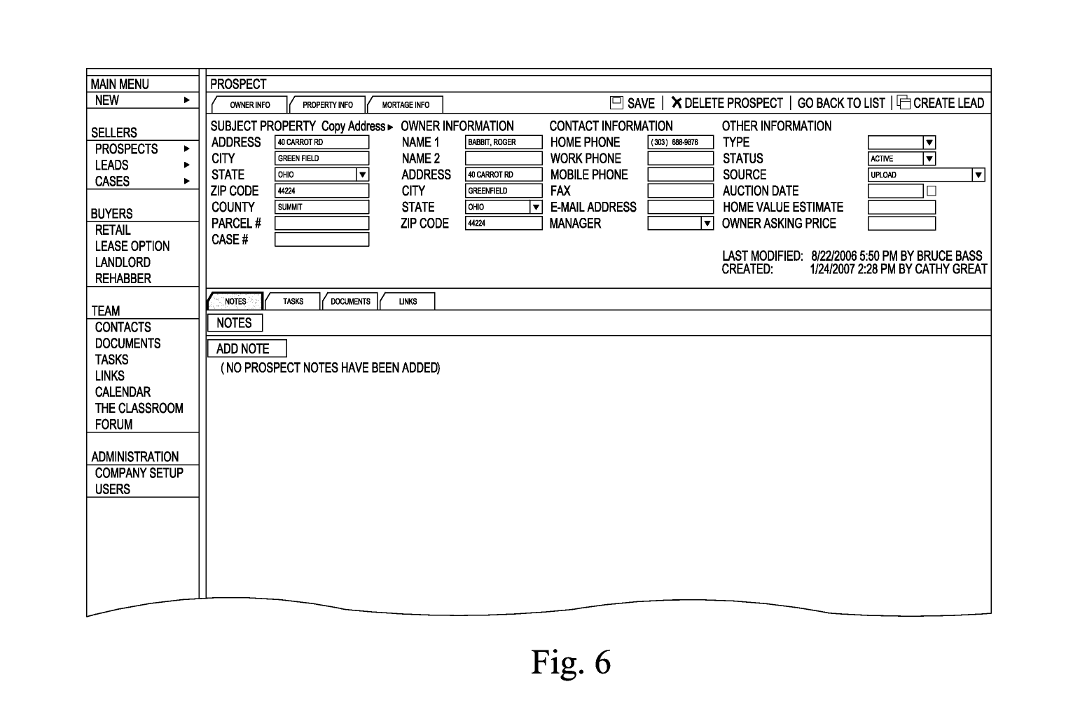

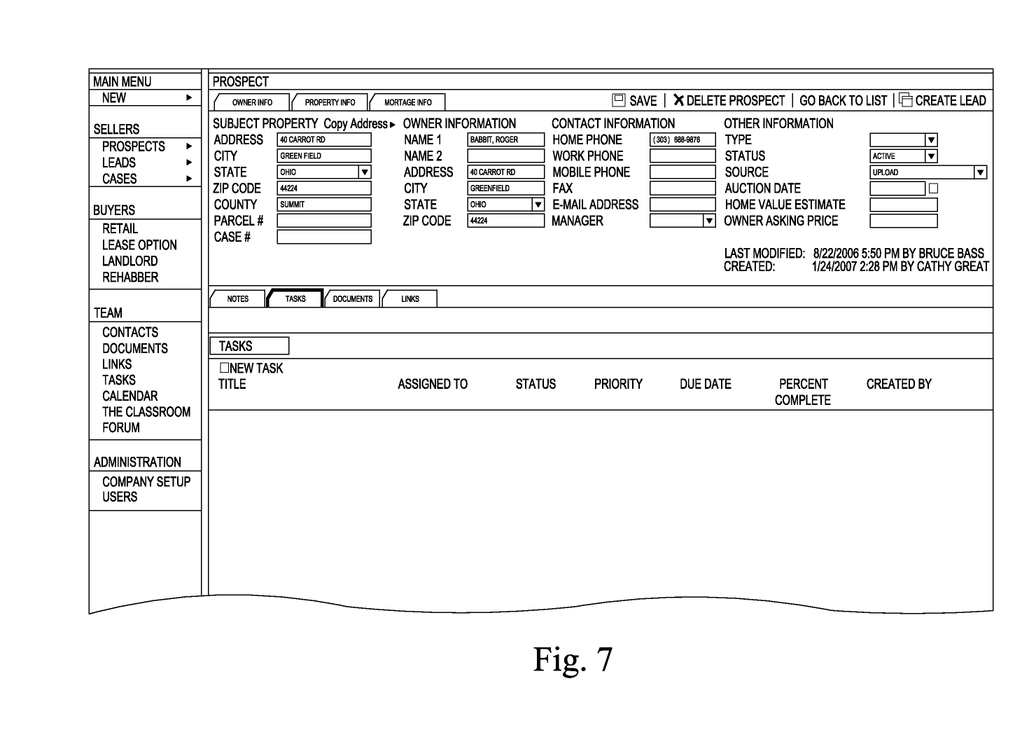

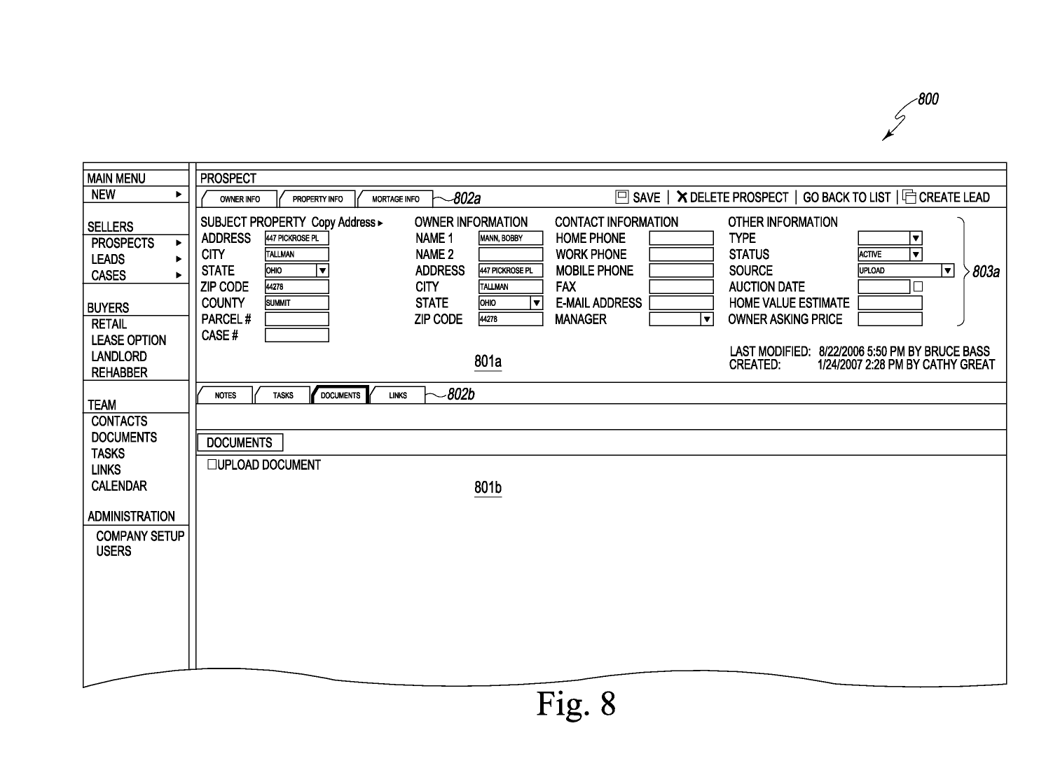

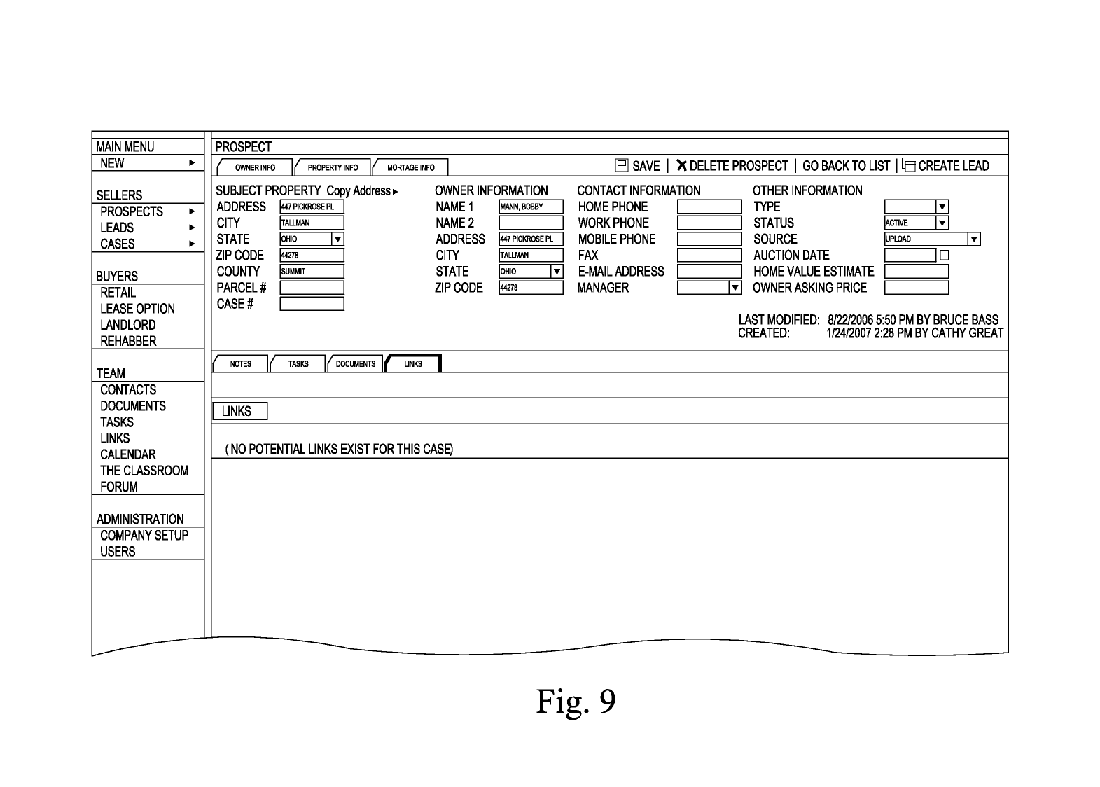

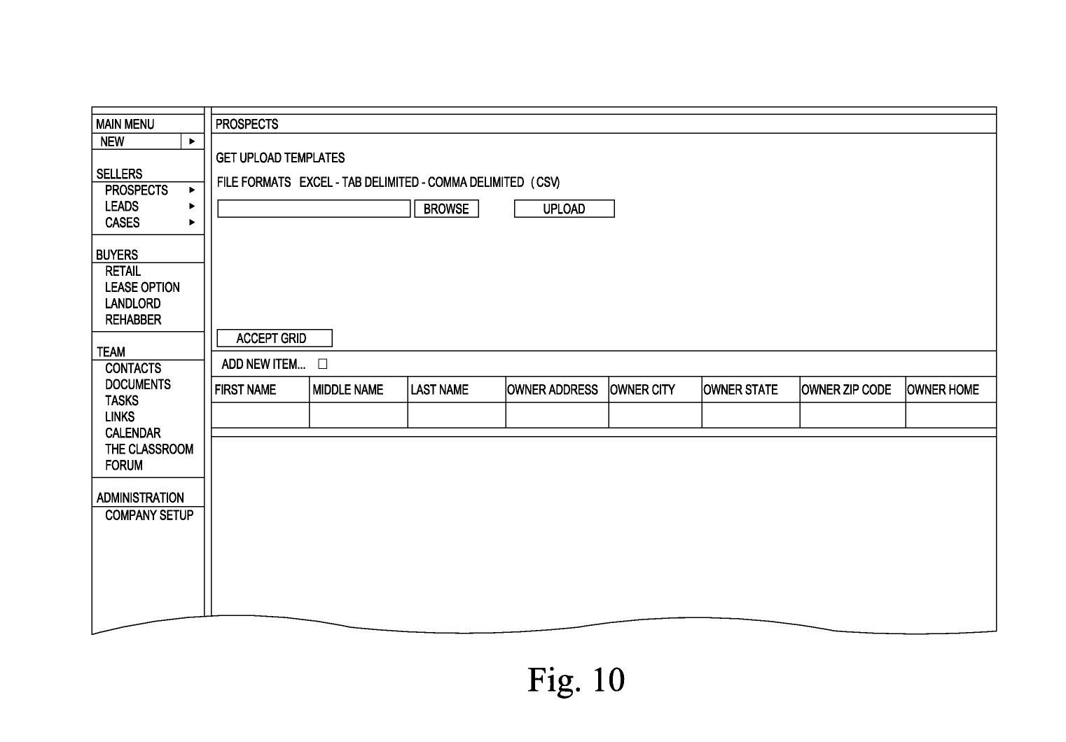

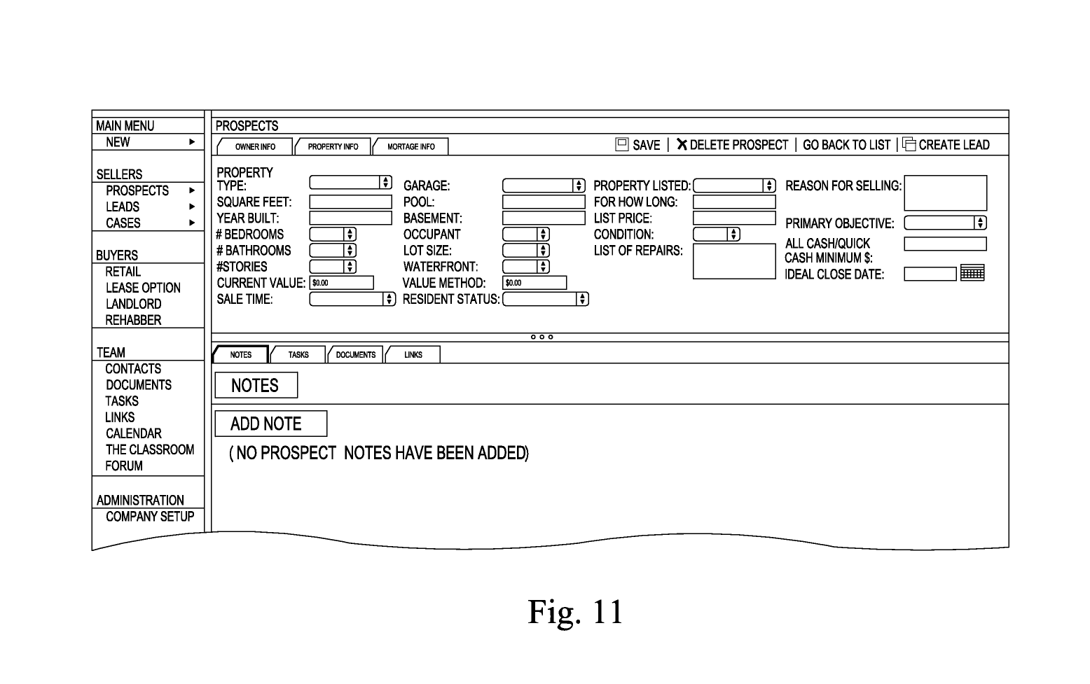

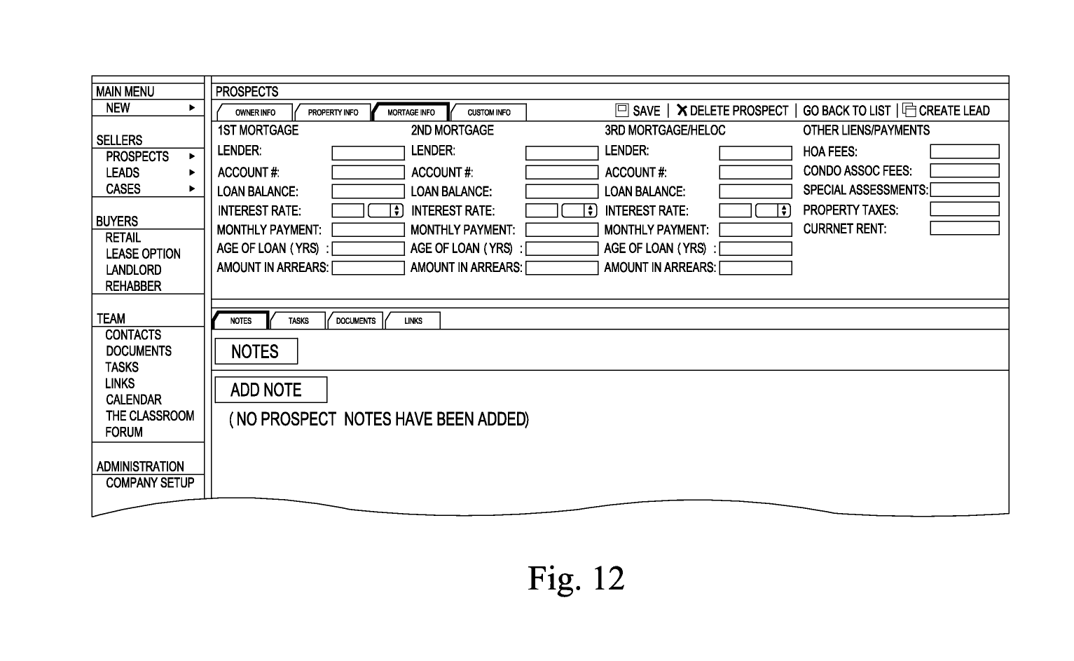

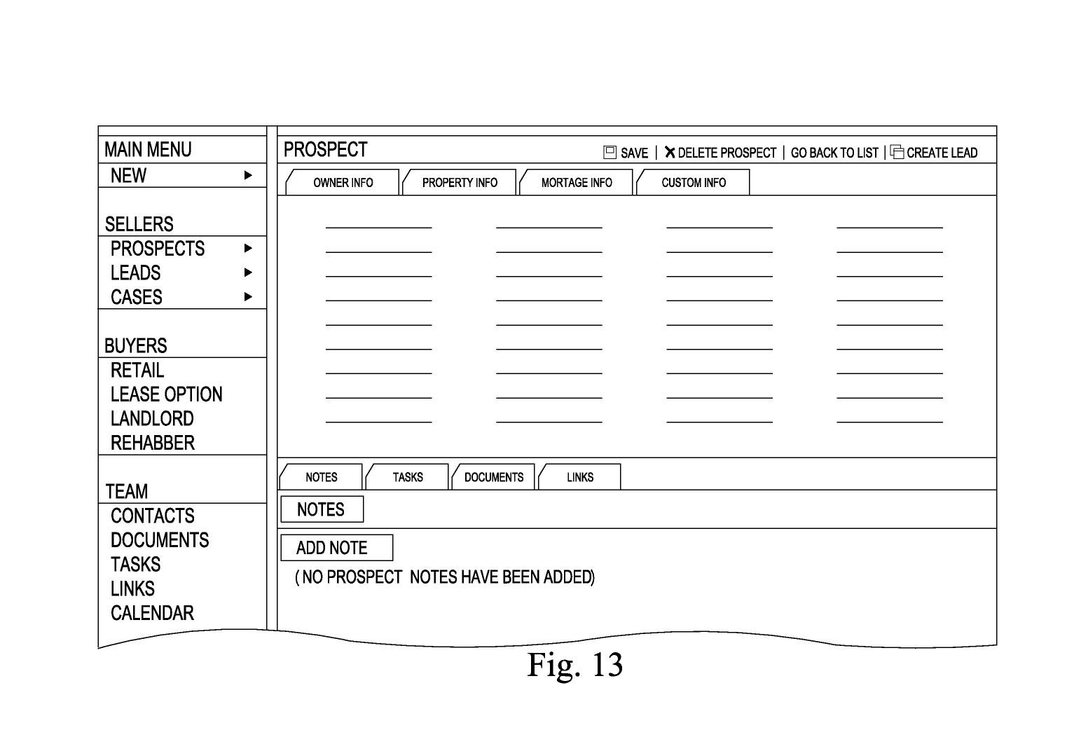

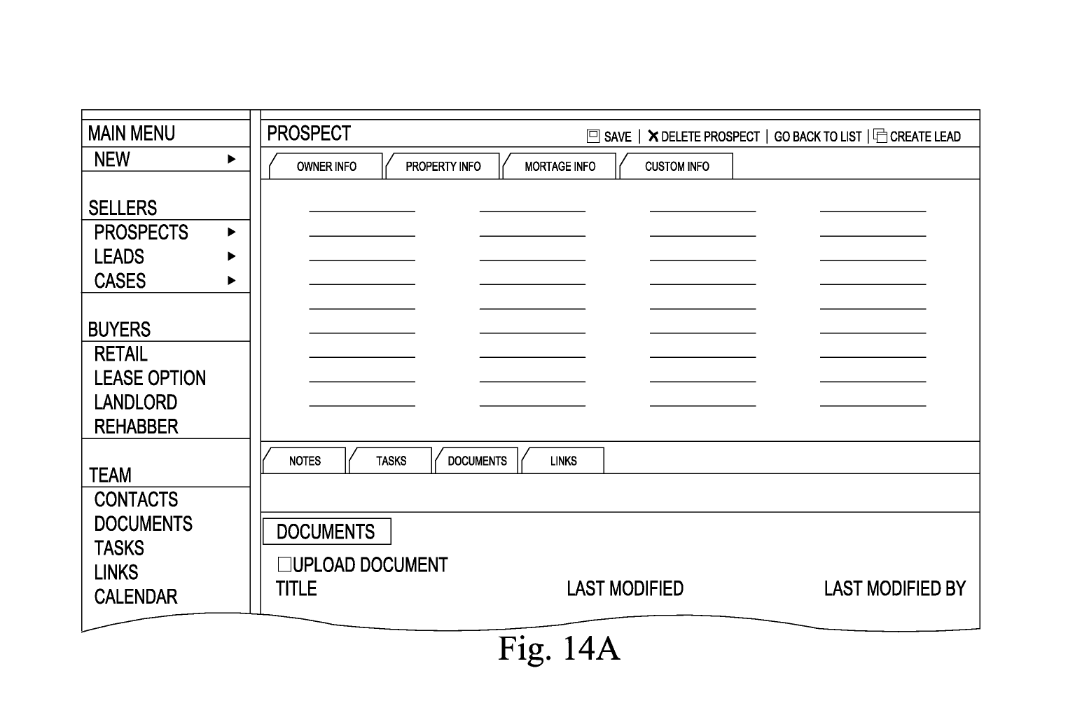

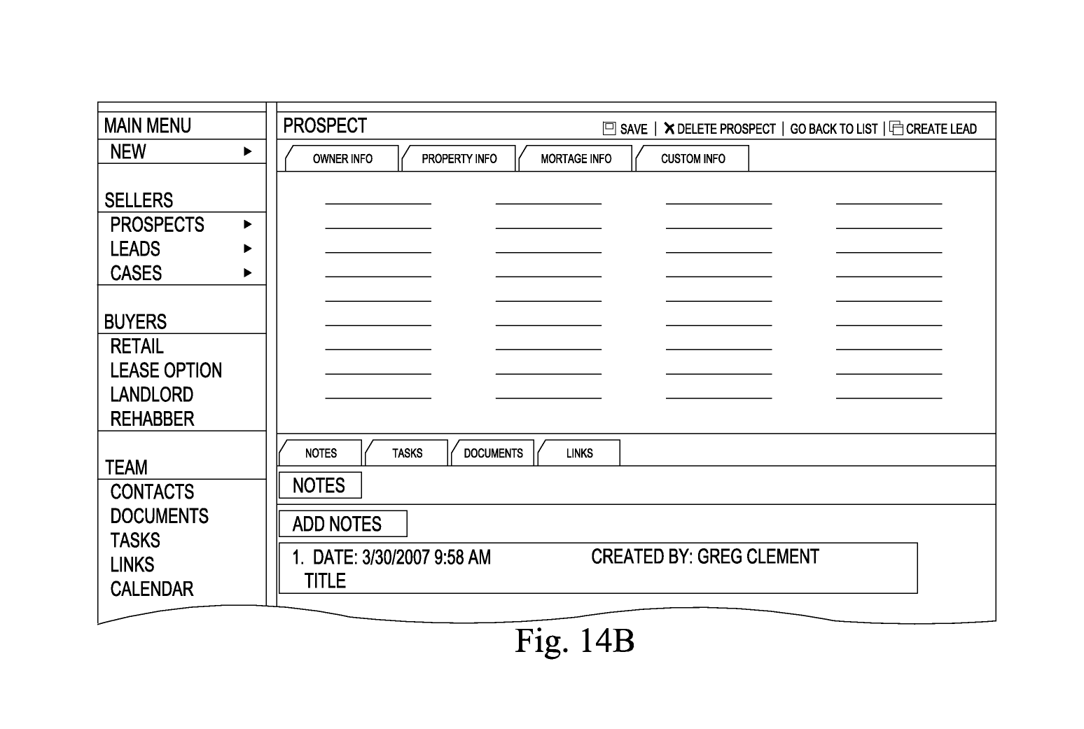

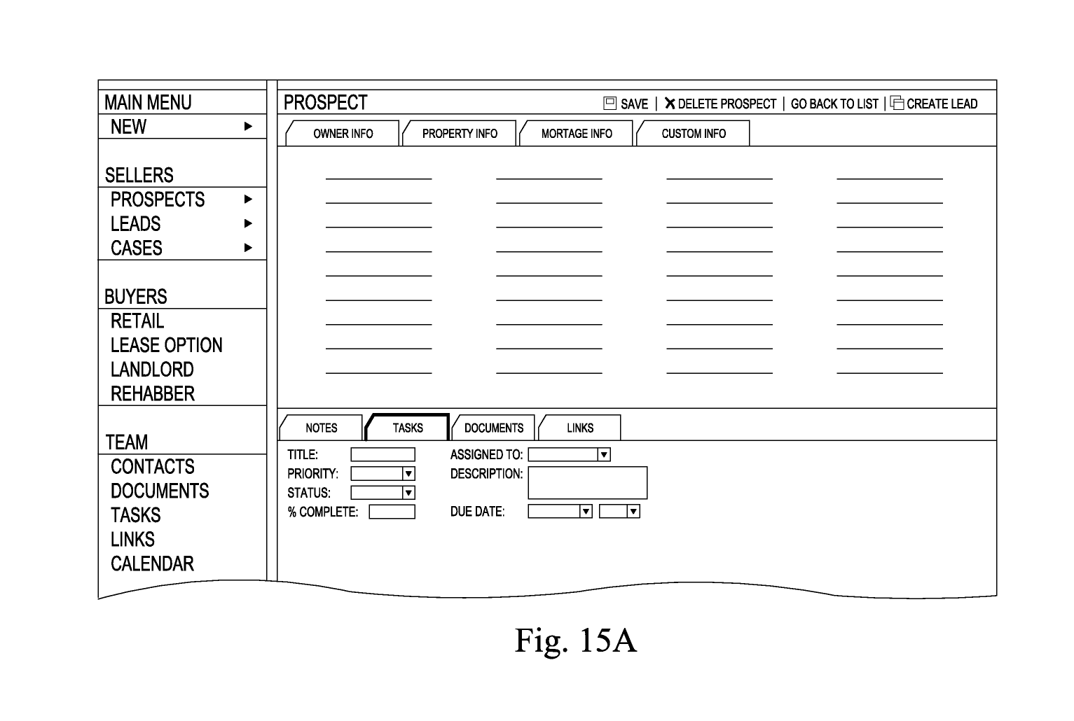

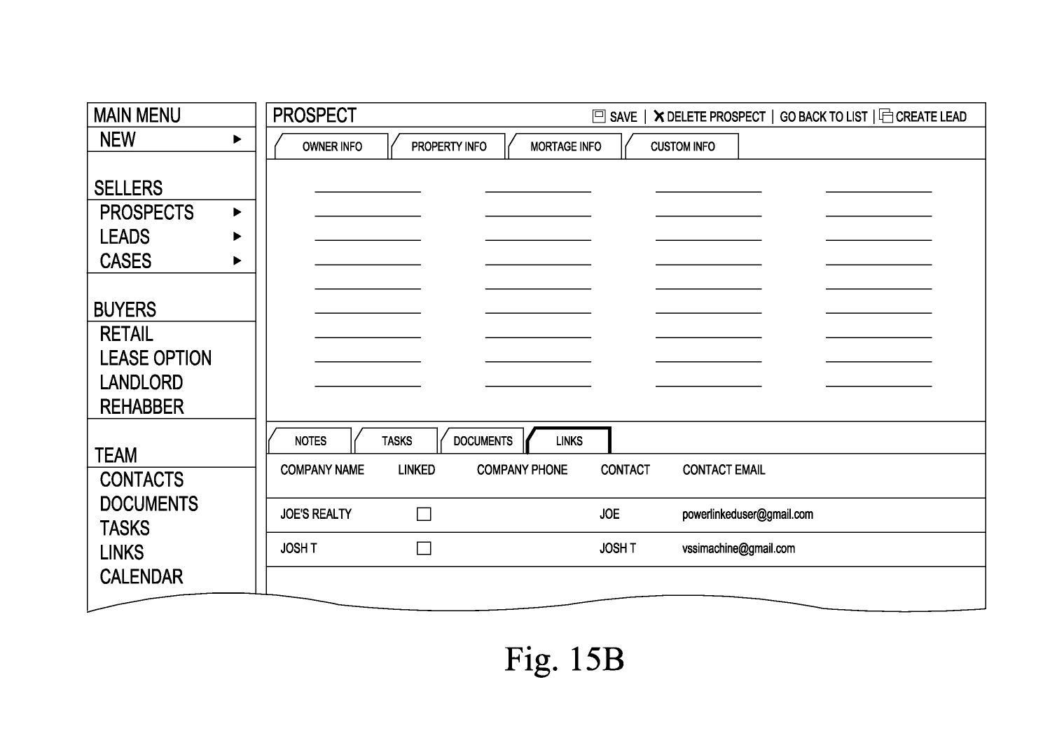

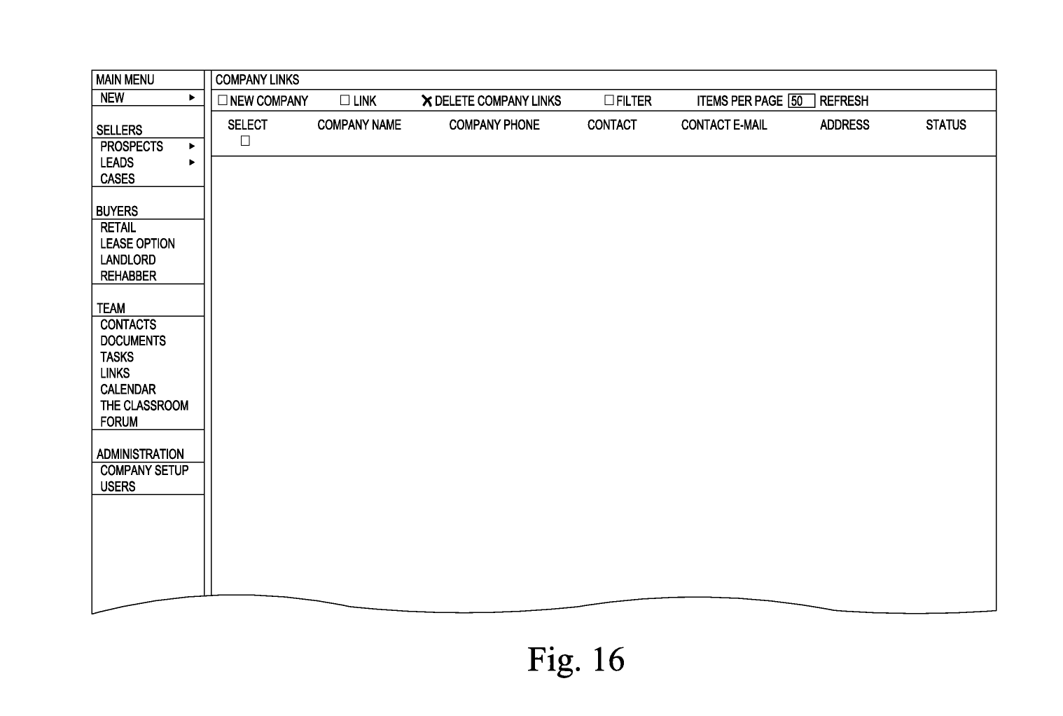

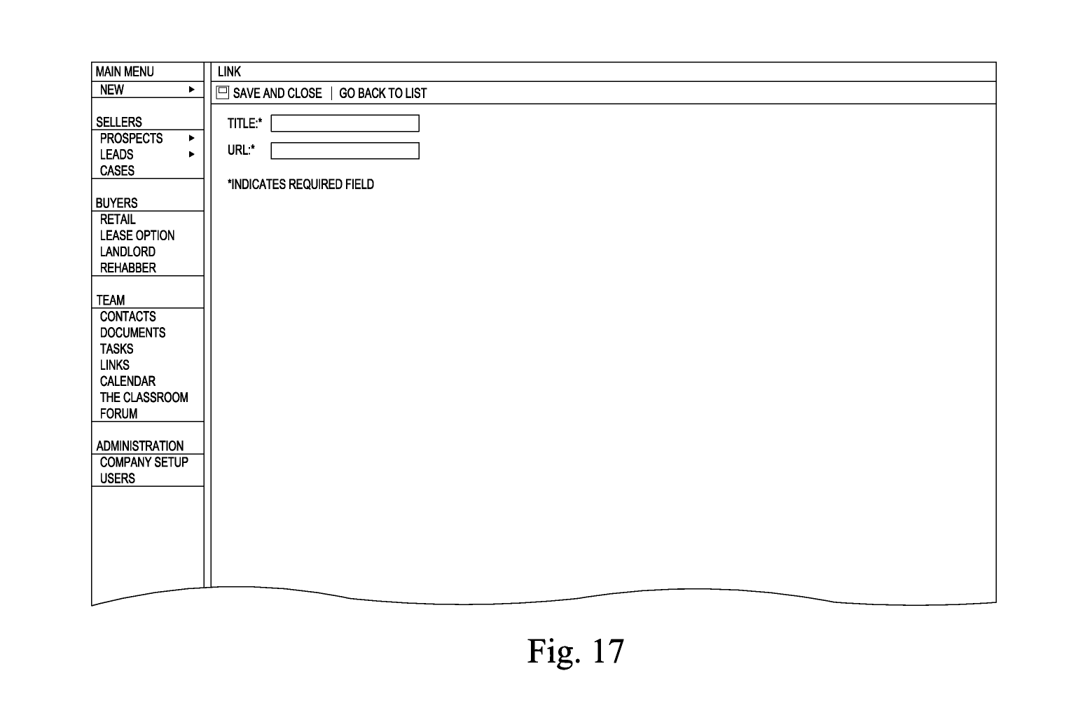

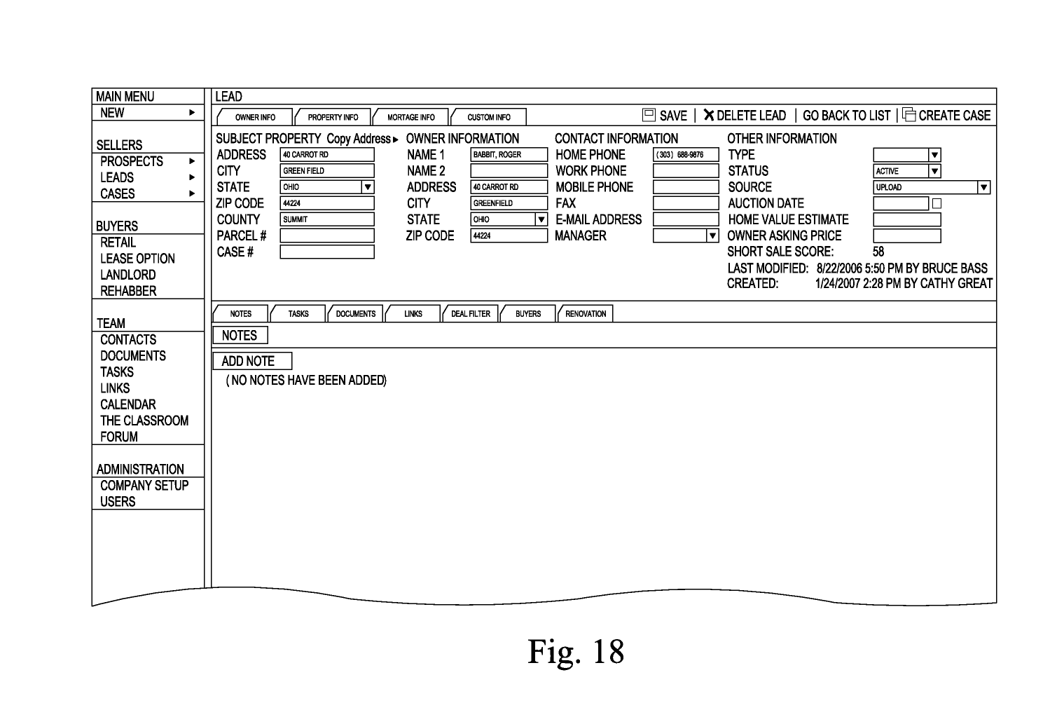

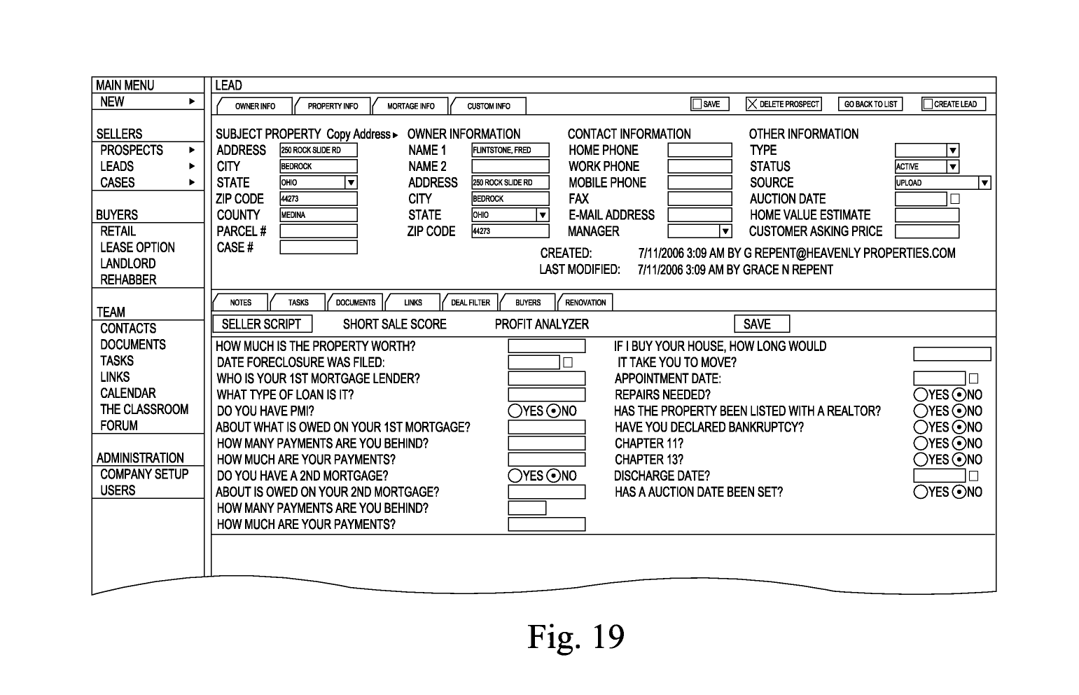

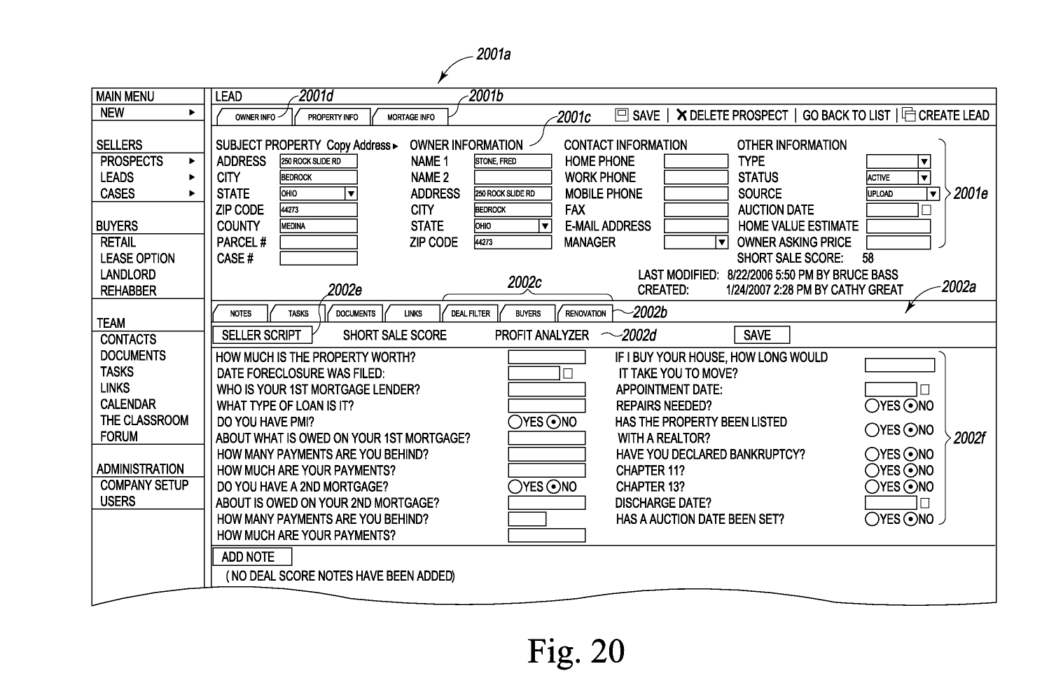

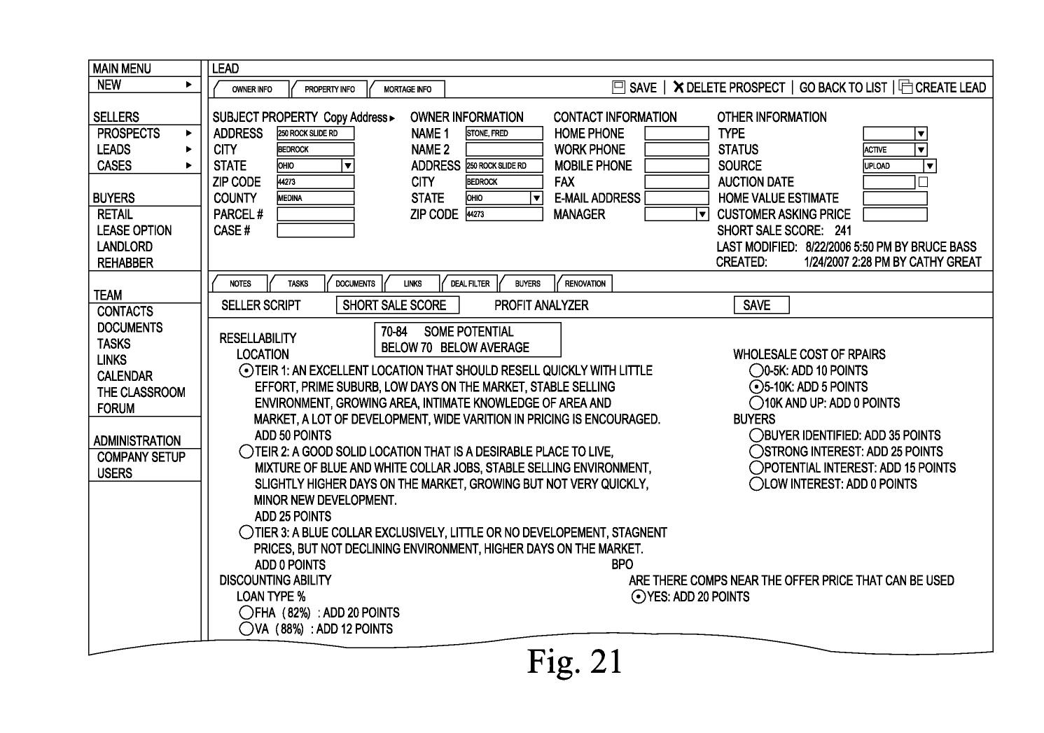

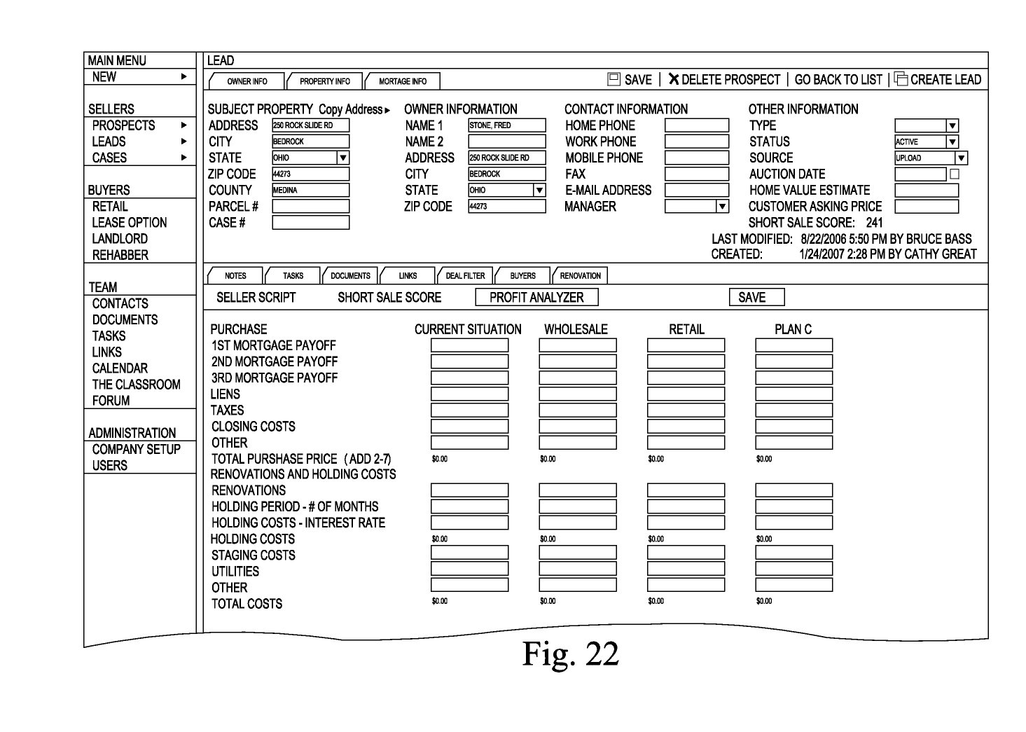

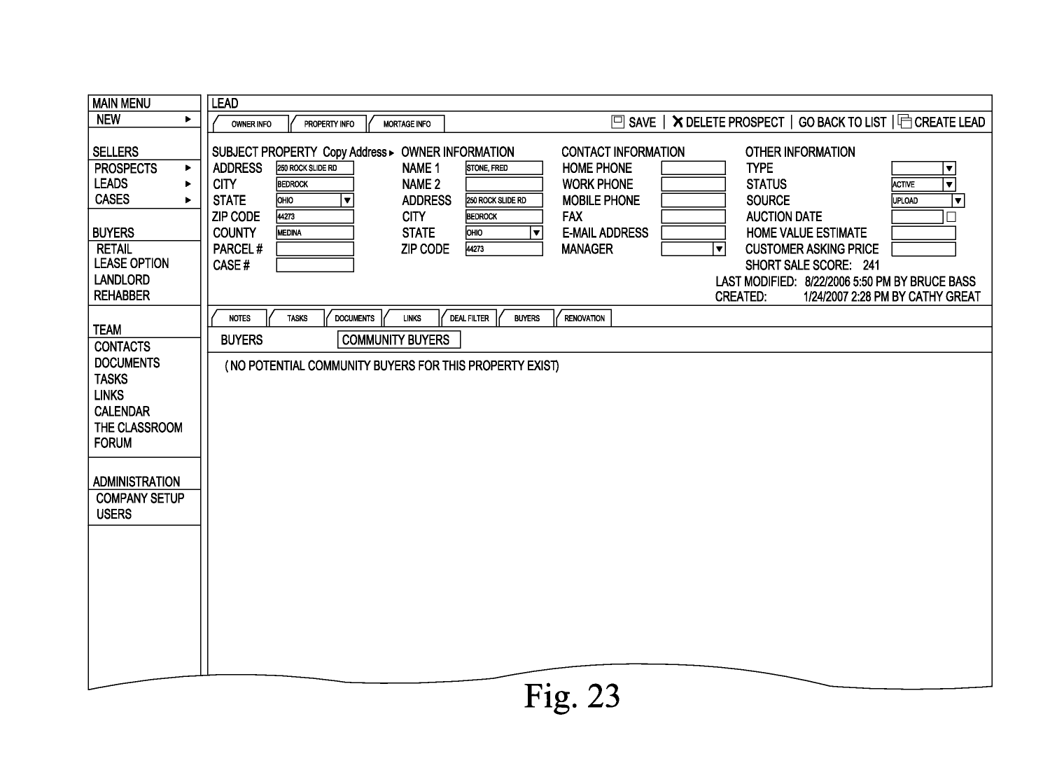

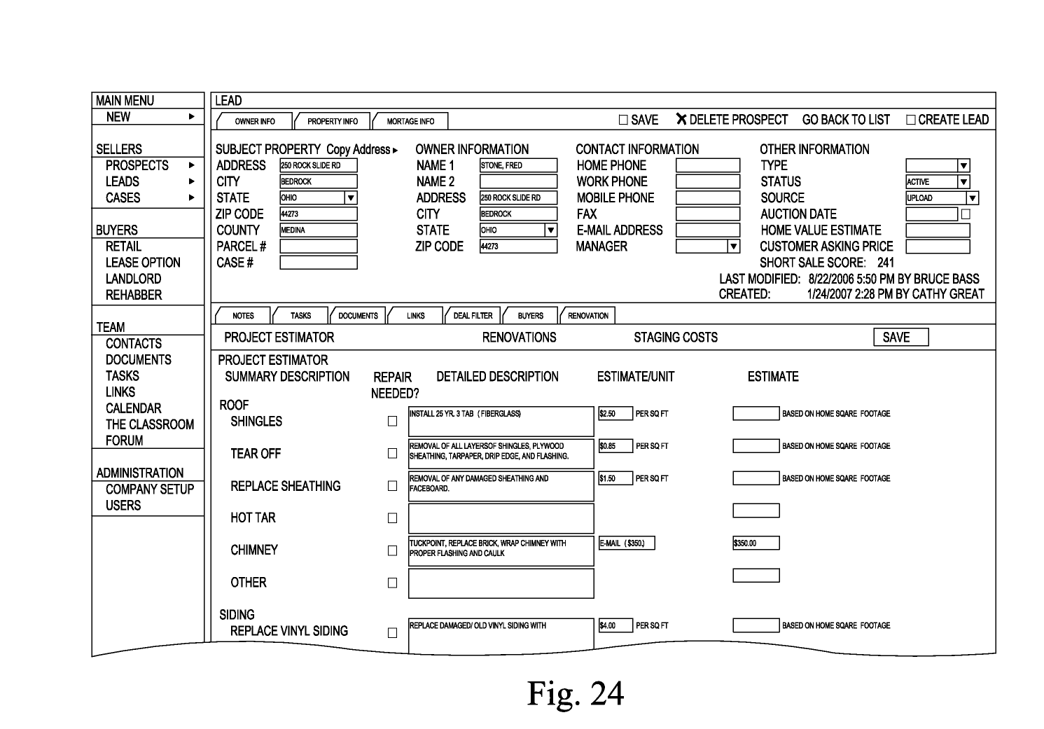

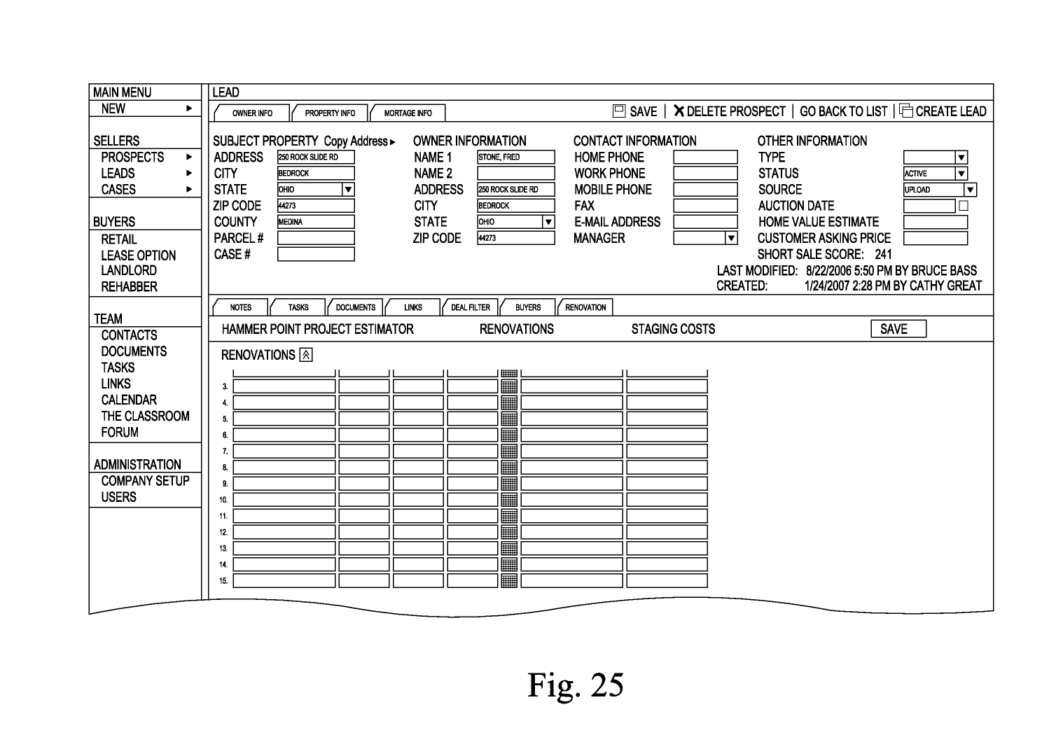

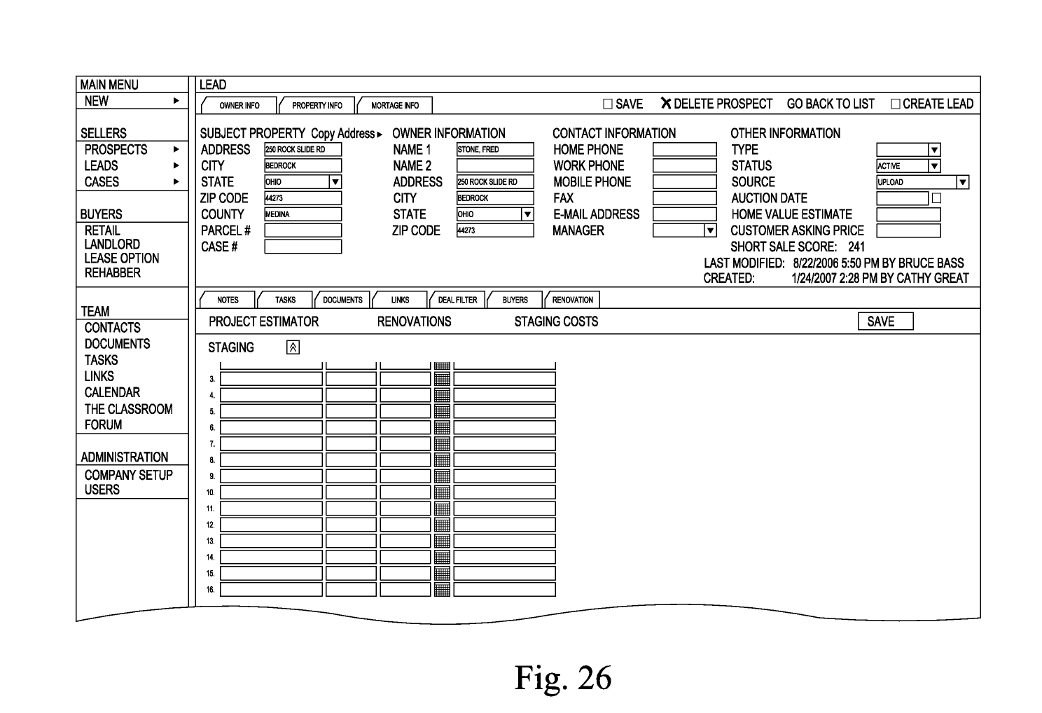

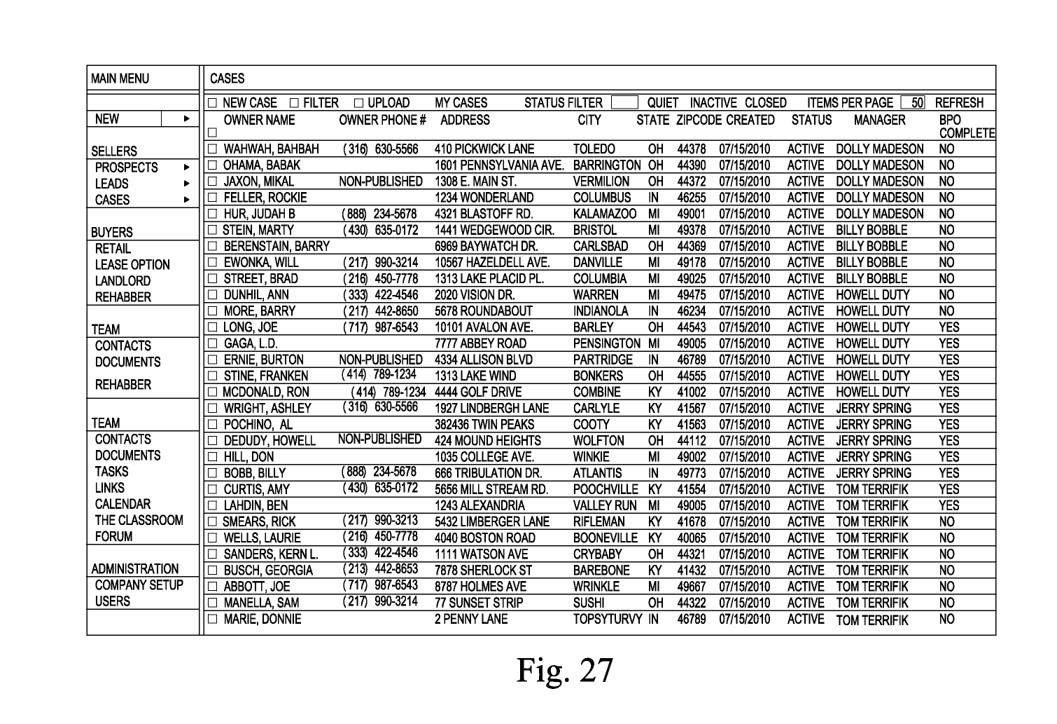

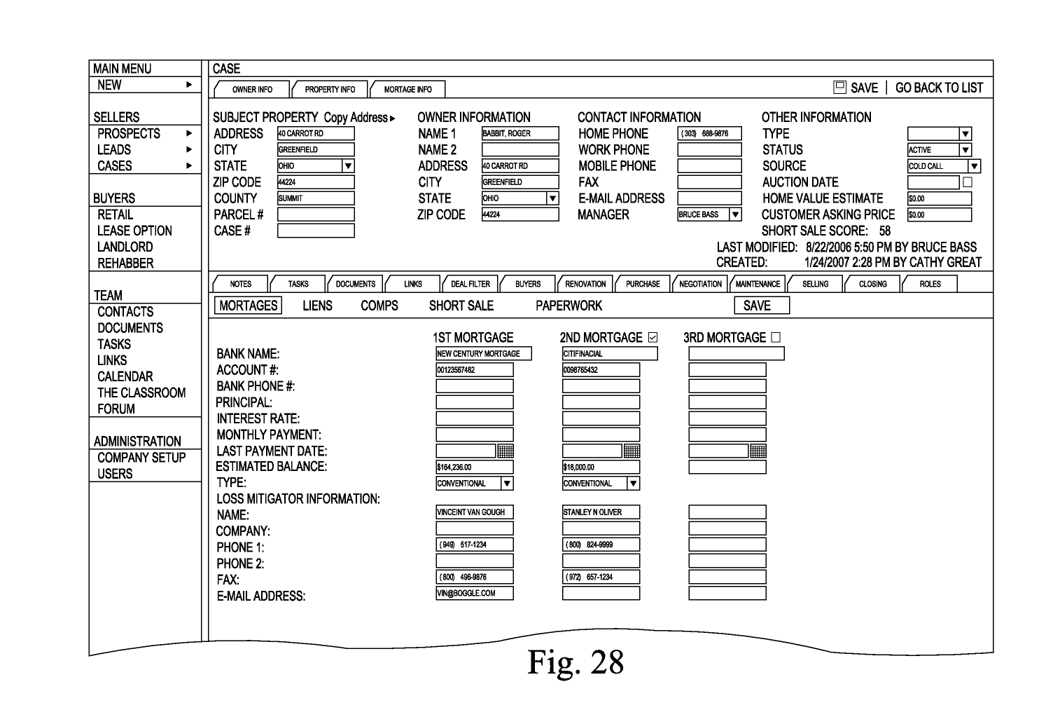

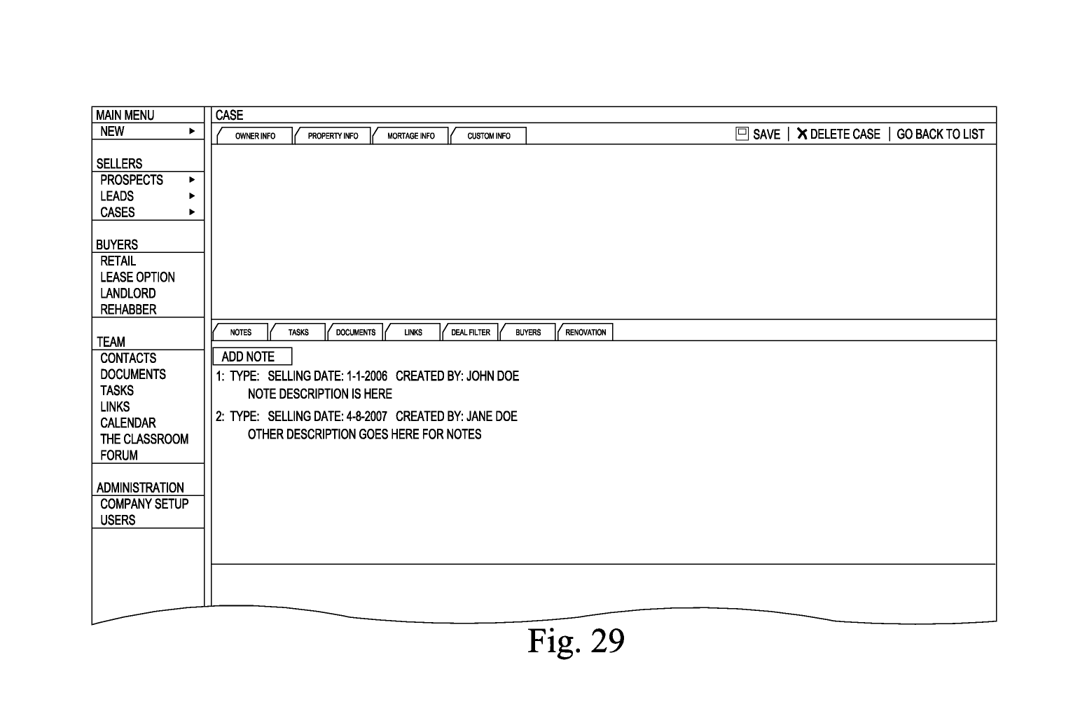

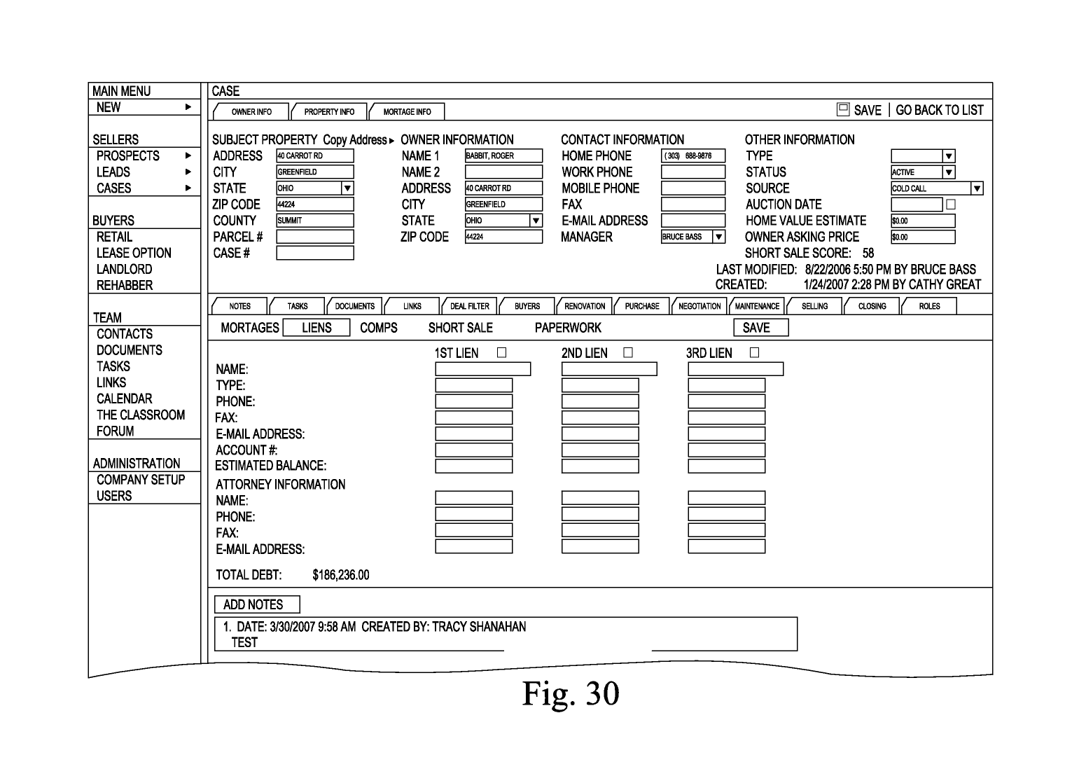

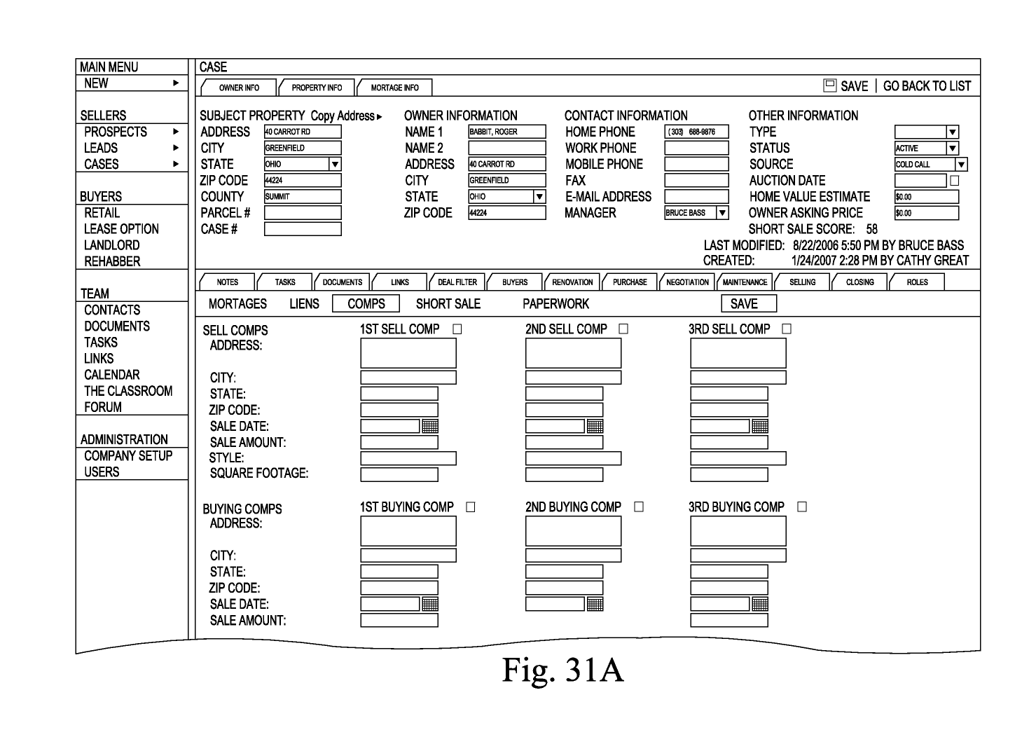

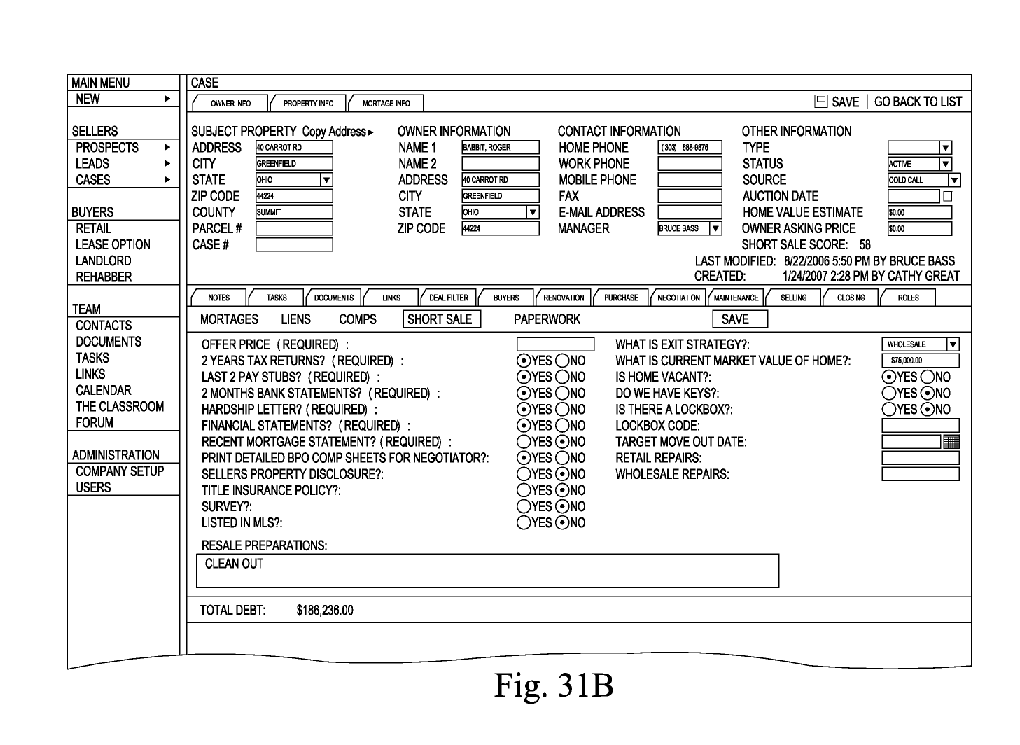

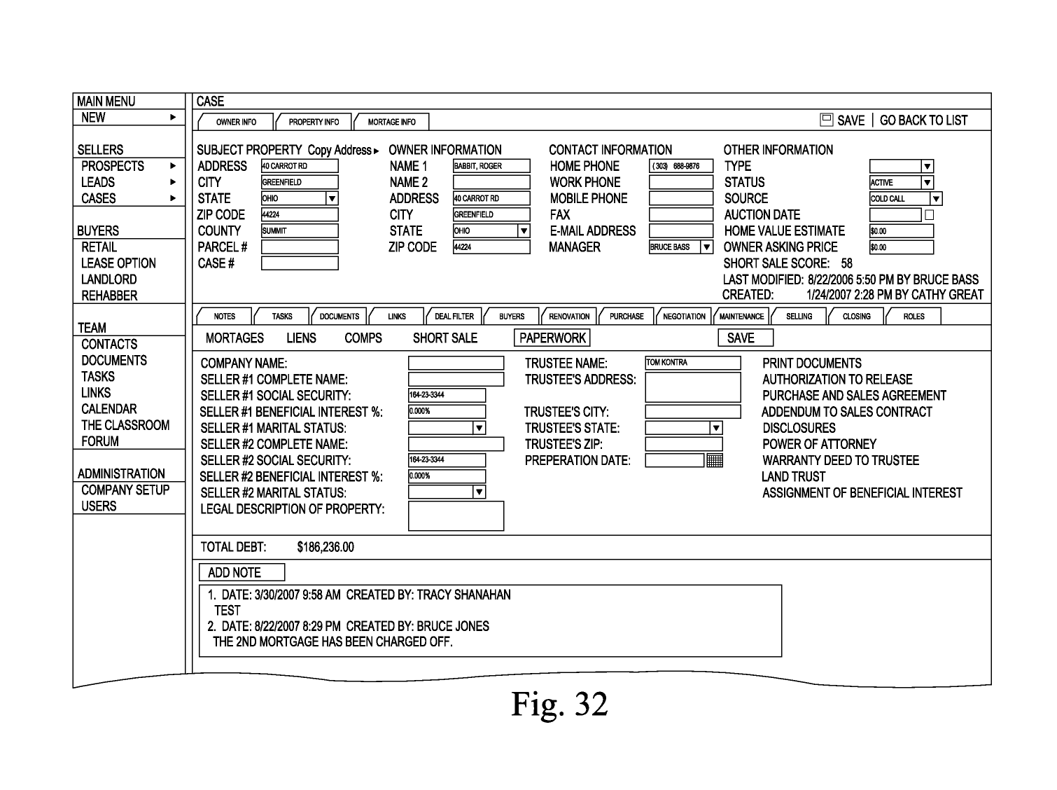

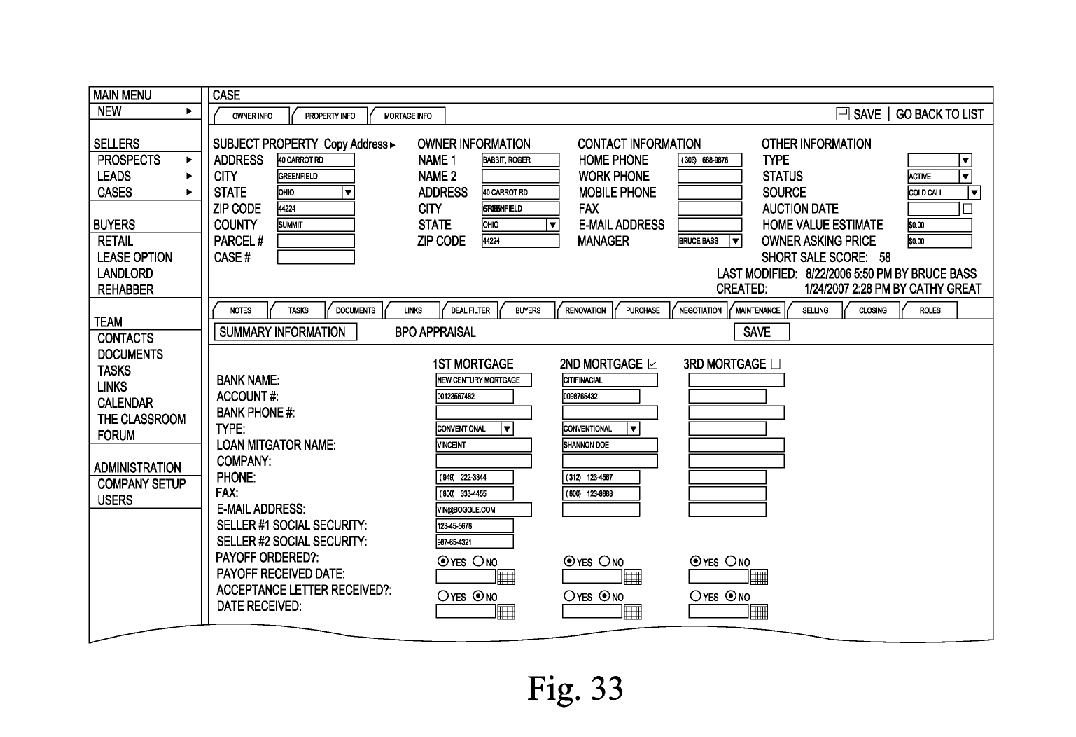

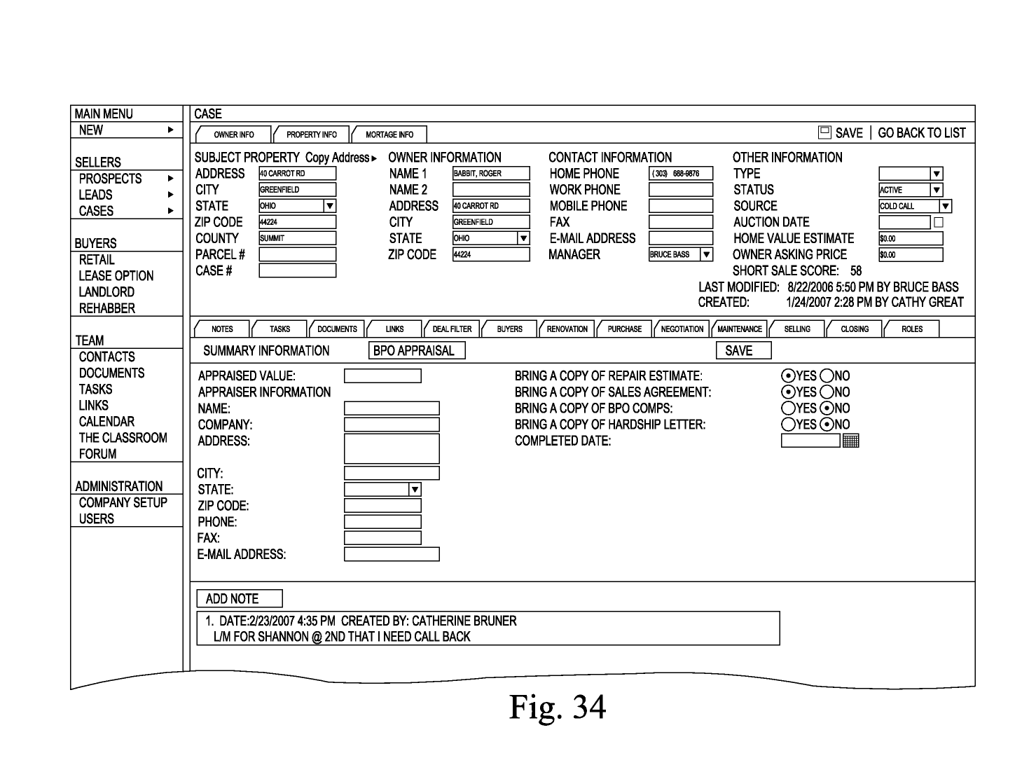

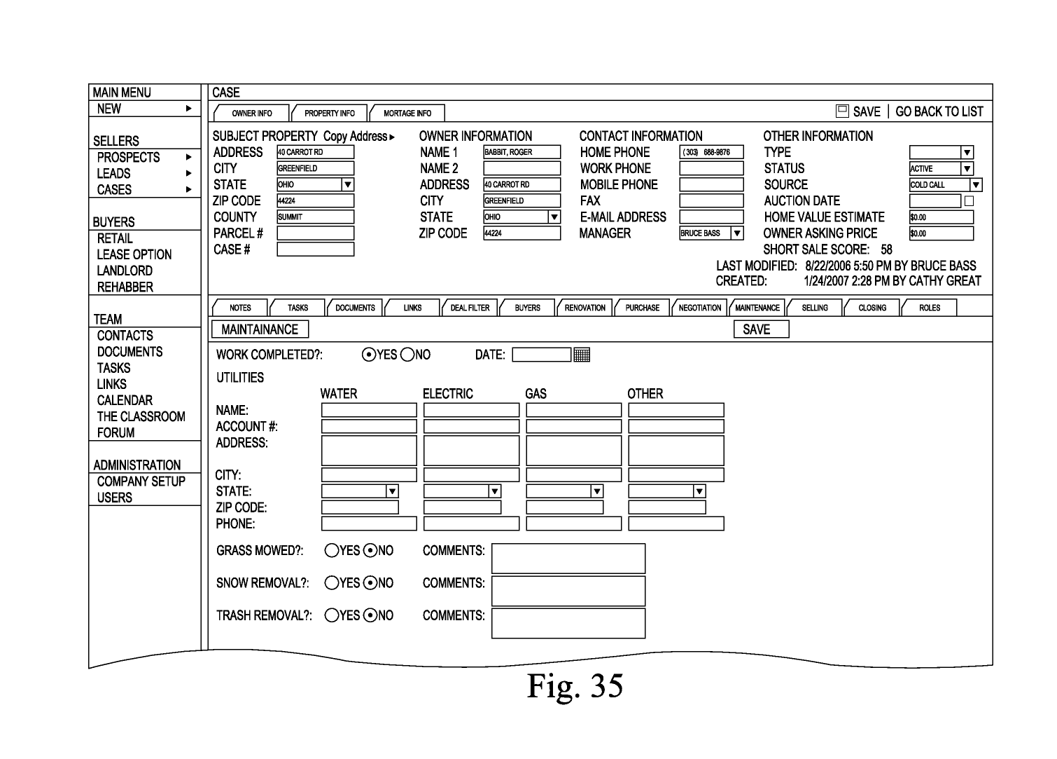

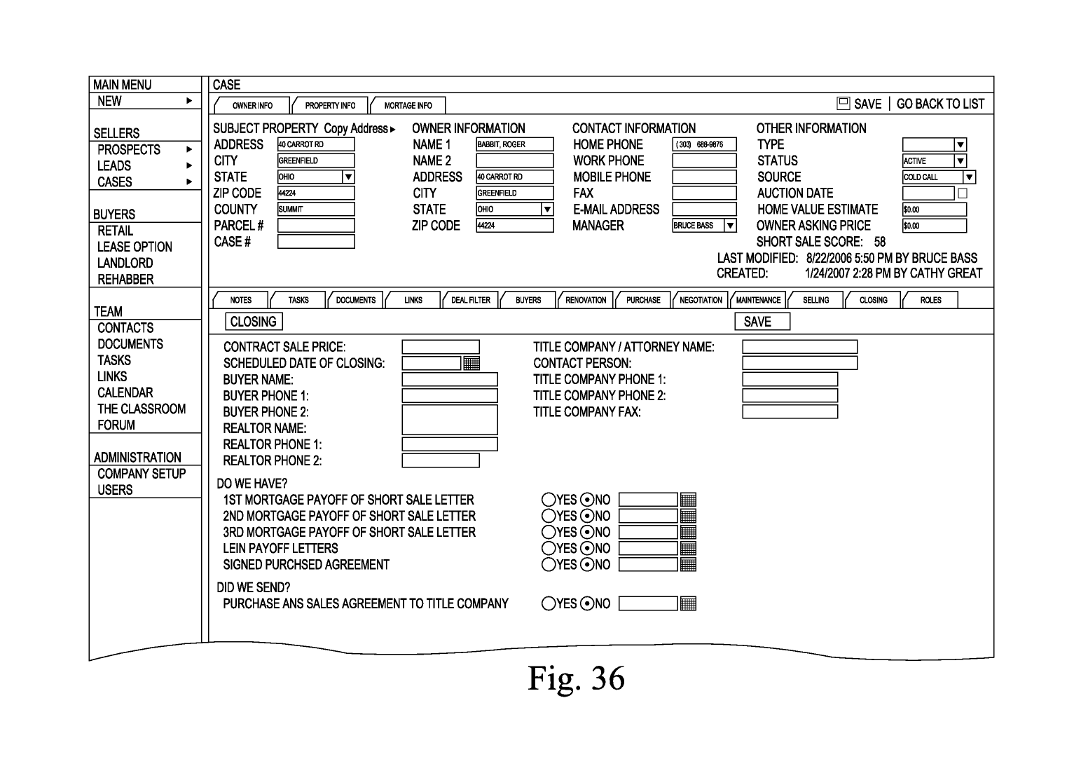

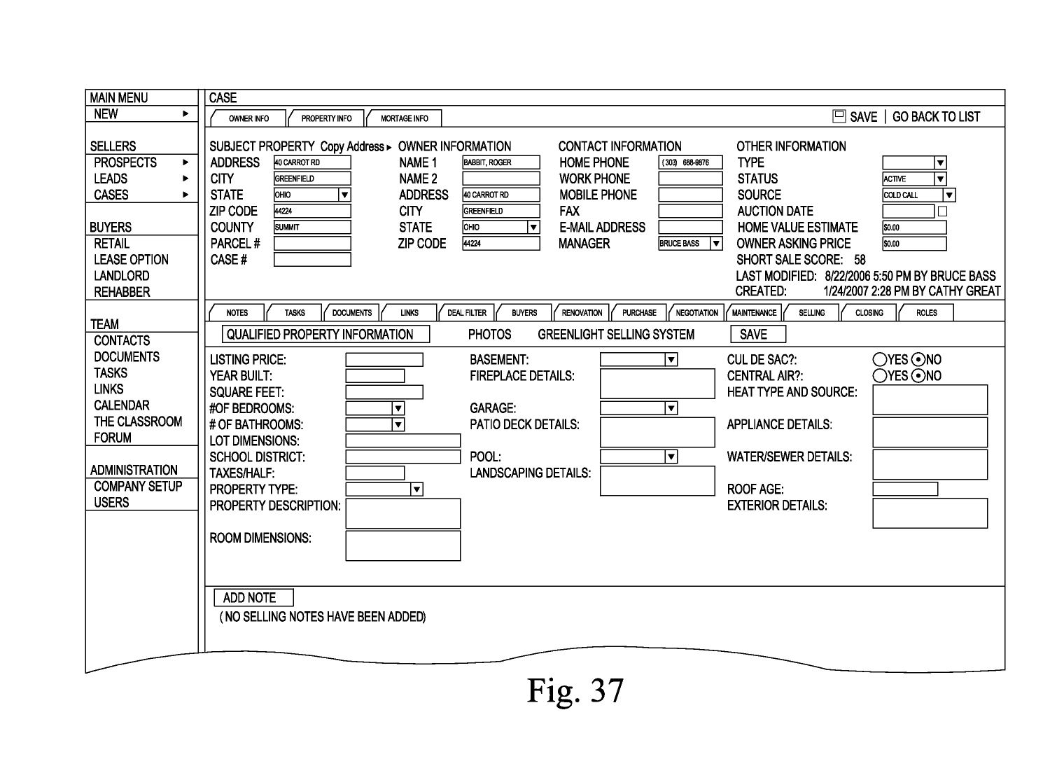

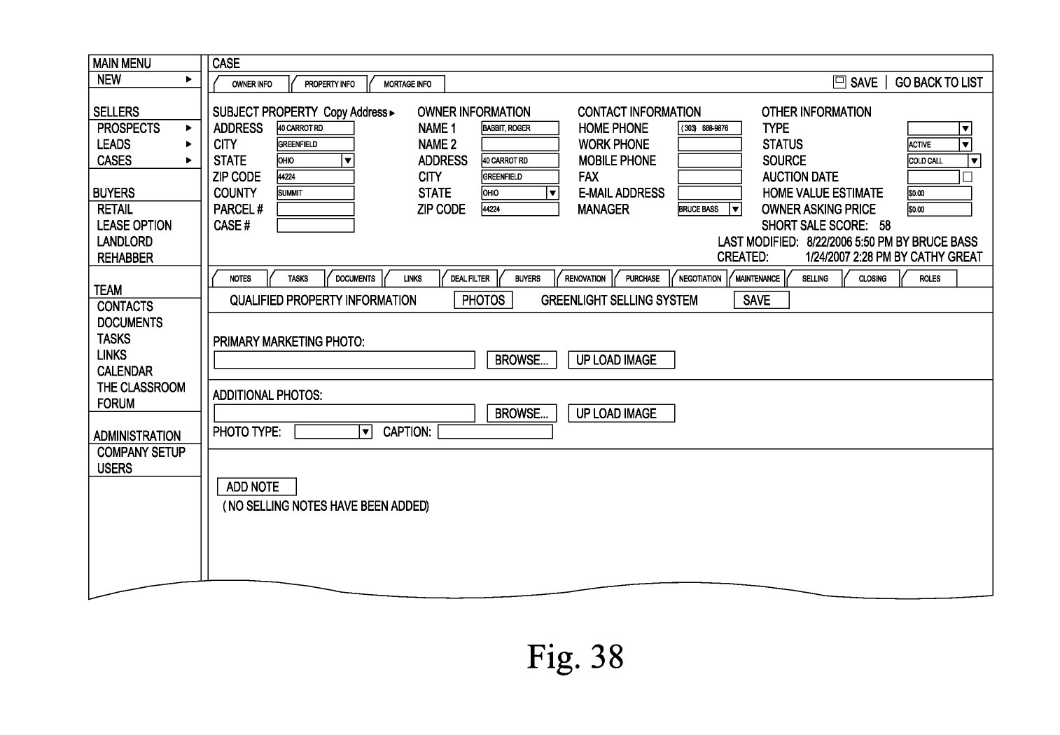

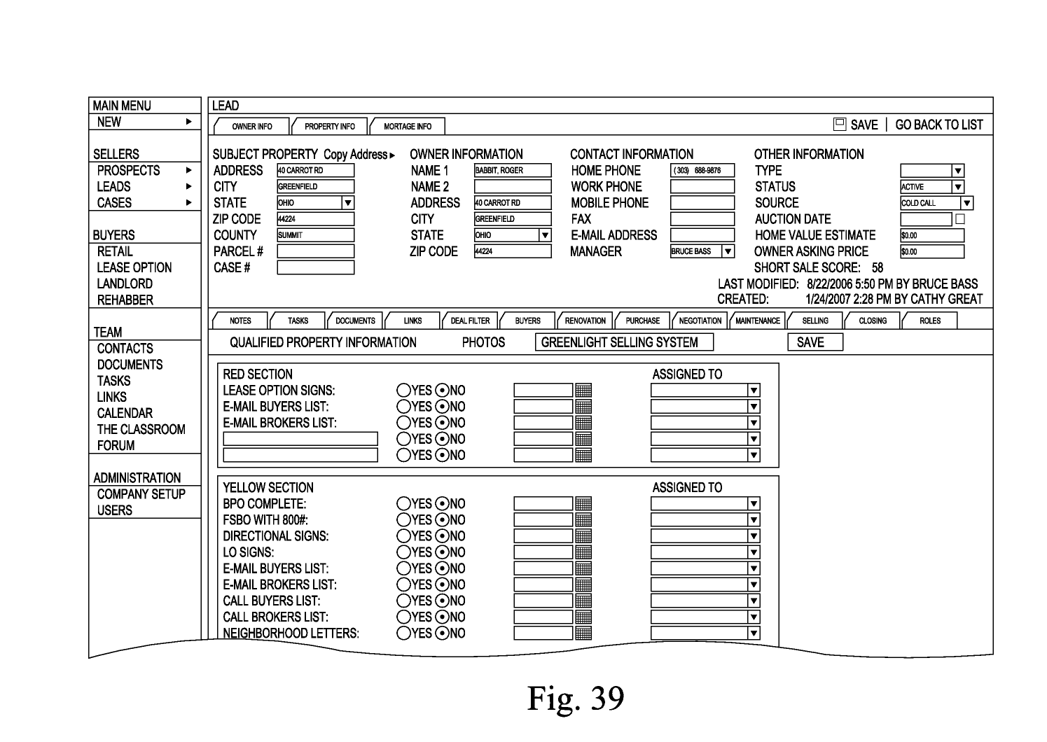

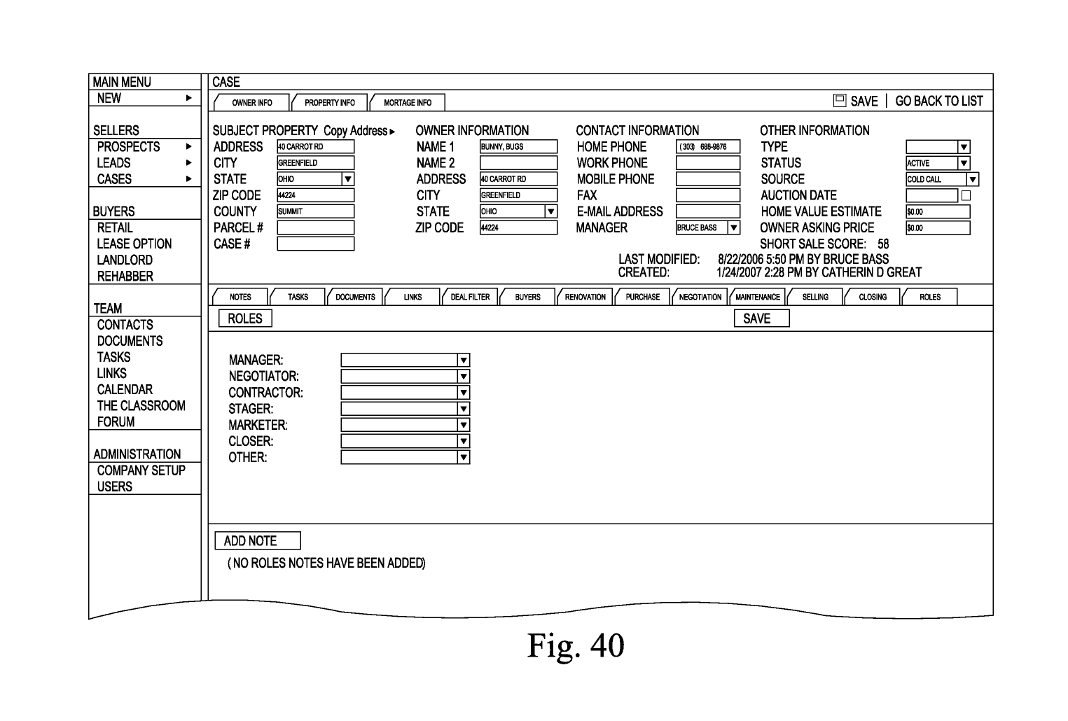

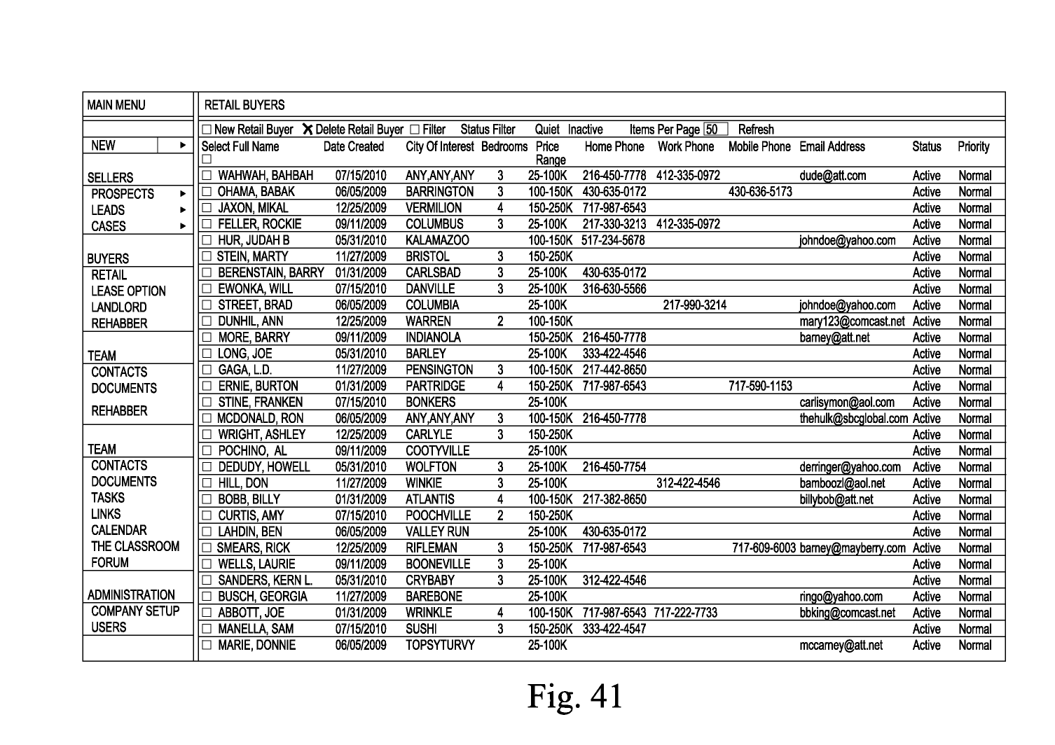

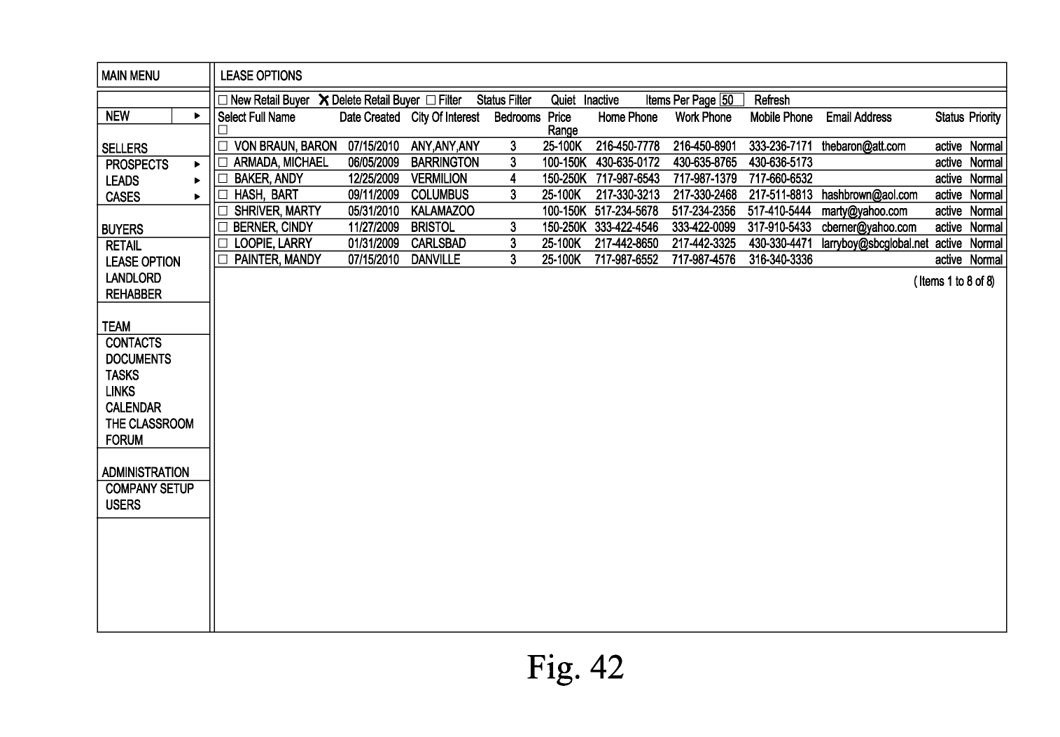

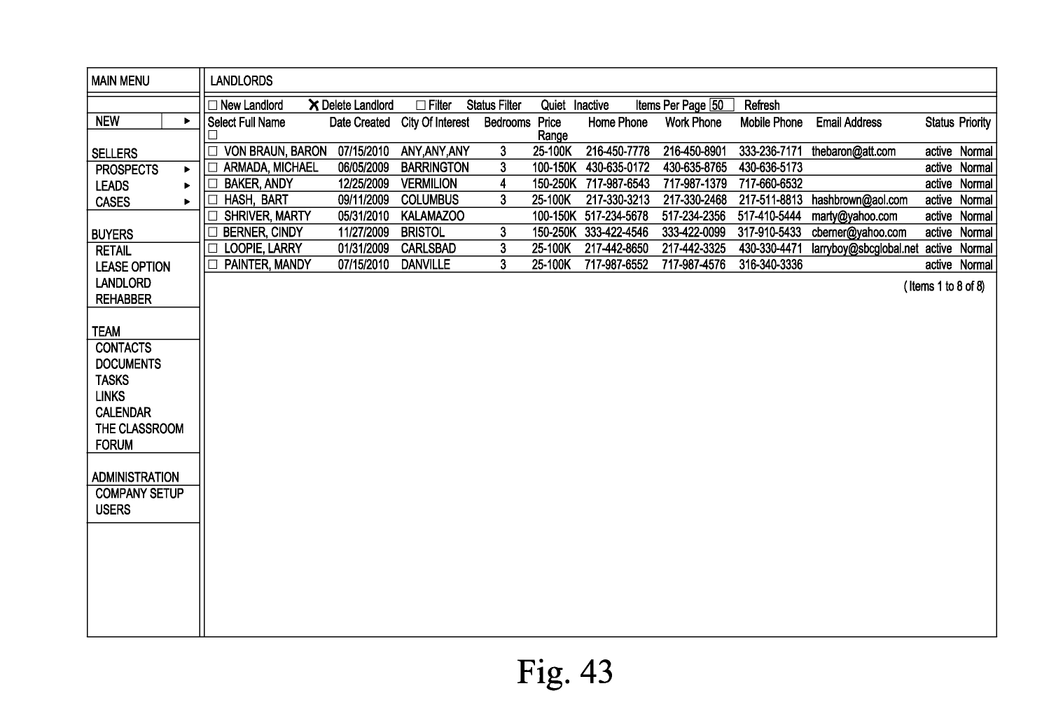

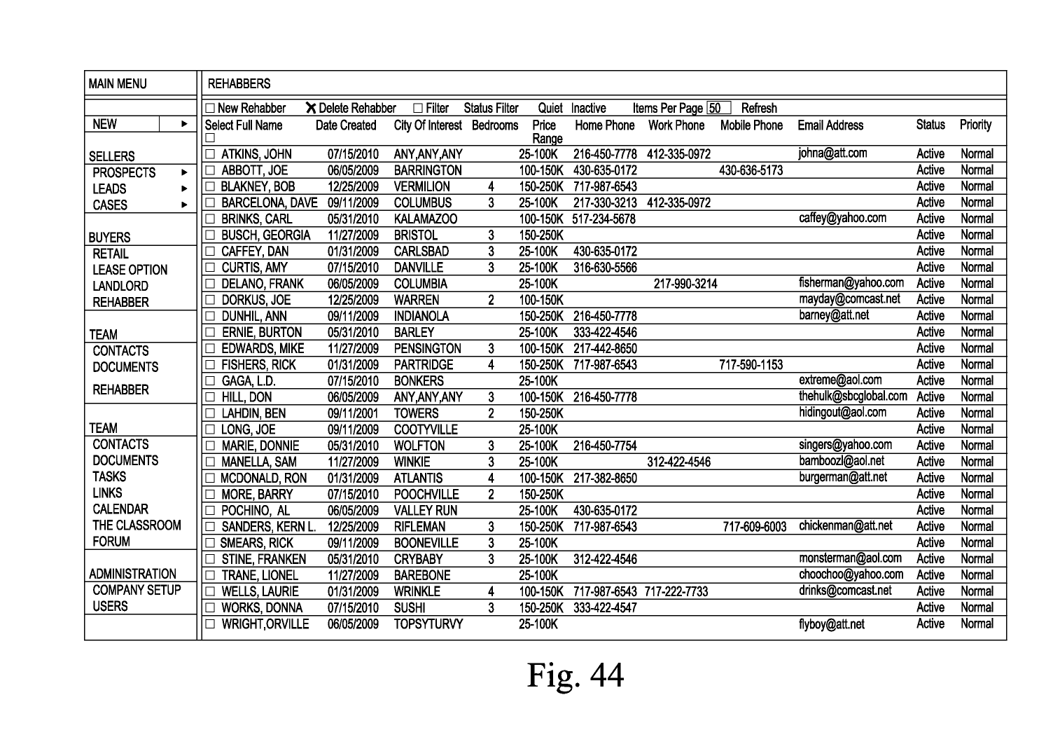

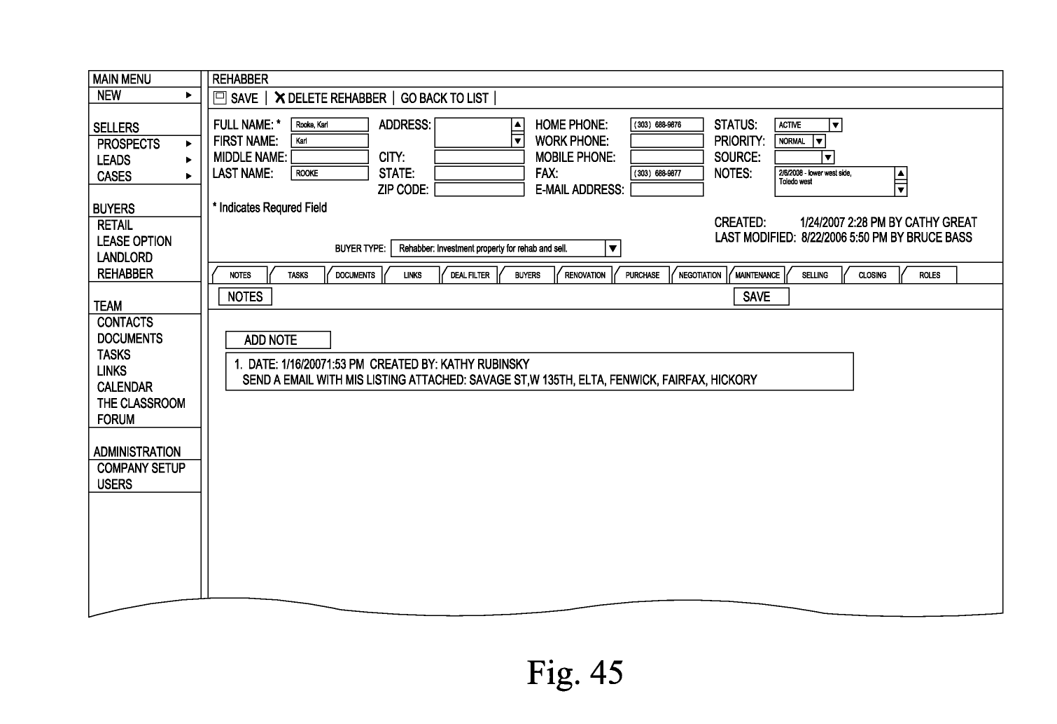

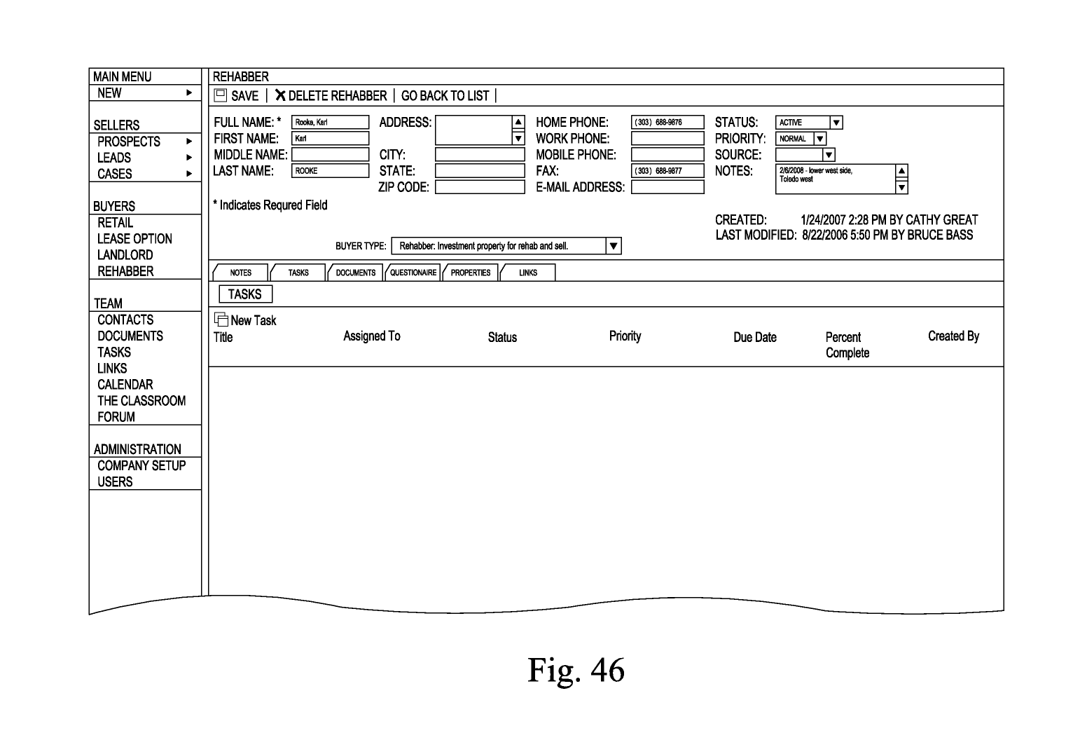

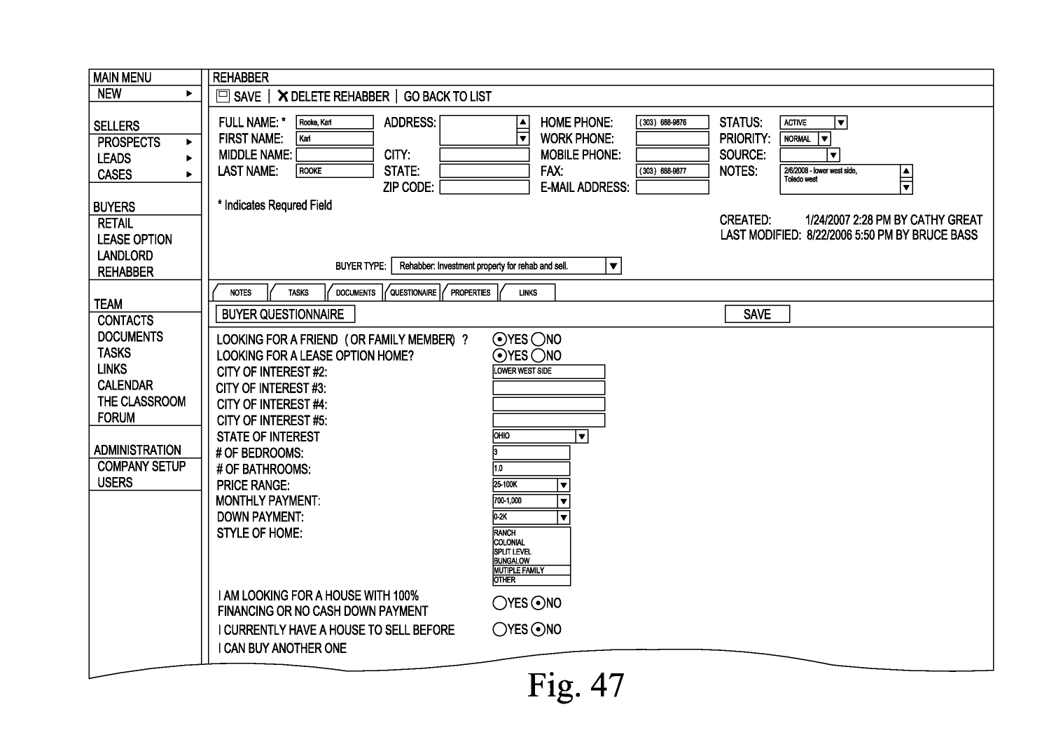

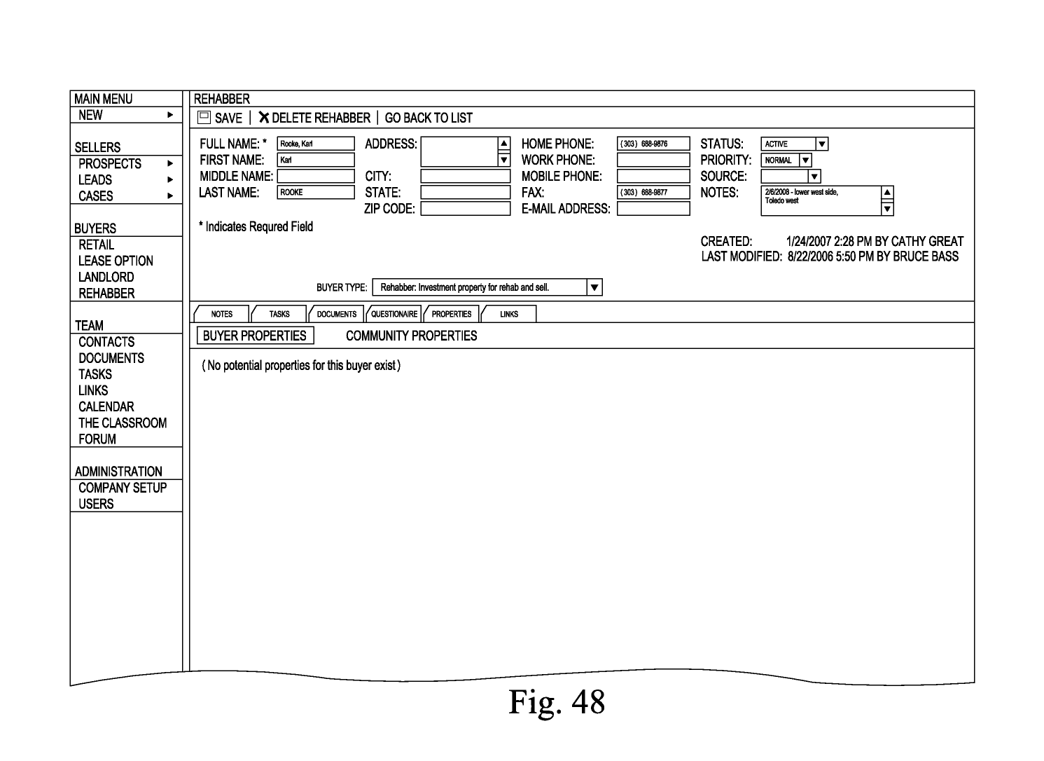

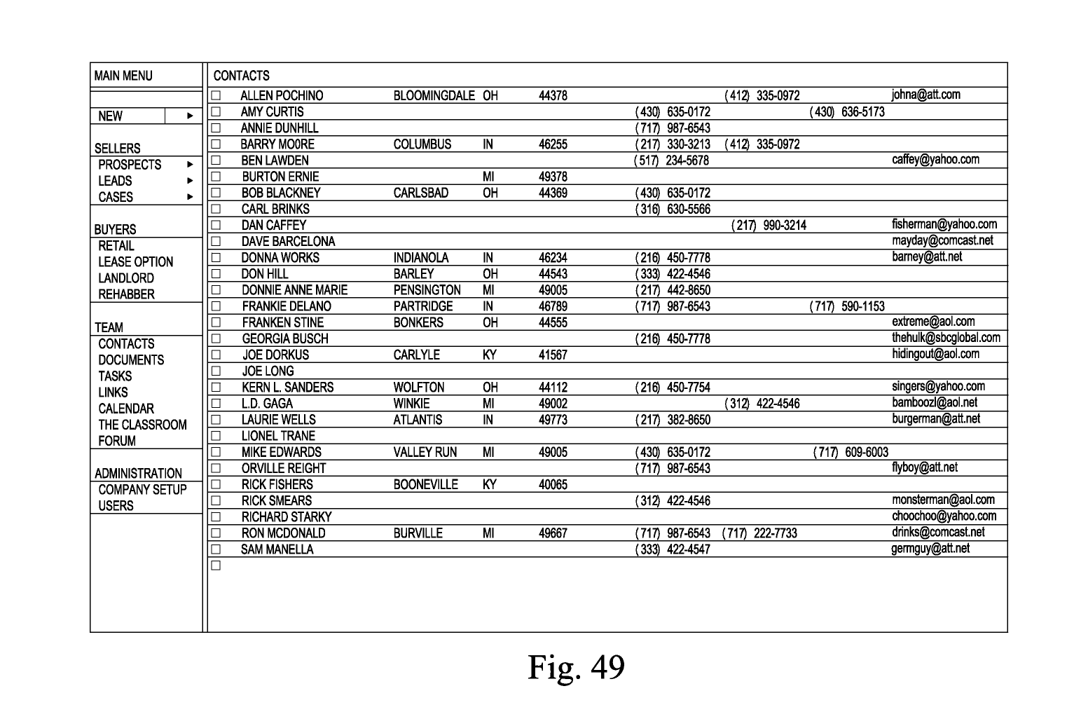

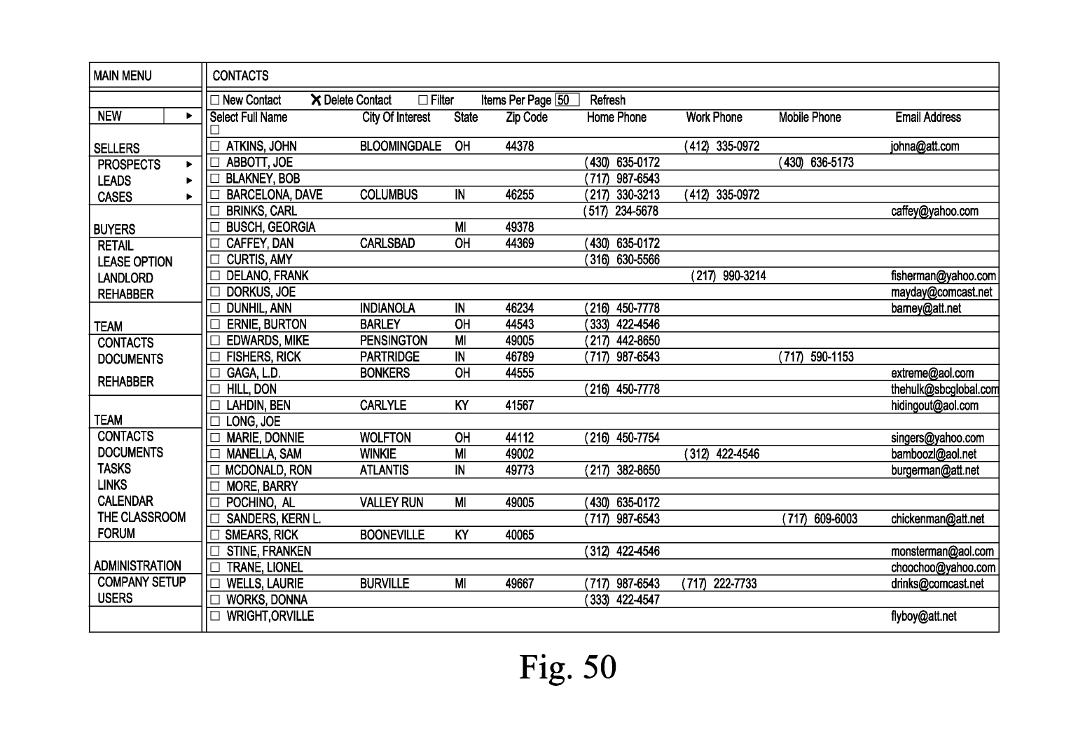

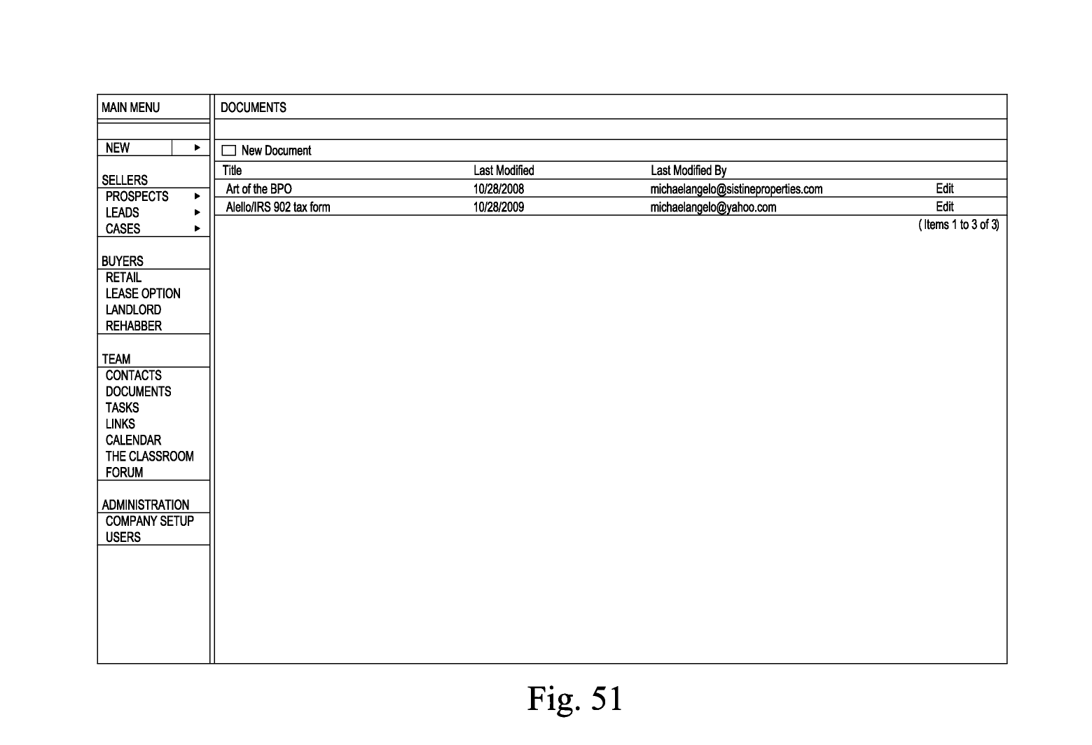

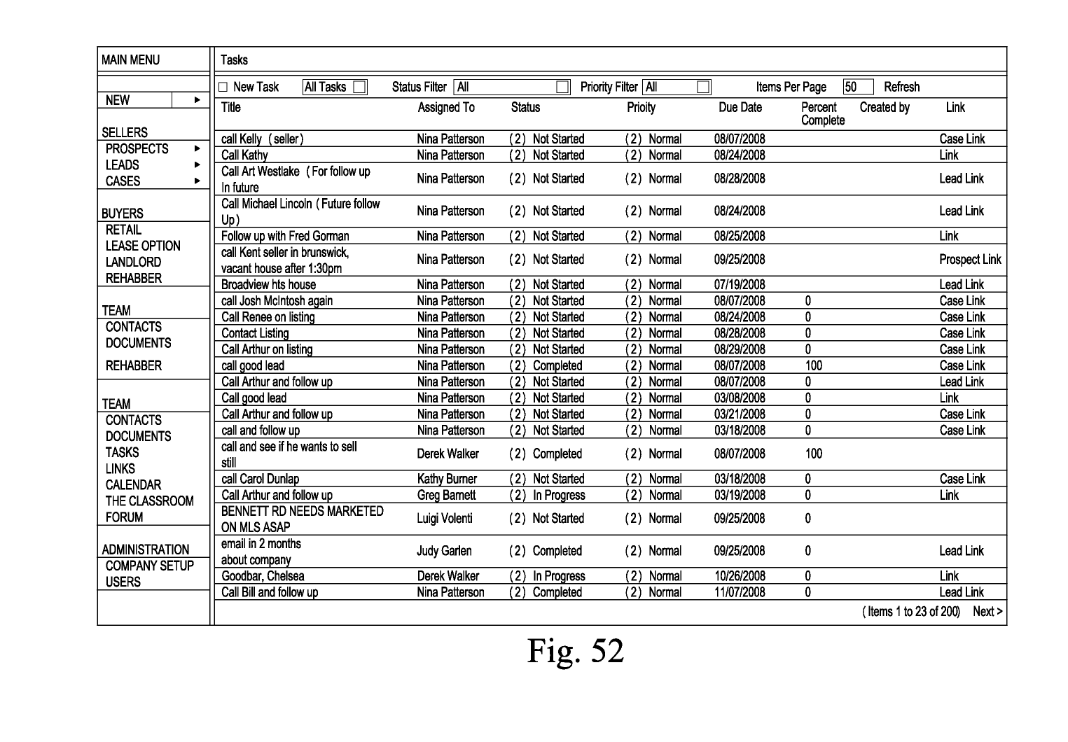

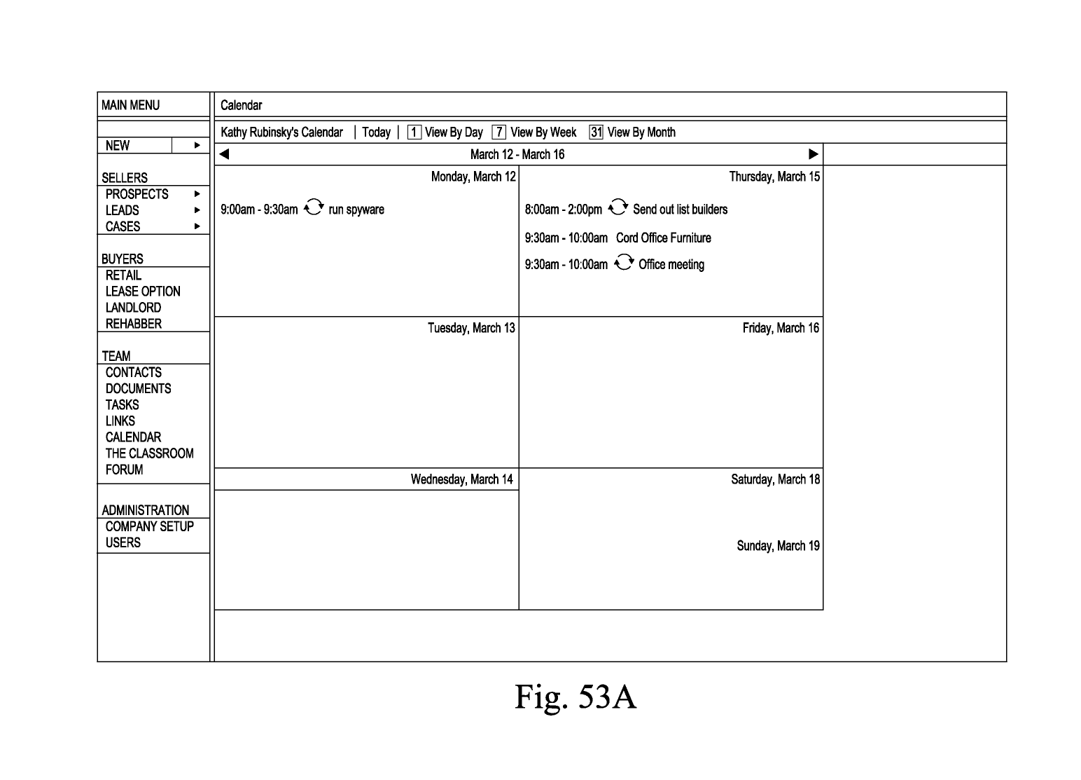

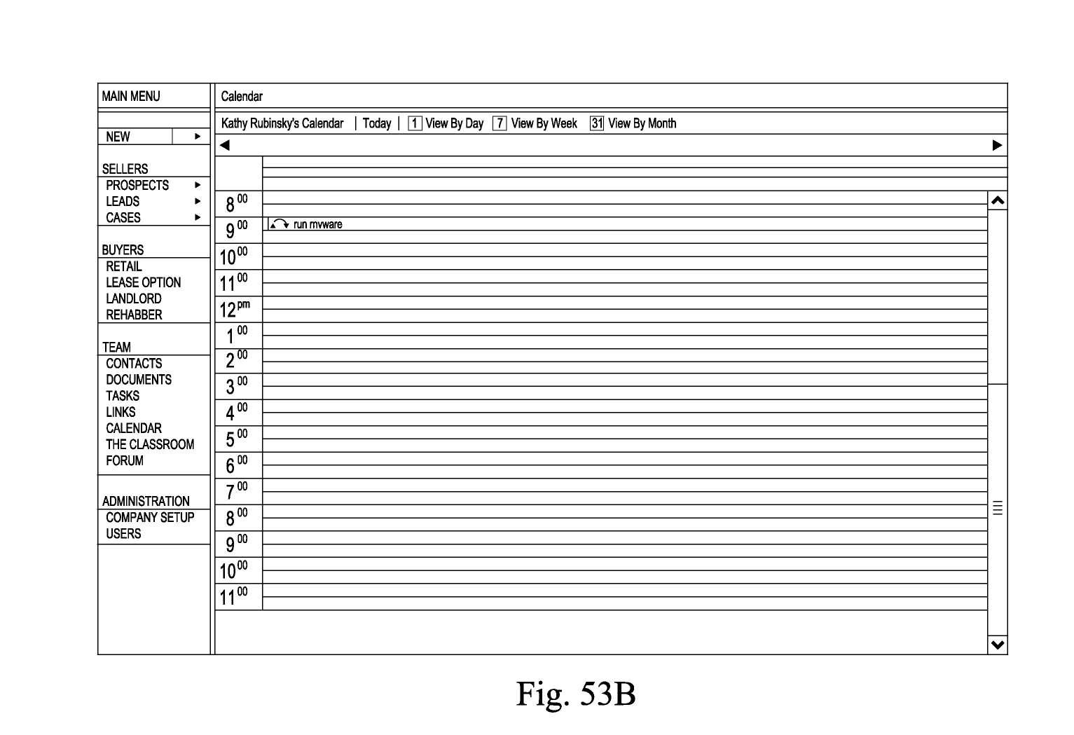

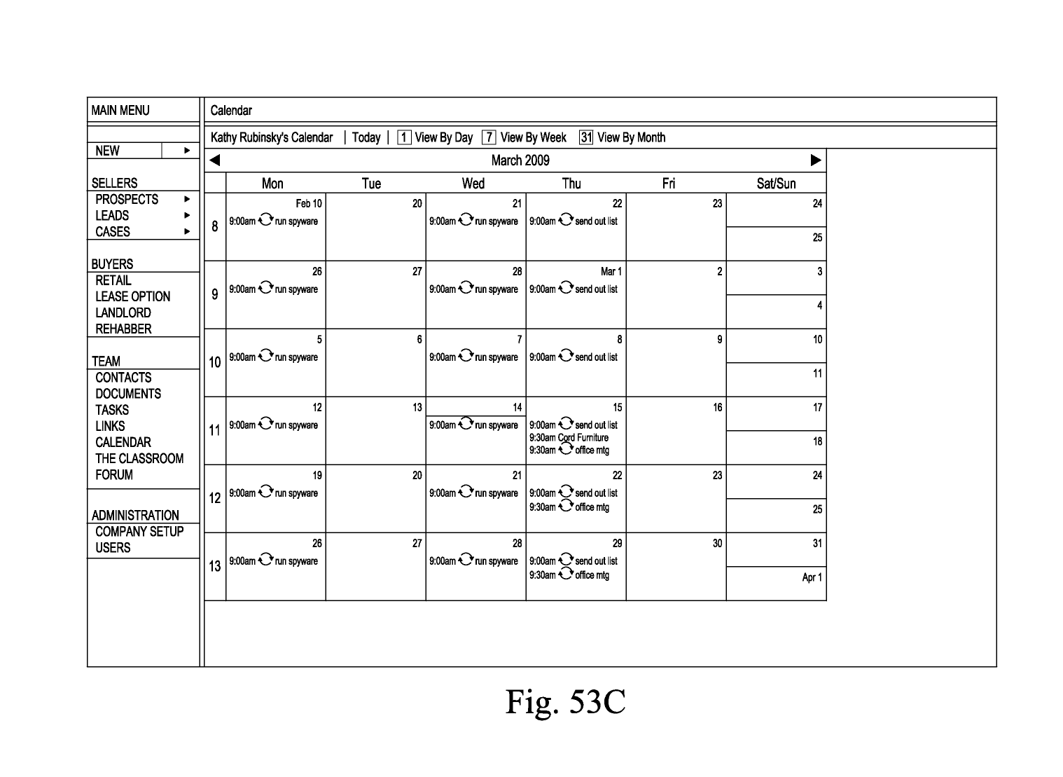

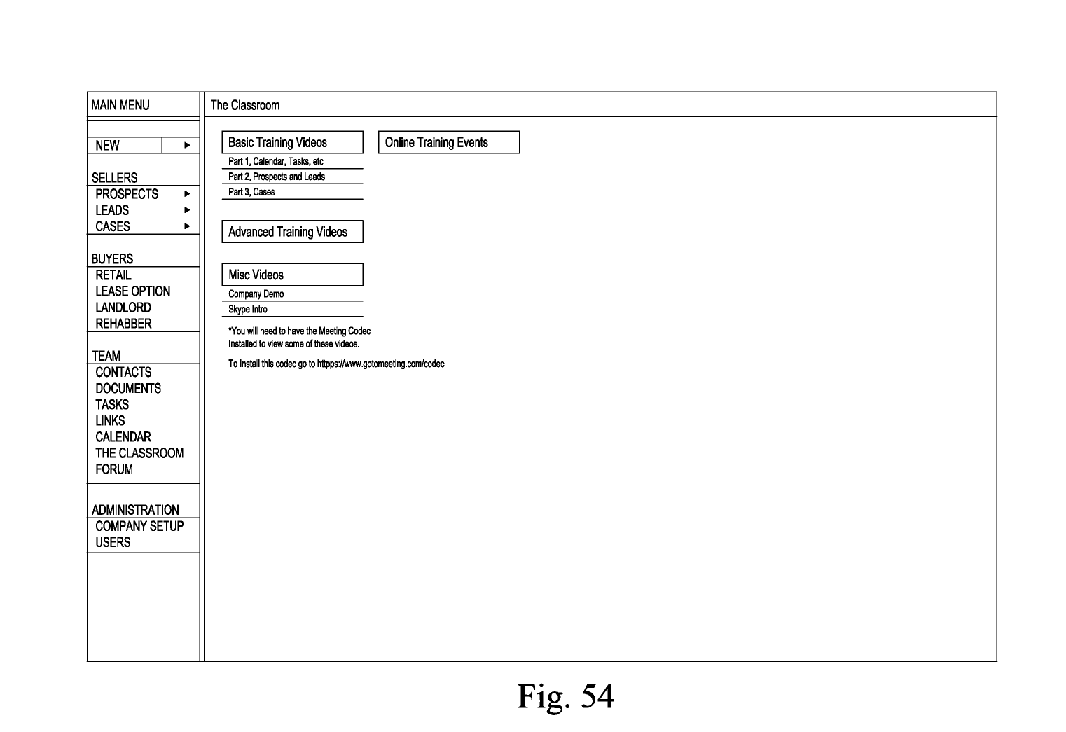

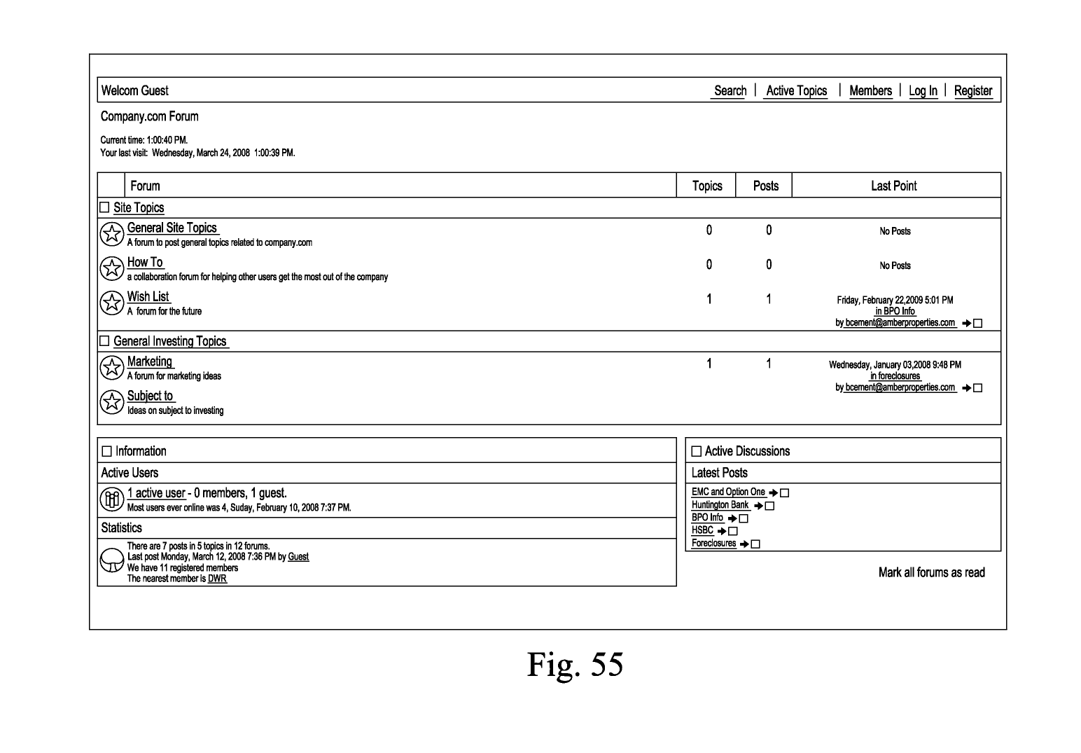

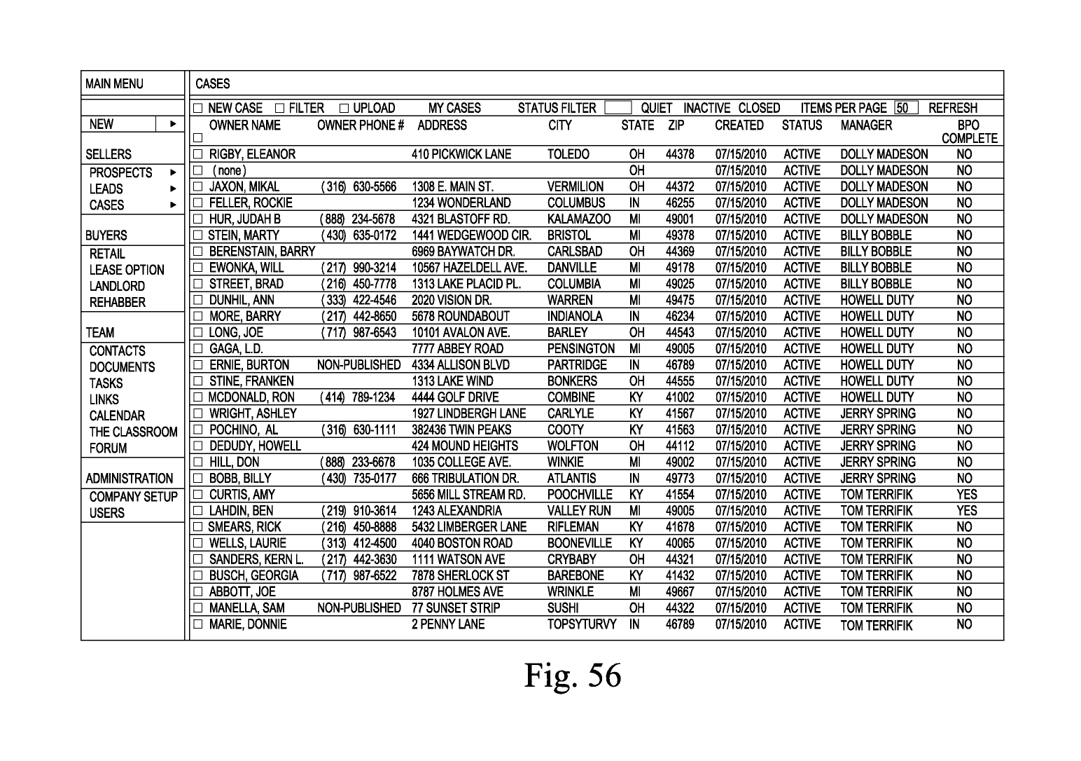

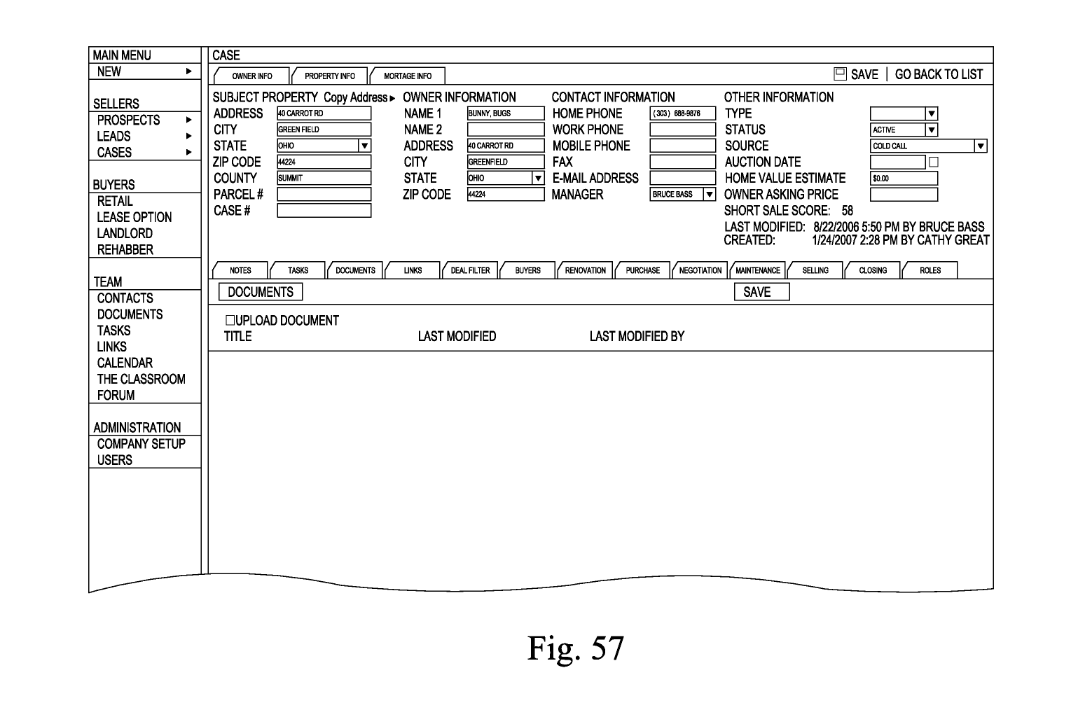

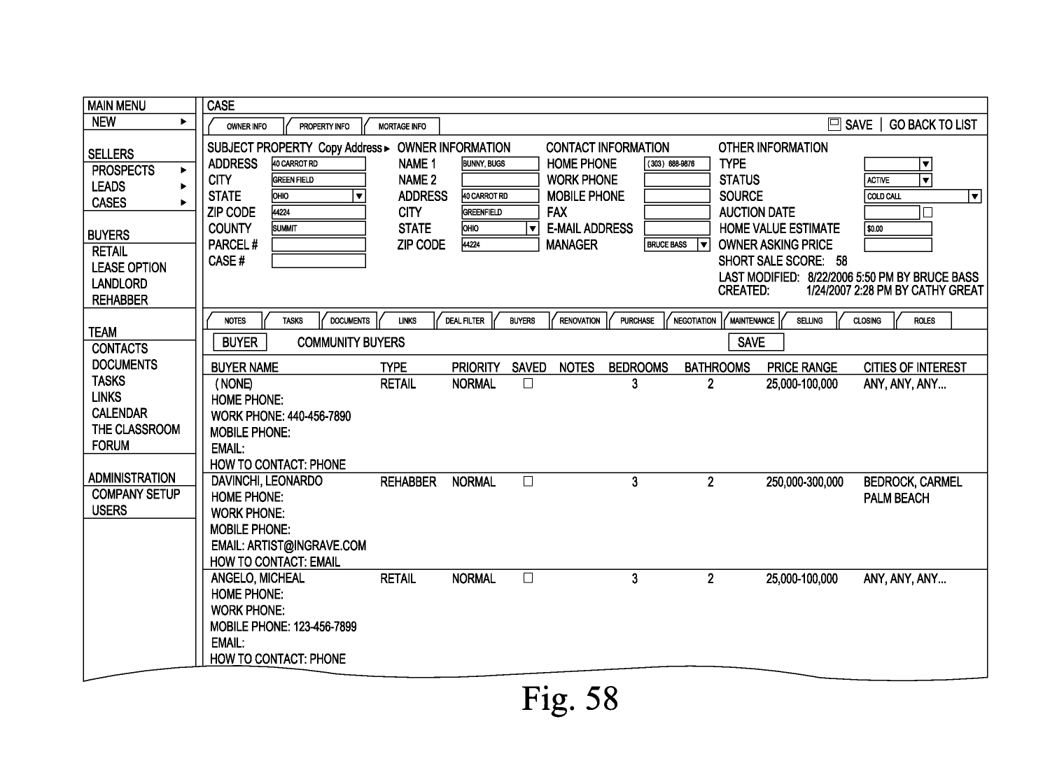

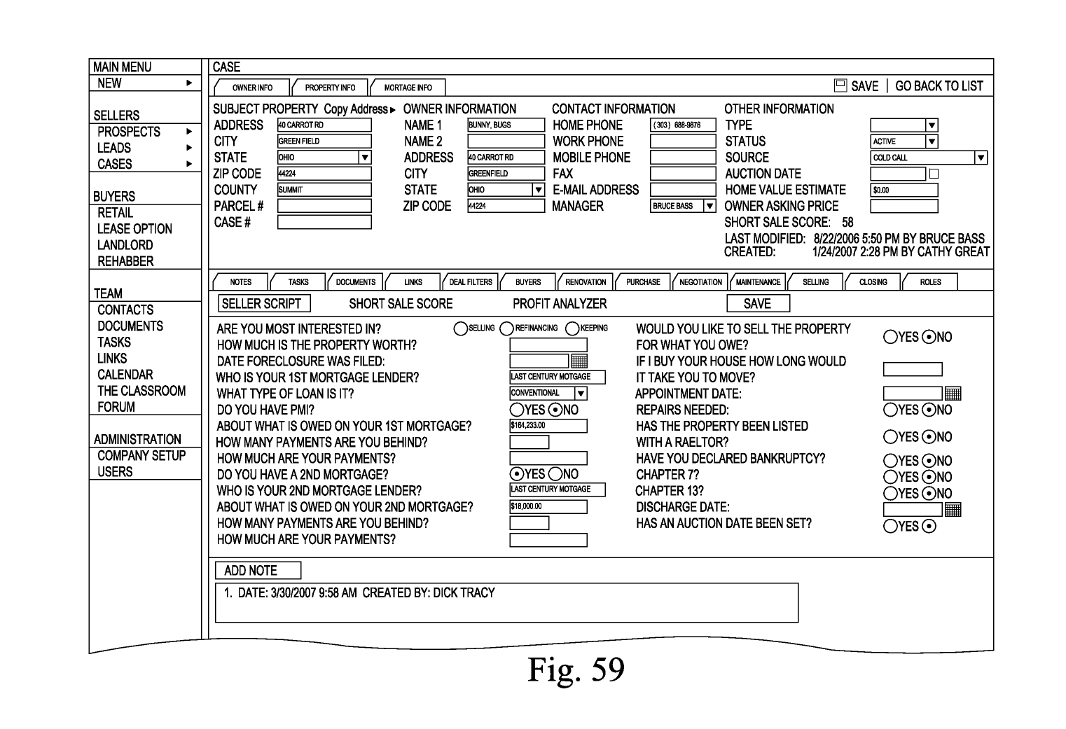

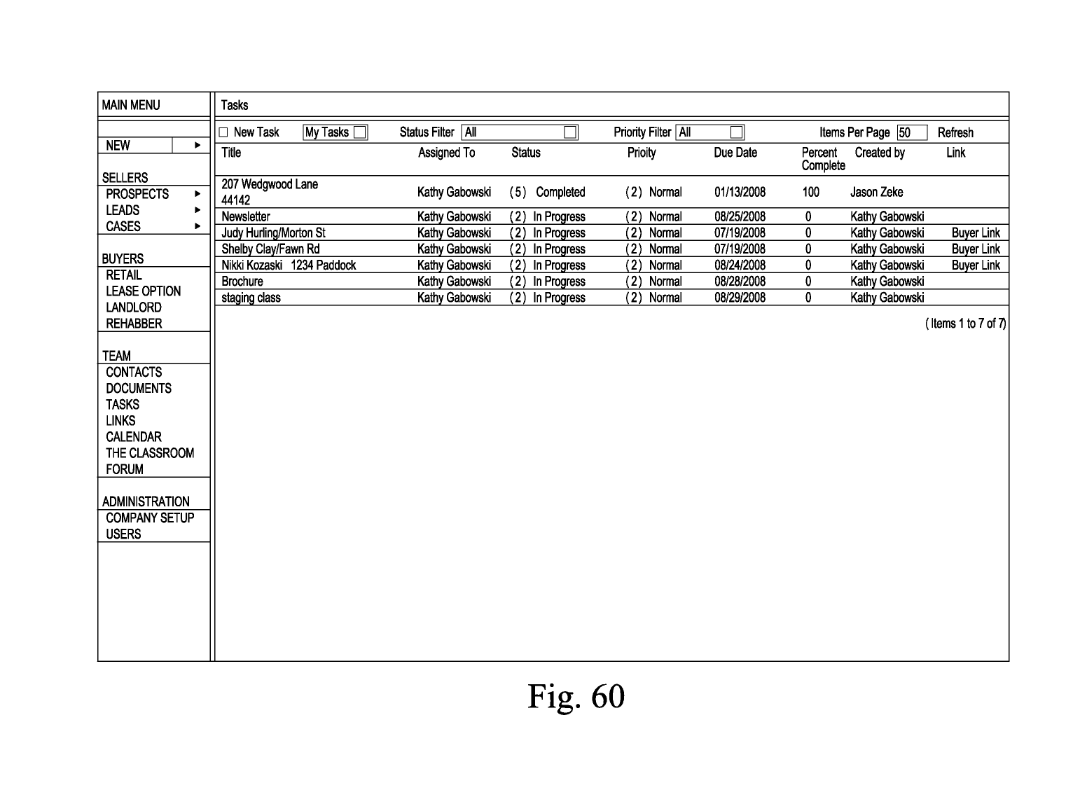

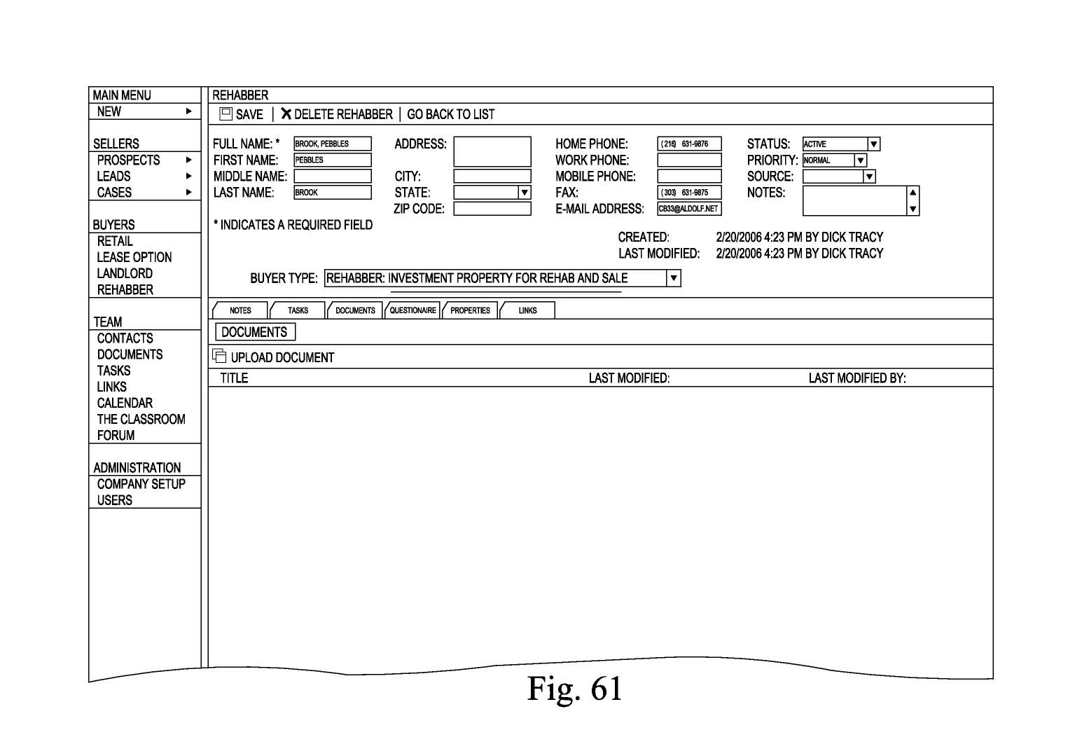

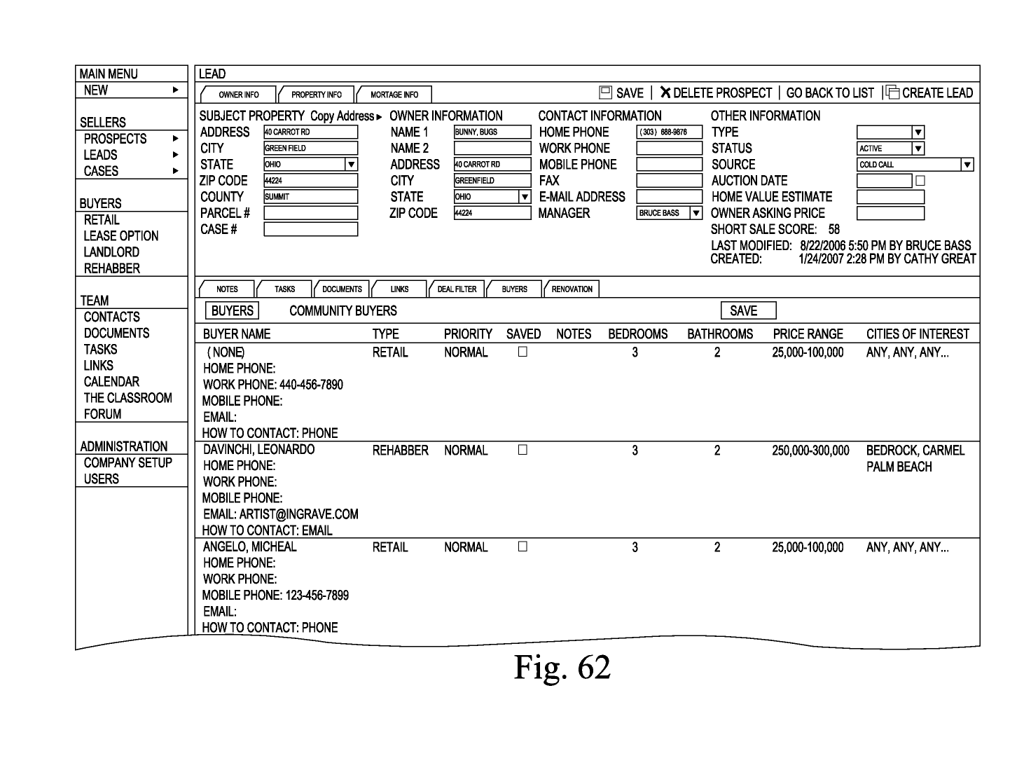

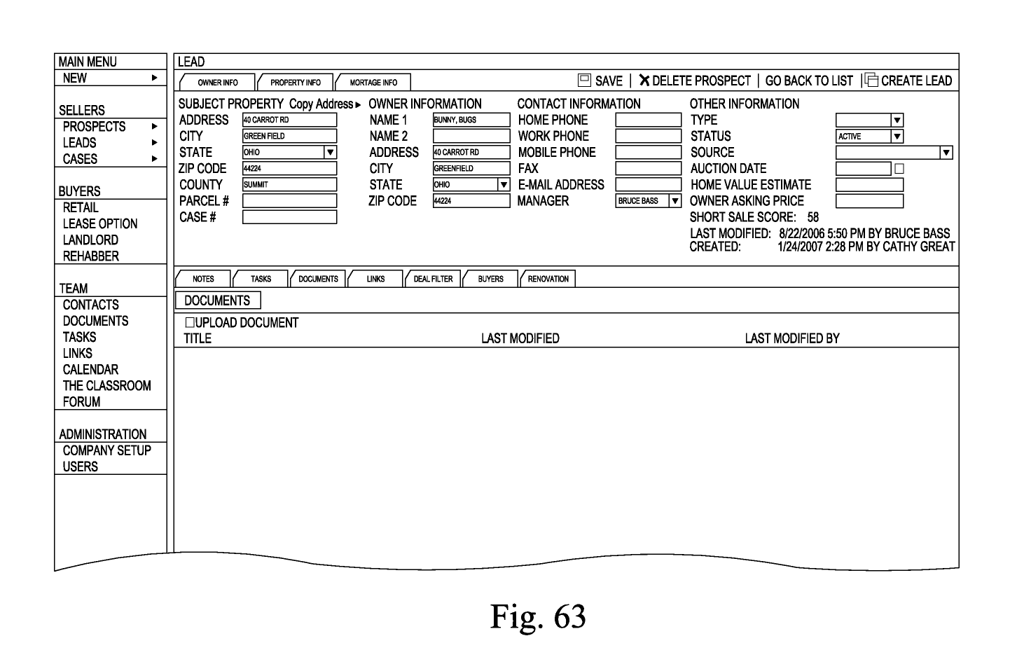

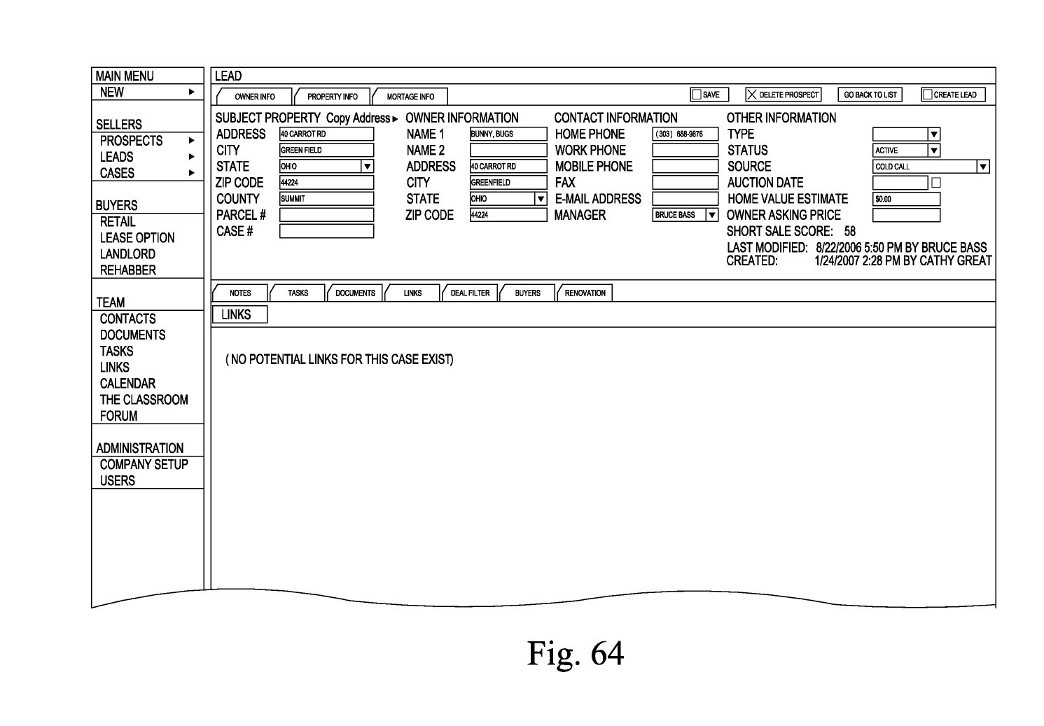

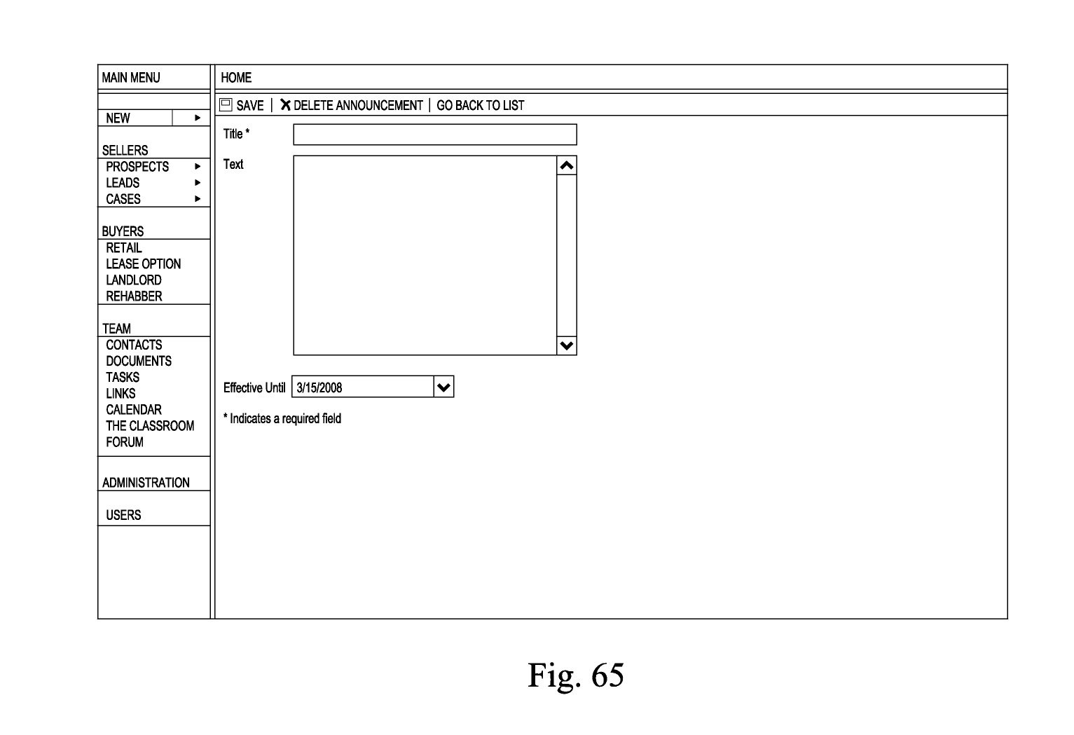

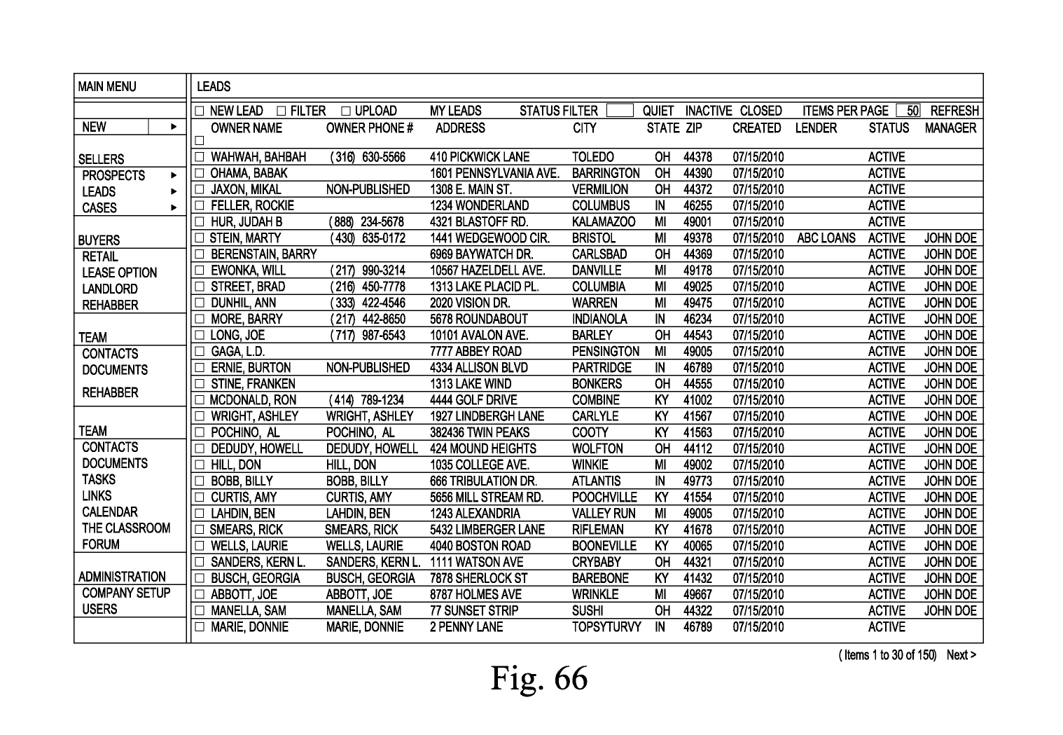

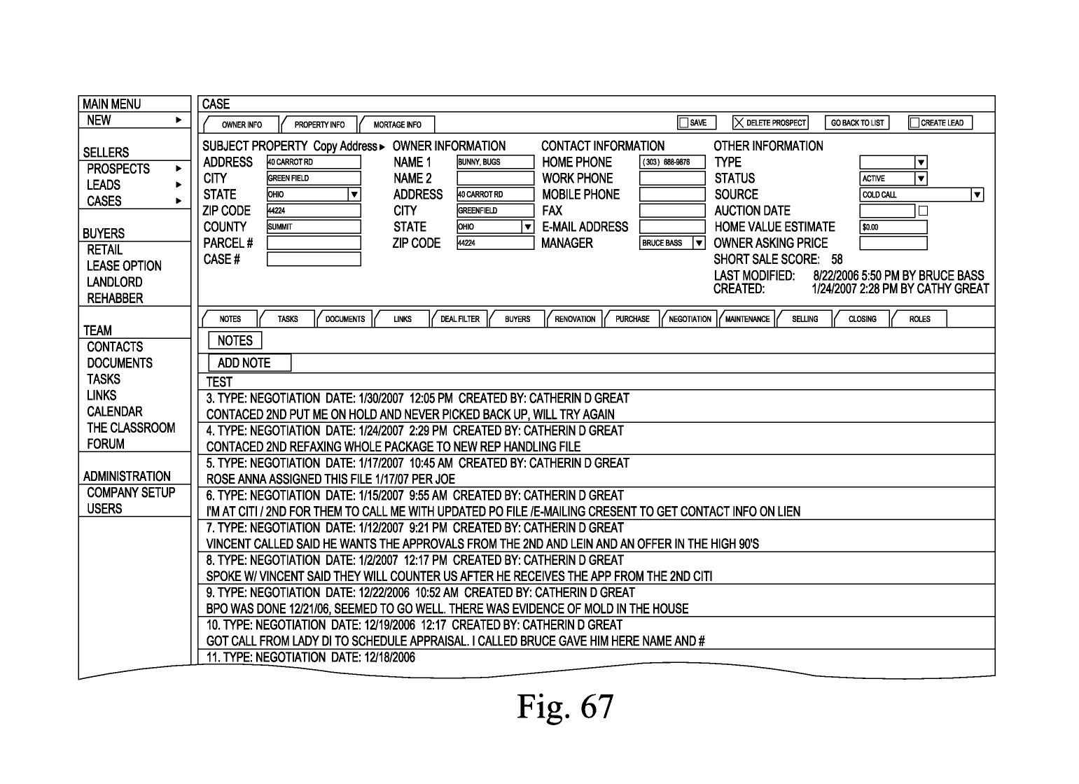

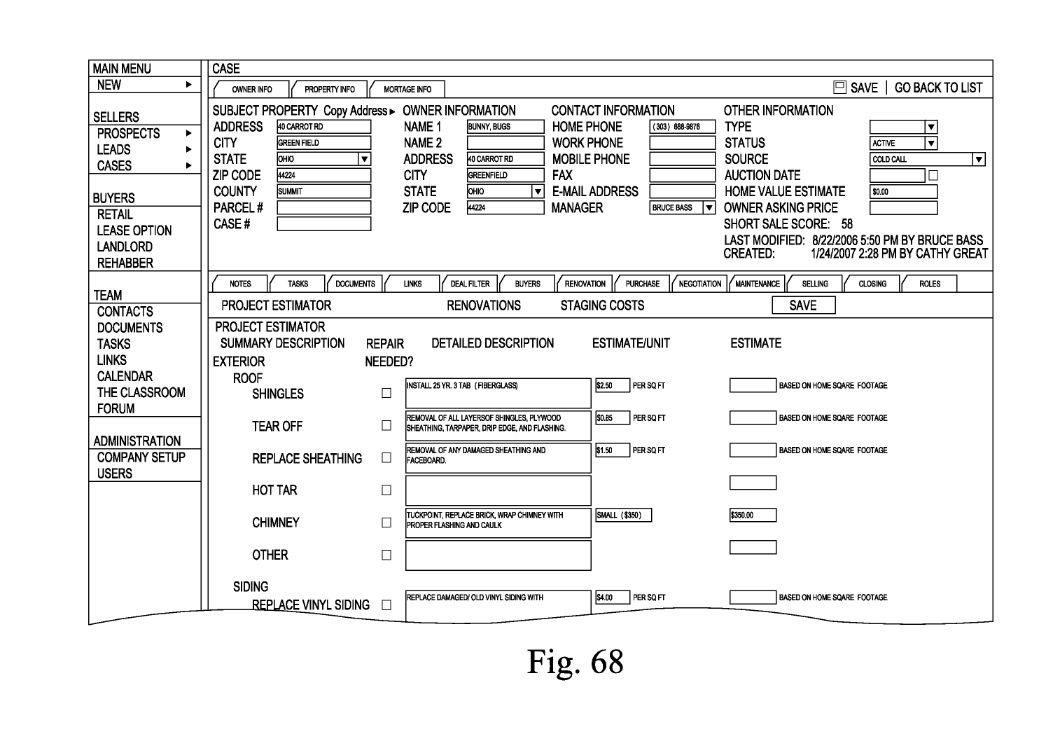

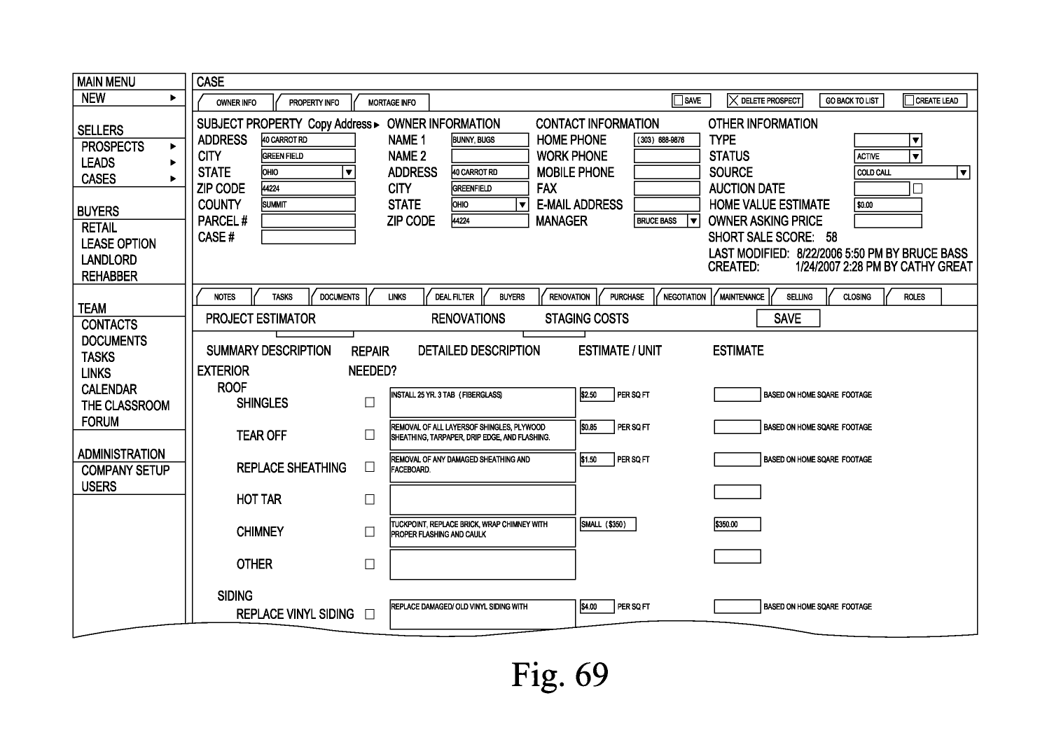

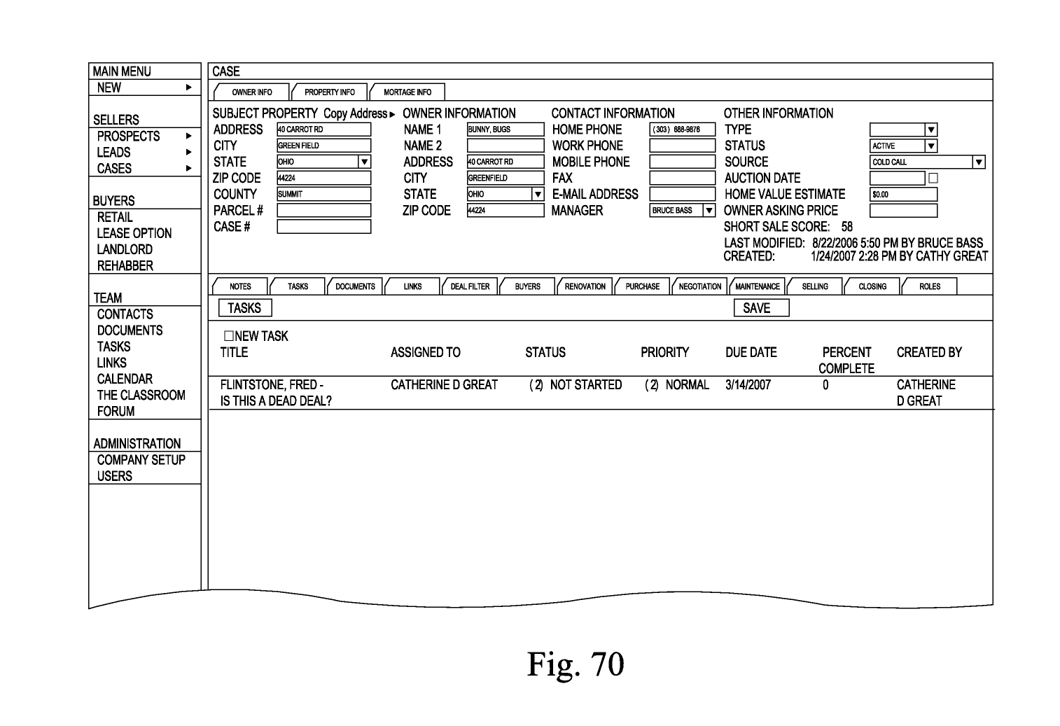

FIGS. 3A through 3B, with further reference to FIG. 1A illustrate how REM interface engine 111a provides a hierarchical workflow based REM interface that may include singular or multiple split timelines or “workflows” and persist-able transaction aspect advancement or target data. By doing so, engine 111a thereby enables one or more users or other participants to be more optimally guided through a more efficient conducting of real estate business management and share-able independent knowledge base accumulation (i.e., and utilization). FIGS. 4 through 70 further illustrate the exemplary REM interface in greater detail, as well as examples of system 100a operational components (“features” or “REM tools”) that may be accessible to users by interacting with the REM interface. FIGS. 4 through 70 also provide a “walk through” of various visual and primarily textual presentations, user interactions and system 100a responses thereto of the interface and operational features. (It will be appreciated, however, that a resulting REM interface is not limited to any particular manner of interaction or media. Rather, various REM interface embodiments may employ mouse, keyboard, speech, biometrics, signal, actuator, controller or substantially any other interaction mechanism, and may provide for the use of text, graphics, audio, speech, video, animation or substantially any other type of multimedia presentation or interaction, in accordance with the requirements of a particular implementation.)

FIGS. 3A through 3B, for example, illustrate an REM interface embodiment 300a-300b that may be generated by REM interface engine 111a. For consistency sake, REM interface 300a is again implemented as a group of Web pages that may be presented by Mozilla Firefox, Microsoft Internet Explorer or substantially any other conventional or other Web browser, e.g., Web client 201a, Web client enabled application portion or additions, extensions or enhancements thereto (hereinafter collectively referred to as simply a “browser”). Applicable real estate data and the now well known Web browser menus/toolbar options 301b and status bar 301c have, however, been removed so as not to obscure aspects of the invention. FIG. 3a more specifically illustrates an example of a hierarchical split-timeline REM interface configuration 300a, while FIG. 3b illustrates a further secondary hierarchical split timeline interface configuration 300b that may also be included in an REM interface generated by REM interface engine 111a of FIG. 1A. (For purposes of the REM interface discussion, the term “interface” will refer collectively to a more complete interface that may include multiple presentations, e.g., screens or Web pages, as well as one or more individual “pages” or “screens” of the REM interface.)

As shown in FIG. 3A, interface 300a comprises, in addition to the above-noted browser features 301a-b, visually presented interface components including main menu 302 and workspace 303-306. Main menu 302 provides a vertically stacked menu structure of menu options and sub-menu options (indicated by right facing arrows). Unlike conventional menus that are typically organized as encapsulated generic groupings tool functions, however, main menu 302 is organized according to managing real estate business, corresponding workflow and a third party participant type, here, sellers 331 and buyers 332. A further “team” menu 333 also provides, in a workflow based manner, for conducting tasks relating to managing a user team, and an “administration” menu 334 provides for conducting such administrative tasks as setting up an account for an organization or agents thereof on REM system 101, and entering users. All information entered via invocation of main menu 302 or further interaction with REM interface 300a, according to one embodiment, is stored by KB controller 111b in a REM KB, e.g. 112 or 200 of FIGS. 1A-1B and 2 respectively. (Administration information is, for example, stored as administration/tracking data, and so on, as was already discussed. Note that a “task” may generally include an assigned or otherwise assumed activity of initiating, conducting, completing or otherwise managing a deal, transaction or transaction aspect, which task may also include accumulating knowledge base data or parameters.)

Seller menu 331 provides for conducting real estate management and knowledge accumulation corresponding to third party participant status and may, for example, include prospects, leads and parties to a deal or “case”. While the aforementioned status advancing order may, for example, include leads, then prospects and then cases, sellers menu 331 ordering instead corresponds with system 100a providing for independent and concurrent efforts, in addition to managing development of leads and ongoing deals, to accumulate an inventory or pool of re-usable prospects with which new or further deals may be generated.

Buyers menu 332 provides for conducting real estate management and knowledge base accumulation corresponding to third party participants whose subtype may, for example, include a preference for retail property, lease options, rental property (“landlord”) or property purchased for rehabilitation and resale or “rehabber”. (Such data may also be stored in a corresponding knowledge base, e.g., REM KB 112 of FIGS. 1A-1B or REM KB 200 of FIG. 2, as a property data property preference that may be associated with a corresponding participant.) Buyers may also, in various embodiments, be classified according to their status as a lead, prospect or party to a deal.

Team menu 333 is arranged according to tasks that an individual user or user conducting real estate business management/knowledge accumulation as part of a team may focus on at any given point. As shown, such tasks may, for example, respectively include reviewing, working with or otherwise managing contacts, documents, particular transactions or transaction aspects that may also be specially indicated as tasks, World-Wide-Web hyperlinks or correspondences of system 101 data, studying (“the classroom”) and conducting system 100a user discussion (“forum”).

The REM interface 300a workspace 303-306, ignoring search field 306 for now, is divided into multiple (here, two) independently operable but advancement-coordinate-able regions: deal-and-transaction timeline region (“deal region”) 303a and transaction-and-transaction-aspect (“task”) timeline region 304a. Each of regions 303a and 304a is further divided into a variable number of workflow regions that are designated by region selection handles depicted as “tabs” 303b, 304b, and at least one work area 303c, 304d. Search field 306, provides for user-initiated simple or complex searches of all or portions of workspace 303-306, REM KB 112 (FIG. 1A), or further, extra-workspace sources including, for example, the community of users or non-user participants, data acquisition nodes 105, external data sources 107, data presentation nodes 107 (FIG. 1A), network resources including but not limited to the Internet, and so on, or some combination. Searches may be more generic or may be more limited, for example, according to any one or more of: user, participant, document, deal, transaction, type, status, interface portion, conditions, other KB parameters, contextual delimeters, and so on. See, for example, the above REM KB discussion.

Interface 300a provides for presenting regions 303a and 304a as hierarchically based multiple independent workflows or timelines, or further, for persisting within the interface 300a presentation essential information relating to currently conducted management of a current deal, transaction or transaction aspect or knowledge base accumulation. In one embodiment, for example, REM interface engine 111c generates timeline regions 303a, 304a and workflow regions 303b, 304b and tool or feature components to be presented within such regions as corresponding with current transaction parameters including a currently selected non-user participant type, and further, the current third party participant status or sub-type. REM interface engine 111c in the present embodiment conducts such generation regardless of whether a particular third party participant is currently selected or even yet known, so long as such parameters may be ascertained, e.g., through user selection or system 101 reference to REM KB or other determination.

FIG. 8, for example, illustrates how REM interface engine 111c responds to user selection of a “seller lead” by generating task timeline region 801a and deal timeline region 801b, and inserting, within each timeline region, workflow regions 802a and 802b respectively. REM interface engine further populates workflow regions 802a and 802b with interface components 803a and applicable data, if any, corresponding to the seller type and lead status, or further, to one or more particular sellers or properties. (In this example, the task timeline workflow regions include owner information, property information and mortgage information, while the deal timeline workflow regions include notes, tasks, documents and links. Interface components for workflow region 802a include portions of a data entry form for accumulating basic seller lead related information or “owner information” including identification of the property, owner information, contact information and miscellaneous other information; REM interface engine 111c also populates deal timeline region. The selected document workspace region of deal timeline workspace regions 802b is populated as blank, since there is no document management associated with the user selection, at least at this point in managing the illustrated seller as a lead.

Returning to FIG. 3A with further reference to FIG. 8, REM interface engine 111c also generates workflow regions according to a timeline or workflow associated with the current participant type and status. In this example, the workflow is applicable to both of the inserted workspace regions and the ordering of the workspace regions. REM interface engine 111c, for example, inserts additional ones of deal timeline workspace regions 304b as corresponding to the workflow associated with the type and current participant status, or more specifically, the advancing of the current participant's status. (Stated alternatively, engine 111c renders certain workspace regions unavailable unless a current participant has advanced or is otherwise associated with a corresponding participant status.)

Specifically, REM interface engine 111c always presents notes region 341 and, in accordance with the general applicability and importance of note taking, always placed such region first (i.e., leftmost of tabs 304b). REM interface engine 111c adds, to the right of tab 304c, seller leads workflow regions 342 as corresponding to the participant type and status of “seller” and “lead”, workflow regions 343 as corresponding to “seller” and “prospect” and workflow regions 344-346 as corresponding to “seller” and “party to a deal” respectively.

REM interface engine 111c further adds workflow regions within such workflow region groups according to a workflow ordering with which a user will likely at least initially utilize each successive workflow region, e.g., an order in which seller information is typically more optimally obtained. While in the present embodiment the workspace region, interface components and ordering thereof are predetermined (e.g., and stored in REM KB 112), it will be appreciated that other embodiments may also provide for imposing one or more component or data content/ordering variations according to user preferences, system 101 monitoring of actual use and determination therefrom of general, initial contact, type, use, location, meeting, call or other context, per session or other user workflow or workflow or other tendency, and so on or some combination. (See, for example, FIGS. 6-9, 18-26 and 28-40, which also illustrate examples of interface components corresponding to each of the respective groups of workspace regions.)

Continuing with FIG. 3B, REM interface engine 111c also conducts such workflow based interface generation with regard to sub-workspace regions, which engine 111c also automatically generates and inserts according to the split timeline configuration. In this embodiment, for example, REM interface engine 111c responds to a current third party participant type and status of “seller” and “lead” by generating and inserting, into task timeline region 303a, sub-workspace regions 303d including subject property 371, and owner information, contact information and other information 372. Engine 111c further generates and inserts, into deal timeline region 304a, sub-workspace regions 304e including mortgages 381, and liens, comparables or “comps, short sale and paperwork 382. Engine 111c may also inserts corresponding interface control components, including but not limited to inserting save button 383 as interface component 304f.

REM interface engine 111c further conducts such workflow based interface generation such that any two or more timeline regions and workflow regions may operate in an yet coordinated manner that may further persist selected data. That is, an interface portion presented in timeline region 303a or modification or replacement of region 303a may occur without impacting the interface portion presented by timeline region 304a and visa versa. However, engine 111c also generates coordinated sets of workspace regions and sub-regions such that user workflow may be co-supported by the interface presented by such regions and sub-regions. FIG. 20, for example, illustrates one embodiment in which the interface portion 2001e presented by timeline region 2001a may vary according to user or system 101 selection of workspace regions 2001b without obscuring or otherwise impacting the interface portion 2002f presented by timeline region 2002a via selection of workspace regions 2002b and visa versa. Moreover, at least a portion (and typically all) of workspace regions 2001b, 2002b and sub-regions 2001c, 2002d are generated by engine 111c in a coordinated manner, such that the information presented is co-supportive, and in a manner that may persist selected data.

Thus, for example, responsive to a user initiating an assumed a task of contacting a seller prospect (as evidenced by the addition of seller prospect tabs 2002c) regarding information not yet collected from the seller, REM interface engine 111c may present the user with the illustrated interface and with contact form 2001e automatically selected. The user may review deal or transaction data corresponding to which the seller corresponds in workspace regions 2002b or sub-regions 2002d before, during or following the call without affecting form 2001e, which regions and sub-regions are coordinated with regions 2001b and subregions 2001c, and which regions and sub-regions are easily reviewable due to their timeline or workflow ordering. The seller's identification and other information also remains presented. Returning to FIG. 1A, REM interface engine 111c also persists selectable data, which engine 111c has automatically selected (e.g., as a default) as including identification of the seller called by the user as the owner-occupier of the property and having the name Barbara Moore. Therefore, the user may also be presented with a persisted reminder as to such identification, even though the user may also browse workspace regions 2001b or workspace sub-regions 2001c other than form 2001d.

(It will be appreciated persistable data is not limited to participant identification or persisting of selected data in only a timeline “region bar”. Rather, the particular data may be determined by a user or automatically by system 101 as corresponding, for example, to a default data type, a data type that corresponds with a currently selected workspace region or group of workspace regions, context, deal, transaction or transaction aspect, and so on, in accordance with the requirements of a particular implementation. Visual perisitable data may also be inserted in other portions of a presented interface or other mechanisms may also be used, e.g., pop-up, mouse-over or other actuation, speech, and so on.)

Returning again to FIG. 1A, deal engine 111d and transaction/task engine 111e provide for responding to communication controller 111a by controlling REM system 101 operation corresponding to potential and actual deals (or “cases”) and to transactions, transaction aspects and tasks respectively. More specifically, deal engine 111d provides for responding to REB interface engine 111c requests (via controller 111a) for deal status information or data by invoking KB controller 111b to retrieve such data from REM KB 112 and transferred data to REB interface controller 111b. Deal engine 111d also provides for initiating KB controller 111b for storing such data as may result from user interaction, e.g., utilizing a deal workspace region (FIG. 3a-b), and for initiating system 101 components corresponding to a deal or team operation (e.g., components 111f and 111k-n) and returning resulting data to KB controller 111b for storage or REB interface engine 111b for use in generating an REB interface portion. Deal engine 111d further provides for invoking and receiving responses from transaction engine 111e corresponding to transactions, transaction aspects and designated tasks that may be utilized in providing responses to invocation respecting deals.

Transaction/task engine (“transaction engine”) 111e operates in substantially the same manner as deal engine 111d, but with regard to transactions, transaction aspects and designated tasks, and responsive to deal engine 111d operation. More specifically, transaction engine 111d provides for responding to REB interface engine 111c requests (via controller 111a and deal engine 111d) for transaction, transaction aspect and task status information or data by invoking KB controller 111b to retrieve such data from REM KB 112 and transfers such data to deal engine 111d. Transaction engine 111e also provides for initiating KB controller 111b for storing such data as may result from user interaction, e.g., utilizing a deal/transaction or transaction/task workspace region (FIG. 3a-b), and for initiating system 101 components corresponding to a deal or team operation (e.g., components 111g j) and returning resulting data to KB controller 111b for storage or REB interface engine 111b (via deal engine 111d) for use in generating an REB interface portion. In accordance with such an arrangement of deal engine 111d and transaction engine 111e, deal engine may determine control, status or data corresponding to a deal. Deal engine may also delegate those aspects that may correspond with an underlying transaction, transaction aspect or designated task to transaction engine 111e and delegate those aspects that correspond with a component processing to a corresponding (deal level) component. Deal engine may also incorporate transaction, transaction or task results received from transaction engine 111e or such other system 101 components in forming a response to the deal engine invocation.

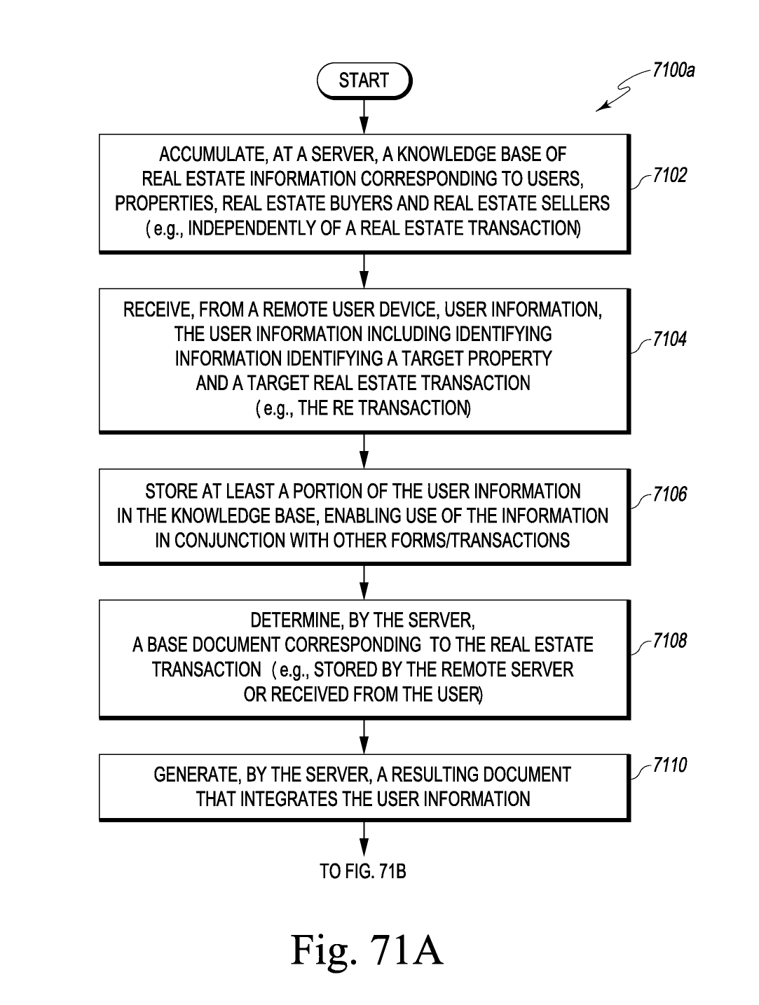

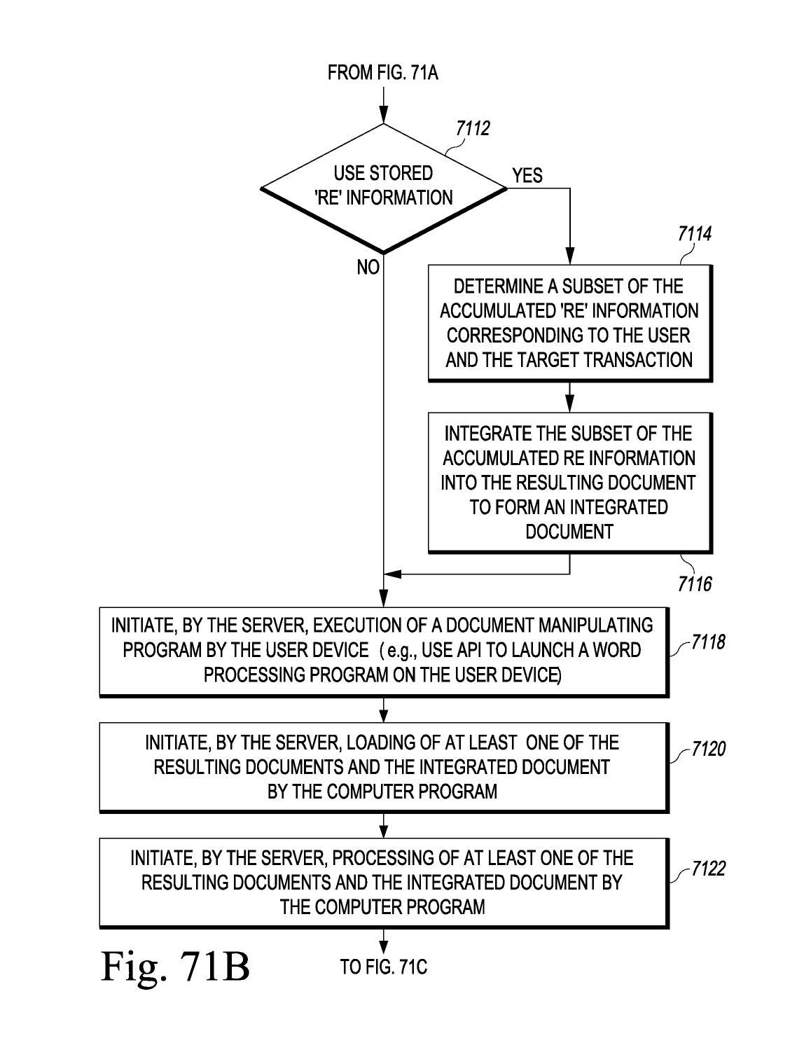

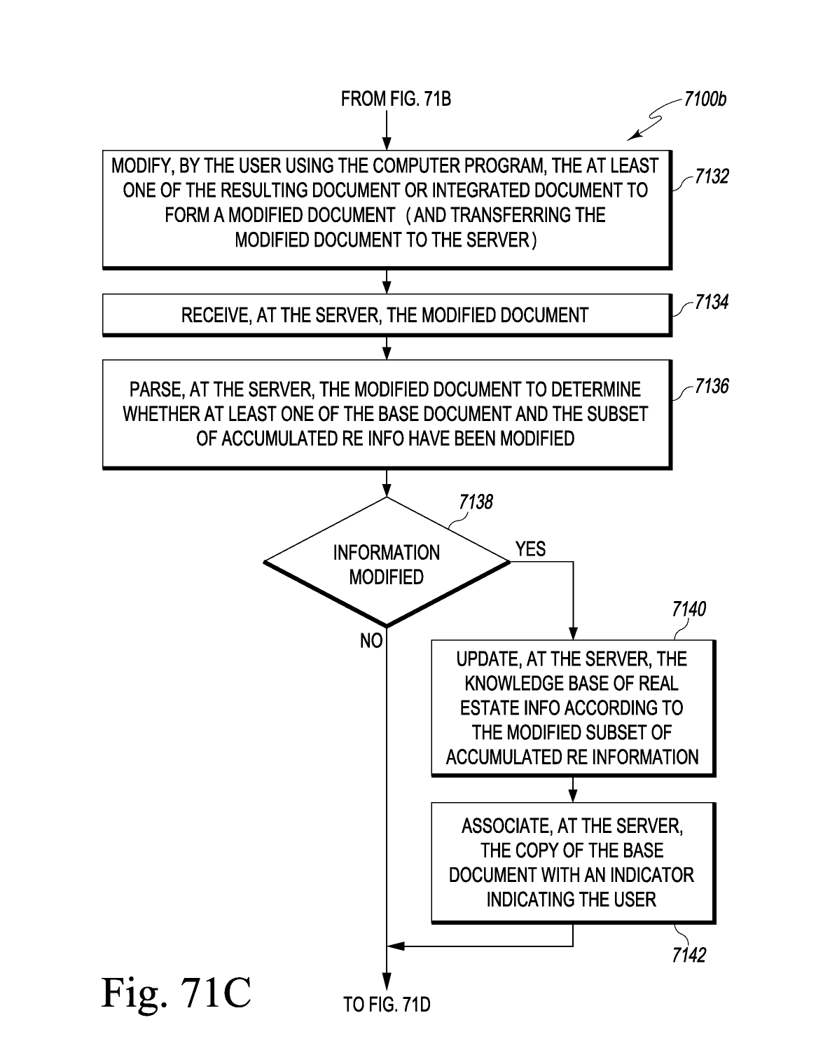

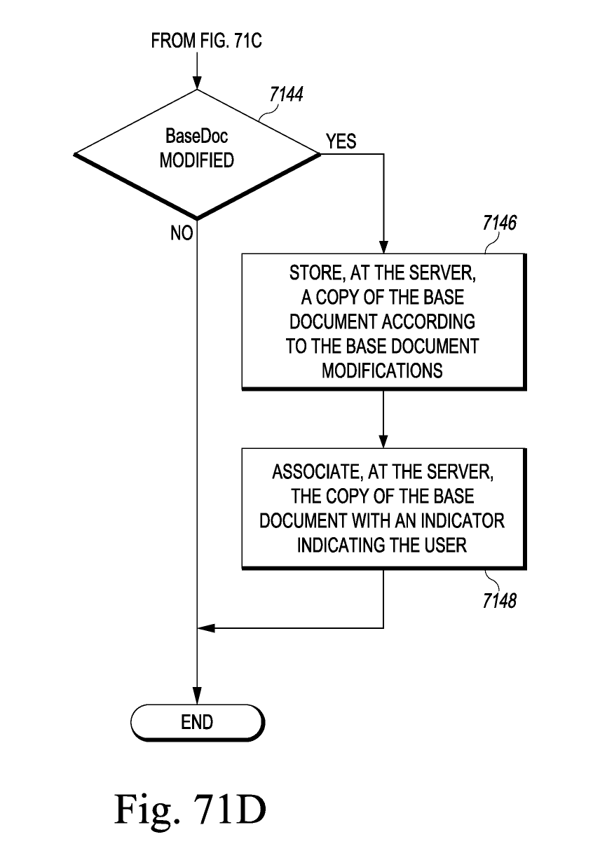

FIG. 71A-D, FIG. 72A-C, and FIG. 73A-D are flow diagrams illustrating embodiments that may comprise one or more of the components of the estate business, collaboration and knowledge acquisition sharing system according to any of the embodiments of the invention.

FIGS. 71A-D will now be described. FIG. 71A begins at start point 7100a. Accumulate, at a server, a knowledge base of real estate information corresponding to users, properties, real estate buyers and real estate sellers (e.g. independently of a real estate transaction (stage 7102). Receive, from a remote user device, user information, the user information including identifying information identifying a target property and a target real estate transaction (e.g. the ‘RE’ transaction) (stage 7104). Store at least a portion of the user information in the knowledge base, enabling use of the info in conjunction with other forms/transactions (stage 7106). Determine, by the server, a base document corresponding to the real estate transaction (e.g. stored by the remote server or received from the user) (stage 7108). Generate, by the server, a resulting document that integrates the user information (stage 7110).

Continuing with FIG. 71B, if the stored ‘RE’ information is used (decision point 7112), then determine a subset of the accumulated ‘RE’ information corresponding to the user and the target transaction (stage 7114), and integrate the subset of the accumulated ‘RE’ information into the resulting document to form an integrated document (stage 7116). Whether using stored ‘RE’ information or not, then initiating, by the server, execution of a document manipulating program by the user device (e.g. use API to launch a word processing program on the user device) (stage 7118). Initiate, by the server, loading of at least one of the resulting documents and the integrated document by the computer program (stage 7120). Initiate, by the server, processing of at least one of the resulting documents and the integrated document by the computer program (stage 7122).

Continuing with FIG. 71C, at point 7100b, modify, by the user using the computer program, the at least one resulting document or integrated document to form a modified document (and transferring the modified document to the server) (stage 7132). Receive, at the server, the modified document (stage 7134). Parse, at the server, the modified document to determine whether at least one of the base document and the subset of the accumulated ‘RE’ info have been modified (stage 7136). If the information has been modified (decision point 7138), update, at the server, the knowledge base of real estate information according to the modified subset of accumulated ‘RE’ information (stage 7140). Associate, at the server, the copy of the base document with an indicator indicating the user (stage 7142).

Continuing with FIG. 71D, if the base document has been modified (decision point 7144), then store, at the server, a copy of the base document according to the base document modifications (stage 7146), and associate, at the server, the copy of the base document with an indicator indicating the user (stage 7148).

FIGS. 72A-C will now be described. FIG. 72A begins at start point 7200a with determining average costs for conducting specific updates to a generalized sampling of properties (stage 7202). Determining average cost deviations of the average costs for the conducting of specific updates according to an accumulated knowledge base of property information of properties (e.g. location of property) (stage 7204). Receiving, from a user, update indicators that applicable ones of types and repetitions of updates may be conducted on areas of target property (e.g. to features located in or relating to specific areas of a home or home layout to place the home in an at, below or above market value or other specified condition) (stage 7206). Receiving, from a user, one or more cost difference indicators indicating cost differences between the average costs or average cost deviations and update costs applicable to the user, if any (stage 7208).

Continuing with FIG. 72B, if there are not differences (decision point 7210), then the following stages are performed. Determining a cost estimate for conducting updates corresponding to the user according to a user selection of at least one of the average costs, average cost deviations and cost difference indicators (stage 7212). Generating a project estimation report corresponding to the cost estimate and transferring the cost estimate report to a user device (e.g. to a remote user device) (stage 7214). Storing cost estimate indicators indicating the cost estimate and an association of the cost estimate with the user (stage 7216). Determining one or more ‘RE’ transactions associated with the user (stage 7218). Associate the cost estimate indicators with the ‘RE’ transactions (stage 7220). Applying the cost estimate to a viability, cost or profit analysis, (or further, negotiation or other subsequent transaction) of the user if the user conducts such analysis (e.g. deal filter, profit analyzer) (stage 7222).

If there are differences (decision point 7210), then the stages in FIG. 72C are performed, as identified at point 7200b. Determine at least one reliability indicator indicating a reliability of the cost difference indicators (e.g. according to a rating of user reliability, user cost reliability history, applicable user experience, contractor or other product/service provider data, market variation/fluctuations, a consensus, significant number or other predetermined acceptability measure of other users, search data, etc. (stage 7232). If the analysis indicates sufficient reliability (decision point 7234), then compare the cost difference indicators with classification indicators to determine if the cost difference indicators correspond with average cost estimate or average cost deviation error, location variation or price fluctuation (e.g. by comparing with information utilized in forming reliability indicator (stage 7236). Update at least one of the average cost estimate, average cost deviation or a price fluctuation estimate according to the determining of block 7136 (stage 7238). Determine whether other users may have been or may be impacted by the update, and notifying one or more of the other users as to the update or providing opportunity for updating of resultant data produced using a corresponding one or more of the average cost estimate or deviation (stage 7240).

FIGS. 73A-73C will now be discussed. FIG. 73A begins at start point 7300a. Receiving, from a plurality of users, third party participant data corresponding with the disposition of property corresponding to the respective third party participants (e.g. buyer, seller and property data of actual or potential buyers or sellers of real estate in which the buyers and/or sellers may include one or more of leads and prospects) (stage 7302). Receiving, from third party participants or other non-users, third party participant data corresponding with the disposition of property corresponding to respective ones of the third party participants (e.g. from actual or potential buyers, sellers, agents, brokers, etc.) (stage 7304). Associating the received data with corresponding ones of the plurality of users (stage 7306). Associating the received data with transaction attributes corresponding to real estate transaction data characteristics (stage 7308). Accumulating the data and associations in a knowledge base (e.g. storing the data and associations in a real estate business management knowledge base corresponding to a REM system (stage 7310).

Turning now to FIG. 73B, receiving, from at least one current user of the plurality of users and subsequent to the receiving of the data, a transaction request corresponding to an actual or potential real estate deal, the request corresponding to one or more transaction attributes (stage 7312). Comparing the transaction attributes of the request with at least a portion of the accumulated data (or association) corresponding to the current user to determine third party participants corresponding to the request (e.g. selecting at least partially matching stored buyers that may be or become interested in purchasing a property of a current user having a property to sell or at least partially matching stored sellers that may be or become interested in selling a property of interest to a current user interested in purchasing such a property (stage 7314). Filtering or prioritizing the third party participants (according to predetermined criteria), such that a prioritized or filtered subset of the corresponding third party participants includes at least one of: third party participants that more closely correspond with the request and third party participants that whose data or para indicate that they will more likely or more readily consummate a corresponding real estate deal (stage 7316).

Turning now to FIG. 73C, receiving a participation request from at least a subset of the users to share, with other users, at least a portion of third participant data (or parameters) of third party participants corresponding to the respective users in the subset of users (stage 7320). Comparing the transaction attributes of the transaction request with at least a portion of the accumulated data (or association) corresponding to the subset of sharing users to determine third party participants corresponding to the transaction request (stage 7322). Filtering or prioritizing the corresponding shared third party participants, such that a prioritized or filtered subset of the corresponding shared third party participants correspond with the request and third party participants that whose data or para indicate that they will more likely or more easily consummate a corresponding real estate deal (stage 7324).

Turning now to FIG. 73D, filtering or prioritizing the corresponding third party participants and shared third party participants, such that a prioritized or filtered subset of the corresponding third party participants and shared third party participants includes at least one of: third party participants that more closely correspond with the request and third party participants that whose data or para indicate that they will more likely or more readily consummate a corresponding real estate deal (stage 7326). Compiling the shared third party participant data to at least one of: remove third party participant identification information identifying at least a subset of the shared third party participants, and to summarize the corresponding third party participant data (stage 7328). Associating, with the compiled third party participant data to form associated third party participant data, at least one of: user information of respective corresponding users, and contact information for contacting the respective corresponding users (stage 7330). Presenting, to the current user, at least a portion of the third party participant data resulting from the comparing (stage 7332).

The FIG. 74A-B flow diagram illustrates a computing system embodiment that may comprise one or more of the components of FIG. 1A through FIG. 1B. While other alternatives may be utilized or some combination, it will be presumed for clarity sake that components of systems 100a through 100b and elsewhere herein are implemented in hardware, software or some combination by one or more computing systems consistent therewith, unless otherwise indicated or the context clearly indicates otherwise.

Computing system 7400 comprises components coupled via one or more communication channels (e.g. bus 7401) including one or more general or special purpose processors 7402, such as a Pentium®, Centrino®, Power PC®, digital signal processor (“DSP”), and so on. System 7400 components also include one or more input devices 7403 (such as a mouse, keyboard, microphone, pen, and so on), and one or more output devices 7404, such as a suitable display, speakers, actuators, and so on, in accordance with a particular application.

System 7400 also includes a computer readable storage media reader 7405 coupled to a computer readable storage medium 7406, such as a storage/memory device or fixed, removable or stand alone storage/memory media; such devices or media are further indicated separately as storage 7408 and memory 7409, which may include hard disk variants, floppy/compact disk variants, digital versatile disk (“DVD”) variants, smart cards, partially or fully hardened removable media, read only memory, random access memory, cache memory, battery backed memory, flash memory, and so on, in accordance with the requirements of a particular implementation. One or more suitable communication interfaces 7407 may also be included, such as a modem, DSL, infrared, RF or other suitable transceiver, and so on for providing inter-device communication directly or via one or more suitable private or public networks or other components that may include but are not limited to those already discussed.

Working memory 7410 further includes operating system (“OS”) 7411, and may include one or more of the remaining illustrated components in accordance with one or more of a particular device, examples provided herein for illustrative purposes, or the requirements of a particular application. REM engine components 7412 may, for example, include one or more real estate business management systems and REM KB 7413 may include a shared real estate business management knowledge base, e.g., as discussed with reference to FIG. 1A-B. Data acquisition node engine 7414, external data source node acquisition engine 7415, data presentation node engine 7416 may, for example, respectively include: a data collection program for receiving buyer or seller participant-submitted data (e.g., from a web site or call center); transfer, search, smart agent or spider program for accumulating non participant statistics, participant credit scores or records, or other data according to which real estate transactions may be conducted; and a Web site setup and transfer program for creating, populating or maintaining a user Website (e.g., for marketing a property for sale). Telecomm communication engine 7417 and telecomm message engine 7418 respectively provide for conducting Web-based, plain old telephone system, cellular or other communications in conjunction with an REM system. System administration engine 7419 provides for conducting administration of Real estate management system 101 components. Working memory of one or more processing systems may also include other program(s) 7415, including any add-on or other code, which may similarly be stored or loaded therein during use.

The particular OS may vary in accordance with a particular device, features or other aspects in accordance with a particular application, e.g., using Windows, WindowsCE, Mac, Linux, Unix, a proprietary OS, and so on. Various programming languages or other tools may also be utilized, such as those compatible with C variants (e.g., C++, C#), the Java 2 Platform, Enterprise Edition (“J2EE”) or other programming languages. Such working memory components may, for example, include one or more of applications, add-ons, applets, servlets, custom software and so on for implementing functionality including, but not limited to, the examples discussed elsewhere herein. Other programs 7415 may, for example, include one or more of security, compression, synchronization, backup systems, groupware, networking, or browsing code, assessment delivery/conducting code for receiving or responding to resulting items or other information, and so on, including but not limited to those discussed elsewhere herein.

When implemented in software, one or more of system 100a through 100b or other components may be communicated transitionally or more persistently from local or remote storage to memory (SRAM, cache memory, etc.) for execution, or another suitable mechanism may be utilized, and one or more component portions may be implemented in compiled or interpretive form. Input, intermediate or resulting data or functional elements may further reside more transitionally or more persistently in a storage media, cache or other volatile or non-volatile memory, (e.g., storage device 7408 or memory 7409) in accordance with the requirements of a particular implementation.

Turning now to FIGS. 75-139, other implementations of real estate business system 100a and/or REM system 101 (of FIG. 1A) are described. FIG. 75 is a diagrammatic view of a real estate business collaboration system 10000 of one implementation. System 10000 has a lead generation module 10020, collaboration module 10200, and a paperless office module 10300. System 10000 conducts or otherwise facilitates real estate business, collaboration and knowledge accumulation sharing. In one implementation, some or all of the components, sub-components, tools, and/or features of real estate business collaboration system 10000 can be included part of REM system 101. In another implementation, some or all of the components, sub-components, tools, and/or features of real estate business collaboration system 1000 may be separate from REM system 101.

Lead generation module 10020 is responsible for facilitating the generation of leads for real estate transactions, such as leads on people or companies who may be interested in buying or selling particular type of property that other users of real estate business collaboration system 10000 may be interested in. In one implementation, lead generation module can obtain lead data from external data source(s) 108 (of FIG. 1A). Lead generation module 10020 has a property syndication tool 10040, squeeze pages tool 10060, follow-up sequences tool 10080, lead pipes tool 10100, property launch template tool 10120, and other tools 10140.

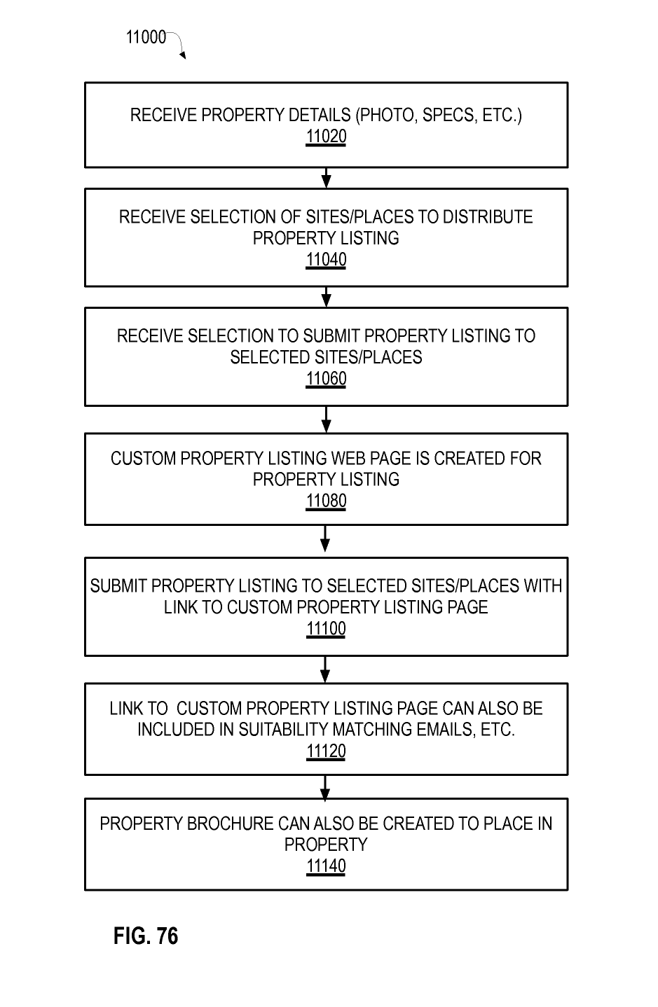

Property syndication tool 10040 is responsible for submitting a property listing record out to various sources, including several web sites that allow for property listings to be posted. Property syndication tool 10040 is described in further detail in FIGS. 76-87.

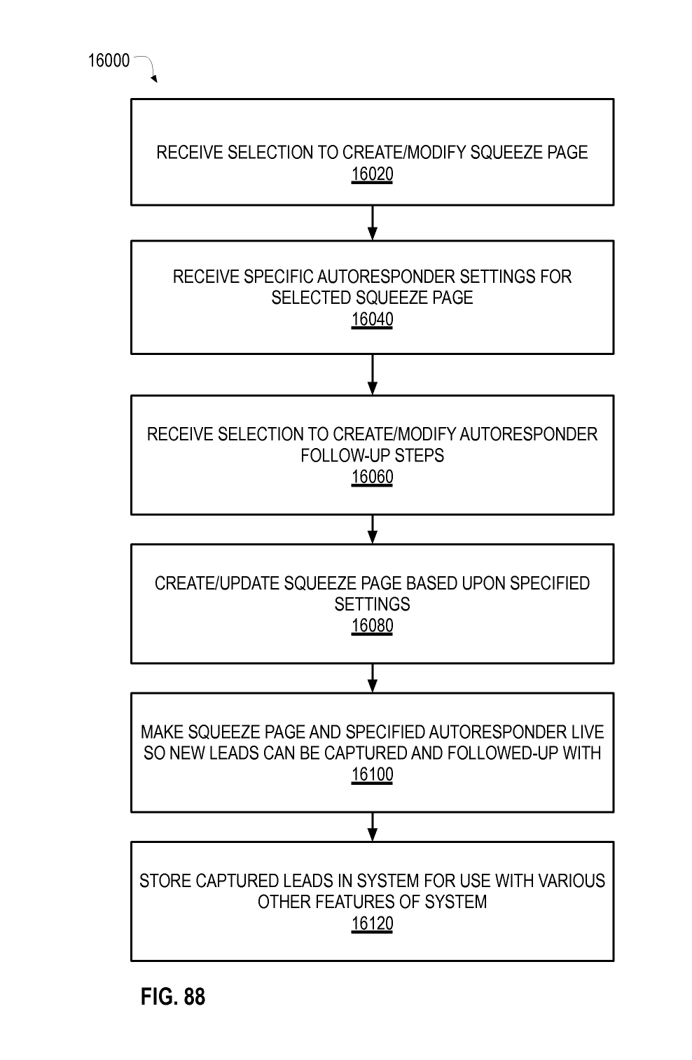

Squeeze pages tool 10060 is responsible for generating and managing web site squeeze pages that can be used to capture name, email address, or other details of potential leads for a real estate transaction. Follow-up sequences tool 10080 works in conjunction with squeeze pages tool 10060 to send follow-up messages to those who request information from a particular squeeze page. More details regarding squeeze pages tool 10060 and follow-up sequences tool 10080 are described in FIGS. 88-94.

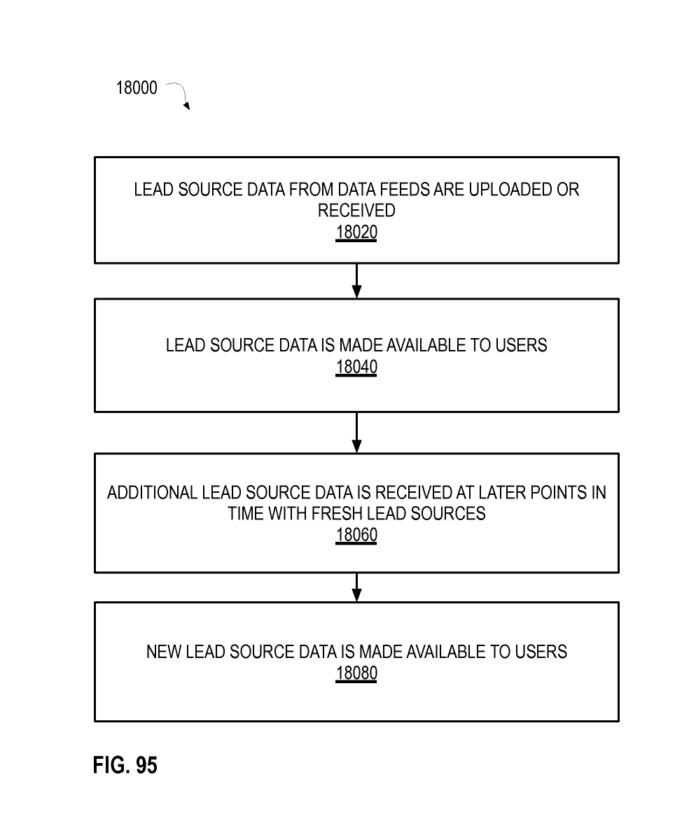

Lead pipes tool 10100 is responsible for providing additional data sources of potential leads to users of real estate business collaboration system 10000 from various sources, such as data feeds from third parties. Lead pipes tool 10100 is described in further detail in FIGS. 95-108.

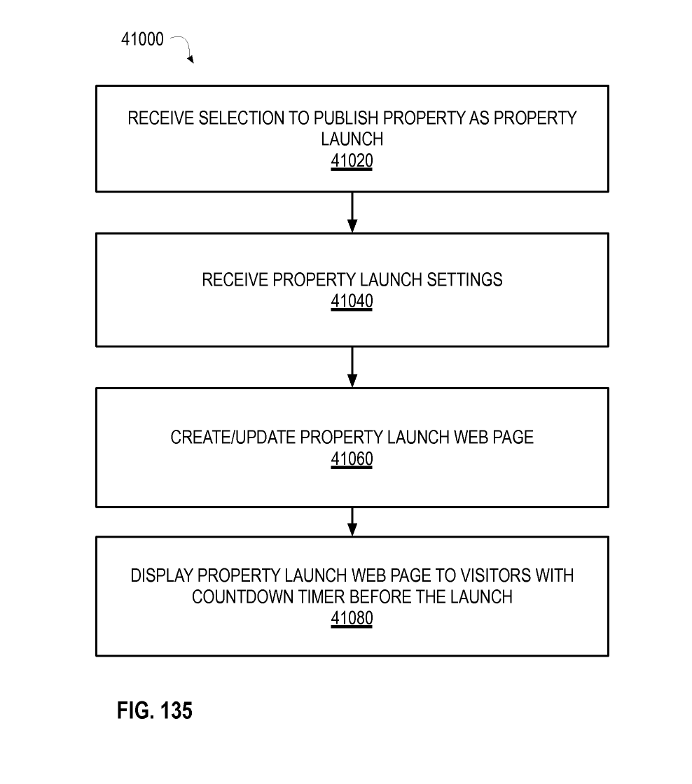

Property launch template tool 10120 is responsible for providing a property launch web site with a specific countdown timer, with the web site being used to capture leads of people who may be interested in a particular property. Property launch template tool 10120 is described in further detail in FIGS. 135-138. Other lead generation tool(s) 10140 can be included in other implementations to aid in generating new leads for users of real estate business collaboration system 10000.

Collaboration module 10200 is responsible for facilitating transactions among users of real estate business collaboration system 10000 and/or third parties, as well as for tracking the progression of activities throughout the life cycle of a real estate transaction.

Suitability matching tool 10220 is responsible for associating actual and/or potential buyers with transaction attributes that indicate their areas of preference, proximity, resource availability, deal/transaction history, likely follow through or other indicators of for a future actual or potential purchase or sale of a property. Suitability matching tool 10220 is further responsible for helping identify whether one or more of those sellers or buyers may be interested or should be considered as potential purchasers of the properties. In another implementation, potential buyers can include buyers that the user may identify, and/or blind or community matching buyers that one or more other users or the system may indicate exist. Suitability matching tool 10220 can also operate in conjunction with other persons, properties or other roles in conjunction with a particular deal or transaction. In one implementation, some or all of the features, components, and/or sub-components of suitability matching tool 10220 are part of suitability matching/linking engine 111g (of FIG. 1A). In other implementations, some or all of the features, components, and/or sub-components of suitability matching tool 10220 may be separate from suitability matching/linking engine 111g.

Linking tool 10240 is responsible for allowing a user of real estate business collaboration system 10000 to selectively limit access by third parties to the user's data. Such access may, for example, be limited to one or more particular deals or transactions that the user authorizes the third party to participate in. In one implementation, some or all of the features, components, and/or sub-components of linking tool 10240 is part of suitability matching/linking engine 111g (of FIG. 1A). In other implementations, some or all of the features, components, and/or sub-components of linking tool 10240 may be separate from suitability matching/linking engine 111g.

Other collaboration module(s) 10260 may be used in other implementations to provide various features for facilitating collaboration throughout the progression of a real estate transaction, such as the numerous real estate collaboration features described in detail in FIGS. 1-74.

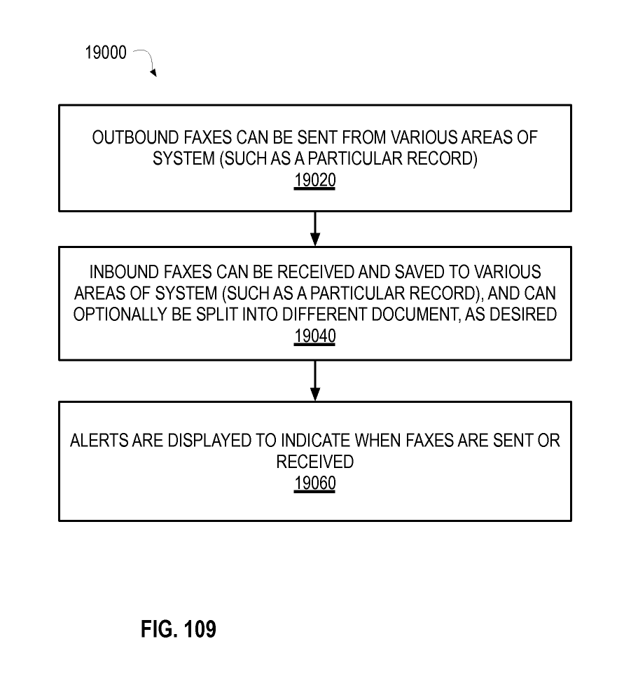

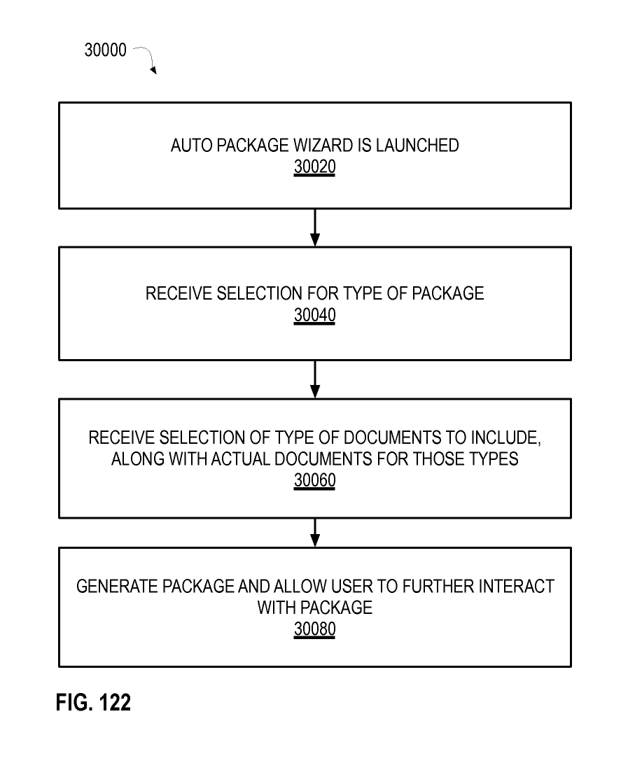

Paperless office module 10300 is responsible for providing various automated tools that streamline the process of moving through a real estate transaction. Auto package generator tool 10320 is responsible for allowing various auto packages to be created and sent off to the appropriate parties. Auto package generator tool 10320 is described in further detail in FIGS. 122-134. Digital fax tool 10340 enables digital faxes to be sent and received from real estate business collaboration system 10000. Digital fax tool 10340 is described in further detail in FIGS. 109-121.

Project estimator tool 10360 is responsible for assisting with the generation of property repair estimates after prompting the user to answer a series of questions about the condition of the property and what needs repaired. Project estimator tool 10360 is then able to generate a property estimate on how much it will cost to repair the property to a desired condition that will be necessary for the real estate transaction to happen (or for other purposes in which an estimate is desired).

Other paperless office tool(s) 10380 can be included in other implementations to facilitate the automation of various activities that are involved in a real estate transaction.

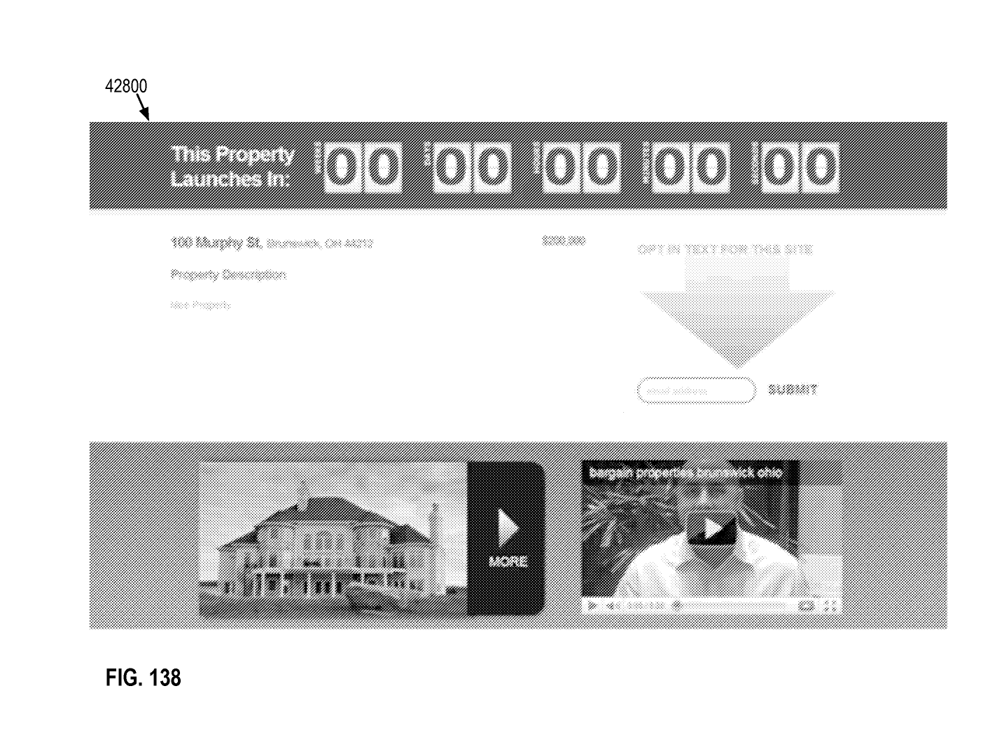

Turning now to FIGS. 76-138, the stages for implementing one or more implementations of real estate business collaboration system 10000 are described in further detail. In some implementations, the processes of FIG. 76-138 are at least partially implemented in the operating logic of computing device 50000 (of FIG. 139).

FIG. 76 is a process flow diagram 11000 for one implementation illustrating the stages involved in syndicating property listings to multiple web sites. Property details are received from the user, such as photos, specifications about the property, etc. (stage 11020). A selection is received for the sites or other places to distribute the property listing (stage 11040). Once a selection is received to submit the property listing to the selected sites/places (stage 11060), a custom property listing web page is created for the property listing (if one doesn't already exist) (stage 11080). The custom property listing web page includes various details about the property.

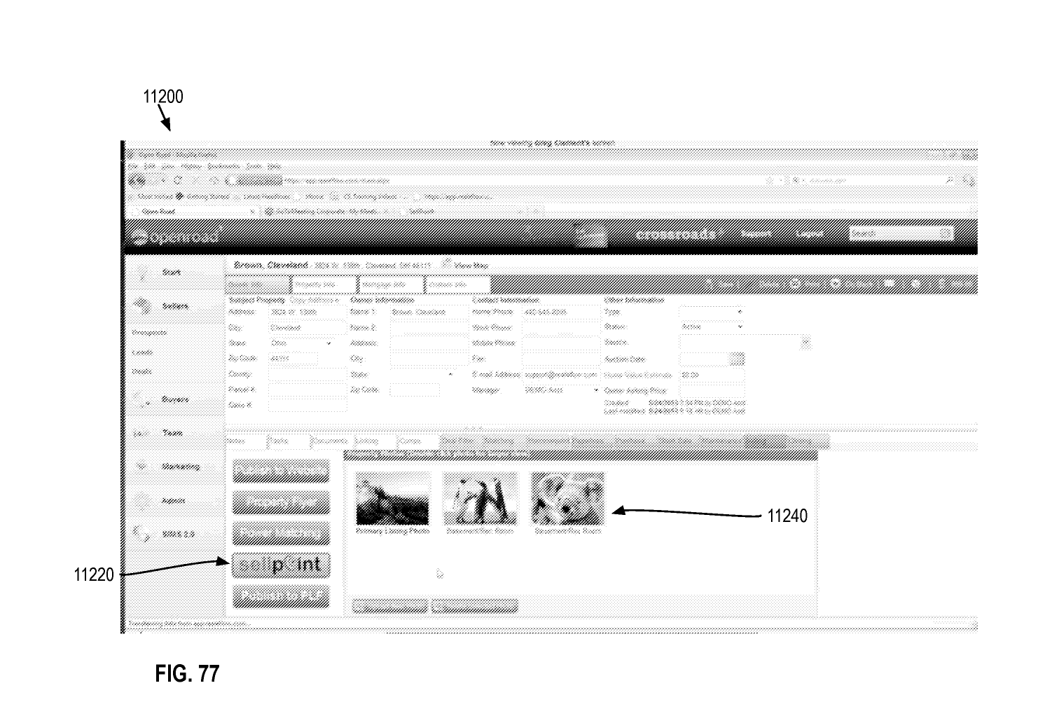

The property listing is then submitted to the selected sites/places, with the link to the custom property listing page being included when appropriate (stage 11100). For example, if the property listing is submitted to a particular third party web site that allows property listings, then the web site link that points to the custom property listing page is included in that post so that viewers can click the link to go to the site and view the property listing. The link to the custom property listing page can also be included in other parts of the system, such as in emails that are sent between users and/or third parties from suitability matching tool 10220. A property brochure can also be created to place in the physical property location (or elsewhere), as desired (stage 11140). FIGS. 77-87 provide several simulated screens to illustrate this process of syndicating property listings in much greater detail.

FIG. 77 is a simulated screen 11200 for one implementation that illustrates launching a property syndication tool. Upon selecting the property syndication tool option 11220, a screen is displayed to allow the user to add further details about the property that can be used in the syndication process. For example, photos 11240 can be specified for the property (as part of the syndication process or independently thereof).

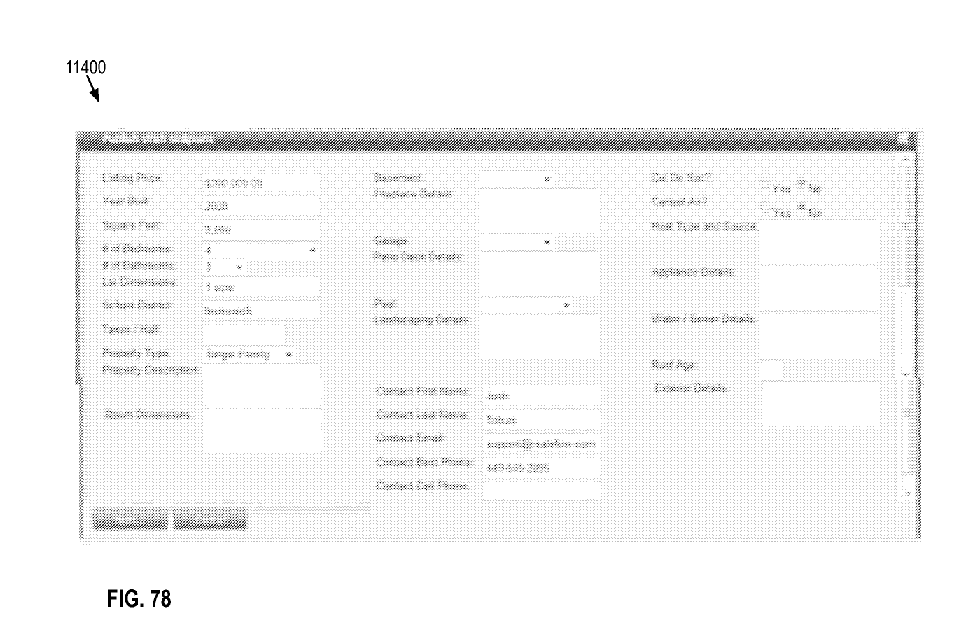

FIG. 78 is a simulated screen 11400 for one implementation that illustrates specifying details for a property listing for use in syndication. Various details are specified for the property listing, such as the listing price, year built, square feet, number of bedrooms, number of bathrooms, lot dimensions, school district, semi-annual tax amount, property type, property description, and room dimensions. Additional details that can be specified for the property listing include whether the property has a basement, fireplace details, garage type, patio deck details, pool status, landscaping details, and the contact information (first name, last name, email, best phone, and cell phone) of the person to contact. Additional details that can be specified for the property listing also include details on whether the property is on a cul de sac, central air status, heat type and source, appliance details, water/sewer details, roof age, and exterior details. In other implementations, additional or fewer details could be included as options for the property listing. These are just some non-limiting types of examples.

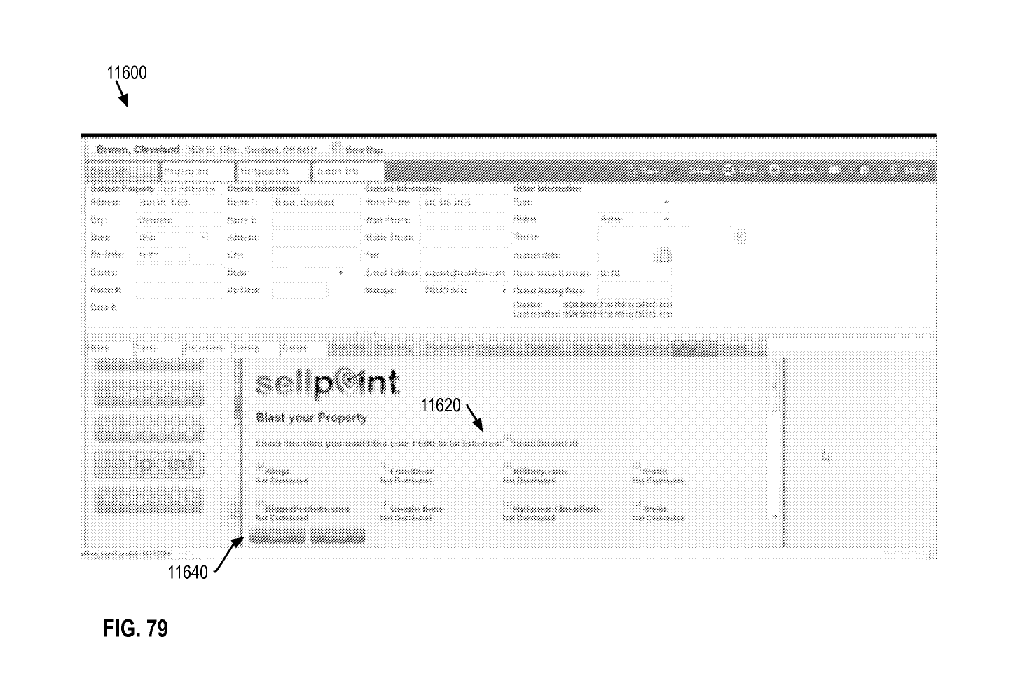

FIG. 79 is a simulated screen 11600 for one implementation that illustrates selecting the places to submit the property listing to. Various third party and other places that the property listing can be submitted to are displayed 10620, along with a blast option 11640 that will then submit the property listing to the specified places. In one implementation, these places are web sites of various companies that allow properties to be listed for sale. In other implementations, these places could include other distribution mediums such as fax, mail, or voice distributions to other sources that allow for property listings to be submitted.

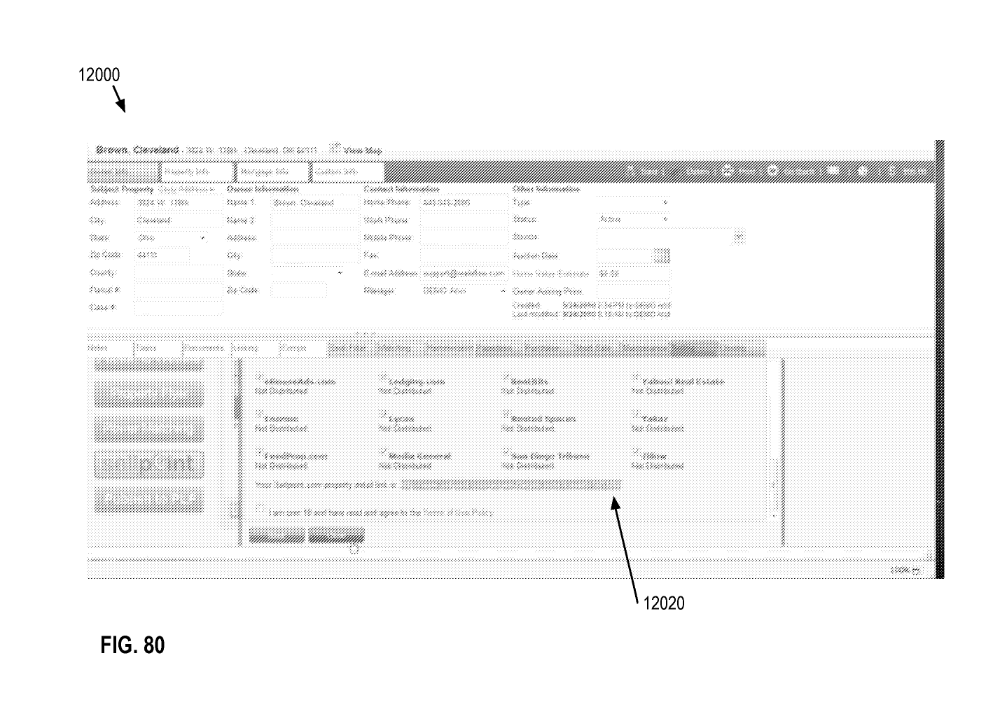

FIG. 80 is a simulated screen 12000 for one implementation that illustrates a link 12020 to a custom property listing page that gets used with the syndication. Link 12020 is generated as a unique identifier that allows visitors to view the custom property listing. In one implementation, the custom property listing is generated as a web page that is accessible through a web browser, and the link 12020 is a URL to that web page.

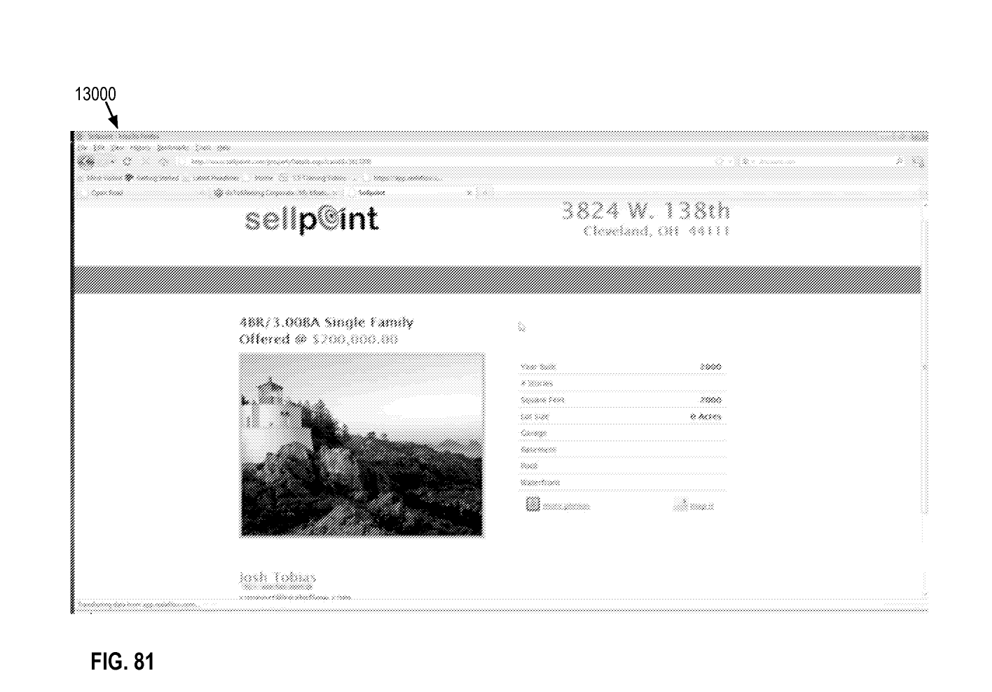

FIG. 81 is a simulated screen 13000 for one implementation that illustrates an exemplary custom property listing page that gets created by the syndication tool. The custom property listing page is what people who visit the third party sites where the property listing was submitted will be redirected to if they click on the link in the listing.

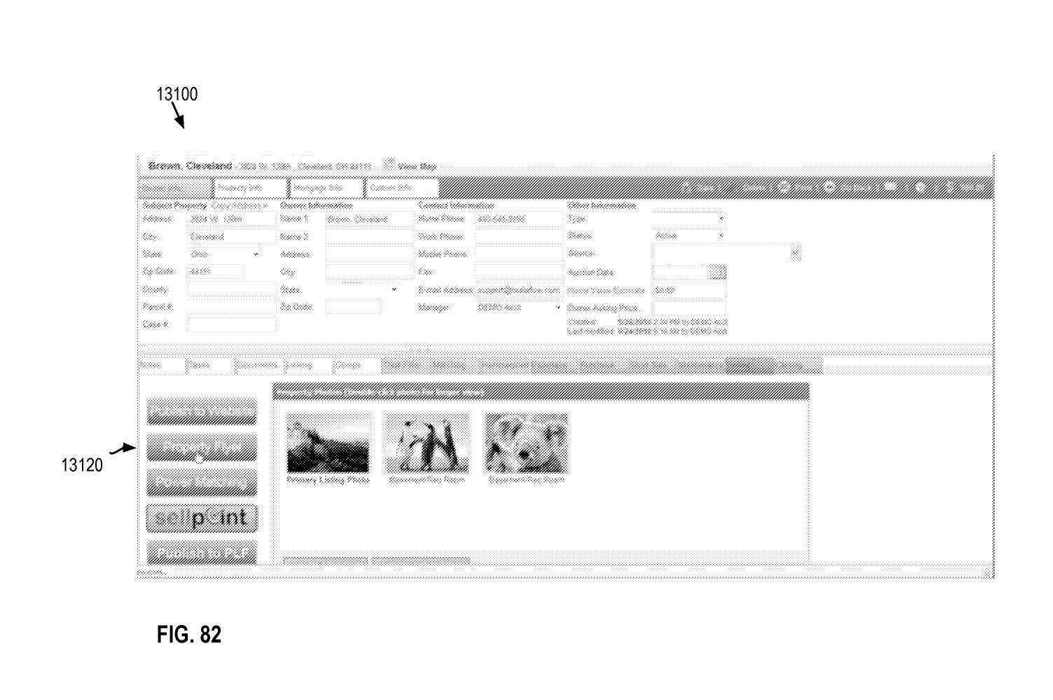

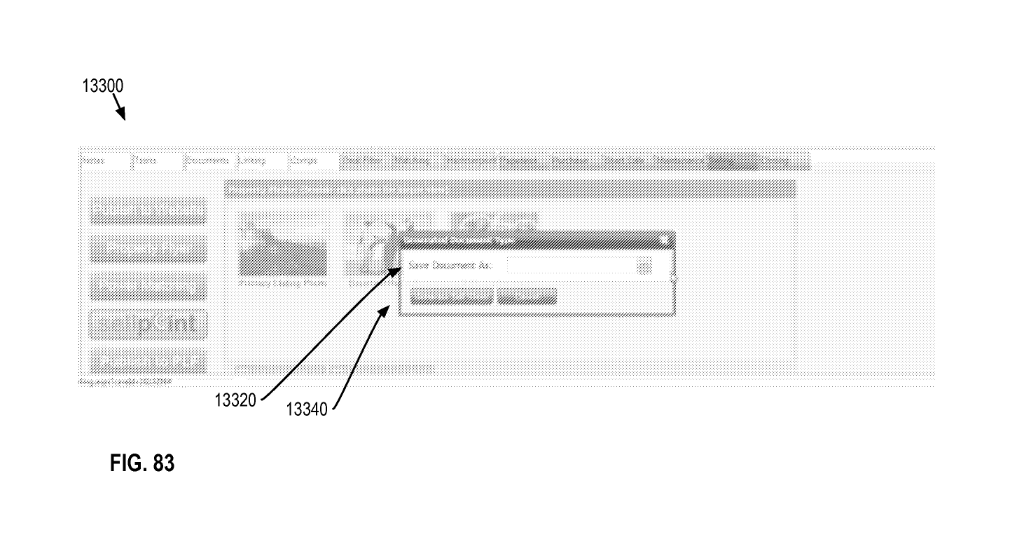

FIG. 82 is a simulated screen 13100 for one implementation that illustrates creating a property flyer. Upon selecting property flyer option 13120, a property flyer tool is launched, such as one shown in FIG. 83.

FIG. 83 is a simulated screen 13300 for one implementation that illustrates specifying the type of document 13320 to be used to create a property flyer, such as a Word document (.doc), Rich Text File (.rtf), etc. Upon selecting generate sell sheet option 13340, a request is submitted to generate the property flyer.

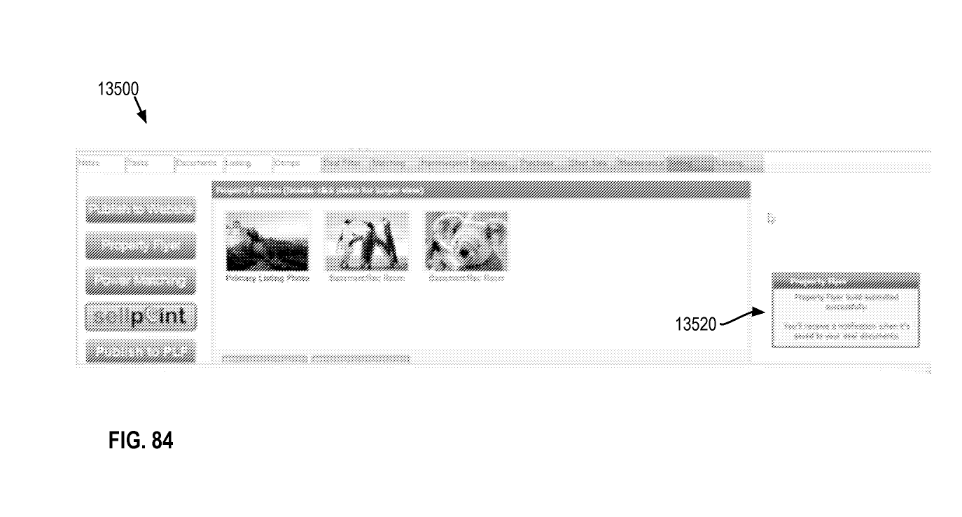

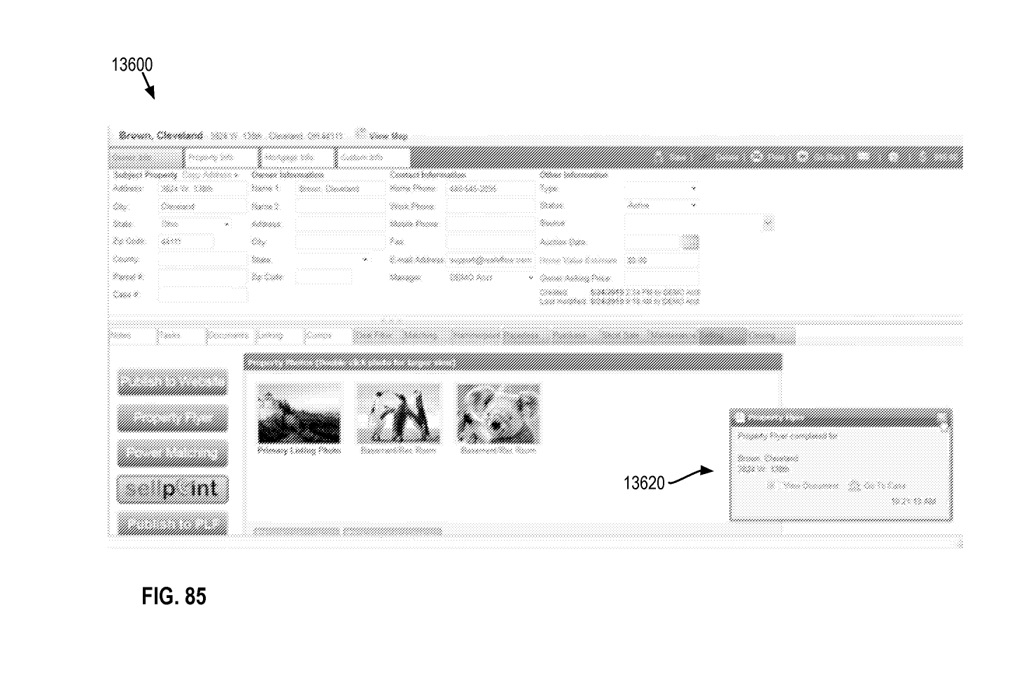

An alert notification 13520 such as the one shown in the simulated screen 13600 of FIG. 84 is displayed to confirm that the property flyer is being generated. Alert notification 13520 indicates that the property flyer build was submitted successfully, and that a notification will be provided when the property flyer has been saved to the deal documents (or elsewhere as appropriate). Then, once the property flyer has actually been generated, another alert notification 13620 as shown in simulated screen 13600 of FIG. 85 is displayed. In this instance, alert notification 13620 indicates that the property flyer has been completed. Options are also provided to enable the user to view the property flyer (view document), or to go to the case that the property flyer is associated with. In other words, even if the user is working on some other case or part of the system, once the property flyer has been generated, the user can easily jump back to that case to continue working on it now that the flyer is ready.

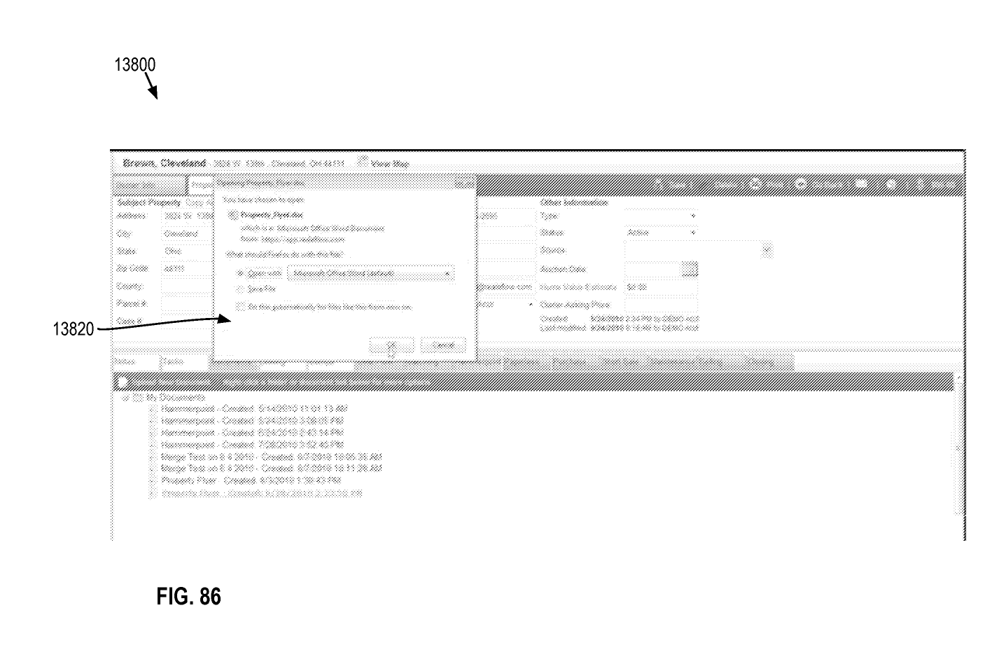

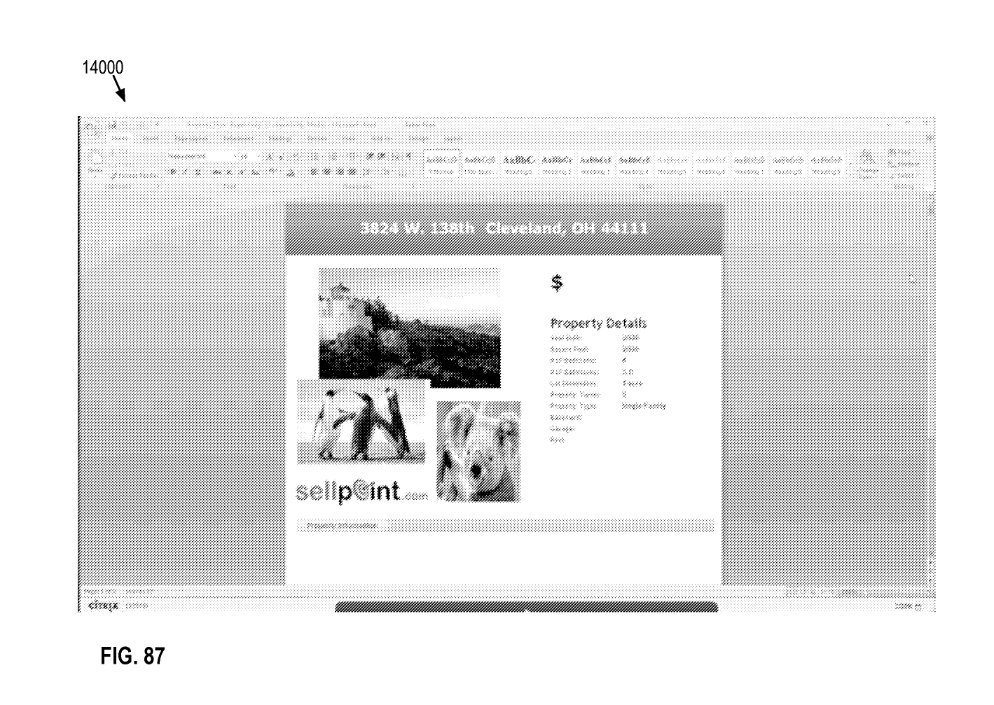

Upon selecting the option to view the property flyer from alert notification 13620, simulated screen 13800 of FIG. 86 is displayed. Screen 13800 provides the user with an option to open the property flyer, or to save the file to a specified location. Upon selection the open option 13820 to open the property flyer, the property flyer that was generated is then shown. An example of a property flyer is displayed in simulated screen 14000 of FIG. 87.

FIG. 88 is a process flow diagram 16000 for one implementation illustrating the stages involved in creating and managing squeeze pages and their corresponding autoresponder sequences. Squeeze pages are web pages that are designed to capture information such as name, email, phone number, and/or other details about a person. Squeeze pages can also offer additional incentives for providing such information, such as a free report that would be interesting to the person visiting the site.

Once a selection is received from the user to create or modify a squeeze page (stage 16020), specific autoresponder settings can also specified and received from the user for the selected squeeze page (stage 16040). A selection can be received from the user to create and/or modify autoresponder follow-up steps (stage 16060). The autoresponder follow-up steps specify the email or other communications that are sent to subscribers who request information on a particular squeeze page upon submitting the requested details (such as name and email address).

In one implementation, complete templates are provided for users for an entire autoresponder follow-up sequence. This complete sequence can include the free report itself, as well as all of the follow-up messages that are designed to follow-up with the visitors over a period of time. By having a complete sequence to choose from, users of real estate business collaboration system 10000 can just select a template and have everything already done for them without having to create any free report, create any web page, or create any follow-up messages. They just choose a template they like and the free report, web page, and/or follow-up messages are already setup. Users can also choose to customize their own squeeze pages from scratch, or to modify a template to their own preferences (such as to modify some parts but keep others).

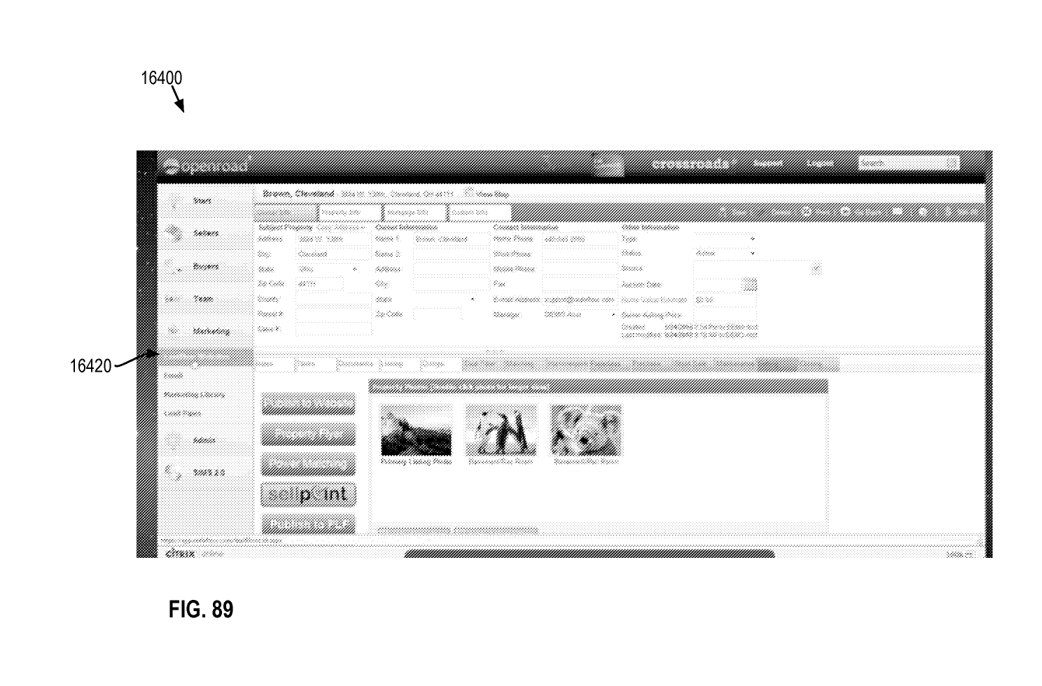

A squeeze page is then created and/or updated based upon the settings that were specified by the user (stage 16080). The squeeze page can be uploaded or otherwise made live on an actual web site, along with the corresponding autoresponder, so that new leads can be captured an followed up with (stage 16100). The leads that are captured from the squeeze pages are stored in the system for use with various other features of real estate business collaboration system 10000, such as for saving the leads into their own record as a potential buyer or seller, which then opens up numerous other functionalities of real estate business collaboration system 10000 for facilitating one or more real estate transactions with that lead. Several simulated screens are shown in FIGS. 89-94 to illustrate squeeze pages and autoresponder follow-up steps in additional detail.

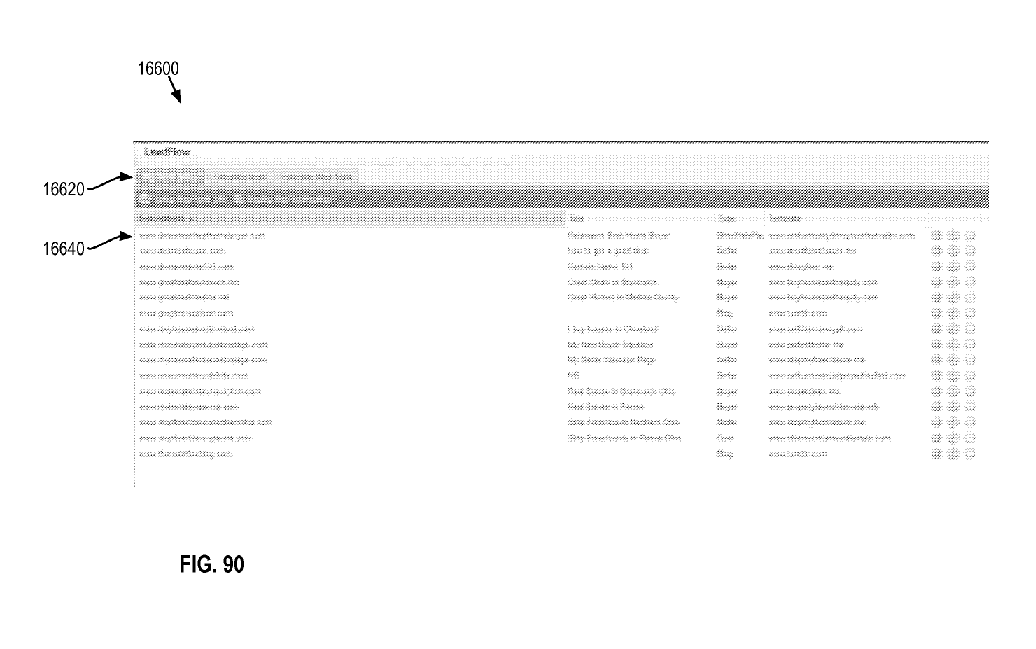

FIG. 89 is a simulated screen 16400 for one implementation that illustrates selecting an option to view and manage squeeze pages. Upon selection the squeeze page option 16420, a simulated screen such as 16600 of FIG. 90 is displayed to list any existing squeeze pages, along with options to create additional squeeze pages, or edit existing ones. Various squeeze page options 16620 are offered, such as to view my web sites (squeeze pages), view template sites, and purchase web sites. For the current view of existing squeeze pages, various details about the page are listed, such as the site address, title, type, and template. Different templates can be selected to give the squeeze page a different look and feel. The autoresponder follow-up steps can also be modified for the squeeze page(s), as described in further detail herein.

FIG. 91 is a simulated screen 16800 for one implementation that illustrates an exemplary squeeze page. In the example shown, the user is offered a free report in exchange for providing contact information. Numerous other types of squeeze pages could be provided that include fewer or additional contact fields, and/or that offer or don't offer a free report or other offering in exchange for submitting the information.

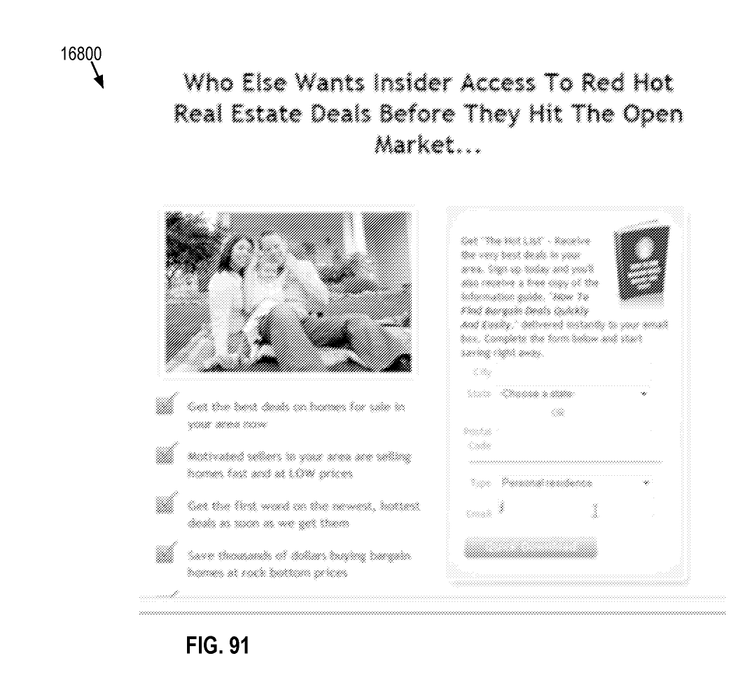

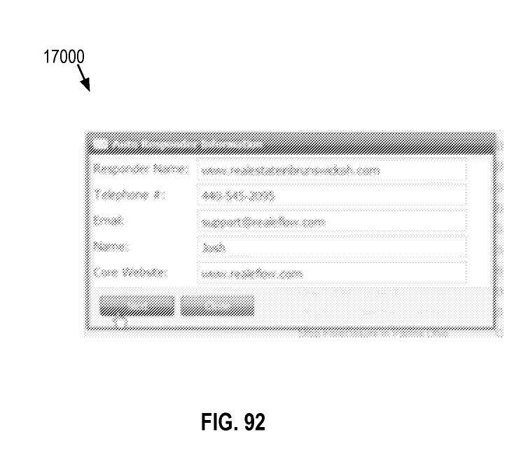

FIG. 92 is a simulated screen 17000 for one implementation that illustrates customizing autoresponder information for one or more squeeze pages. Some examples of the autoresponder settings that can be customized include the autoresponder name (such as the web site name), the telephone number, email, name, and core web site that the autoresponder is associated with. These are just a few non-limiting examples.

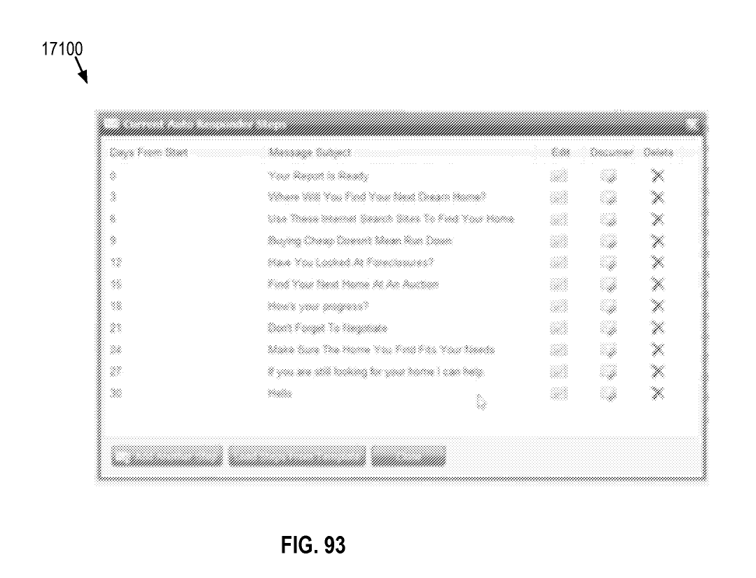

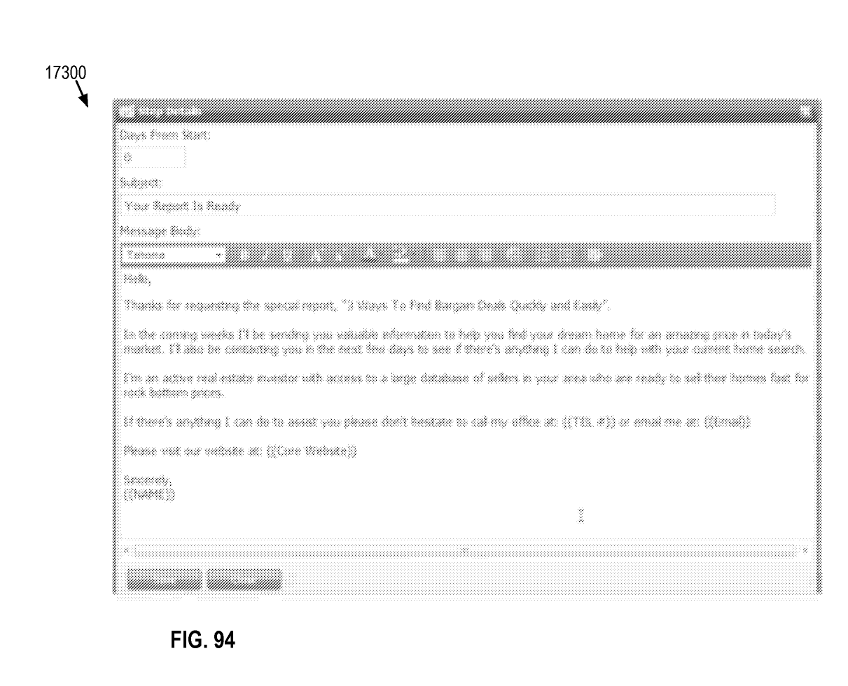

FIG. 93 is a simulated screen 17100 for one implementation that illustrates some exemplary autoresponder steps for a selected squeeze page. In the example shown, there are several follow-up messages that get sent on the specified days to anyone who visits the squeeze page and provides the requested information. Those follow-up messages can be modified as desired, such as to add another step, load a step from a template, or close the screen. Upon selecting an option to modify the contents of a particular follow-up message, a simulated screen 17300 such as FIG. 94 is displayed to allow the user to edit the contents of the message (which in this example, is an email).

Turning now to FIGS. 95-108, more details will be provided regarding lead pipes tool 10100. Lead pipes are additional data sources that have data on individuals or companies that are possible leads for buying or selling property. Some examples of lead pipes include bankruptcy records, tax lien records, cash buyers, and property syndication users (those who use the property syndication tool of real estate business collaboration system 10000, or as a standalone system). Lead pipes allow the buyer or seller to get leads fed to them without having to do the hard work on their own. The user get the leads from inside real estate business collaboration system 10000, without having to leave the system and do the work of finding those leads on their own (or re-entering the data into real estate business collaboration system 10000 once a lead is located). The user can then can use those leads with various other features of real estate business collaboration system 10000, such as for saving one or more leads into their own record as a potential buyer or seller, which then opens up numerous other functionalities of real estate business collaboration system 10000 for facilitating one or more real estate transactions with that lead.

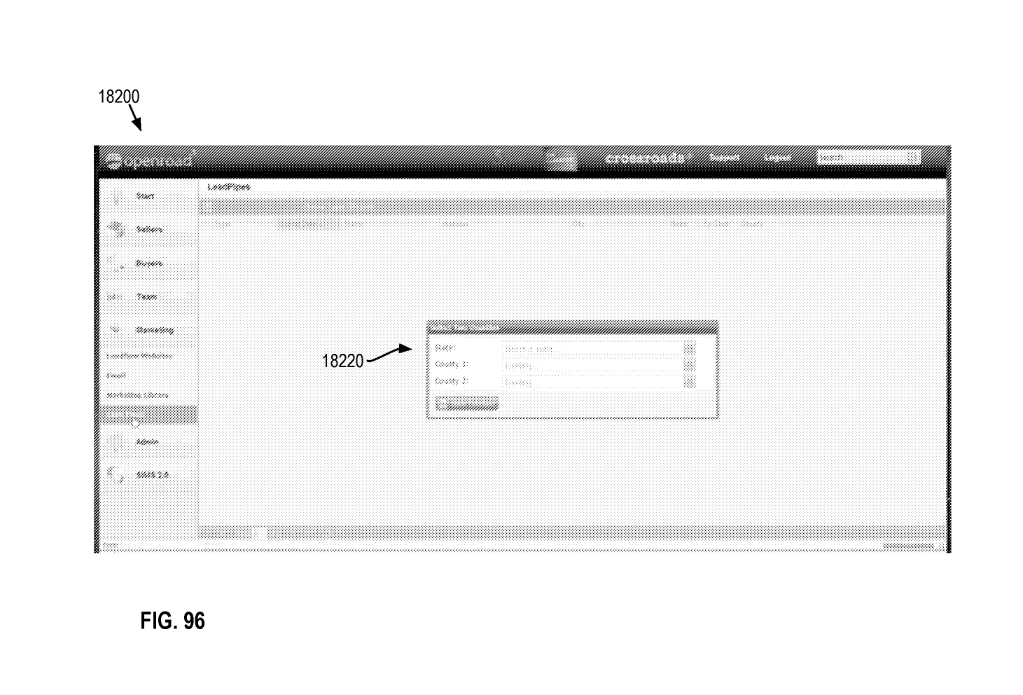

FIG. 95 is a process flow diagram 18000 for one implementation illustrating the stages involved in using lead pipes as additional lead sources. Lead source data is uploaded or received from one or more data feeds (stage 18020), such as third party bankruptcy or tax lien records, or internally within real estate business collaboration system 10000 based upon submissions of other users through the property syndication tool, or from other preferences that have been specified by users of real estate business collaboration system 10000 on the types of deals they are interested in. The lead source data is made available to users of system 10000 (stage 18040), such as for use within the system, for external telephone calls or follow-up, for direct mail campaigns, etc. Additional lead source data is received at later points in time with fresh lead sources (stage 18060). New lead source data is then made available to users as it becomes available (stage 18080). Several simulated screens are shown in FIGS. 96-108 to illustrate lead pipes in further detail.

FIG. 96 is a simulated screen 18200 for one implementation that illustrates specifying criteria 18220 to use for identifying new leads using lead pipes. In the example shown, state, county 1, and county 2 can be provided to narrow down the lead search results of a lead pipe search.

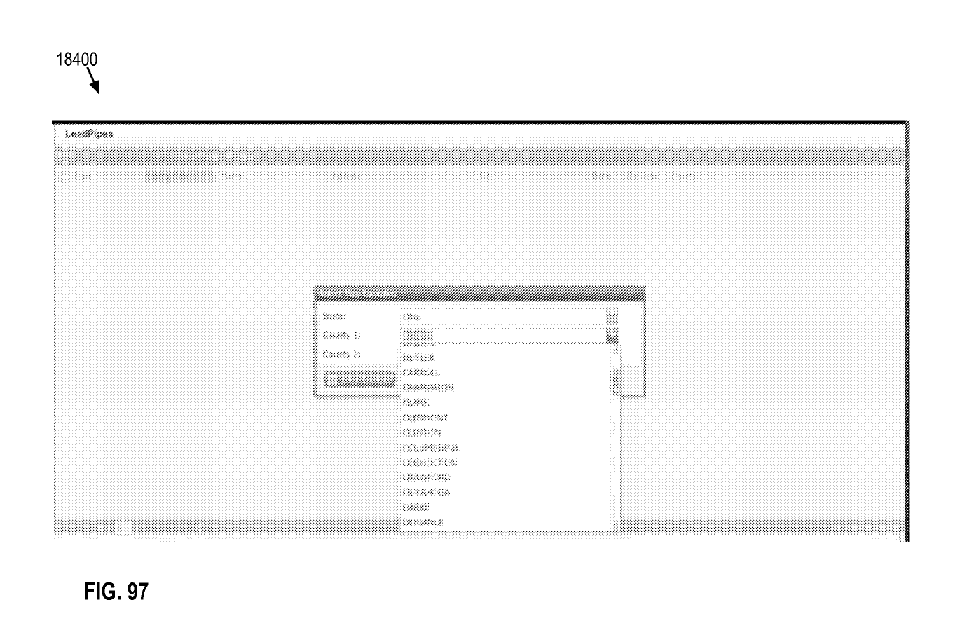

FIG. 97 is a simulated screen 18400 for one implementation that illustrates selecting a county to use in a lead pipe search. In other implementations, other types of selection criteria can be used to further limit the records that are selected.

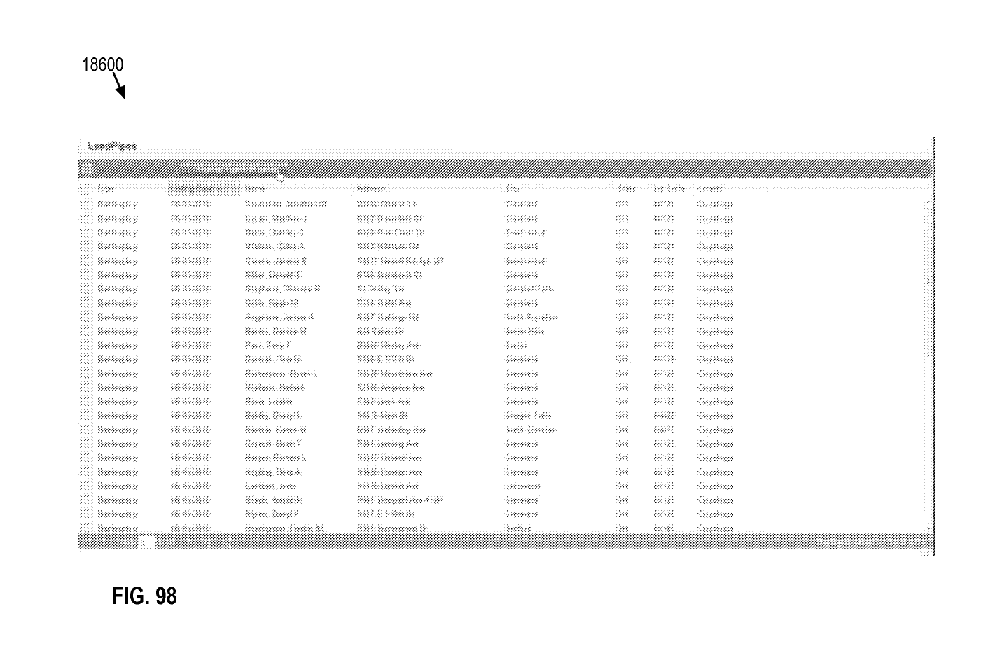

FIG. 98 is a simulated screen 18600 for one implementation that illustrates some example data records that were returned as possible leads from the lead pipe search. In the example shown, several fields are displayed for each potential lead, including type of lead (bankruptcy, tax lien, etc.), listing date, name of the person, address, city, state, zip code, and county. In other implementations, fewer or additional data fields could be shown for the leads.

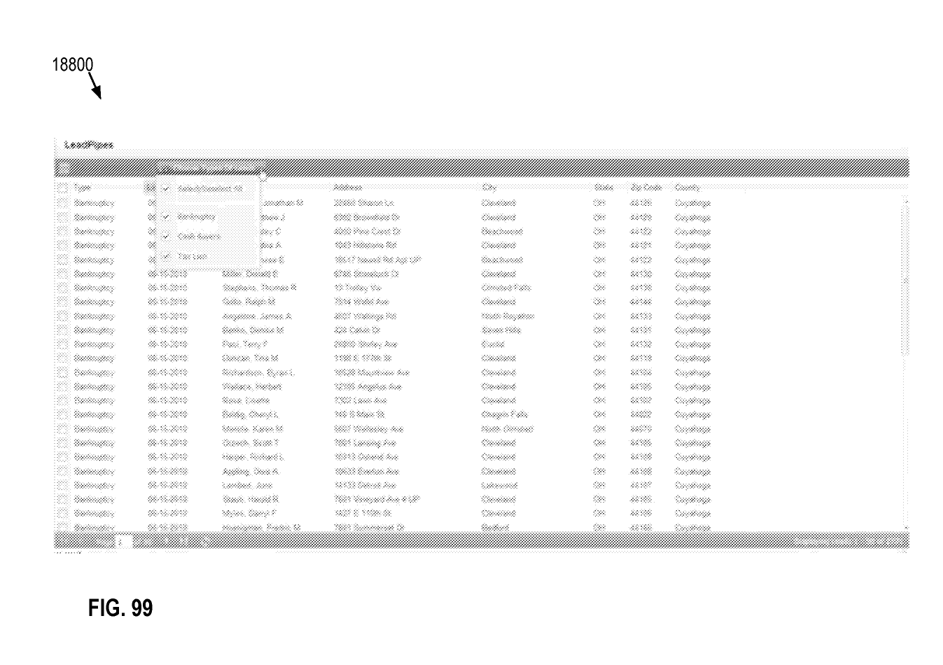

FIG. 99 is a simulated screen 18800 for one implementation that illustrates some exemplary types of lead pipes. In the example shown, there are three types of lead pipes that data comes from: bankruptcy records, cash buyers, and tax lien records. Data could come from various other sources in other implementations.

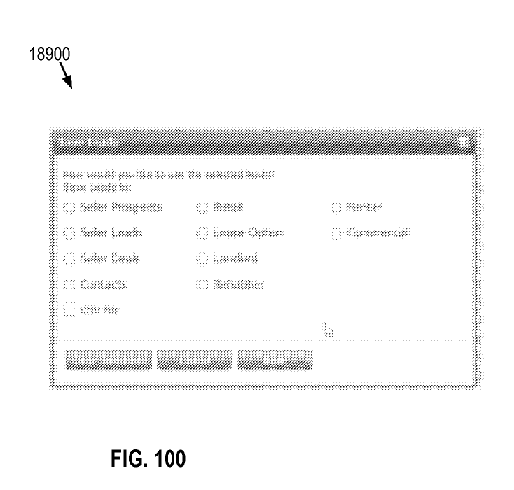

FIG. 100 is a simulated screen 18900 for one implementation that illustrates some exemplary options for saving one or more selected leads for later use with other system features. In the example shown, one or more selected lead records can be saved as seller prospects, seller leads, seller deals, contacts, retail, lease option, landlord, rehabber, renter, commercial, or to an external data file (such as CSV). In one implementation, system 10000 automatically saves the lead records to a buyer or seller record according to the type of lead. In another implementation, the user can specify how and where to save one ore more particular lead records. These examples herein are just a few examples of how the lead records can be saved for use with other parts of real estate business collaboration system 10000.

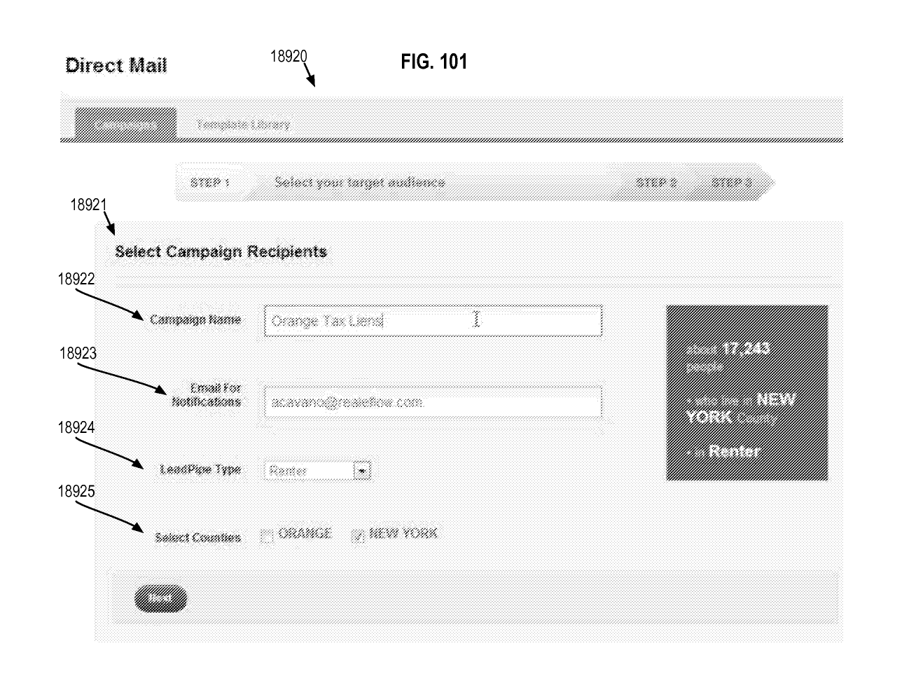

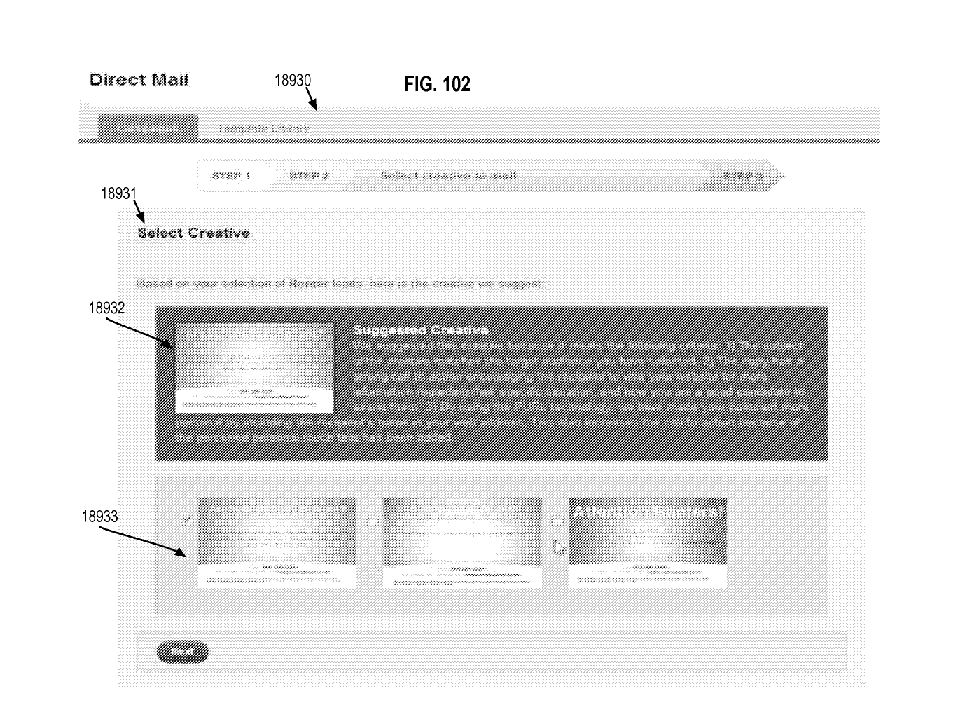

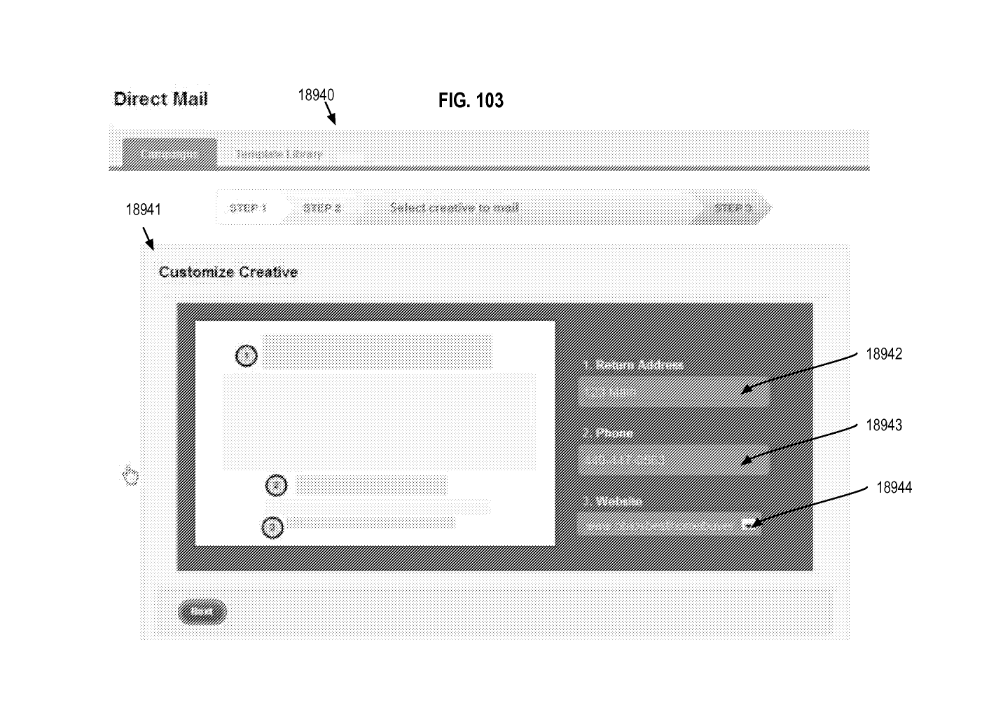

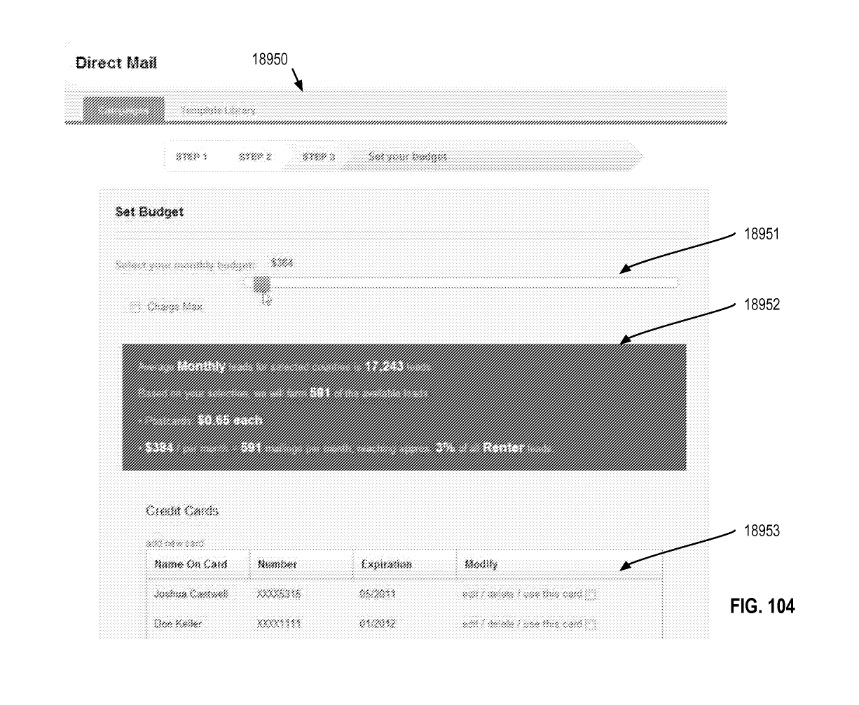

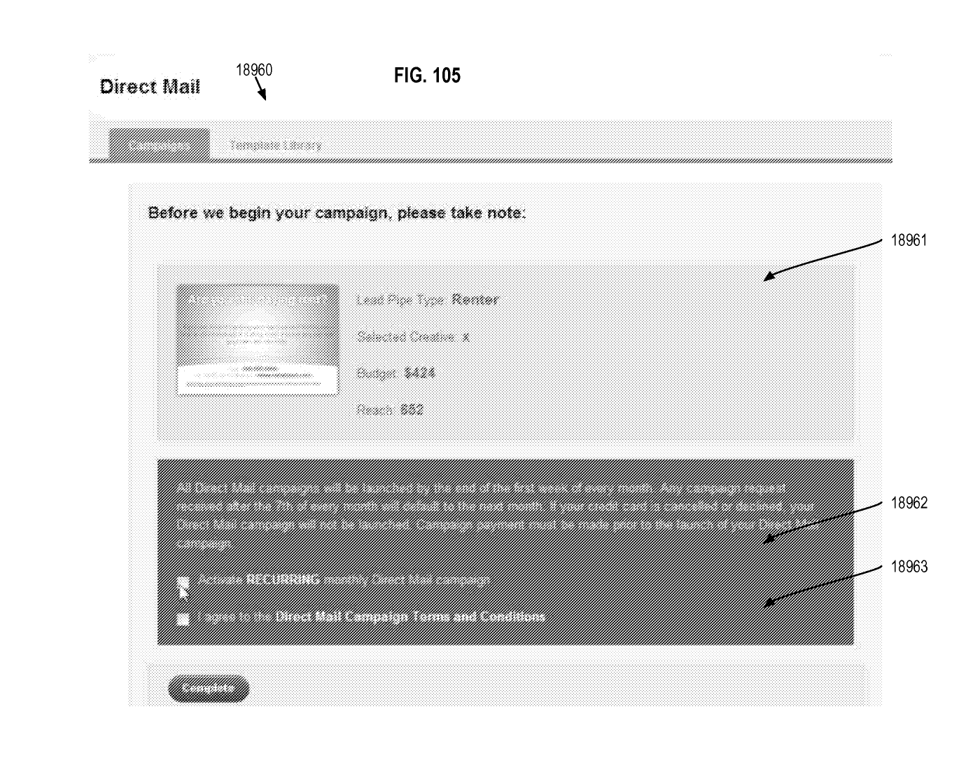

Turning now to FIGS. 101-108, a direct mail tool 18920 is described that can be part of, or separate from lead pipes tool 10100 and/or lead generation module 10020. In one implementation, the direct mail tool illustrated in FIGS. 101-108 is used to setup direct mail campaigns (such as post cards, flyers, or letters) that can be sent to leads that were generated from lead generation module 10020, from lead pipes tool 10100, and/or from other data sources. Direct mail tool allows for the recipients (leads) to be selected (as shown further in FIG. 101), for the creative that specifies the format of the direct mail piece to be selected/customized (as shown further in FIGS. 102-103), and/or for a budget for the direct mail campaign to be specified/calculated (as shown further in FIGS. 104-105). In one implementation, once the direct mail campaign is finalized, the direct mail pieces can be automatically sent to a third party (such as an internal or external print shop, automated system, etc.) for processing. In another implementation, the direct mail pieces can be provided to the user of system 10000 for further processing/mailing.

FIG. 101 is a simulated screen of direct mail tool 18920 for one implementation that illustrates selecting recipients to use as part of a particular direct mail campaign. In one implementation, the recipients for the direct mail campaign can be chosen from any of the available lead pipes (such as bankruptcy records, foreclosures, tax liens, property renters, homeowners, etc.), as described in further detail in FIGS. 95-100. In the example shown in FIG. 101, details about the campaign recipients 18921 can be specified, such as campaign name 18922, email for notifications about the campaign 18923, lead pipe/data source type 18924, and counties/region 18925. In other implementations, different data fields could be specified to select the proper recipients of the direct mail campaign.

FIG. 102 is a simulated screen 18930 for one implementation that illustrates selecting the creative 18931 to be used as part of a direct mail campaign. The type of creative to be used for the direct mail campaign can also be specified. The creative includes the type of mailing that will be sent, the layout, design, and/or the wording that will be used. In the example shown in FIG. 102, a suggested creative 18932 is shown to suggest what the system 10000 has determine could be a suitable choice based upon prior selections. Other available options 18933 for the creative are also displayed.

FIG. 103 is a simulated screen 18940 for one implementation that illustrates customizing the selected creative to be used as part of a direct mail campaign. In the example shown in FIG. 103, the return address 18942 is specified, the contact phone 18943 that the recipient should call for information, and the website 18944 that the recipient can visit for more information. In one implementation, personalized URL's can be used and/or generated programmatically in the direct mail campaign so that the web site that is printed on each respective direct mail piece is customized with the recipient's name or identifier as part of the web site URL (e.g. www.adomain.com/recipientname). The use of personalized URL's (or PURLS) allows system 10000 to track whenever a particular recipient responded to a particular direct mail piece, which further allows system 10000 to record this recipient's interest in the appropriate lead record that corresponds to the recipient.

FIG. 104 is a simulated screen 18950 for one implementation that illustrates setting a budget 18951 for the specified direct mail campaign. In one implementation, a budget can be set for the direct mail campaign, and then the number of recipients for the direct mail campaign adjusted accordingly. In the example shown, budget 18951 is set by adjusting a slider bar to get to the desired number of recipients for the desired price. Details about the number of recipients that can be obtained based upon the current setting are displayed in budget detail area 18952. Payment information 18953, such as credit card information, can be specified for use with one or more of the selected campaigns.

In one implementation, the campaign cost can be based upon one or more factors, such as the physical cost to mail the piece to the specified number of recipients, the cost to acquire the data from the lead source, and/or a service charge based upon some criteria such as volume, to name a few non-limiting examples. In other implementations, such as if the direct mail campaign is being sent digitally through email (e.g. in a digital post card, digital letter, or text-based email promotion), there may not be a budget to set for the campaign if there is no physical mailing cost or additional fee to be charged.

FIG. 105 is a simulated screen 18960 for one implementation that illustrates finalizing the direct mail campaign settings for the specified direct mail campaign. In the example shown, a summary 18961 showing the selected lead pipe/data source is shown, along with the selected creative, campaign budget, and number of recipients that will be reached with the campaign. A recurring option 18962 can be specified to run this campaign on a recurring basis (such as monthly). A terms and conditions option 18963 is provided to confirm that the user accepts the terms of the direct mail campaign before it is activated. Once the setup is completed, the direct mail campaign is activated, and the direct mail pieces can be provided to subscribers on the scheduled basis (or as otherwise specified for automatic or manual delivery by the system, a third party, or the user). In one implementation, the recipients that are included in any particular direct mail campaign are automatically saved to a seller or buyer lead record as appropriate for the type of lead. In another implementation, the user of system 10000 can specify which type(s) of records to save the recipients to.

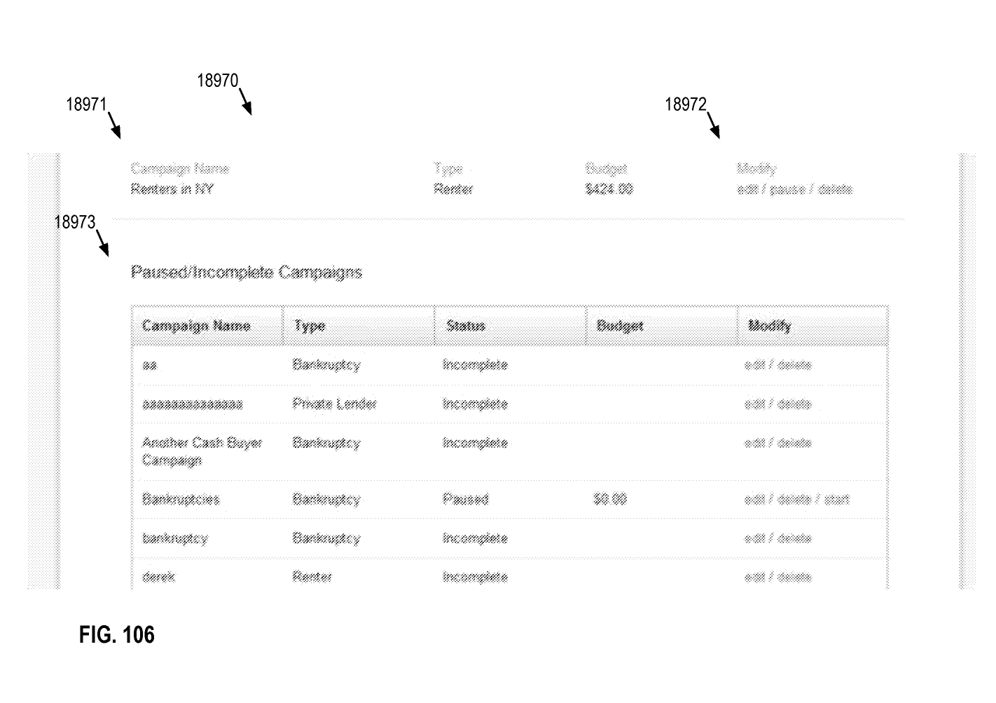

FIG. 106 is a simulated screen 18970 for one implementation that illustrates reviewing details about any existing direct mail campaigns. Active campaigns 18971 are displayed, along with active campaign options 18972, such as edit campaign, pause campaign, or delete campaign. Paused/incomplete campaigns 18973 are also shown, along with options for modifying any paused/incomplete campaigns, such as to activate or delete one or more specified campaigns.

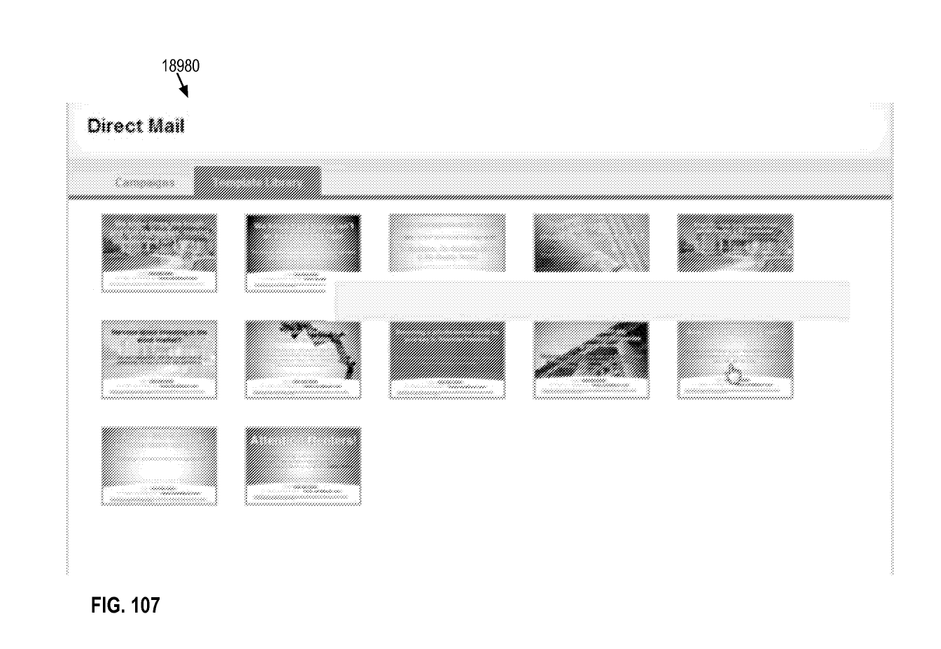

FIG. 107 is a simulated screen 18980 for one implementation that illustrates a template library for use with direct mail campaigns. The template library can display various templates that can be used as a starting point for the creative for the direct mail campaigns.

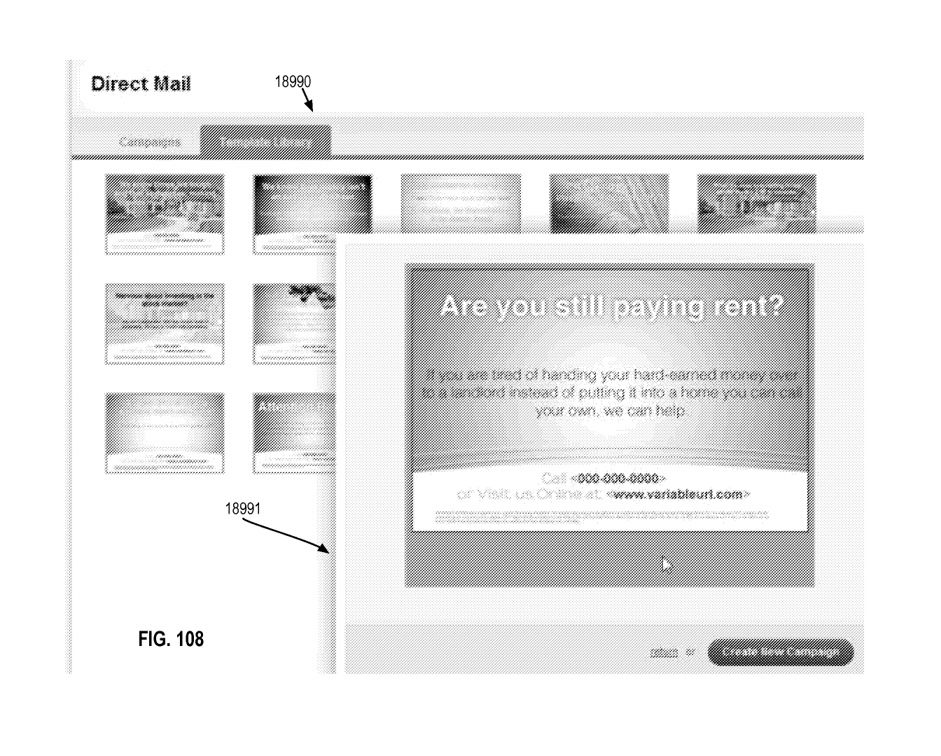

FIG. 108 is a simulated screen 18990 for one implementation that illustrates previewing a selected one of the templates 18991 from the direct mail template library to see a bigger view of the template.

Turning now to FIGS. 109-121, more details are described regarding digital fax tool. Digital fax tool enables faxes to be sent and received without leaving real estate business collaboration system 10000. Digital fax tool also allows outbound faxes to be generated with various documents that have already been uploaded into real estate business collaboration system 10000, such as with auto package generator 10320. Digital fax tool also allows inbound faxes to be integrated with and/or saved to existing records and features of real estate business collaboration system 10000.

FIG. 109 is a process flow diagram 19000 for one implementation illustrating the stages involved in using a digital fax service. Outbound faxes can be sent from various areas of real estate business collaboration system 10000, such as from a particular buyer or seller record (stage 19020). Inbound faxes can be received and saved to various areas of real estate business collaboration system 10000, such as to a particular buyer or seller record (stage 19040). A split fax option is included that allows the fax to be split out into separate documents, when desired (stage 19040). Alerts are displayed to indicate when faxes are sent or received (stage 19060).

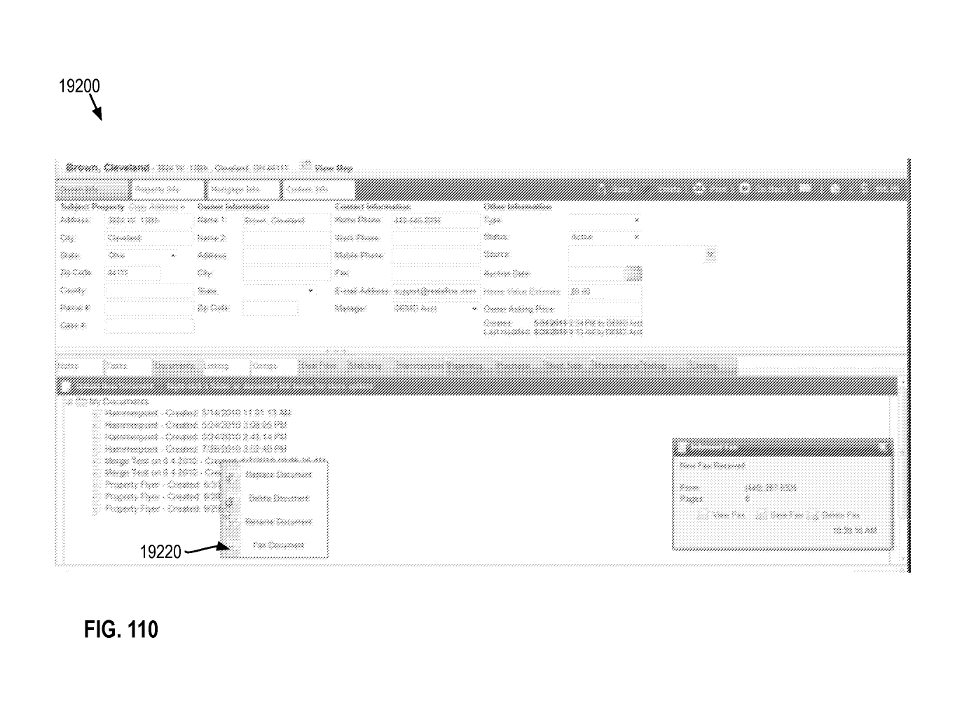

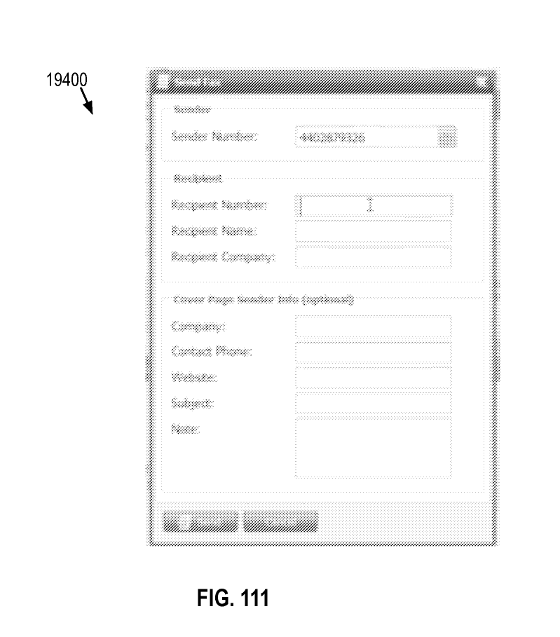

FIG. 110 is a simulated screen 19200 for one implementation that illustrates the selection of an option to send a fax. Upon selecting fax document option 19220, several fax sending options are displayed, such as simulated screen 19400 of FIG. 111. In the example shown, the fax options include the sender number, recipient number, recipient name, recipient company, and cover sheet info (company, contact phone, website, subject, and note). Upon selecting the send option, the selected document is faxed based upon the settings specified in the fax options.

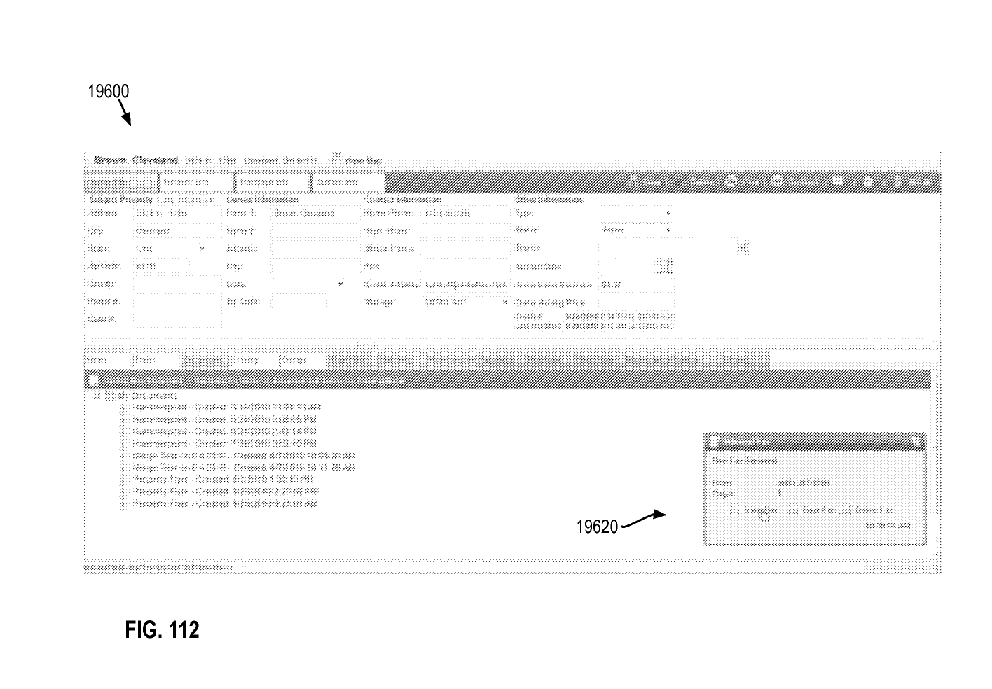

FIG. 112 is a simulated screen 19600 for one implementation that illustrates an alert message 19620 that is displayed when a new fax is received. In one implementation, no matter what the user is doing within the system, the alert is displayed to let the user know that the inbound fax has arrived. The alert message 19620 includes several options, such as view fax, save fax, and delete fax.

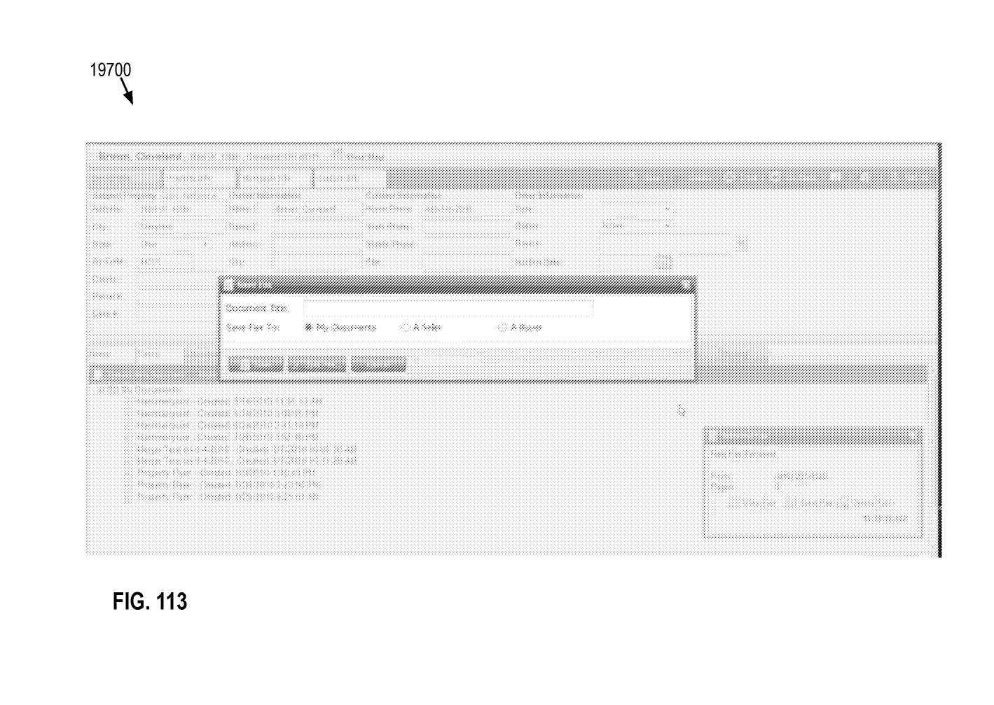

FIG. 113 is a simulated screen 19700 for one implementation that illustrates options for saving a fax to a particular record or other document location. In the example shown, the user can specify the document title, and where to save the fax (to “my documents” in the system, to a seller record, or to a buyer record). An option is provided to split the fax into different documents, as described in more detail in later figures.

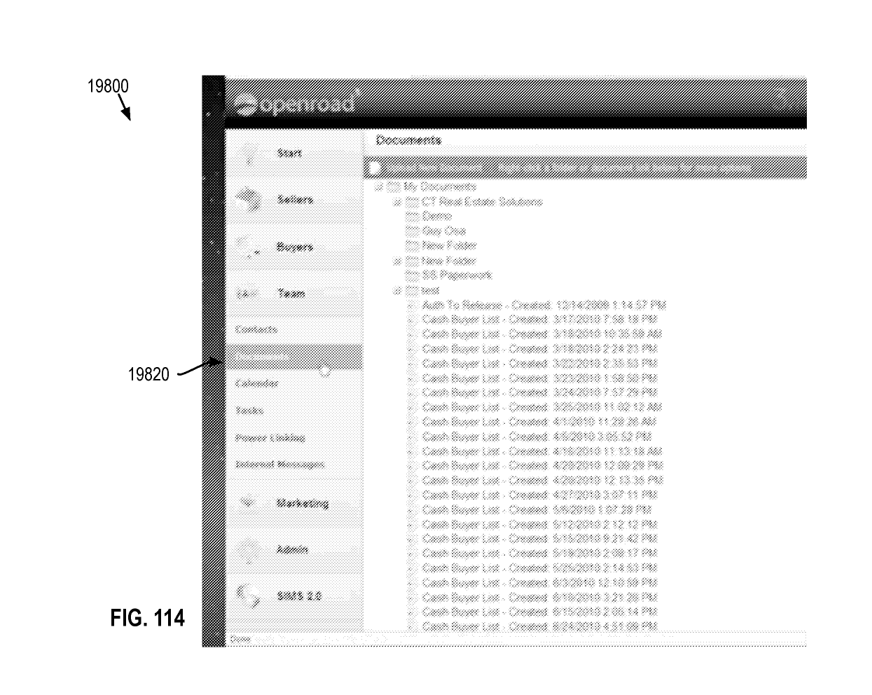

FIG. 114 is a simulated screen 19800 for one implementation that illustrates a documents section 1982 of the system that faxes can be saved to.

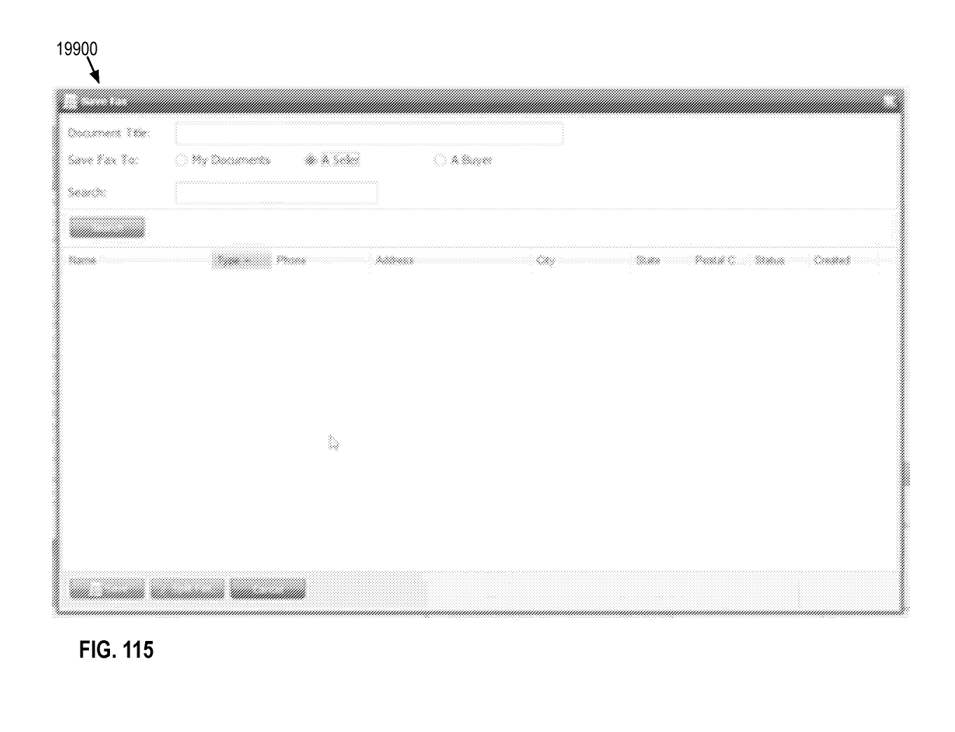

FIG. 115 is a simulated screen 19900 for one implementation that illustrates some options for saving a fax to a seller record. When the option to save the fax to a seller is selected, additional fields are displayed, such as a search option to locate a particular seller record. Once the search is performed, matching seller records will be displayed in a list, such as with their name, type, phone, address, city, state, postal code, status, and created date.

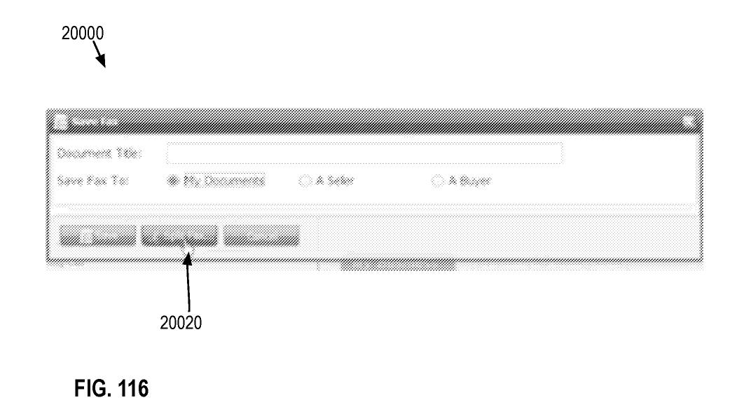

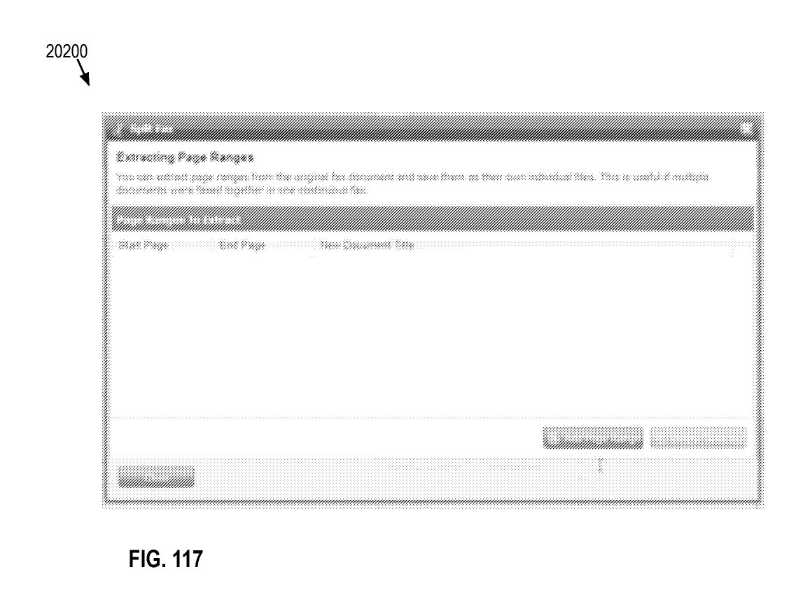

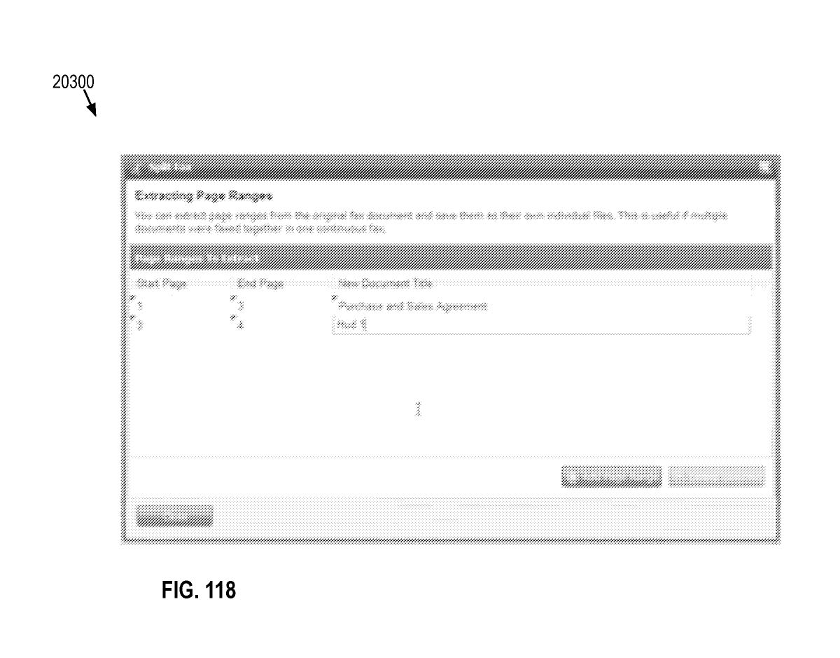

FIG. 116 is a simulated screen 20000 for one implementation that illustrates selecting an option to split a fax into multiple documents. Upon selecting split fax option 20020, a simulated screen 20200 as shown in FIG. 117 is displayed. The user can select the add page range option to add page ranges for how the fax should be split up. FIG. 118 is a simulated screen 20300 that shows an example how the selected fax can be split into different page ranges, including page ranges that overlap, when desired. In the example shown, there are two documents that will be created from this one fax. The start page, end page, and new document title fields indicate the details for how the split will be performed.

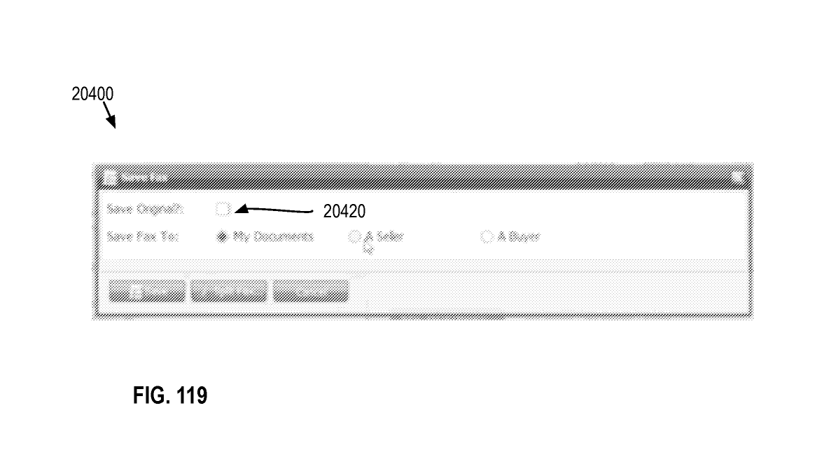

FIG. 119 is a simulated screen 20400 for one implementation that illustrates having an option to save the original fax 20420 in addition to the split fax. When option 20420 is selected, the original fax will be saved as well as the different documents that created from splitting up the fax into separate documents.

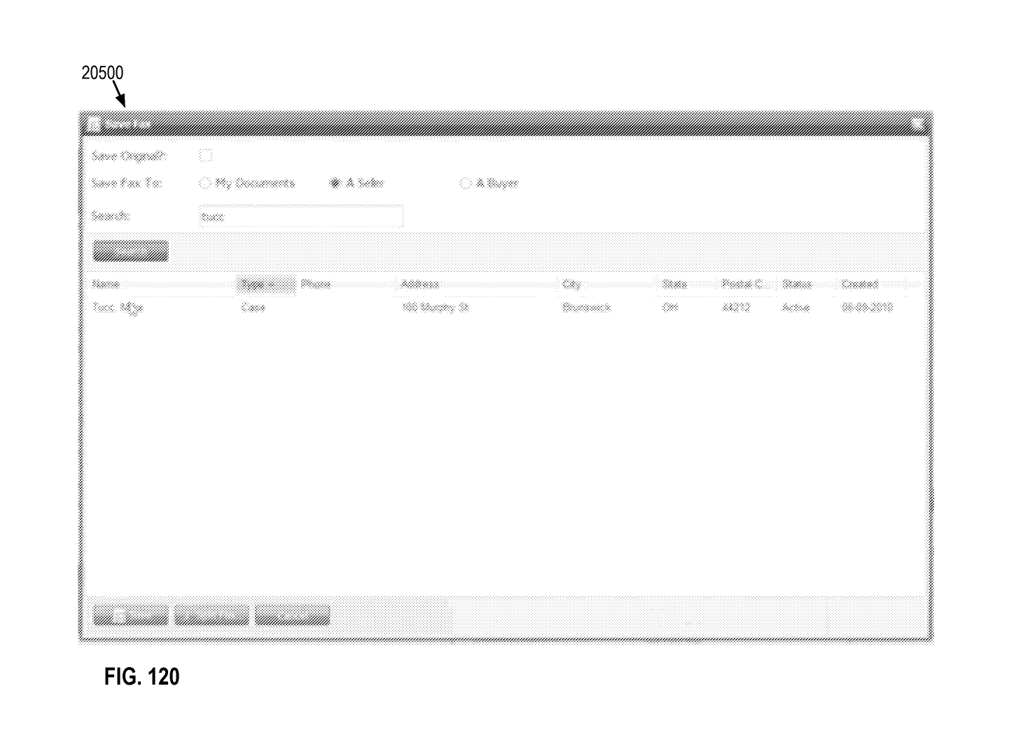

FIG. 120 is a simulated screen 20500 for one implementation that illustrates searching for a seller record to save the fax to. Seller records that match the specified criteria are displayed, and upon selecting a seller record in the list and choosing the save option, the fax is saved to that seller record.

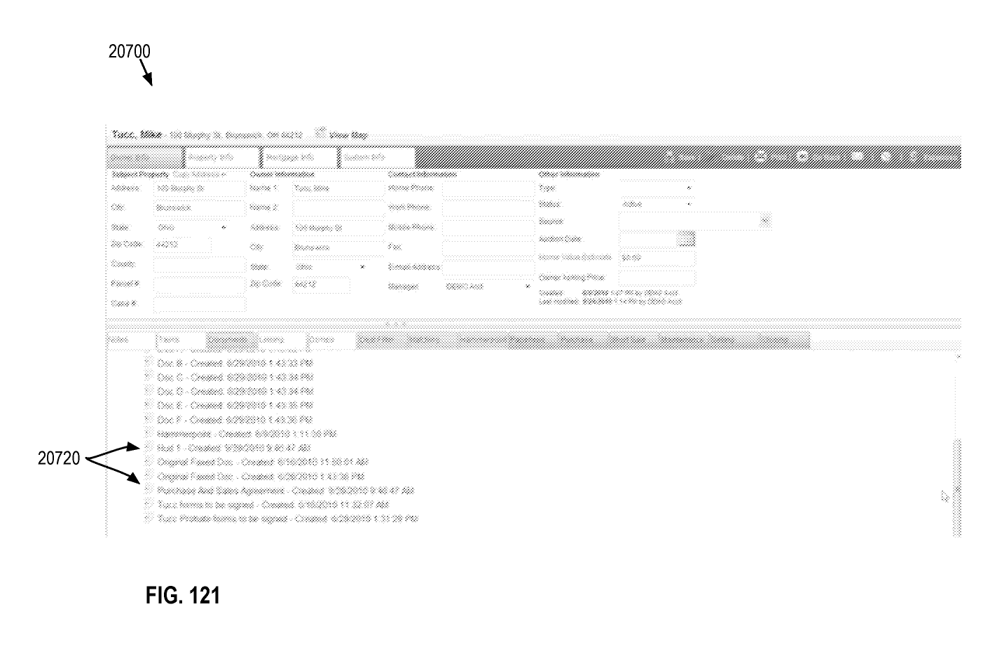

FIG. 121 is a simulated screen 20700 for one implementation that illustrates the split fax being saved as separate documents 20720 to the selected seller record, because the split fax option was used in these examples for illustration purposes. In other examples, the fax does not have to be split, but would just simply be displayed in its original form.

Turning now to FIGS. 122-134, additional details are provided on auto package generator 10320. Auto package generator 10320 allows various types of document packages to be created (and optionally then faxed to others using the digital fax feature). One example of how auto package generator can be used is to create a short sale package that a bank may require before approving a short sale to sell a property for a lower amount than current owner's mortgage balance. Such packages tend to be really complex and require several different documents to be included. Auto package generator 10320 streamlines the process of creating and optionally submitting such packages, all from within real estate business collaboration system 10000.

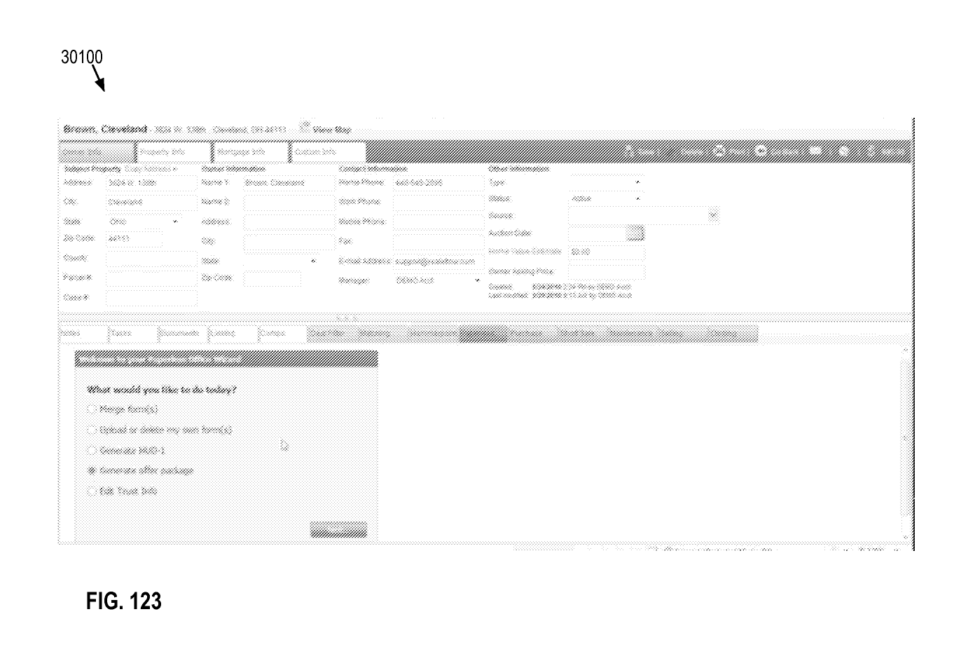

FIG. 122 is a process flow diagram 30000 for one implementation illustrating the stages involved in using an auto package generator to create document packages. The auto package wizard is launched (stage 30020), such as when a user selects an option to create a new package. A selection is received from the user on the type of package to be created (stage 30040), such as short sale package, probate package, wholesale package, etc. A selection is received from the user on the types of documents to include in the package (stage 30060). In one implementation, a list of the common types of documents that need to be included in the specified package are provided as a guide. The user then selects the actual document(s) that correspond with each type of document that needs to be included in the package (stage 30060). When the user selects an option to generate the package, the package is generated (stage 30080). A notice or other indicator is also displayed to the user when the package has been generated to allow the user to further interact with the package, such as to view the package or go to the record associated with the package (stage 30080). Several simulated screens are provided in FIGS. 123-134 to provide additional details on the auto package generator 1032.

FIG. 123 is a simulated screen 30100 for one implementation that illustrates to selecting an option to use an auto package generator. In the example shown, the user has selected an option to generate an offer package.

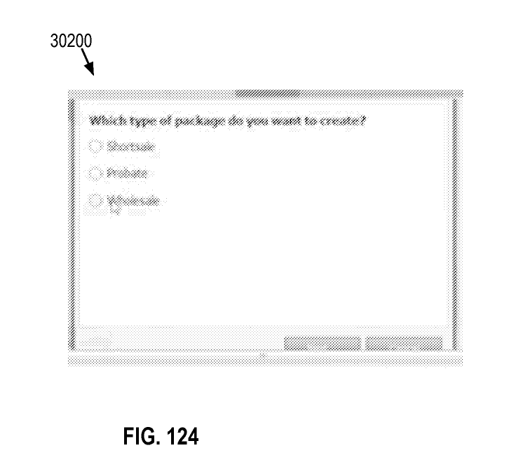

FIG. 124 is a simulated screen 30200 for one implementation that illustrates selecting a type of auto package to generate. In the example shown, the user can create a short sale package, probate package, or wholesale package.

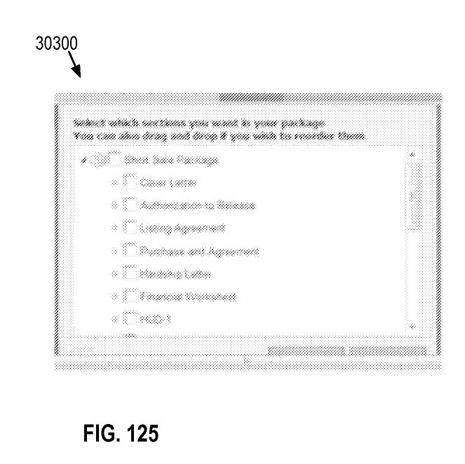

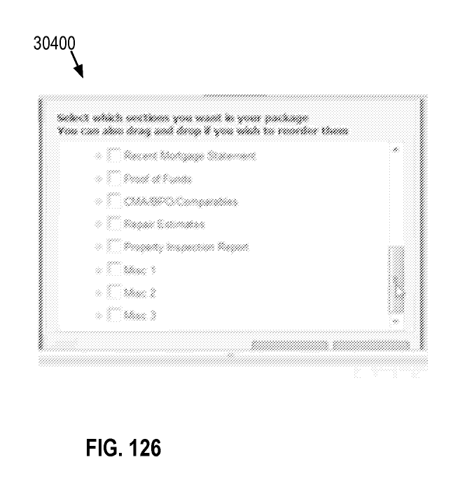

FIG. 125 is a simulated screen 30300 for one implementation that illustrates some exemplary section of a short sale package. In the example shown, there are numerous types of documents that are typically included in a short sale package, such as Cover Letter, Authorization to Release, Listing Agreement, Purchase and Agreement, Hardship Letter, Financial Worksheet, HUD1, etc. As shown in simulated screen 30400 of FIG. 126, custom sections (such as those marked as Misc 1, Misc 2, and Misc 3) can also be specified instead of or in addition to those included in the template list.

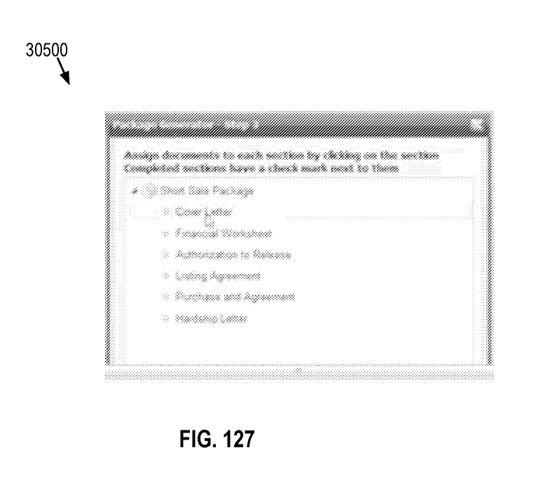

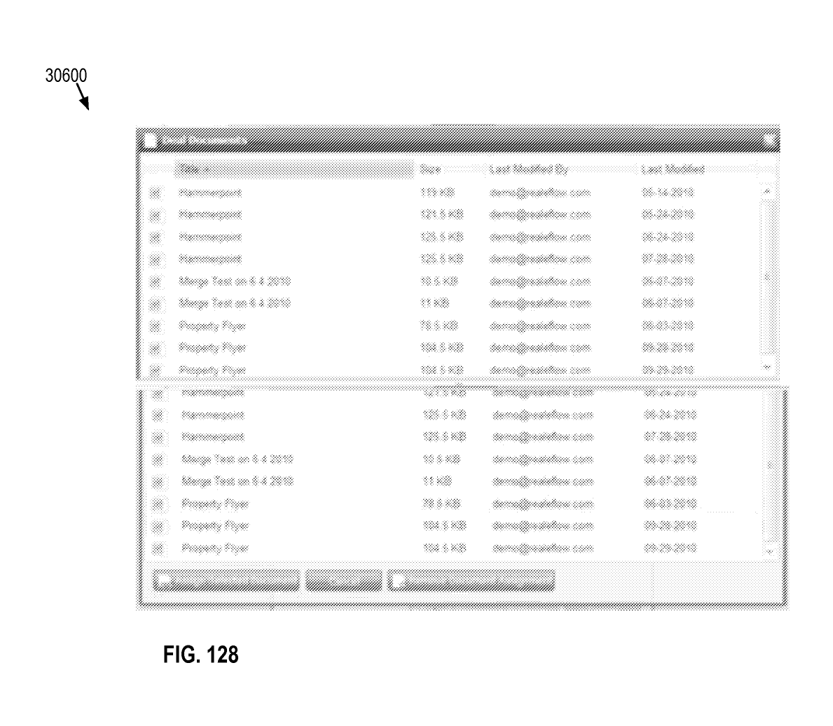

FIG. 127 is a simulated screen 30500 for one implementation that illustrates selecting a section to assign document(s) to. As one non-limiting example, once cover letter is selected in the example shown, another window will be displayed to allow the user to assign document(s) to use as the cover letter. A simulated screen 30600 such as the one shown in FIG. 128 is then displayed to bring up a list of possible documents that can be used for that section.

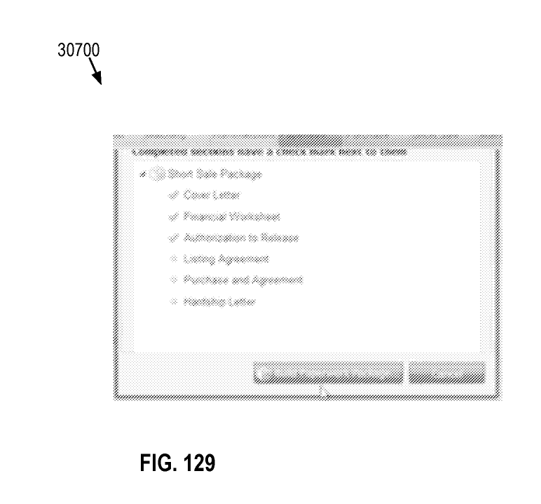

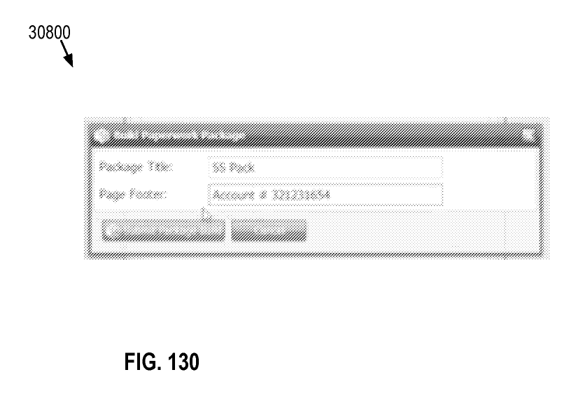

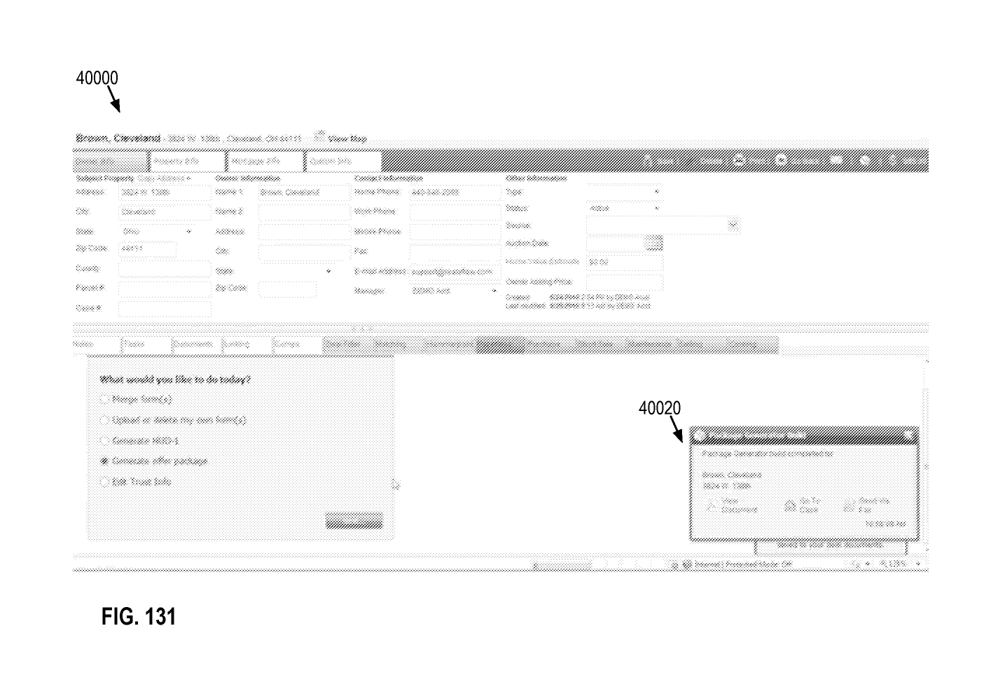

FIG. 129 is a simulated screen 30700 for one implementation that illustrates which sections of the auto package have been specified (such as with a check box). Simulated screen 30700 also includes an option to generate the package. Once the option to build the paperwork package has been selected, another screen such as simulated screen 30800 of FIG. 130 is displayed. The user can specify the package title, page footer, and/or other details to include within the package. The user can select the submit package build option to have the package generated. An alert notification is then displayed to indicate that the package has been generated, such as the alert 40020 that is shown in simulated screen 40000 of FIG. 131. Alert notification 40020 includes various options, such as view document, go to case associated with the package, or send the package to someone (such as a bank) by the digital fax tool.

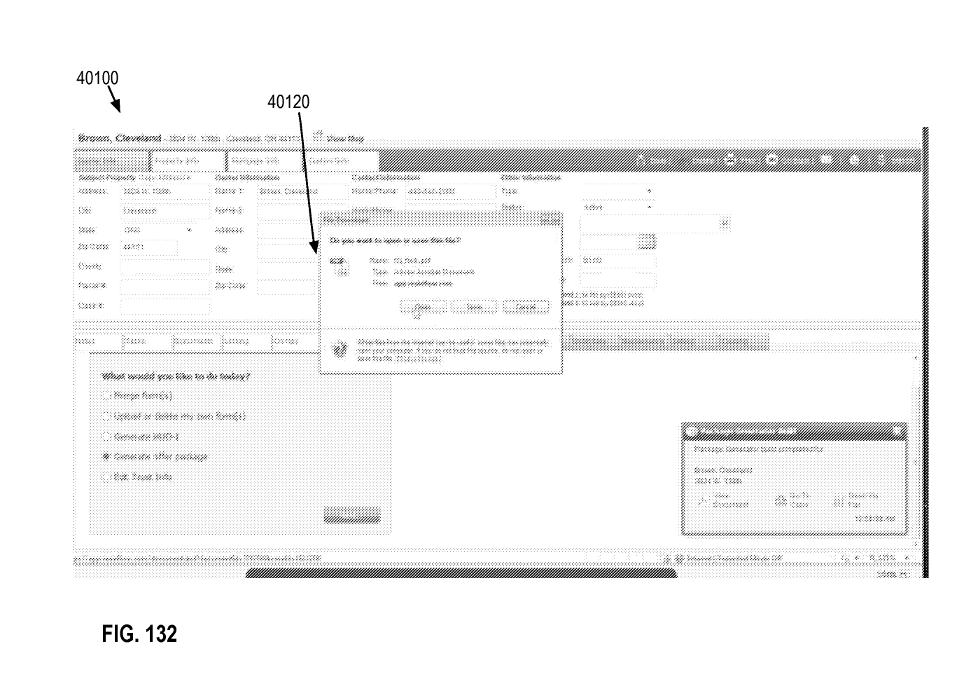

FIG. 132 is a simulated screen 40100 for one implementation that illustrates selecting an option 40120 to open the newly created package.

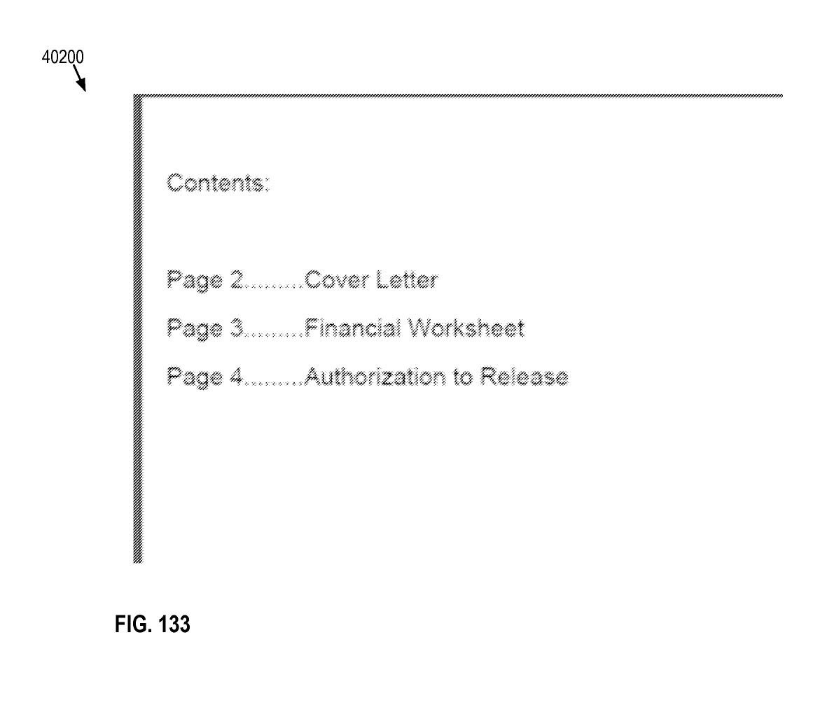

FIG. 133 is a simulated screen 40200 for one implementation that illustrates an exemplary package that was created using the auto package generator.

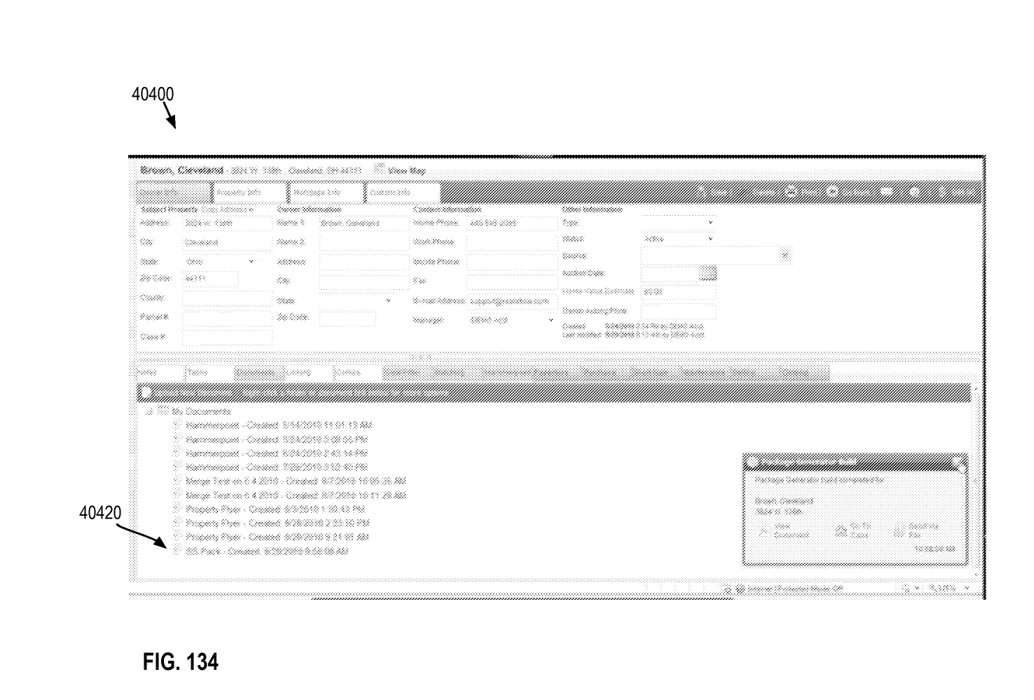

FIG. 134 is a simulated screen 40400 for one implementation that illustrates how the package 4042 gets saved in the record it was generated for.

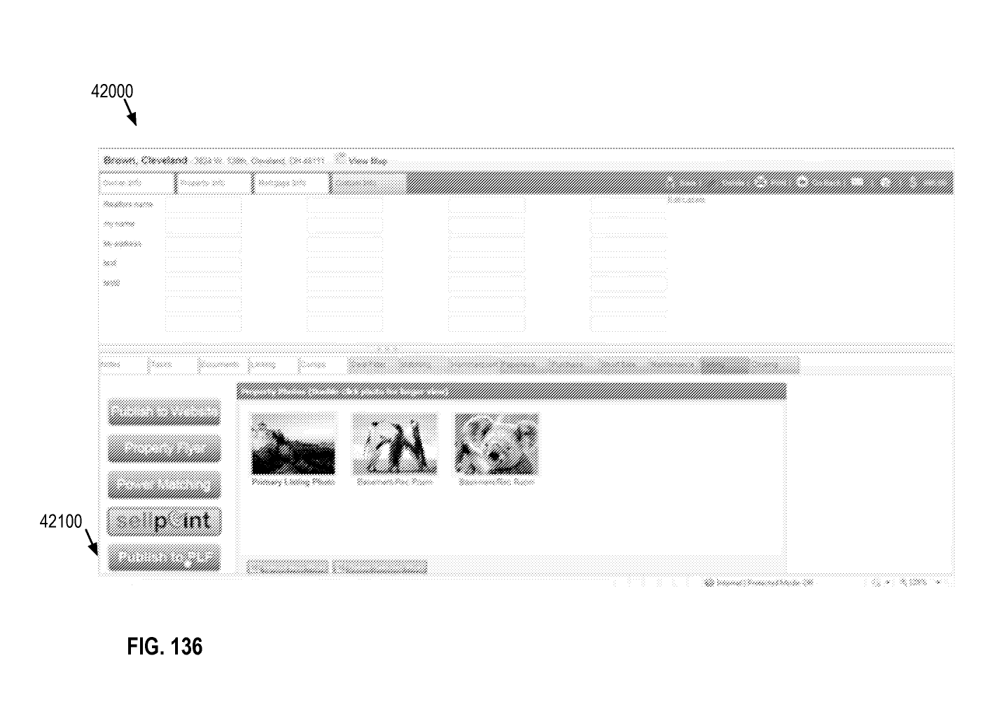

Turning now to FIGS. 135-138, additional details are provided for property launch template tool 10120. Property launch template tool 10120 enables a property to be launched (made available for sale) on a certain date and time, but with a countdown timer and other features to encourage new leads to request additional information about the property. FIG. 135 is a process flow diagram 41000 for one implementation illustrating the stages involved in using a property launch template to launch a property for sale at a specific date and time. A selection is received from a user to publish a property as a property launch (stage 41020). The property launch settings are also received from the user, such as the website location for the property launch and the launch date (stage 41040). The property launch web page is created or updated based upon the specified settings (stage 41060). The property launch web page is then displayed to visitors, with the ticking countdown timer being displayed up to the time of the launch (stage 41080). Some additional details regarding the property launch template tool are provided in FIGS. 136-138.

FIG. 136 is a simulated screen 42000 for one implementation that illustrates selecting an option 42100 to launch a property launch template tool.

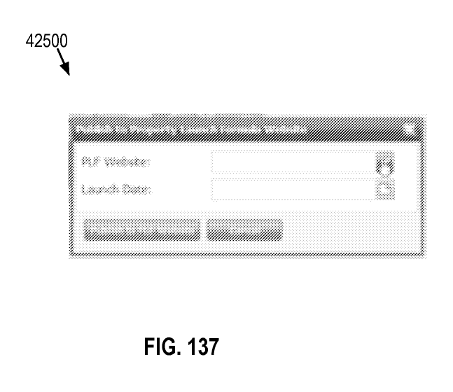

FIG. 137 is a simulated screen 42500 for one implementation that illustrates specifying details of the property launch. In the example shown, the web site location for the property launch, and the launch date can be specified. Upon selecting the publish to web site option, the property launch web site is created and/or updated with the new settings.

FIG. 138 is a simulated screen 42800 for one implementation that illustrates an exemplary property launch web site. In the example shown, the property has already launched, so the countdown timer is at 0. That means that the property is available for sale and offers can be made. Additional details about the property are shown, such as the property address, list price, photos, a video about the property, an opt-in option to request additional information about the property. In other implementations, fewer or additional details could be included on the property launch page.

As shown in FIG. 139, an exemplary computer system to use for implementing one or more parts of the system includes a computing device, such as computing device 50000. In one implementation, one or more parts of computing device 50000 can be part of the devices described in FIG. 74A. In its most basic configuration, computing device 50000 typically includes at least one processing unit 50020 and memory 50040. Depending on the exact configuration and type of computing device, memory 50040 may be volatile (such as RAM), non-volatile (such as ROM, flash memory, etc.) or some combination of the two. This most basic configuration is illustrated in FIG. 139 by dashed line 50060.

Additionally, device 50000 may also have additional features/functionality. For example, device 50000 may also include additional storage (removable and/or non-removable) including, but not limited to, magnetic or optical disks or tape. Such additional storage is illustrated in FIG. 139 by removable storage 50080 and non-removable storage 50100. Computer storage media includes volatile and nonvolatile, removable and non-removable media implemented in any method or technology for storage of information such as computer readable instructions, data structures, program tools or other data. Memory 50040, removable storage 50080 and non-removable storage 50100 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 50000. Any such computer storage media may be part of device 50000.

Computing device 50000 includes one or more communication connections 50140 that allow computing device 50000 to communicate with other computers/applications 50150. Device 50000 may also have input device(s) 50120 such as keyboard, mouse, pen, voice input device, touch input device, etc. Output device(s) 50110 such as a display, speakers, printer, etc. may also be included. These devices are well known in the art and need not be discussed at length here.

Reference throughout this specification to “one embodiment”, “an embodiment”, “a specific embodiment”, or “one implementation”, means that a particular feature, structure, or characteristic described in connection with the embodiment is included in at least one embodiment of the present invention and not necessarily in all embodiments. Thus, respective appearances of the phrases “in one embodiment”, “in an embodiment”, “in a specific embodiment”, or “in one implementation” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

For example, a person of ordinary skill in the computer software art will recognize that the examples discussed herein could be organized differently on one or more computers to include fewer or additional options or features than as portrayed in the examples.

Further, at least some of the components of an embodiment of the invention may be implemented by using a programmed general purpose digital computer, by using application specific integrated circuits, programmable logic devices, or field programmable gate arrays, or by using a network of interconnected components and circuits. Connections may be wired, wireless, by modem, and the like.

It will also be appreciated that one or more of the elements depicted in the drawings/figures may also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear. As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

1-17. (canceled)

18. A computer implemented real estate lead generation and business collaboration system comprising:
a database configured to store buyer data about one or more buyers who are real estate investors, wherein the buyer data includes attributes of real estate transactions the one or more buyers are potentially interested in;
the database configured to store intermediary data about one or more intermediaries who are member users, wherein each intermediary represents one or more buyers, and wherein the relationship between each intermediary and the one or more buyers is stored in the database;
wherein the system is configured to accept input from a seller who is a member user, and wherein the input defines attributes of a proposed real estate transaction; and
a suitability matching tool configured to compare the attributes of the proposed real estate transaction with the buyer data to produce a list of one or more buyers and to identify their corresponding intermediaries,
wherein the suitability matching tool is configured to send a message from the seller to the identified intermediaries providing information about the proposed transaction, and
wherein each identified intermediary is enabled to send the proposed transaction information to listed buyers who are associated with that intermediary.

19. The system of claim 18, comprising:
a guest linking tool configured to provide the listed buyers associated with one or more of the identified intermediaries access to the system to access the proposed transaction information, wherein the guest linking tool is configured to monitor and report the responsiveness of the one or more buyers to the proposed transaction to a member user.

20. The system of claim 19, wherein the system is configured to allow a member user to control access to the details about the proposed transaction.

21. The system of claim 18, comprising:
a property syndication tool configured to broadcast details about the proposed transaction properties to a plurality of distribution mediums.

22. The system of claim 21, wherein the plurality of distribution mediums include online classified ad web sites.

23. The system of claim 24, comprising:
a property launch template configured to generate a web page with information about the proposed real estate transaction, wherein the web page is configured to capture information about buyers who express interest in the proposed real estate transaction.

24. The system of claim 18, comprising:
a paperless office module configured to create and send digital documents used by the seller, a buyer, and an intermediary in finalizing the proposed real estate transaction.

25. The system of claim 18, comprising:
a lead pipes tool that is configured to analyze data from external sources to look for potential real estate transactions and associated sellers.

26. The system of claim 25, wherein the external sources are selected from the group including bankruptcy records, foreclosure records, tax lien records, renter records, homeowner records, and cash buyer records.

27. A computer implemented real estate lead generation and collaboration system comprising:
a database configured to store buyer data about one or more buyers, wherein the buyer data includes transaction attributes for real estate deals that each buyer is interested in;
the database configured to store intermediary data about one or more intermediaries, wherein each intermediary is associated with one or more buyers, and wherein the intermediaries are member users;
wherein the system accepts from a seller a proposed real estate transaction with specified proposed transaction attributes, and wherein the seller is a member user;
a suitability matching tool configured to compare the proposed transaction attributes with the associated buyer data to produce a list of one or more potential buyers and their corresponding intermediaries whose buyer data matches the proposed transaction attributes, wherein the suitability matching tool is configured to notify the one or more corresponding intermediaries and to provide information about the proposed real estate transaction for distribution to the listed buyers who are associated with that intermediary.

28. The system of claim 27, wherein the system is configured to provide the one or more potential buyers access to the proposed transaction information, wherein the system is configured to monitor the responsiveness of the potential buyers to the proposed transaction and report it to a member user.

29. The system of claim 28, wherein the system is configured to allow a member user to control access to the details about the proposed transaction.

30. The system of claim 27, comprising:
a property syndication tool configured to broadcast details about the proposed real estate transaction to a plurality of distribution mediums.

31. The system of claim 30, wherein the plurality of distribution mediums include online classified ad web sites.

32. The system of claim 27, comprising:
a property launch template configured to generate a property launch web page with information about the proposed real estate transaction, wherein the property launch web page is configured to capture information from buyers who express interest in the proposed real estate transaction.

33. A computer implemented real estate lead generation and collaboration system comprising:
a database configured to store buyer data about one or more buyers, wherein the buyer data includes transaction attributes for real estate deals that each buyer is interested in;
the database configured to store intermediary data about one or more intermediaries, wherein each intermediary is an agent operating on behalf of one or more buyers, and wherein the intermediaries are member users;
wherein the system accepts from a seller a proposed real estate transaction with specified proposed transaction attributes, and wherein the seller is a member user;
a suitability matching tool configured to compare the proposed transaction attributes with the buyer data to produce a list of one or more potential buyers and their corresponding intermediaries whose buyer data matches the proposed transaction attributes,
wherein the suitability matching tool is configured to notify the one or more corresponding intermediaries representing each of the buyers on the list of buyers;
a guest linking tool configured to provide the one or more potential buyers access to the system to access details about the proposed transaction, wherein the guest linking tool is configured to monitor the responsiveness of the one or more potential buyers to the proposed transaction.

34. The system of claim 33, comprising:
a paperless office module configured to create and send digital documents used by the seller, one or more buyers, and intermediaries that are used in finalizing the proposed real estate transaction.

35. The system of claim 33, wherein the system is configured to allow a member user to control access to the details about the proposed transaction.

36. The system of claim 33, comprising:
a property syndication tool configured to broadcast details about the proposed real estate transaction to at least one web site.

37. The system of claim 33, wherein the guest linking tool is configured to report the responsiveness of the one or more potential buyers to a member user.
